(19) United States
(12) Patent Application Publication
(10) Pub. No.: US 2014/0341109 A1
(43) Pub. Date: Nov. 20, 2014

(54) Methods, Apparatus and Systems for Managing Converged Gateway Communications

(71) Applicants: John Cartmell, North Massapequa, NY (US); John L. Tomici, Southold, NY (US); Bartosz Balazinski, Montreal (CA); Alexander Reznik, Titusville, NJ (US); David G. Greiner, New Hyde Park, NY (US); John M. McNally, Huntington, NY (US); Kenneth F. Lynch, Wayne, PA (US); Prabhakar R. Chitrapu, Blue Bell, PA (US); Jane Mack, Melville, NY (US); Suresh Palanisamy, Namakkal District (IN); Khasim Shaheed, Bangalore (IN); Siddhartha Kundalkar, Karnataka (IN)

(72) Inventors: John Cartmell, North Massapequa, NY (US); John L. Tomici, Southold, NY (US); Bartosz Balazinski, Montreal (CA); Alexander Reznik, Titusville, NJ (US); David G. Greiner, New Hyde Park, NY (US); John M. McNally, Huntington, NY (US); Kenneth F. Lynch, Wayne, PA (US); Prabhakar R. Chitrapu, Blue Bell, PA (US); Jane Mack, Melville, NY (US); Suresh Palanisamy, Namakkal District (IN); Khasim Shaheed, Bangalore (IN); Siddhartha Kundalkar, Karnataka (IN)

(73) Assignee: INTERDIGITAL PATENT HOLDINGS, INC., Wilmington, DE (US)

(21) Appl. No.: 14/123,505

(22) PCT Filed: Jun. 1, 2012
(86) PCT No.: PCT/US12/40588

§ 371 Date: Aug. 6, 2014

Related U.S. Application Data
(60) Provisional application No. 61/492,690, filed on Jun. 2, 2011.
(60) Provisional application No. 61/506,388, filed on Jul. 11, 2011.
(60) Provisional application No. 61/564,528, filed on Nov. 29, 2011.
(60) Provisional application No. 61/564,534, filed on Nov. 29, 2011.
(60) Provisional application No. 61/564,533, filed on Nov. 29, 2011.

(51) Int. Cl. H04L 12/801; H04L 12/26; H04W 40/02

(52) U.S. Cl. CPC H04L 47/14; H04W 40/02; H04L 43/50
USPC 370/328

(57) ABSTRACT

Systems and methods for providing a converged gateway (CGW) may be disclosed. A policy may be by the CGW to make routing decisions (e.g. segregation and/or aggregation of flows or traffic associated with data) for various interfaces and/or radio access technologies (RATs) that may be included in a LAN, device, and/or communication system. The policy may be locally stored within the CGW. Dynamic flow management, load balancing, offloading, PDF context establishment, prioritization, detection of devices, and the like may also be provided and/or implemented in the CG W and may be used to route flows and/or traffic associated with data.

### BACKGROUND

Typically, cellular communication systems transmit and receive signals within a designated spectrum. Unfortunately, the capacity of such a spectrum tends to be limited. Additionally, the demand for such cellular communication systems continues to increase and expand to service users and devices associated with the users. As such, a number of wireless communication techniques have been developed to reduce the demand on the spectrum associated with cellular communication systems including offloading techniques such as IP flow mobility. For example, in a core network associated with such cellular communication systems, traffic may be offloaded using IP flow mobility from the cellular communication systems to another interface or radio access technology (RAT) such as a Wireless Fidelity (Wi-Fi, WiFi, or Wifi). Unfortunately, current offloading techniques including IP flow mobility may be controlled by the device associated with the user even though such techniques may be managed by the core network and, as such, the core network may not be able to make decisions regarding such offloading techniques including IP flow mobility.

### SUMMARY

Systems, methods, and/or techniques for routing data traffic and/or data flows may be provided. For example, in an embodiment, data may be segregated using a converged gateway (CG) by storing a policy for a device on the CGW where the device may include a first interface and a second interface; receiving a flow addressed to the device at the CGW where the flow may include a packet; identifying a flow type of the packet at the CGW; and transmitting the packet from the CGW to the device via one of the first and second interfaces identified in a policy associated with the flow type when the device is reachable via the first and second interfaces.

In another embodiment, data may be segregated using a CGW by receiving a packet from a mobile core network addressed to a device; transmitting the packet via a cellular network when the device is not reachable over a Wi-Fi network; and determining a packet transport preference for the device and transmitting the packet to the device via the transport preference when the device is reachable over the Wi-Fi network where the transport preference may be either the cellular network or the Wi-Fi network.

Data may also be segregated, for example, in another embodiment, by receiving a plurality of flows addressed to a device where the device may have a first radio access technology (RAT) connection and a second RAT connection; identifying a category of each of the flows; prioritizing each of the flows based on the category and a classification of a user of the device; and sending each of the plurality of the downlink flows to the device via one of the first RAT connection and the second RAT connection based on the priority of each flow.

According to yet another example embodiment, data may be aggregated by receiving an Internet Protocol (IP) data flow; identifying the IP data flow; and transmitting the IP data flow to user equipment (UE) through a first radio access technology (RAT) and a second RAT based on a policy.

In an embodiment, data or traffic may also be routed by receiving, at a CGW within a mobile network, a network packet from a serving gateway where the network packet may be addressed to a node associated with a first radio access technology; and offloading, at the CGW, the network packet to a node associated with a second radio access technology.

Data or traffic may further be routed by segregating, at a CGW, a plurality of traffic flows based at least in part on a segregation factor; assigning, at the CGW, a traffic flow to one of plurality of radio access technology (RAT) connections provided by a terminal device; and load balancing, at the CGW, the plurality of RAT connections.

The Summary is provided to introduce a selection of concepts in a simplified form that are further described below in the Detailed Description. This Summary is not intended to identify key features or essential features of the claimed subject matter, not is it intended to be used to limit the scope of the claimed subject matter. Furthermore, the claimed subject matter is not limited to any limitations that solve any or all disadvantages noted in any part of this disclosure.

### BRIEF DESCRIPTION OF THE DRAWINGS

A more detailed understanding of the embodiments disclosed herein may be had from the following description, given by way of example in conjunction with the accompanying drawings.

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D depicts a system diagram of another example radio access network and an example core network that may be used within the communications system illustrated in FIG. 1A.

FIG. 1E depicts a system diagram of another example radio access network and an example core network that may be used within the communications system illustrated in FIG. 1A.

FIG. 2 is an exemplary illustration of a procedure for CGW initialization.

FIG. 3 is an exemplary illustration of a procedure for HNB initialization.

FIG. 4 is an exemplary illustration of a procedure for LGW initialization.

FIG. 5 is an exemplary illustration of a procedure an IMS client initialization.

FIG. 6 is an exemplary illustration of a LGW registration.

FIG. 7 is an exemplary illustration of a proxy call session control function (PCSCF) discovery procedure.

FIG. 8 is an exemplary illustration of an IMS registration procedure.

FIG. 9 is an exemplary illustration of a procedure for subscription to ‘reg’ Event state.

FIG. 10 is an exemplary illustration of a procedure for device registration.

FIG. 11 is an exemplary illustration of a procedure for UE registration (NON CSG UE).

FIG. 12 is an exemplary illustration of a procedure for UE registration (CSG UE).

FIG. 13 is an exemplary illustration of a procedure for a UE attached to its home LGW and accessing a device on its home network.

FIG. 14 is an exemplary illustration of a procedure for a LIPA path setup and data transfer.

FIG. 15 is an exemplary illustration of a procedure for a UE that goes into IDLE state while preserving its PDP context.

FIG. 16 is an exemplary illustration of a procedure for a UE previously attached to its home LGW and the network initiates a data transfer.

FIG. 17 is an exemplary illustration of a procedure for PDP context creation.

FIG. 18 is an exemplary illustration of a procedure for RAB setup and user plane tunnel establishment for one tunnel.

FIG. 19 is an exemplary illustration of a procedure for RAB setup and user plane tunnel establishment for two tunnels.

FIG. 20 is an exemplary illustration of a procedure for RAB release and PDP context preservation.

FIG. 21 is an exemplary illustration of a procedure for Iu release and PDP context preservation.

FIG. 22 is an exemplary illustration of a procedure for a UE attached to a neighbor's HNB accessing a device on the UE's home network.

FIG. 23 is an exemplary illustration of a procedure for ELIPA path setup and data transfer.

FIG. 24 is an exemplary illustration of a procedure for an attached UE going into IDLE state while its PDP context is preserved.

FIG. 25 is an illustration of a procedure for a UE previously attached to its home LGW and a network initiated data transfer.

FIG. 26 is an exemplary illustration of a procedure for PDP context creation.

FIG. 27 is an exemplary illustration of a RAB setup and user plane establishment with one tunnel.

FIG. 28 is an exemplary illustration of a RAB setup and user plane tunnel with two tunnel establishment.

FIG. 29 is an exemplary illustration of a procedure for RAB release and PDP context preservation.

FIG. 30 is an exemplary illustration of an Iu release and PDP context preservation.

FIG. 31 is an exemplary illustration of a procedure for a UE moving to a neighbor's HNB after attachment to the UE's home LGW and the UE accessing a device in its home network.

FIG. 32 is an exemplary illustration of a procedure for a UE moving to its home node B while attached to a neighbor's HNB.

FIG. 33 is an exemplary illustration of a procedure wherein a UE attached to its home HNB moves to a macro network.

FIG. 34 is an exemplary illustration of a procedure wherein a UE attached to a macro network moves to its home network.

FIG. 35A is an exemplary illustration of a procedure for intra HNBGW mobility (LIPA to ELIPA).

FIG. 35B is an exemplary illustration of a procedure for intra HNBGW mobility (LIPA to ELIPA), wherein FIG. 35B is a continuation of 35A.

FIG. 36A is an exemplary illustration of a procedure of a UE accessing a home device and moving to a macro network (LIPA to MRA).

FIG. 36B is an exemplary illustration of a procedure a UE accessing a home device and moving to a macro network (LIPA to MRA), wherein FIG. 36B is a continuation of FIG. 36A.

FIG. 37 A is an exemplary illustration of a procedure for a UE accessing a home device via a macro network and moving to a femto network (MRA to LIPA).

FIG. 37B is an exemplary illustration of a procedure for a UE accessing a home device via a macro network and moving to a femto network (MRA to LIPA), wherein FIG. 37B is a continuation of FIG. 37 A.

FIG. 38 is an exemplary illustration of a procedure for the establishment of data services between a UE and core network.

FIG. 39 is an exemplary illustration of a procedure for the mobility of a UE connected to one HNB to a neighbor's home network, wherein the neighbor is connected to another HNB.

FIG. 40 is an exemplary illustration of a procedure for BWM initialization.

FIG. 41 is an exemplary illustration of a procedure for CGW initialization in the presence of BWM.

FIG. 42 is an exemplary illustration of a procedure for HNB registration.

FIG. 43 is an exemplary illustration of UE registration (Non closed subscriber group (CSG) UE).

FIG. 44 is an exemplary illustration of UE registration for a CSG UE.

FIG. 45 is an exemplary illustration of packet switched (PS) data services establishment.

FIG. 46 is an exemplary illustration of cellular PDP context establishment.

FIG. 47 A is an exemplary illustration of procedures for intra HNBGW mobility (LIPA to ELIPA).

FIG. 47B is an exemplary illustration of procedures for inU′a HNBGW mobility (LIPA to ELIPA), wherein FIG. 47B is a continuation of FIG. 47A.

FIG. 48 is an exemplary illustration of IKE IPSec procedures between BWM and SeGW.

FIG. 49 is an exemplary illustration of procedures for RAB Setup and user plane establishment with one tunnel establishment.

FIG. 50 is an exemplary illustration of procedures for RAB setup and user plane tunnel establishment with two tunnel establishment.

FIG. 51 is an exemplary illustration of architecture of a CGW Hybrid Network.

FIG. 52 is an exemplary illustration of architecture of a CGW Hybrid Network.

FIG. 53 is an exemplary block diagram that illustrates the high-level architecture of a Converged Gateway.

FIG. 54 is an exemplary illustration of a network layout including a BWM system.

FIG. 55 is an exemplary illustration of an enterprise implementation of BWM.

FIG. 56 is an exemplary illustration of a downlink data flow in an implementation of BWM.

FIG. 57 is an exemplary illustration of an uplink data flow in an implementation of BWM.

FIG. 58 is an exemplary illustration of a downlink cellular data flow that does not use BWM.

FIG. 59 is an exemplary illustration of a downlink data flow across BWM entities with mobility.

FIG. 60 is an exemplary illustration of an uplink cellular data flow that does not use BWM.

FIG. 61 is an exemplary illustration of an uplink data flow across BWM entities with mobility.

FIG. 62 is an exemplary illustration of an enterprise scenario with no BWM server.

FIG. 63 is an exemplary illustration of an enterprise scenario with one BWM server.

FIG. 64 is an exemplary illustration of an enterprise scenario with multiple BWM servers.

FIG. 65 is an exemplary illustration of a data path layer topology with no BWM server.

FIG. 66 is an exemplary illustration of a control path layer topology with no BWM server.

FIG. 67 is an exemplary illustration of a data path layer topology with a BWM server.

FIG. 68 is an exemplary illustration of a topology with a BWM server.

FIG. 69 is an exemplary illustration of protocol stack with BWM.

FIG. 70A is an exemplary illustration of a data protocol without BWM implemented.

FIG. 70B is an exemplary illustration of a data protocol with BWM.

FIG. 71A is an exemplary illustration of a data protocol with BWM.

FIG. 71B is an exemplary illustration of a data protocol with BWM.

FIG. 72 is an exemplary illustration of a BWM server sitting between the CN and RAN portions of the HNB.

FIG. 73 is an exemplary illustration of a BWM server sitting between the HNB and the SeGW of the MCN.

FIG. 74 is an exemplary illustration of a BWM server sitting somewhere on the Internet.

FIG. 75 is an exemplary illustration of a BWM server sitting somewhere on the Internet.

FIG. 76 is an exemplary illustration of BWM implemented in a selected IP traffic offload (SIPTO) network configuration.

FIG. 77 is an exemplary illustration of BWM implemented in an extended local internet protocol (ELIP A) network configuration.

FIG. 78 shows an exemplary illustration of a communication network including a CGW.

FIGS. 79-80 show exemplary illustrations of data traffic within a LAN including a CGW.

FIGS. 82-87 show exemplary illustrations of data traffic within a communication network including a CGW.

FIG. 88 shows an exemplary illustration of a topology of a LAN including a CGW.

FIG. 89 shows an exemplary illustration of IP addressing when a destination for the data is local to the LAN.

FIG. 90 is an exemplary illustration of IP addressing when a destination for the data is outside the LAN.

FIGS. 91A-91B show an exemplary illustration of a functional architecture of a CGW and wireless terminal device.

FIG. 92 shows an exemplary illustration of a Downlink Flow Routing table.

FIG. 93 shows an exemplary illustration of a segregation flow chart when a device has segregation disabled.

FIG. 94 shows an exemplary illustration of a segregation flow chart when a device has segregation enabled.

FIG. 95 shows an exemplary illustration of outbound mobility.

FIGS. 96-97 show exemplary illustrations of inbound mobility.

FIGS. 98-102 show exemplary illustrations of tables maintained by the CGW.

FIGS. 103 and 104 illustrate exemplary flow charts for segregating a flow of data.

FIG. 105 illustrates an exemplary flow chart for aggregating bandwidth.

FIG. 106 illustrates an exemplary flow chart for dynamic flow mobility.

FIG. 107 illustrates an exemplary flow chart for segregating a flow of data.

FIG. 108 illustrates a LTE mobile core network (MCN) architecture incorporating a converged gateway (CGW) in accordance with one non-limiting embodiment.

FIG. 109 illustrates an example data plane, in absence of a CGW, in accordance with one non-limiting embodiment.

FIG. 110 illustrates an example data plane, including a CGW, in accordance with one non-limiting embodiment.

FIG. 111 illustrates an example data plane, including a CGW and a Wi-Fi Access Point, in accordance with one non-limiting embodiment.

FIG. 112 illustrates an example control plane, in absence of a CGW, in accordance with one non-limiting embodiment.

FIG. 113 illustrates an example control plane, including a CGW, in accordance with one non-limiting embodiment.

FIGS. 114A-8D illustrate various signaling paradigms in accordance with various non-limiting embodiments.

FIGS. 115A-9B illustrate a procedure for establishing a PDP context, in absence of a CGW, in accordance with one non-limiting embodiment.

FIGS. 116A-10C illustrate a procedure for establishing a PDP context, in the presence of a CGW, in accordance with one non-limiting embodiment.

FIG. 117 illustrates various traversals of uplink and downlink data packets in accordance with one non-limiting embodiment.

FIGS. 118-123 illustrate non-limiting examples of various architectures that utilize a CGW integrated into a mobile core network.

FIG. 124 shows a configuration of the UE by the CGW in accordance with one non-limiting embodiment.

FIG. 125 depicts a message sequence chart (MSC) describing a non-limiting example interaction between the CGW and the UE that are illustrated in FIG. 124.

FIG. 126 shows a non-limiting example packet processing flow diagram.

FIG. 127 illustrates a non-limiting example flow diagram of a process that may be performed when a new IP Flow has been detected.

FIG. 128 shows a non-limiting example flow diagram for load balancing.

FIGS. 129A-B illustrates a UDP IP Flow assignment process flow in accordance with one non-limiting embodiment.

FIG. 130 illustrates a TCP IP Flow assignment process flow in accordance with one non-limiting embodiment.

FIG. 131 shows an example configuration of the UE and the CGW for providing measurements.

FIG. 132 shows a non-limiting example MSC describing the interaction for configuring the UE to perform measurements.

FIG. 133 shows an example of a UE sending a low signal alarm to a CGW.

FIG. 134 shows an example of a UE sending periodic reports to a CGW.

FIGS. 135A-141B illustrate example message sequence charts for a CGW.

FIG. 142 illustrates an example CGW home network layout.

FIG. 143 depicts example CGW data paths.

FIG. 144 shows TUN and TAP devices.

FIG. 145 shows a netfilter and netfilter queue.

FIG. 146 shows CGW components and interfaces in accordance with various embodiments.

FIG. 147 shows an example outgoing handover.

FIG. 148 shows an example incoming handover.

FIG. 149 shows UE reachability via a Wi-Fi detection procedure.

FIG. 150 shows traffic prioritization.

FIG. 151 shows a block diagram of a system according to an embodiment.

FIGS. 152-153 show an example architecture for a segregator.

FIGS. 154-171 show signaling and/or flows in accordance with various embodiments.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

Systems, methods, and/or techniques for implementing a converged gateway (CGW) and an architecture associated therewith may be provided. Such systems, methods, and/or techniques, for example, for implementing a CGW may provide data segregation based on criteria that may be specified in in an operator provided policy using a technique similar to Deep Packet Inspection (DPI) and/or a policy-based assignment with flow mobility provided by an IP Flow Mobility (IFOM). The data that may be segregated may be originally destined to be delivered to a wireless terminal device (e.g. a UE, WTRU, or other suitable device) via a HNB (e.g. a Home NodeB). Such systems, methods, and/or techniques, for example, for implementing a CGW may further provide data aggregation that may be used to take advantage of and/or access bandwidth available on disparate data connections such as Wi-Fi and cellular connections; may work with a logical interface (LIF) in a terminal device (e.g. without imposing requirements on the LIF that may prevent or affect the ability of terminal devices ability to work in a macro cell environment or a non-CGW HNB environment); may support local traffic such as LIF based local traffic and/or non-LIF based local traffic; may support public Internet traffic such as LIF based public internet traffic- and/or non-LIF based public internet traffic; may support mobile core network (MCN) value added traffic such as LIF based MCN value added traffic and/or non-LIF based MCN value added traffic; may support local IP access (LIPA) over cellular between devices such as local devices; may support MCN-based selected IP traffic offload (SIPTO); and the like.

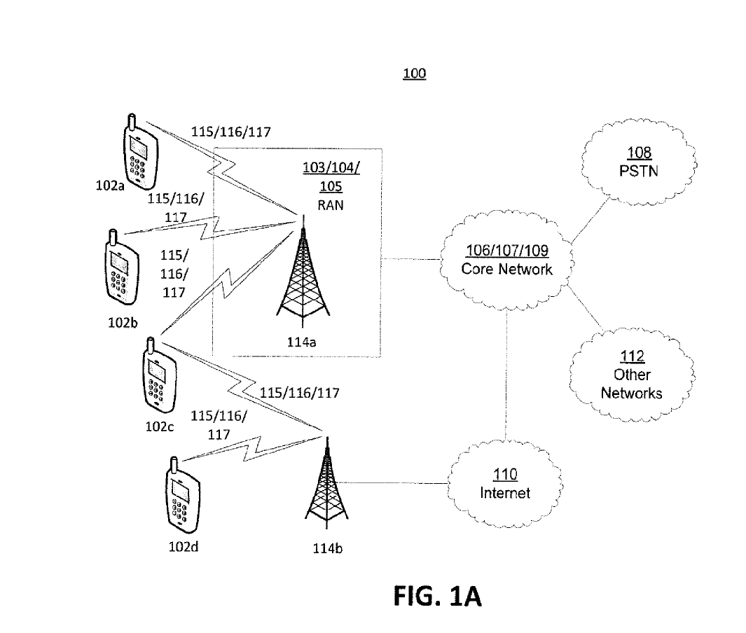

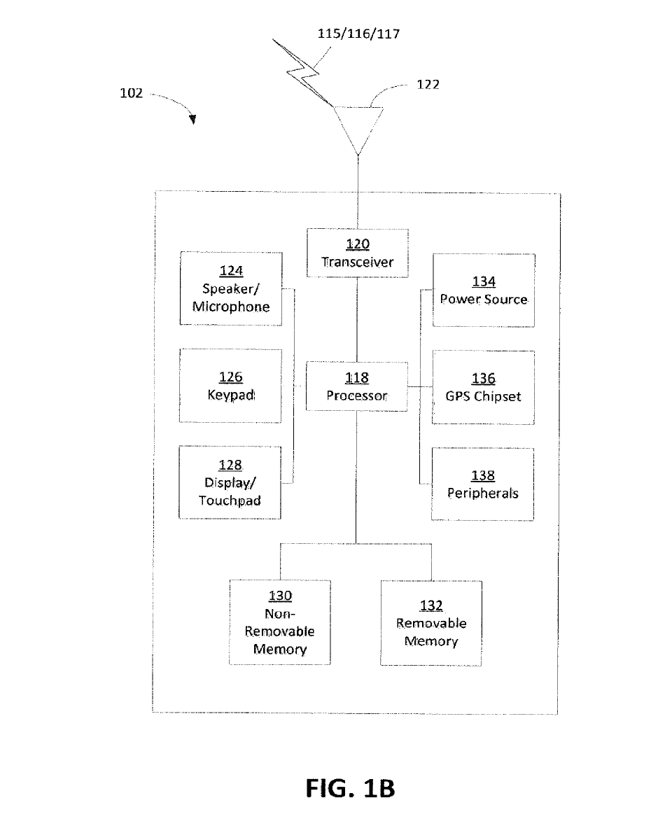

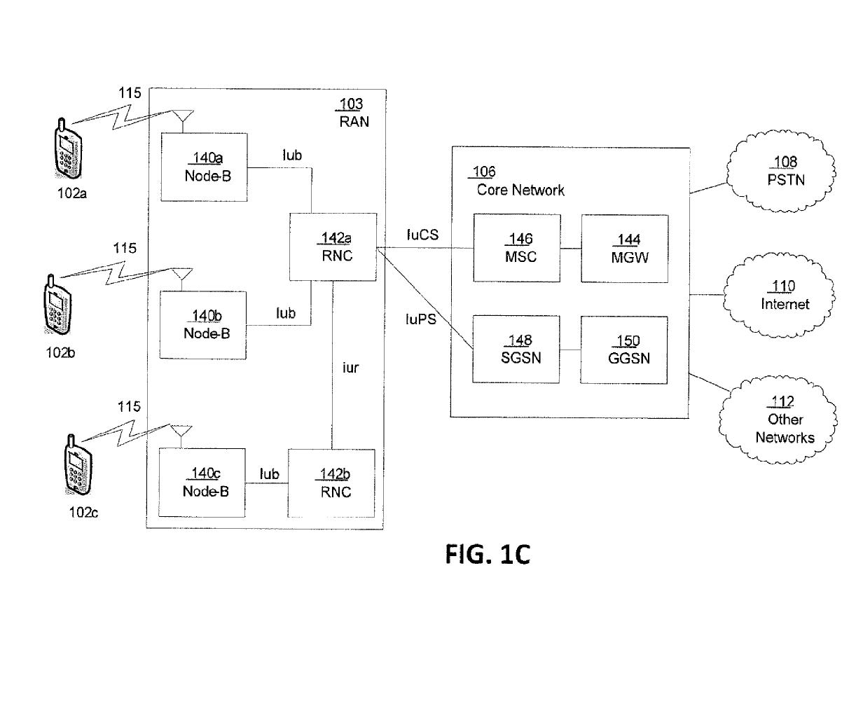

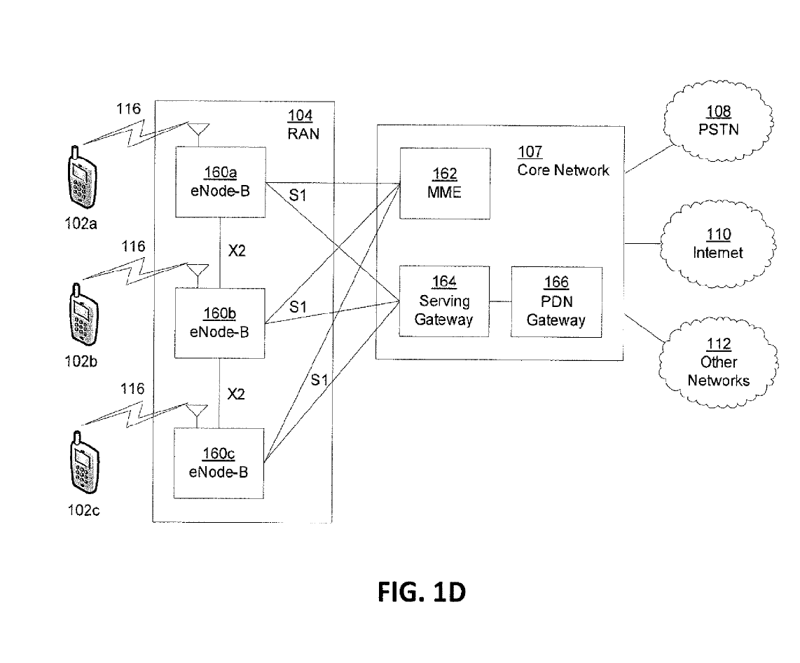

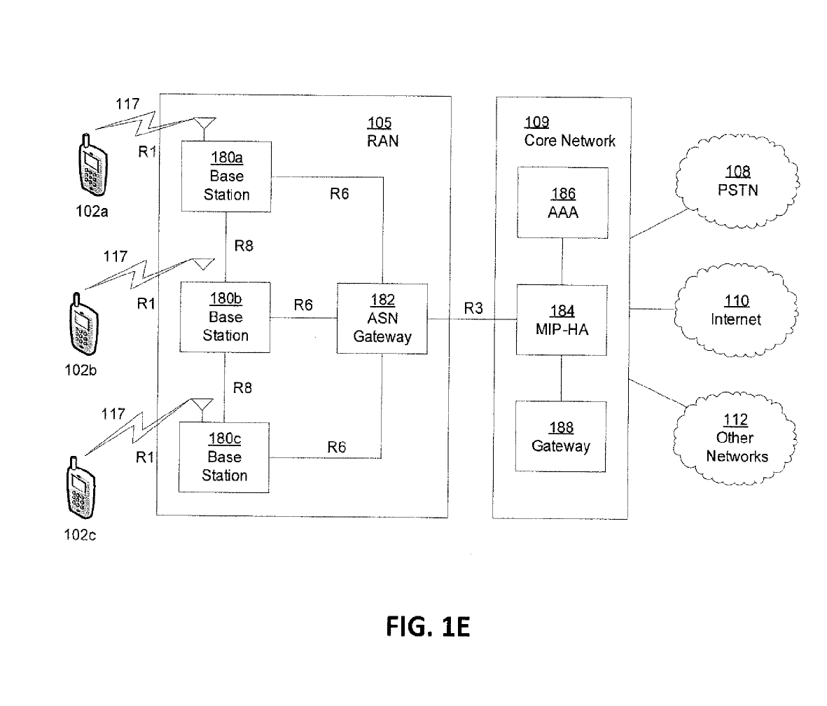

FIG. 1A depicts a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, and/or 102d may be any type of device configured to operate and/or communicate in a wireless environment. By way of example, the WTRUs 102a, 102b, 102c, and/or 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, and/or 102d to facilitate access to one or more communication networks, such as the core network 106/107/109, the Internet 110, and/or the networks 112. By way of example, the base stations 114a and/or 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a and/or 114b may communicate with one or more of the WTRUs 102a, 102b, 102c, and/or 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, and/or 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, and/or 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, and/or 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (TS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, and/or 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, and/or 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, and/or 102d in the communications system 100 may include multi-mode capabilities, i.e., the WTRUs 102a, 102b, 102c, and/or 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B depicts a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it may be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C depicts a system diagram of the RAN 103 and the core network 106 according to an embodiment. As noted above, the RAN 103 may employ a UTRA radio technology to communicate with the WTRUs 102a, 102b, and/or 102c over the air interface 115. The RAN 103 may also be in communication with the core network 106. As shown in FIG. 1C, the RAN 103 may include Node-Bs 140a, 140b, and/or 140c, which may each include one or more transceivers for communicating with the WTRUs 102a, 102b, and/or 102c over the air interface 115. The Node-Bs 140a, 140b, and/or 140c may each be associated with a particular cell (not shown) within the RAN 103. The RAN 103 may also include RNCs 142a and/or 142b. It will be appreciated that the RAN 103 may include any number of Node-Bs and RNCs while remaining consistent with an embodiment.

As shown in FIG. 1C, the Node-Bs 140a and/or 140b may be in communication with the RNC 142a. Additionally, the Node-B 140c may be in communication with the RNC 142b. The Node-Bs 140a, 140b, and/or 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, and/or 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and/or 102c with access to circuit-switched networks, such as the PSTN 108, to facilitate communications between the WTRUs 102a, 102b, and/or 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and/or 102c with access to packet-switched networks, such as the Internet 110, to facilitate communications between and the WTRUs 102a, 102b, and/or 102c and IP-enabled devices.

As noted above, the core network 106 may also be connected to the networks 112, which may include other wired or wireless networks that are owned and/or operated by other service providers.

FIG. 1D depicts a system diagram of the RAN 104 and the core network 107 according to an embodiment. As noted above, the RAN 104 may employ an E-UTRA radio technology to communicate with the WTRUs 102a, 102b, and/or 102c over the air interface 116. The RAN 104 may also be in communication with the core network 107.

The RAN 104 may include eNode-Bs 160a, 160b, and/or 160c, though it will be appreciated that the RAN 104 may include any number of eNode-Bs while remaining consistent with an embodiment. The eNode-Bs 160a, 160b, and/or 160c may each include one or more transceivers for communicating with the WTRUs 102a, 102b, and/or 102c over the air interface 116. In one embodiment, the eNode-Bs 160a, 160b, and/or 160c may implement MIMO technology. Thus, the eNode-B 160a, for example, may use multiple antennas to transmit wireless signals to, and receive wireless signals from, the WTRU 102a.

Each of the eNode-Bs 160a, 160b, and/or 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, and/or 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and/or 160c in the RAN 104 via an S1 interface and may serve as a control node. For example, the MME 162 may be responsible for authenticating users of the WTRUs 102a, 102b, and/or 102c, bearer activation/deactivation, selecting a particular serving gateway during an initial attach of the WTRUs 102a, 102b, and/or 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and/or 160c in the RAN 104 via the S1 interface. The serving gateway 164 may generally route and forward user data packets to/from the WTRUs 102a, 102b, and/or 102c. The serving gateway 164 may also perform other functions, such as anchoring user planes during inter-eNode B handovers, triggering paging when downlink data is available for the WTRUs 102a, 102b, and/or 102c, managing and storing contexts of the WTRUs 102a, 102b, and/or 102c, and the like.

The serving gateway 164 may also be connected to the PDN gateway 166, which may provide the WTRUs 102a, 102b, and/or 102c with access to packet-switched networks, such as the Internet 110, to facilitate communications between the WTRUs 102a, 102b, and/or 102c and IP-enabled devices.

The core network 107 may facilitate communications with other networks. For example, the core network 107 may provide the WTRUs 102a, 102b, and/or 102c with access to circuit-switched networks, such as the PSTN 108, to facilitate communications between the WTRUs 102a, 102b, and/or 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, and/or 102c with access to the networks 112, which may include other wired or wireless networks that are owned and/or operated by other service providers.

FIG. 1E depicts a system diagram of the RAN 105 and the core network 109 according to an embodiment. The RAN 105 may be an access service network (ASN) that employs IEEE 802.16 radio technology to communicate with the WTRUs 102a, 102b, and/or 102c over the air interface 117. As will be further discussed below, the communication links between the different functional entities of the WTRUs 102a, 102b, and/or 102c, the RAN 105, and the core network 109 may be defined as reference points.

As shown in FIG. 1E, the RAN 105 may include base stations 180a, 180b, and/or 180c, and an ASN gateway 182, though it will be appreciated that the RAN 105 may include any number of base stations and ASN gateways while remaining consistent with an embodiment. The base stations 180a, 180b, and/or 180c may each be associated with a particular cell (not shown) in the RAN 105 and may each include one or more transceivers for communicating with the WTRUs 102a, 102b, and/or 102c over the air interface 117. In one embodiment, the base stations 180a, 180b, and/or 180c may implement MIMO technology. Thus, the base station 180a, for example, may use multiple antennas to transmit wireless signals to, and receive wireless signals from, the WTRU 102a. The base stations 180a, 180b, and/or 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, and/or 102c and the RAN 105 may be defined as an R1 reference point that implements the IEEE 802.16 specification. In addition, each of the WTRUs 102a, 102b, and/or 102c may establish a logical interface (not shown) with the core network 109. The logical interface between the WTRUs 102a, 102b, and/or 102c and the core network 109 may be defined as an R2 reference point, which may be used for authentication, authorization, IP host configuration management, and/or mobility management.

The communication link between each of the base stations 180a, 180b, and/or 180c may be defined as an R8 reference point that includes protocols for facilitating WTRU handovers and the transfer of data between base stations. The communication link between the base stations 180a, 180b, and/or 180c and the ASN gateway 182 may be defined as an R6 reference point. The R6 reference point may include protocols for facilitating mobility management based on mobility events associated with each of the WTRUs 102a, 102b, and/or 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and/or 102c to roam between different ASNs and/or different core networks. The MIP-HA 184 may provide the WTRUs 102a, 102b, and/or 102c with access to packet-switched networks, such as the Internet 110, to facilitate communications between the WTRUs 102a, 102b, and/or 102c and IP-enabled devices. The AAA server 186 may be responsible for user authentication and for supporting user services. The gateway 188 may facilitate interworking with other networks. For example, the gateway 188 may provide the WTRUs 102a, 102b, and/or 102c with access to circuit-switched networks, such as the PSTN 108, to facilitate communications between the WTRUs 102a, 102b, and/or 102c and traditional land-line communications devices. In addition, the gateway 188 may provide the WTRUs 102a, 102b, and/or 102c with access to the networks 112, which may include other wired or wireless networks that are owned and/or operated by other service providers.

Although not shown in FIG. 1E, it should, may, and/or will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, and/or 102c between the RAN 105 and the other ASNs. The communication link between the core network 109 and the other core networks may be defined as an R5 reference, which may include protocols for facilitating interworking between home core networks and visited core networks.

Although certain figures display UMTS components, it is contemplated that other mobile telecommunication technologies such as CDMA, LTE and/or LTE-A, among others, are applicable, For example, for LTE the RAN 104 may include eNode-Bs and the core network 106 may include LTE related mobility management gateways (MME), serving gateways, and packet data network (PDN) gateways.

The Home NodeB (HNB) and Home eNodeB (HeNB), which may be jointly referred to as H(e)NB, are 3GPP terms that are not limited to the home only, but may also be applicable to enterprise and metro deployment. The term “Femto Access Point” (FAP) may be considered synonymous with H(e)NB.

The H(e)NB may connect WTRUs over the UMTS terrestrial radio access network (UTRAN) or Long Term Evolution (LTE) wireless air-interface to a cellular operator's network using a broadband IP backhaul.

By providing additional intelligence in an evolved HNB platform and offering new value-added services over the broadband IP backhaul, there may be additional opportunities through integration or interaction of an HNB platform with other digital home/neighborhood/enterprise network elements. Value-added services may include lower cost communication and entertainment options (e.g., “quadruple play”), simplified home network management including remote access, expanded applications for personal devices including audio/video session transfer and/or universal remote control capabilities, IP multimedia session (IMS)-enabled “local” services, improved Personal/home safety, and/or leveraging of operator-supported cyber-security, among others. New capabilities may include wireless broadband backhaul options including 3G technologies, and/or higher bandwidth 4G technologies, such as WiMAX, LTE, and/or LTE-A.

New capabilities may include HNB support for a large number of machine-to-machine (M2M) devices and/or M2M gateways, coordinated multi-RAT delivery of multimedia data, including simultaneous multi-RAT connections, and interconnection of neighboring HNBs to form a neighborhood-area or enterprise-area network, which may facilitate local P2P communications including access to locally cached content.

The new capabilities may also include the interface between a HMB and a wireless access in vehicular environments (WAVE)-enabled vehicle. Such interfaces may assist in session continuity for the users within the vehicle when the users arrive or leave home and the transfer of vehicular data to a network.

The following are examples of service requirements that may be supported by the CGW Hybrid Network Architecture: (1) simplified deployment and operation, including auto configuration; (2) WTRU services (e.g., all WTRU services) as provided by cellular network operators, including mobility to/from macro-cells, support for IMS and/or M2M gateways, among other; (3) local device communication with signaling, and data through the CGW; (4) local device communication with signaling through the CGW, and data through peer-to-peer (P2P) connections between local devices; (5) local IP access from WTRU to the home network; (6) remote access from WTRU to the home network; (7) extension of public warning system to the home network; and/or (8) extension of cellular network television service (e.g., multimedia broadcast multicast services including bandwidth management to the home network).

Examples of access requirements that may be supported by the CGW Hybrid Network Architecture include support for: (1) IP-based broadband backhaul towards cellular operator core network; (2) closed, open, and hybrid subscriber groups for cellular and WLAN access; (3) UMTS air interface, including support for legacy terminals; (4) LTE/LTE-A air interface; (5) 802.11-based WLAN air interface, including support for legacy terminals and 802.11 p WAVE devices; (6) M2M using cellular/WLAN interface/gateway, and/or directly via alternate M2M interface such as ZigBee and/or Bluetooth, among others; (7) inter-RAT and/or interHNB access/service transfer; (8) Multi-RAT access/service; and/or (9) local admission control and/or local resource control.

The CGW may include the following elements: (1) initialization of CGW components including 3GPP HNB, Local GW, IEEE 802.11 AP, IEEE 802.15.4 WPAN, RF Sensing Module, and/or M2M GW, as well as CGW applications including Dynamic Spectrum Management (DSM); (2) registration of CGW components with external operator network(s) and/or service provider(s), including support for IMS and non-IMS services, and/or external M2M servers, among others; (3) local IP access (LIPA) between WTRU and the residential/enterprise network via the CGW; (4) selected IP traffic offload (SIPTO) via the CGW; (5) access to local and mobile core operator (MCN) services via bandwidth management enhanced CGW; (6) idle and/or active mobility from HNB-to-HNB, HNB-to-macrocell, and macrocell-to-HNB; (7) proactive interference management (pIM) for Assisted Self Organizing Networks (SON); and/or (8) M2M Gateway functionality, among others.

Various IP addressing formats may be used. In certain exemplary embodiments, the gateway may be designed to conform to IPv4 addressing, in either a static or a dynamic addressing mode. For example, the gateway may obtain a public IP address from an ISP DHCP server, private IP addresses from a local DHCP server within the gateway, and private IP addresses from a remote DHCP server in the MCN. The gateway may also incorporate NAT functionality to translate between the publicly routable ISP-assigned IP address and the private gateway-assigned local IP addresses.

IEEE 802.15.4 Wireless Personal Area Network (WPAN) devices interacting with the gateway via a WP AN Coordinator (WP AN-C) may be “auto-configured” with IPv6 addresses with assistance from the WPAN-C. WPAN devices may be auto-configured based on their MAC addresses and an IPv6 network prefix provided by an IPv6 routing function in the WPAN Coordinator. The HNB functionality in the CGW may be selected to be fully compliant with UMTS HNB standards, and may support IPSec tunnel establishment with the MCN via the public Internet.

It is contemplated that other mobile telecommunication technologies such as LTE, LTE-A. SGSN, HNBGW, HNB, and/or LGW may support tunnel (e.g., direct tunnel) functionality. For example, direct tunneling between the LGW and the RAN in the connected mode is disclosed herein. A direct tunnel approach may define procedures for establishing a direct tunnel between the RNC and the GGSN. In certain exemplary embodiments, an HNB may function similar to an RNC and/or an LGW may function similar to a GGSN to an SGSN to allow the SGSN to setup a tunnel. The LGW may perform the same or similar functions as a GGSN, but on a home or enterprise network.

The following LIPAISIPTO IP address situations may apply to CGW implementations. An IP address of a WTRU may be assigned by an LGW, acting as a gateway to a local network that a user wishes to access. An IP address may be assigned to a WTRU by an LGW within a home subnet. User mobility (e.g., change of point of radio interface attachment) during an ongoing PS session may not cause a change in the IP address of a WTRU. User mobility during an ongoing PS session may not cause a change of an anchor LGW.

Each LGW may be uniquely resolvable by an APN name. For example, LGWs may have unique names or an SGSN may have the intelligence to identify a particular LGW. Managed remote access (RMA) (or Remote Managed Access (MRA)) may include remote access to a user's home network from a macro cell or from a remote HNB.

The LGW may behave like a GGSN, but GGSNs may be limited in number and may cater to a huge volume (e.g., above a threshold level) of traffic while LGWs may be enormous in number (e.g., above a threshold number) but each individual LGW may cater to a very small amount of traffic (e.g., below a threshold amount of traffic). A concentration function, such as a GW Aggregator (e.g., LGW or CGW similar to an HNB-GW), which may pose as a GGSN to the Core Network, may enable (e.g., hide) many GGSNs (LGWs) that are downstream (behind it). In many embodiments, an LGW Aggregator may be configured in the MCN, analogous to the HNB-GW.

The traffic on interfaces (e.g., all interfaces) owned/managed by the MNO may be secured (e.g., HNB-to-LGW and/or LGW-to-MNC). Certain interfaces may not be managed by the MNO (although such interfaces may emanate from MNO managed elements) and security may not be a concern (e.g., LOW-to-LIPA network and/or LGW-to-SIPTO network, among others).

Active HNB mobility may support combined hard handover and serving radio network subsystem (SRNS) relocation procedures including support for lossless handover. Bandwidth Management in the CGW may include a Bandwidth Management (BWM) Server that may provide multi-RAT distribution of IP packet data between cellular (e.g., UMTS) and 802.11 air interfaces for devices with BWM clients that support multi-mode capabilities. In certain exemplary embodiments, the BWM server may be integrated into the CGW include integration of the BWM server functionality within the HNB, or the BWM server may be a standalone entity between a standard HNB and the MCN.

In certain exemplary embodiment, the BWM server may be integrated with multiple HNBs, which may be useful in an enterprise deployment.

A BWM server or CGW may have the following functionality: (1) DNS Server (or proxy

DNS Server); (2) DNS Client; (3) DHCP Client; (4) GTP entities that support 3GPP TS 29.060, v9.1; and/or (5) IPSec support, among others. The BWM server may have deep packet inspection capabilities for carrying out the following actions: (a) the radio access bearer (RAB) Assignment Request; (b) the RAB Assignment Response; (c) the DNS Request; (d) the TR-069 Set Parameter Value; (e) the RANAP Relocation; (f) the RANAP Forward SRNS Context; and/or (g) forward DL data packets during mobility, among others.

A home or enterprise network may be configured to have a cable modem or digital subscriber line (DSL) connection to the public internet. The network may have HNBs and BWM servers able to connect to each other in the same Home Area Network (HAN) or Enterprise Area Network (EAN) and HNB and BWM server that have IP address on the HAN or EAN.

The HNB and the MCN may be configured to have the following: (1) no change to HNB or MCN element protocols; (2) HNB with initial HNB management system (HMS) fully qualified domain name (FQDN) burnt into memory; (3) HNB configured so that primary DNS server is BWM server; (4) HNB configured to have a pre-shared key in common with the BWM server for use during IPSec tunnel establishment and use; (5) initial or serving (security gateway) SeGW configured to have a pre-shared key in common with the BWM server for use during IPSec tunnel establishment and use; and/or (6) the HNB configured to have initial SeGW FQDN burnt into memory, among others.

The BWM server may be configured so that the initial SeGW FQDN is burnt into memory so that the BWM may agree with the Initial SeGW FQDN in HNB. The BWM server may be configured to know the location of the “outer” DNS server which may be done as part of the DHCP process of assigning the local IP address. “Outer” DNS Server is a DNS Server that may be on the public Internet and an “inner” DNS Server is a DNS Server that may be within the MCN. The BWM server may be powered up and have a local IP address prior to the HNB being powered on. A BWM solution may be provided at a macrocell level and may or may not be implemented in the HNBs (e.g., all of the HNBs). The “BWM” layer may reside between the Transport and IP Layers in both the client and server. The exemplary embodiments described herein support lossless, as well as lossy data services.

Multiple ways exist to trigger the BWM server to establish an IPSec tunnel with the initial or serving SeGW. In general, the BWM server may support the establishment of an IPSec tunnel with the HNB and the BWM server may have the MCN IP address provided by the initial or serving SeGW during the establishment of its IPSec tunnel with the serving SeGW. Ways to trigger the BWM server to establish an IPSec tunnel may include: (1) the HNB may trigger the IPSec tunnel from the BWM server to the initial or serving SeGW by requesting the initial or serving SeGW IP address via DNS; (2) the BWM server may listen to the IKE_SA_INIT message from the HNB and trigger itself to establish an IPSec tunnel with the initial or serving SeGW; and/or (3) the application of power to the BWM server may trigger the IPSec tunnel.

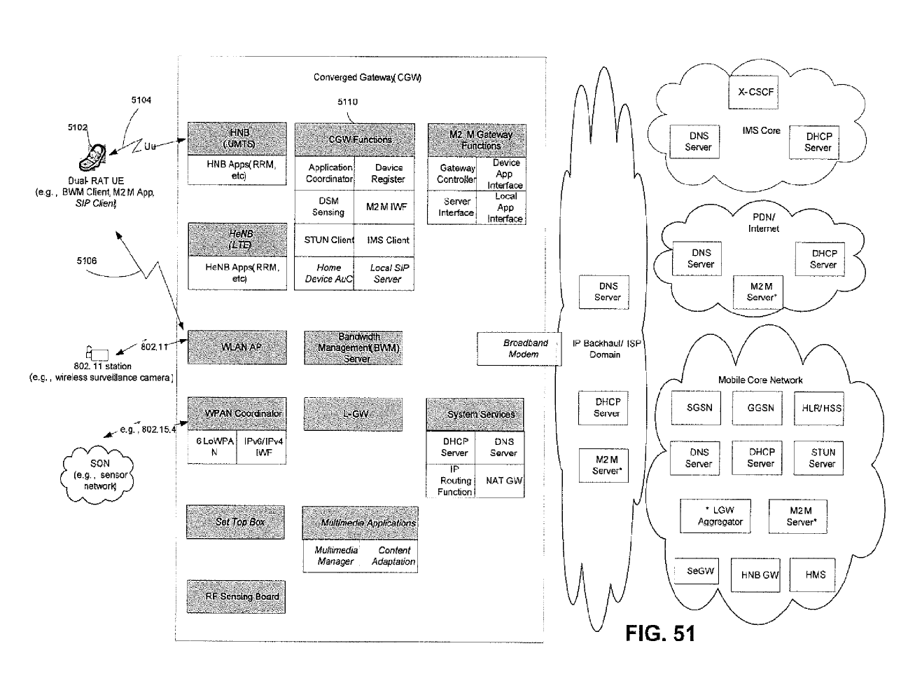

FIG. 51 is an exemplary basic architecture of a CGW Hybrid Network. The physical implementations may vary depending on the specific functions of interest. A description of the major components is summarized herein.

An extension to the architecture shown in FIG. 51 includes one in which a particular interface shown in FIG. 51 (refer to as a logical interface) may actually be implemented by more than one physical interface. For example, an end device, such as a cell phone or an appliance 5102, may have both Wi-Fi 5106 and cellular interfaces 5104. In this example, the logical interface would be a physical multi radio access technology (multiRAT). This may facilitate multiple transmissions to increase the data rate or to provide link robustness (e.g., multiRAT diversity) or to provide flexibility such that each RAT is selected in an adaptive manner depending on the suitability of the RAT to the data being transferred. The suitability may be aspects such as security, data rates supported, QoS supported and/or cost, among others. Variations may be possible in which subsets of functions are implemented. For example, the body area network (BAN) may be absent in a particular variation.

The CGW Infrastructure may consist of home “core network” elements including any hardwired facilities (e.g., Cat. 5 cable, coax cable, phone line, power line and/or fiber, among others). The infrastructure elements may include stationary line-powered devices that may operate via battery-backup in case of temporary power outages to ensure continuity of critical services involving security, healthcare, and/or public safety, among others. Such devices may include cable/DSL modems, access points, routers, M2M gateways, media servers, registration/security database servers, and/or one or more HNBs, among others.

In FIG. 51, certain functions of the CGW platform are shown in the box labeled CGW Functions 5110. These functions may logically exist within the CGW platform, but may be implemented in either a centralized fashion, e.g., within the HNB, or distributed among multiple nodes.

The high level components of the CGW infrastructure network may be separate entities or modules, however, commercial implementations of the generic architecture may combine various components for improved performance and reduced size/cost/energy consumption. For instance, the HNB could be physically integrated with a residential gateway, WLAN access point, and/or TV STB to provide a single-box multi-technology “converged gateway.” To support such a structure, the HNBs, broadband modems, and/or STBs may share a common application layer protocol for remote management based on the Broadband Forum's TR-069 or other standard. In certain exemplary embodiments femtocell base stations may be integrated with residential gateways and Wi-Fi routers.

In certain exemplary embodiments, the HNB may include the capability to provide WTRU-enabled devices with “Local IP Access” (LIP A) to the home-based network and to the external Internet. The HNB may support logical and/or physical connection to and/or integration with other networks via gateways such as WLAN AP.

The HNB may connect via Ethernet to the customer's residential gateway which may provide access to the cellular operator's core network through broadband cable, fiber, or DSL. Fixed wireless broadband access may also be an option, e.g., WiMAX or LTE cellular technologies may be used. For example, ISP providers may limit and may control indiscriminate use of their broadband facilities by H(e)NBs from competing cellular operators.

Non-operator provided WLAN APs may be used in the home network. The CGW may also utilize 802.11n-based APs managed by the cellular operator. This may allow tighter integration with the overall solutions, including support for control functions (e.g., security, mobility, network management, and/or DSM, among others).

M2M devices in the CGW domain may be on the same subnet. IPv4/IPv6 translation may be covered in the WP AN Coordinator such that communication (e.g., all communication) within the home subnet may be IPv4-based. Communication within the WPAN may be IPv6 based. Any IP version (e.g., IPv4 or IPv6) may be used to implement the exemplary embodiments herein.

M2M Gateways may support multiple interfaces (e.g., to communicate within wireless capillary networks via short-range low power interfaces), while exchanging information with the CGW, which may further disseminate the information into the WAN. InterM2M Gateway communication (e.g., for inter-gateway mobility) may also be accomplished via the CGW, or directly, for example, when the M2M gateways share a common M2M technology. Although end devices such as sensors are typically designed for extremely low power consumption, the M2M Gateways could themselves be plugged into power outlets and may easily support multiple air interfaces with higher duty cycle communications. The M2M gateways may be candidates for reconfigurable hardware technologies based on FPGAs, SDR, and/or software configurable hardware, such that a single piece of equipment can be marketed to support multiple standards.

Multi-RAT mobile terminals may also act as M2M gateways. For instance, a handset with cellular, Wi-Fi, and Bluetooth capabilities may communicate with healthcare body sensors via Bluetooth or Wi-Fi, and/or convey the information to a remote network via Wi-Fi or cellular.

The traditional role of a set-top box (STB) is to control and display interactive subscription TV services provided via coaxial cable, digital subscriber line (xDSL), optical fiber-to-the-home (FTTH), satellite, or possibly via wireless cellular technologies such as WiMAX or future LTE/LTE-A. Herein primarily the delivery of TV (primarily digital TV (DTV)) to the STBs will be assumed. The DTV content may be delivered using modulated radio frequency (RF) channels or as IPTV. Digital TV and digital radio options may include “over-the-top” transport using the Internet, subscribed satellite broadcasts, and/or terrestrial over-the-air.

Audio visual devices (AN devices) in the multimedia network may be wireless-enabled, and the STB function may wirelessly transmit subscribed AN content from the service provider, as well as local content from the integrated home network (e.g., media server, handset, and potentially via the HNB and AP). As such, the role of the STB can be expanded to that of a “media gateway.”

To support the CGW functions, various nodes such as servers, databases, and/or storage facilities may be used. For example, the nodes may include: (1) personal media and/or data content; (2) identification and/or addressing registries; and/or (3) security and/or access control policies.

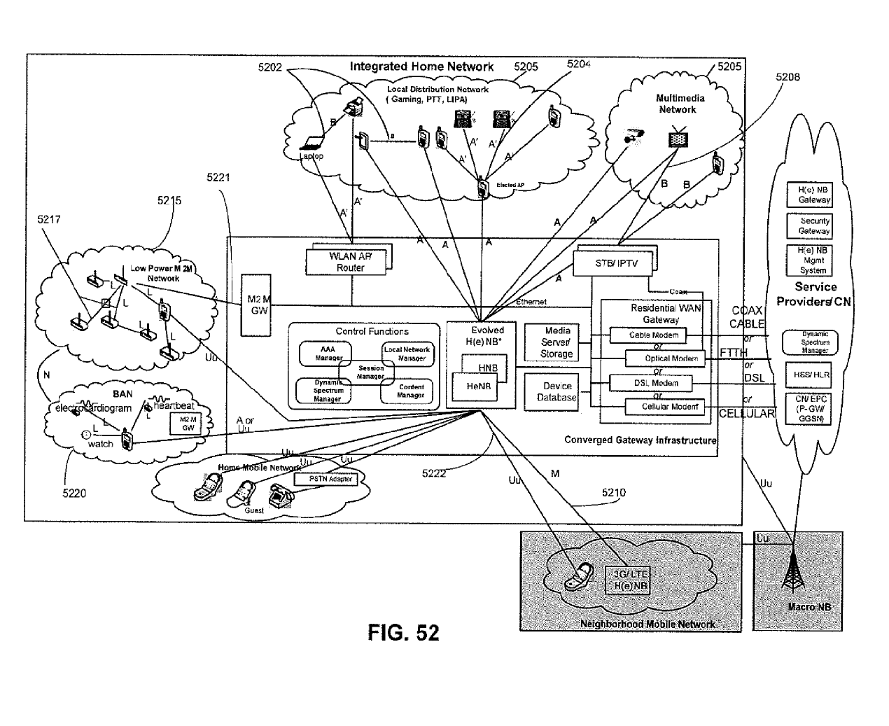

FIG. 52 is another exemplary illustration of a CGW architecture that shows the networks that interact with the CGW. A local distribution network 5205 may include productivity devices that may exchange information between or among local network nodes (e.g., computers, and/or printers, among others) or externally to other networks via gateway-enabled devices. Such networks may operate in infrastructure modes (e.g., via base stations or access points) or non-infrastructure modes (e.g., peer-to-peer or master-slave modes), and may be supported by various wireless technologies including Wi-Fi or cellular. For example, applications may include file transfer, web browsing, and/or email, among others.

In certain exemplary embodiments, the interface can be Ethernet or other wired interface such as backplane and/or power line networking. Similarly, the interface in FIG. 52, which can be termed as ‘M’ 5210, may be the 3GPP defined X2 interface or possibly an enhancement thereof. An M interface may be considered an inter-H(e)NB interface.

FIG. 52 illustrates an example integration of various local networks, such as low power machine-to-machine (M2M) networks, body-area networks (BAN), multimedia networks, and local data/voice communication networks. In FIG. 52, interfaces are shown between devices in the local distribution network. The interface A′ interface 5204, may be an evolved infrastructure mode 802.11-like interface with a centralized Access Point (AP) controlling communications to connected devices. A′ may be considered a generic name for high speed Ad Hoc interface between elected cluster head and device. Direct links can be set up between peer devices using a logical B interface 5202. The logical B interface 5202 may provide high throughput and low latency.

The Low power M2M network 5215 may include wireless sensor and home automation. Such sensors and home automation networks may involve data gathering devices which convey raw, processed, and/or aggregated information between or among local network nodes, and may include external communication with other networks via gateway-enabled devices. Such sensors may be low data rate, low duty cycle, and power-constrained devices. In addition to passive sensing, some devices may support active control functions such as sounding an alarm or flipping a switch. Cluster formation of the sensor networks may occur via device discovery procedures.

The M2M networks may operate in infrastructure modes (e.g., via base stations or access points) or non-infrastructure modes (e.g., peer-to-peer or master-slave modes), and may be supported by various technologies including ZigBee, Bluetooth, Wi-Fi, and/or cellular. In FIG. 52, the logical L interface 5217 may represent any such aforementioned technologies. An L interface may be a generic term for a relatively low speed ad hoc interface. The interface may provide a low throughput, and may be includes with a device that may be power-constrained. Applications that use such an interface may include home security, surveillance, health monitoring, energy management, HVAC control and/or W AYE, among others.

Somewhat similar to the low power M2M networks, body area networks (BANs) 5220 may include wearable/implantable wireless sensors that may convey information locally to the user or externally to other relevant entities via a CGW. The gateway device may also act as an aggregator of content from the wireless sensors.

Wireless multimedia networks 5206 typically include home entertainment equipment that exchange multimedia information (e.g., audio, video and/or data) between local network nodes, or externally with other networks via gateway-enabled devices. These devices may use for much higher data rates than sensor networks. Such networks may operate in infrastructure modes (e.g., via base stations or access points) or non-infrastructure modes (e.g., peer-to-peer or master-slave modes) and may be supported by various technologies including Wi-Fi or cellular. Applications include real-time audio/video, playback of locally/remotely stored content, automated sync between devices, and/or live transfer of sessions between devices, among others. In FIG. 52, the logical B interface 5208 may be used between devices in the multimedia network.

The cellular network may overlap with parts of the previously described networks, and may include macro-cell, inter-Home (e) Node B, and intra-Home (e)Node B elements. Devices may include Closed Subscriber Group (CSG) and non-CSG WTRUs, and may be used for traditional services such as voice, text and/or email. In addition to traditional functionality, the cellular operator's core network may support future value-added services enabled by the evolved CGW platform.

The CGW may communicate with a number of devices, but may not communicate with such devices, within the local clouds. For instance, some devices may not have the appropriate radio access capability or some devices may decide to restrict communication within the local cloud in order to conserve resources (power and/or storage, among others). For devices that are capable and willing to communicate with the CGW, this communication may be via a logical A interface 5221, that provides synchronization, control, and/or a data plane functionality. These functions may be achieved through dedicated physical channels, or through shared channels. Synchronization may provide the local cloud devices with reference timing, and/or may optionally provide an indication of where to find the control information. The control information may provide the signaling (between or among local cloud devices and the CGW) to allow local cloud device registration, local cloud device (re)configuration, measurement reporting to the CGW, and/or local cloud device assistance, among others. The logical A interface 5221 may allow a level of centralized control for interference management and load management within the converged gateway network.

The logical A interface 5221 may be implemented using a new air interface, optimized for the specific application and conditions (home, office and/or industrial conditions). Alternatively, the functions may be carried over the Uu interface 5222 (e.g., H(e)NB interface) or over an 802.11-like interface (shown as A′ 5204 in FIG. 52).

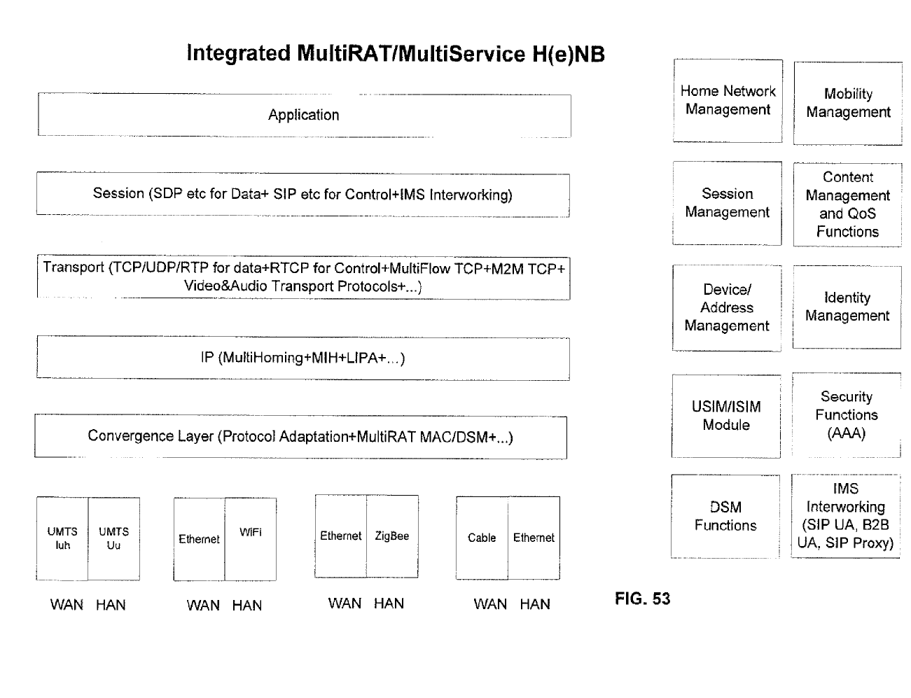

FIG. 53 is an exemplary block diagram that illustrates the high-level architecture of the Converged Gateway.

The CGW may be the central entity in a home (or enterprise) that contains or includes a Broadband Modem, a Cellular H(e)NB, a Wi-Fi Access Point, an IP Router and possibly other functional and physical entities, and/or serves to integrate the various sub-Networks in the integrated home network (IHN). The CGW may provide a logical binding to a home, just as a mobile phone may provide a logical binding to a person. A home, with its devices (e.g., all of the devices), such as sensors, and/or appliances, among others may become identifiable by the CGW so that each of the individual home devices may be indirectly addressable via the CGW. The CGW may become a gateway for each home device to communicate with the wide area network (WAN) as well as other devices locally within the IHN.

The CGW may have a unique identifier, and attached to this identifier may be a list of home devices, each of which may have its own identifier. Because the CGW, may be a communicating entity for which the communication services may be provided by a network operator, the CGW identifier may also include the identity of the network operator. The CGW identity may be any alpha-numeric or binary value, which may also be a user friendly identity. For example, the home address may be the CGW identity, coupled with the Network Operator identity. If the home address is 123 Freedom Drive, Happyville, PA 10011, USA and the communication services are provided by Universal Communications Corporation, then the CGW identity may be 123_Freedom_Drive,Happyville, PA_lOOll, USA@UniversaLCommunications.com. Individual Sub-Networks and devices may be appended to this identity. For example, Thermostat #123_Freedom_Drive,Happyville, PA_lOOll, USA@Universal_Communications.com, where the # sign may be used to denote the split in the address.

Other architectures for the CGW are possible, by adding or deleting certain functional entities. For example, the ZigBee modern may be deleted and a Bluetooth modem added.

The CGW architecture may include many elements. For example, the CGW architecture may comprise the following local devices: (1) 802.15.4 devices (WPAN); (2) 802.11 Devices; (3) WTRUs; (4) generic IP devices (e.g., printers and/or digital picture frames, among others); and/or (5) BWM client enabled multimode devices. Some CGW entities may include HNBs, WLAN-APs, WPAN-Cs, LGWs, BWM servers, and/or RF sensing modules, among others. CGW applications may include M2M JWF applications, application coordinators, IMS clients, STUN clients (e.g., for extended local IP access mobility—ELIP A), and/or DSM spectrum sensing functions (SSFs), among others.

Additional CGW architecture elements may include: M2M gateways; M2M servers; M2M applications; system services (e.g., local DHCP servers, local DNS servers, IPv4 routers, and/or NATs); ISP networks (e.g., ISP/“outer” DNS servers); MCNs (MNCs/inner DNS servers, HNB management systems, SeGWs, HNB gateways, LGW aggregators, SGSNs, GGSNs, RNCs (e.g., for handover between HNB and macrocell), STUN server); and/or IMS core networks (e.g., IMS CN DHCPs, IMS CN DNSs, IMS CN x-CSCFs).

The home network manager, may provide semi-static management of the home network including support of Self Organizing Network (SON) features. This function may discover the access technologies and associated functional capabilities available to the Converged Gateway.

A session manager may be in the CGW platform. This function may control the transfer of media, data and voice sessions between various networks or devices shown in FIG. 52. This function may be centralized, e.g., in the H(e)NB, or distributed among home infrastructure nodes. The initiation of session transfers may be based on user interaction, or automated response based on mobility, context awareness, event-driven cues, and stored user profiles. Once initiated, the Session Manager may control the transfer, possibly involving the cellular operator and its knowledge of “registered” devices within the home, e.g., for digital rights management (DRM). This function may interact with the Content Management function for some transfers.

The Content Manager may handle functions such as content adaptation, e.g., transformation of media formats (e.g., required formats) between the home network and mobile handheld devices. This may include a content decomposition function.

The Dynamic Spectrum Manager (DSM), as shown in FIGS. 51 and 52, may be defined as the entity that facilitates assignment of the right RAT(s)/frequencies/bandwidth to the right application at the right time. The DSM may optimize utilization of available spectrum to minimize the local interference levels, satisfy the desired QoS, may allow spectrum aggregation using the same or different radio access technologies (RATs), and/or may oversee (e.g., control) the spectrum sensing and environment-based information fusion while enabling high throughput real-time multimedia content sharing among local devices.

In the context of the COW, Dynamic Spectrum Management (DSMT) may be a common service providing spectrum sensing functions (SSF) and bandwidth management functions (BMF). For example, to assist with the self-organization of 802.15.4-based WPANs, the WPAN Coordinator may interact with DSMT to obtain initial and alternate channels for operation. Similarly, the Bandwidth Management server (BWMS) may interact with DSMT to decide on bandwidth aggregation and/or switching policies.

A security manager may include Authentication, Authorization, and Accounting (AAA) functions and may facilitate use of operator resources (e.g., providing proxy functions as appropriate).

The IMS interworking functions may enable managed IMS-based services such as VoIP and IPTV to be delivered to the home. Operator provided services may be accessed via remote application servers, and may also be accessed from local application servers or cached storage. Support may be provided for TMS-enabled and non-IMS-enabled devices in the home. Support for non-IMS-enabled devices may be provided by an IMS inter-working function in the CGW.

An RF sensing module may be a centralized single scanner entity as part of CGW. In certain exemplary embodiments, the sensing may be performed in the CGW may represent the interference that may be sensed by the entire network, in which case a single sensing node may be sufficient. The scanner results (outcomes) may drive a SW entity (“Spectrum Sensing Function”) as part of CGW to determine preemptive frequencies against interference. The scanner outcomes may support interference mitigation and bandwidth aggregation decisions. In certain exemplary embodiments, the RF sensing module may be able to scan approximately 30 Hz.

Exemplary illustrations of system description of the CGW have been captured via message sequence charts (MSCs) detailing the interactions between technology elements of the system. The MSCs capture high-level flows and encapsulate exemplary detailed messaging within individual procedure blocks.

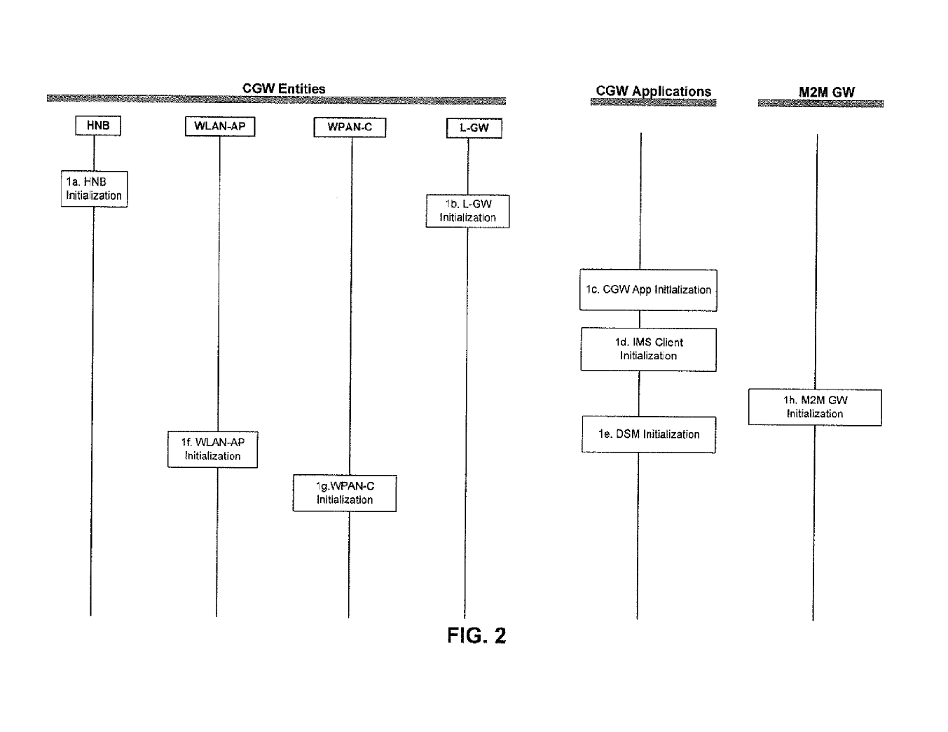

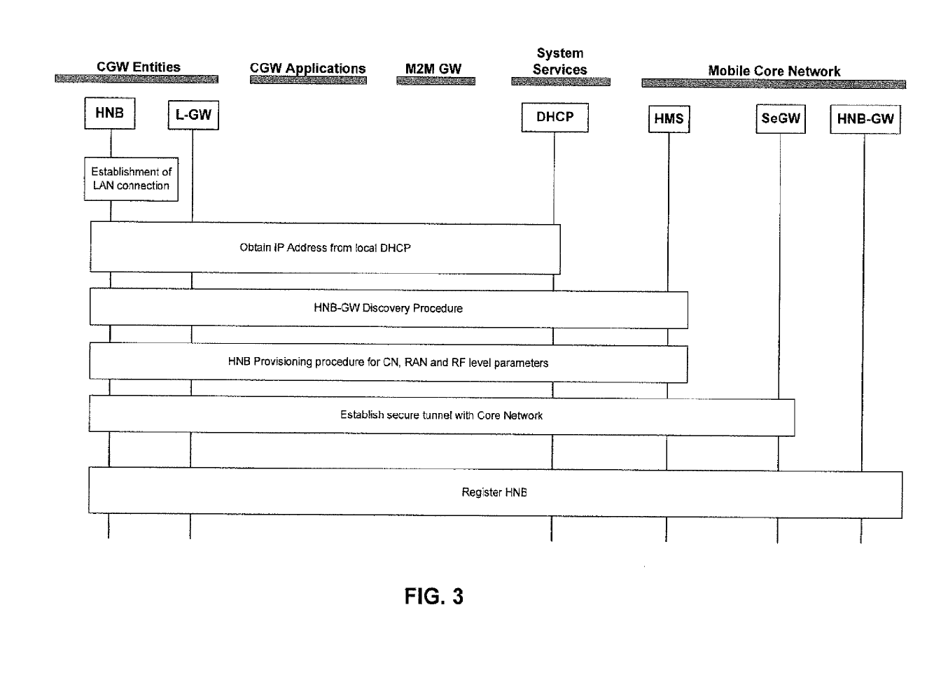

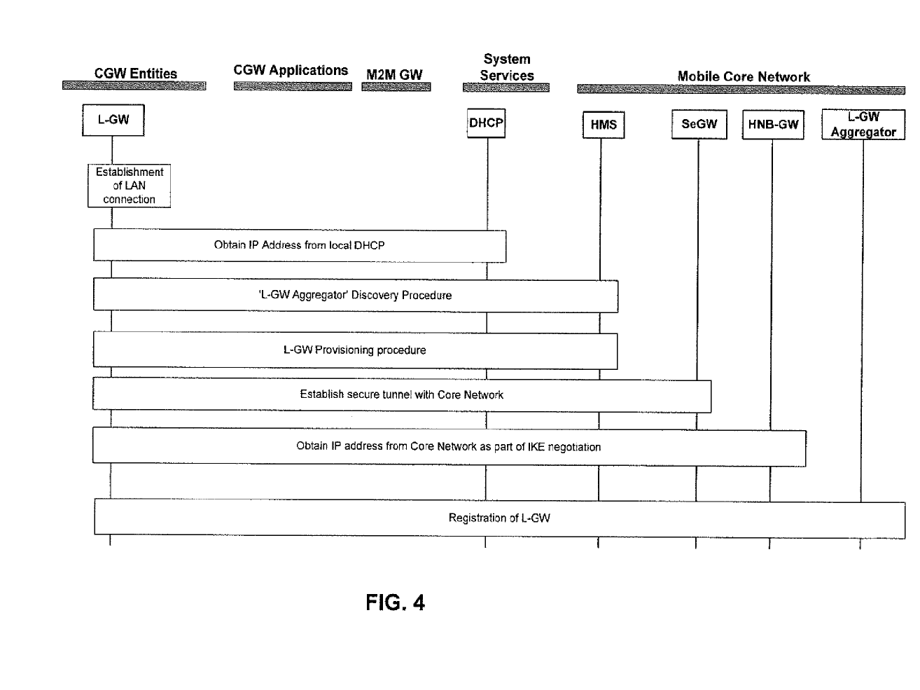

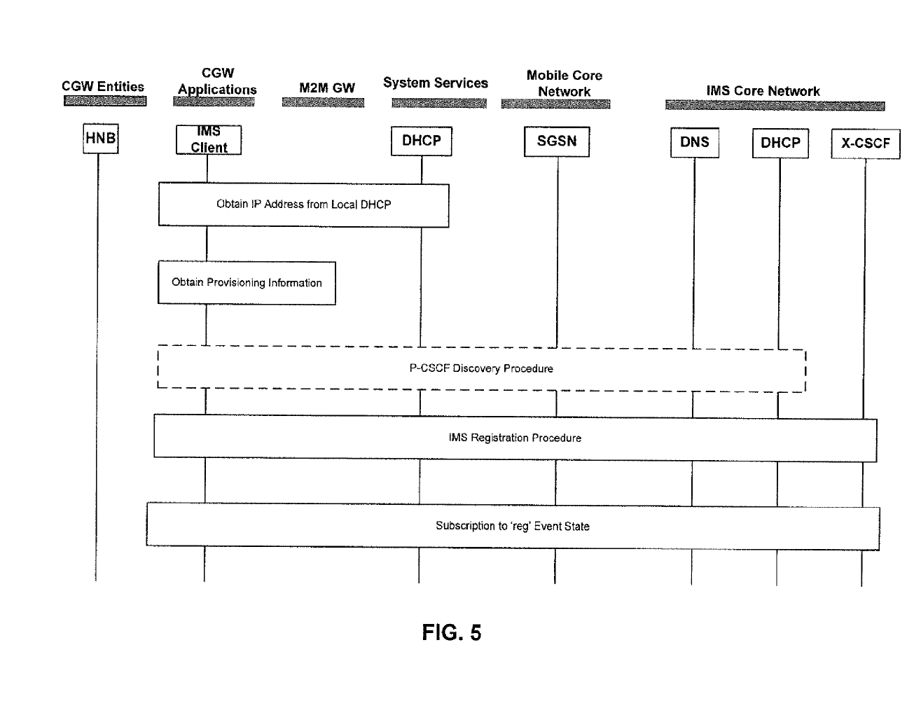

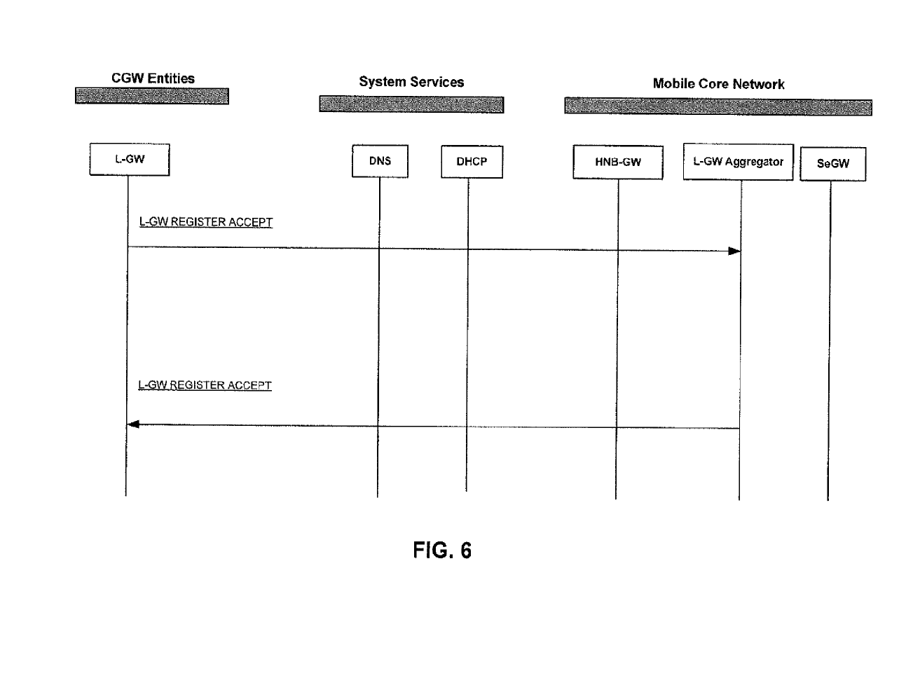

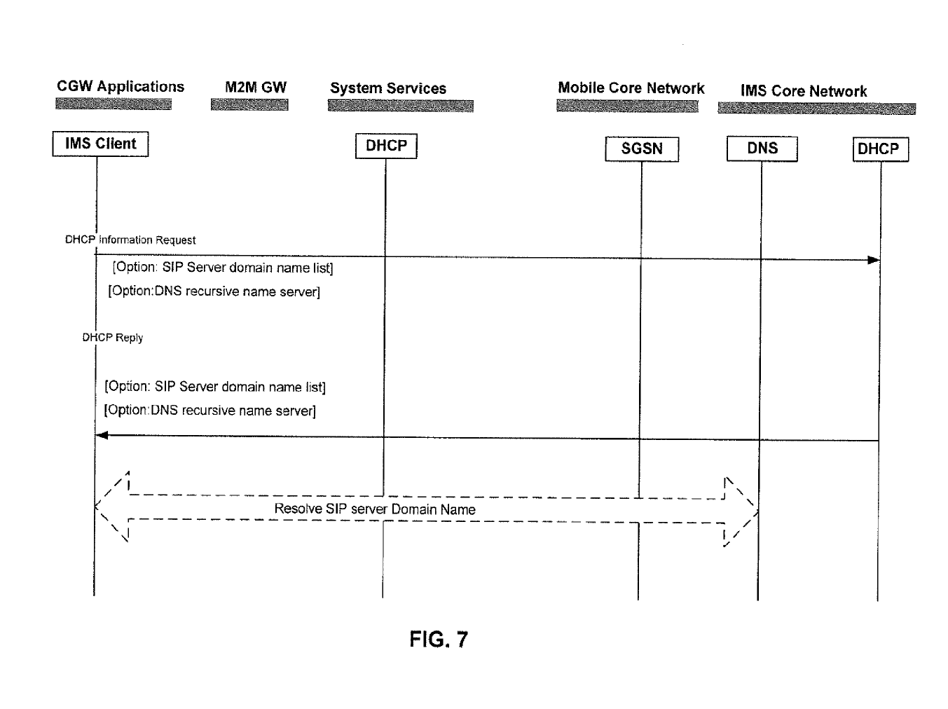

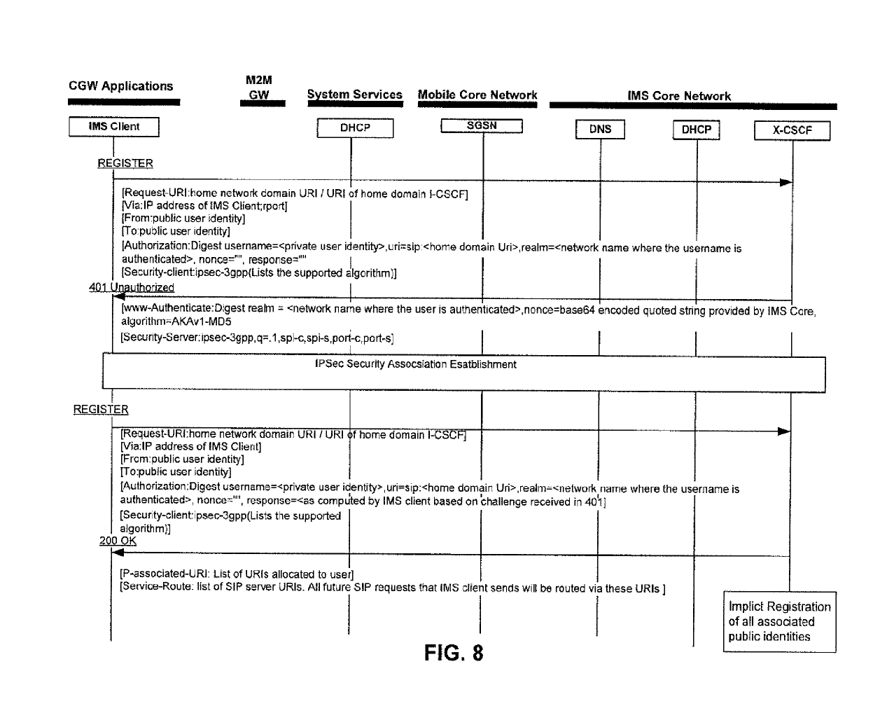

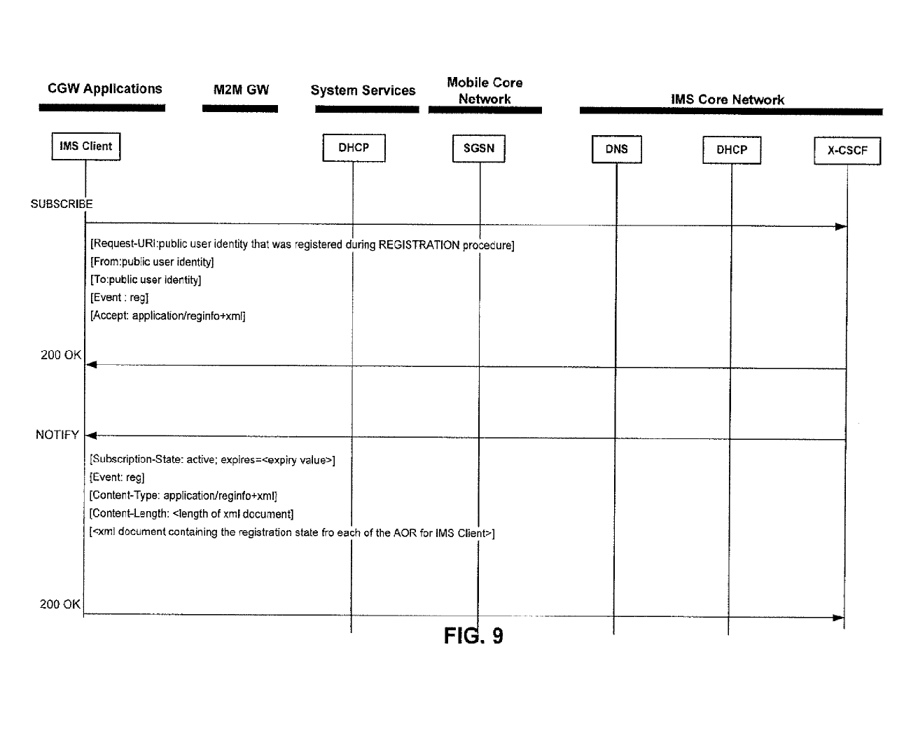

The CGW Initialization and Registration MSCs, as shown in FIG. 2 thru FIG. 9 are exemplary illustrations of the initialization of the CGW entities including HNB, WLAN-AP, WPAN-C, LGW, M2M GW, and CGW Applications including DSM Spectrum Sensing initialization and/or IMS Client registration, among others. FIG. 2 is an exemplary illustration of a procedure for the CGW initialization. FIG. 3 is an exemplary illustration of a procedure for the HNB initialization. FIG. 4 is an exemplary illustration of a procedure for the LGW initialization. The LGW may be a logical entity and its provisioning parameters may be similar to that of a HNB. FIG. 5 is an exemplary illustration of a procedure for the IMS client initialization. FIG. 6 is an exemplary illustration of a LGW registration. FIG. 7 is an exemplary illustration of a proxy call session control function (PCSCF) discovery procedure. FIG. 8 is an exemplary illustration of IMS registration procedure. FIG. 9 is an exemplary illustration of a procedure for subscription to ‘ reg’ Event state.

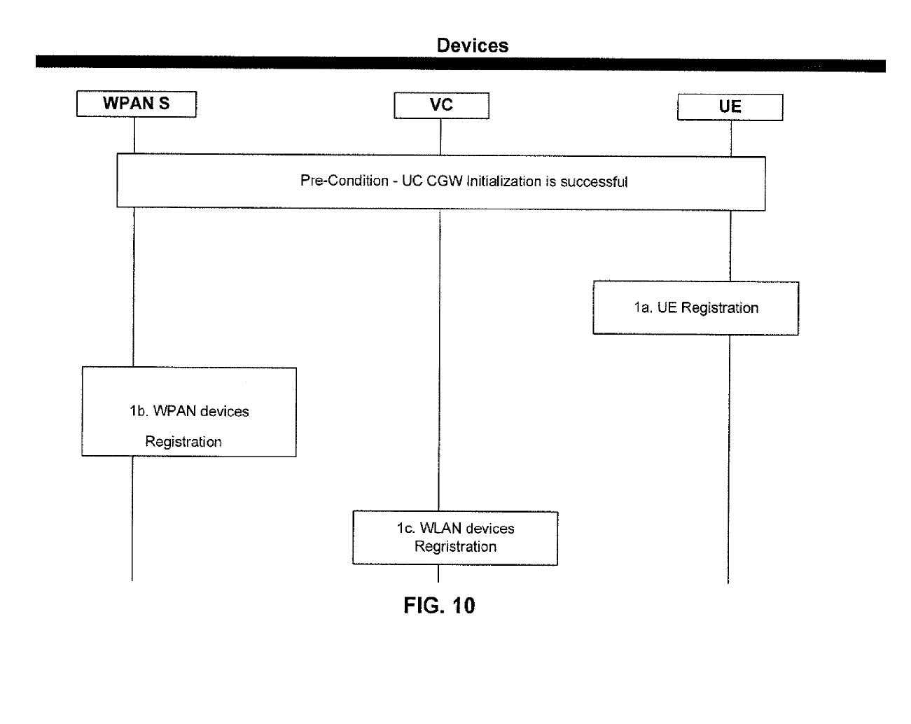

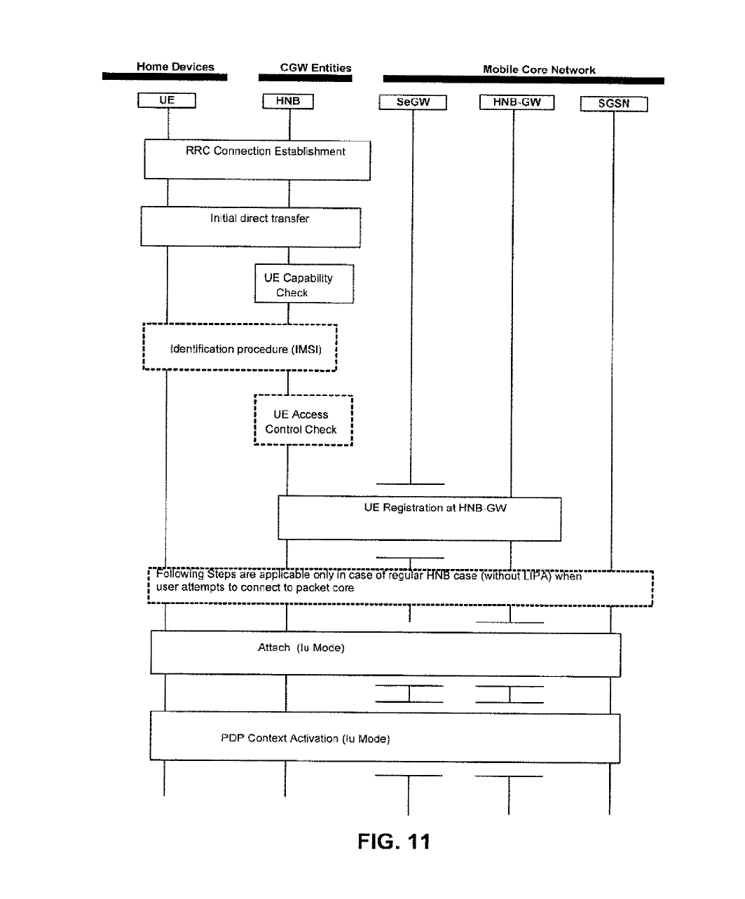

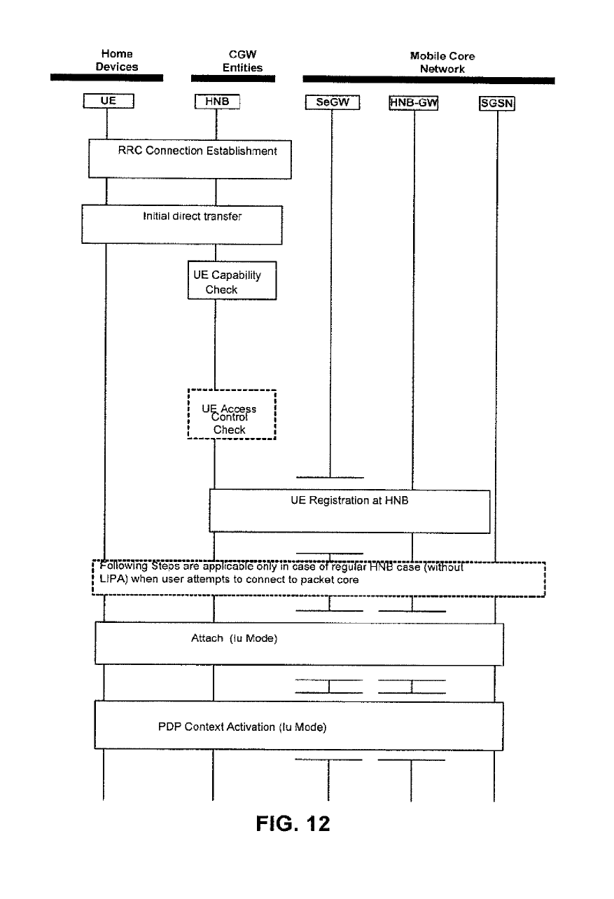

The Device Registration MSCs, as shown in FIG. 10 thru FIG. 12, are exemplary illustrations of the registration of the UE, WLAN, and/or WPAN devices within the CGW, and with external operator/service provider networks. FIG. 10 is an exemplary illustration of a procedure for device registration. FIG. 11 is an exemplary illustration of a procedure for the UE registration (NON CSG UE). FIG. 12 is an exemplary illustration of a procedure for UE registration (CSG UE).

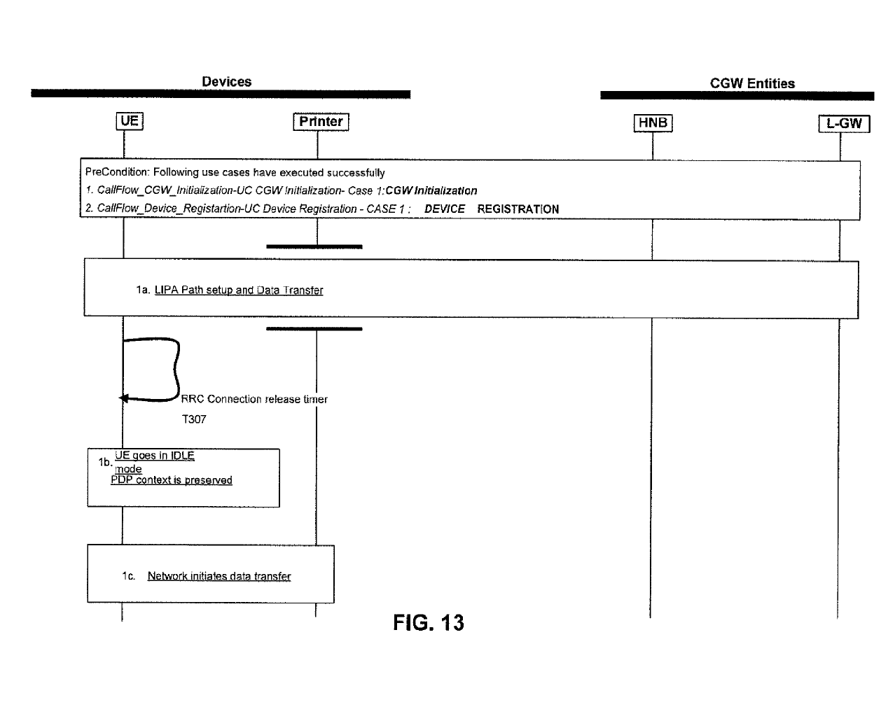

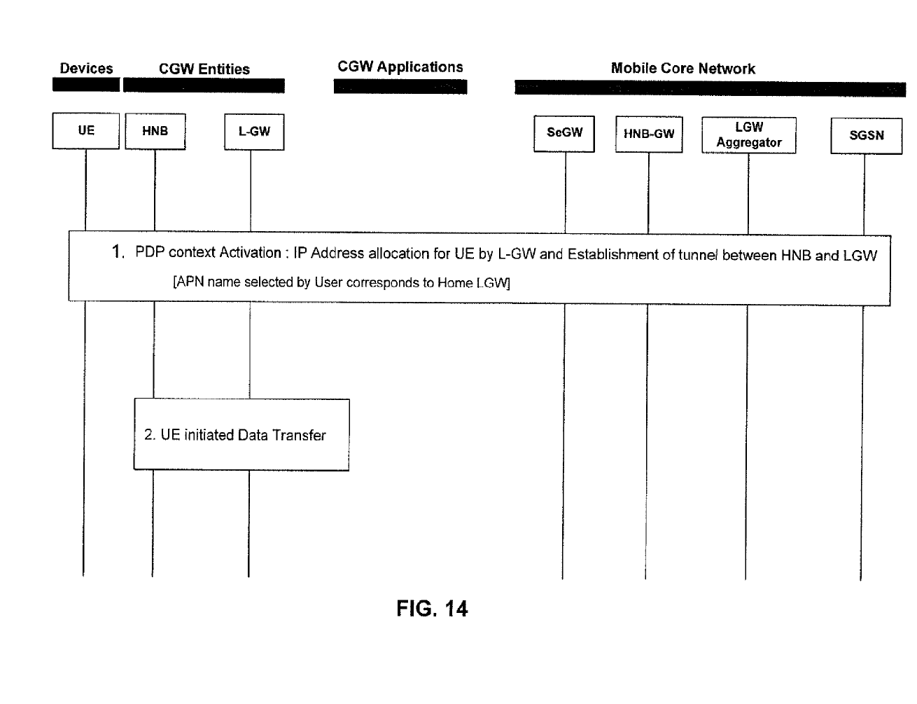

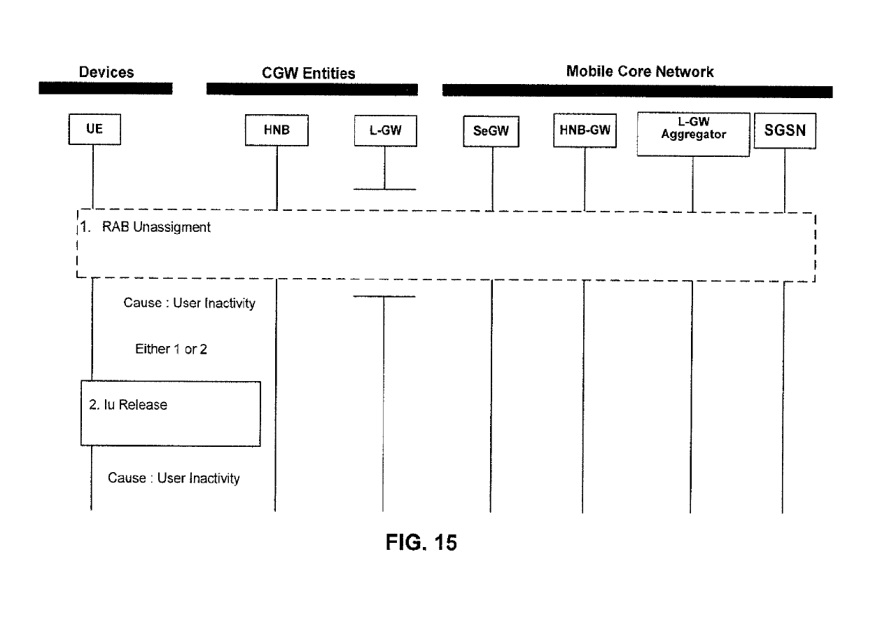

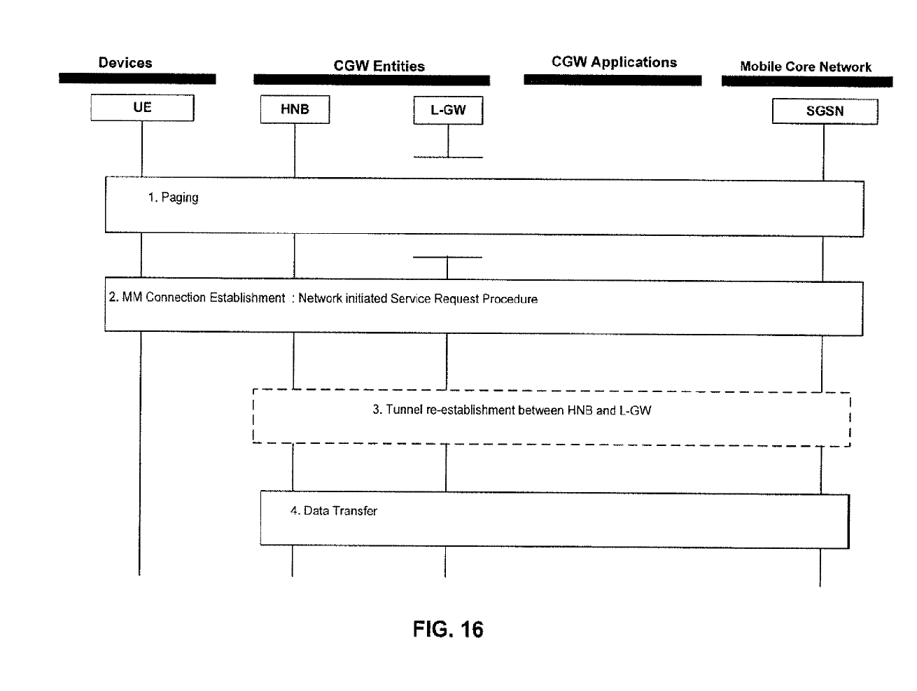

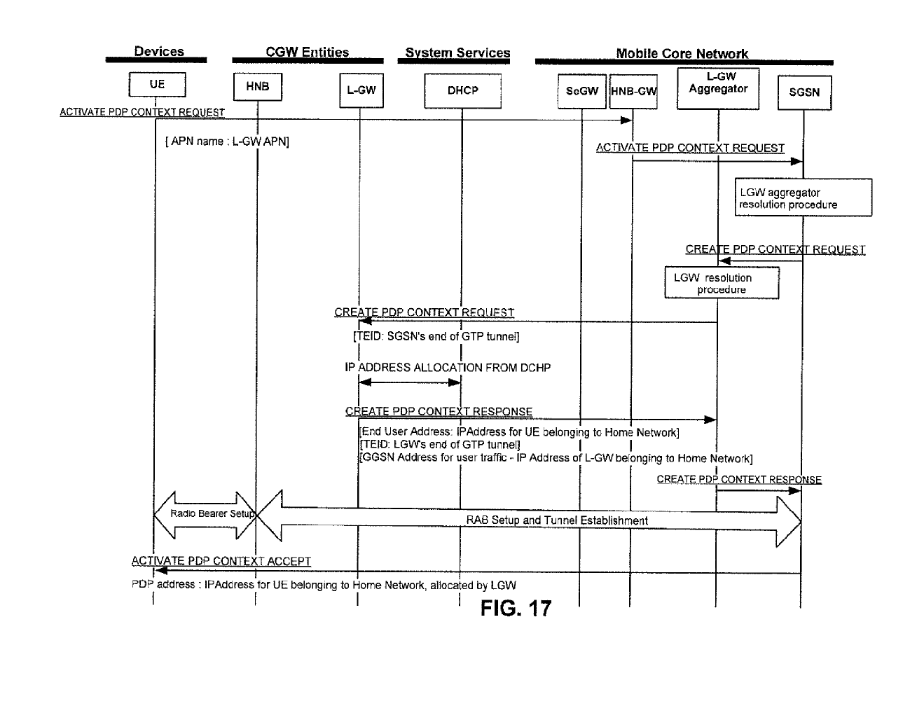

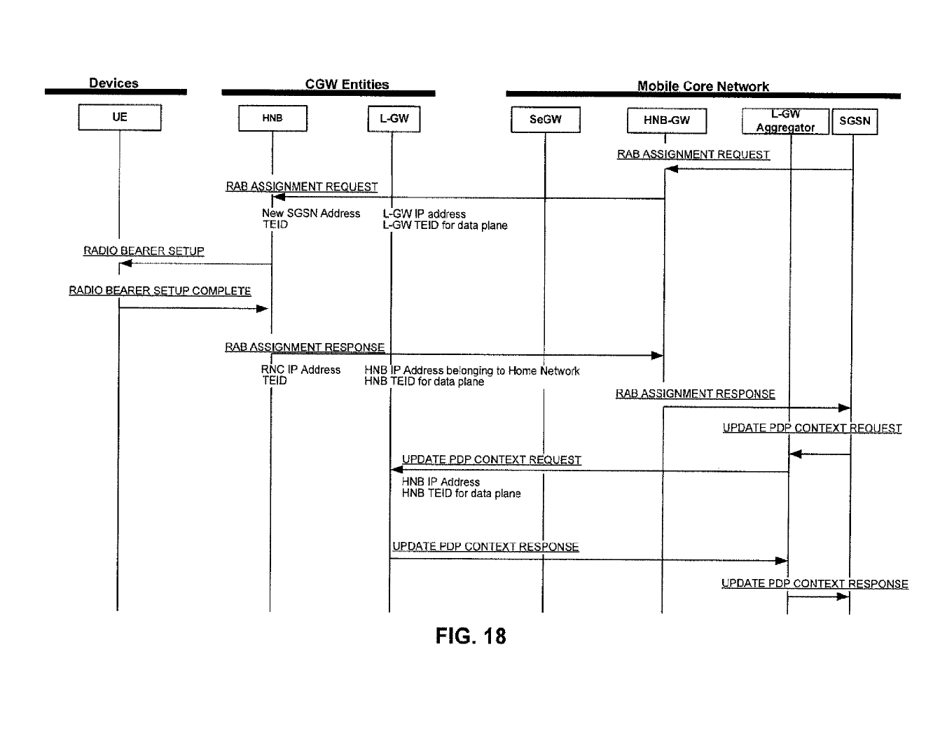

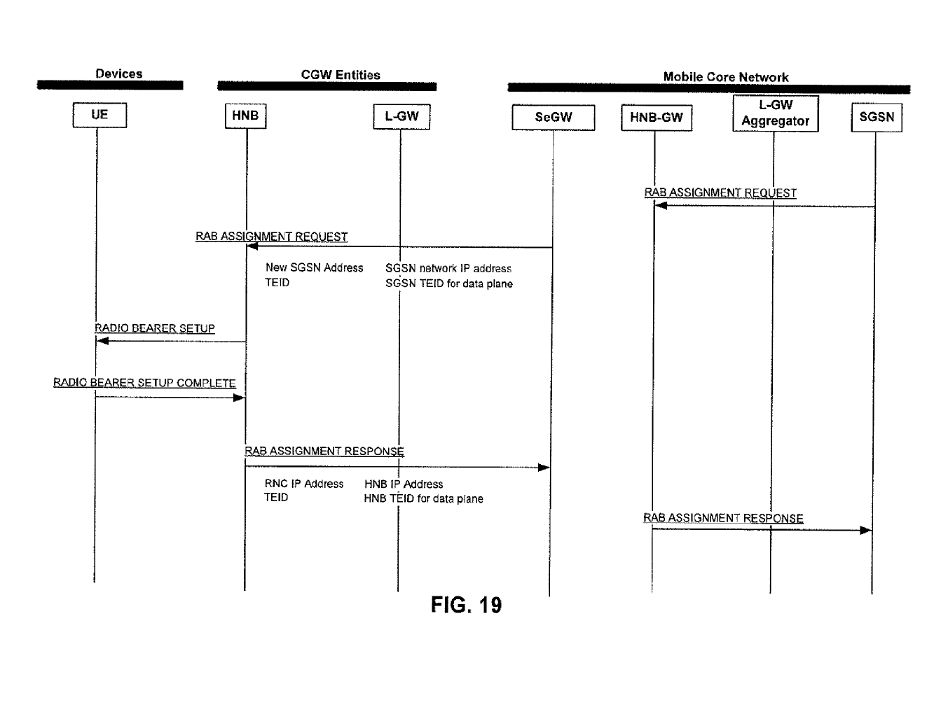

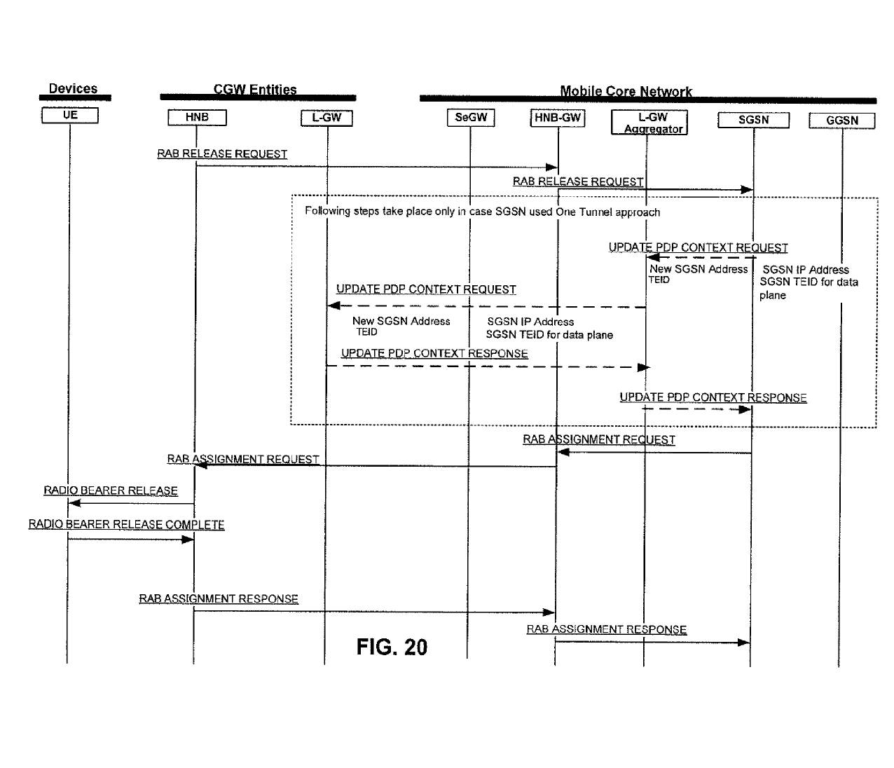

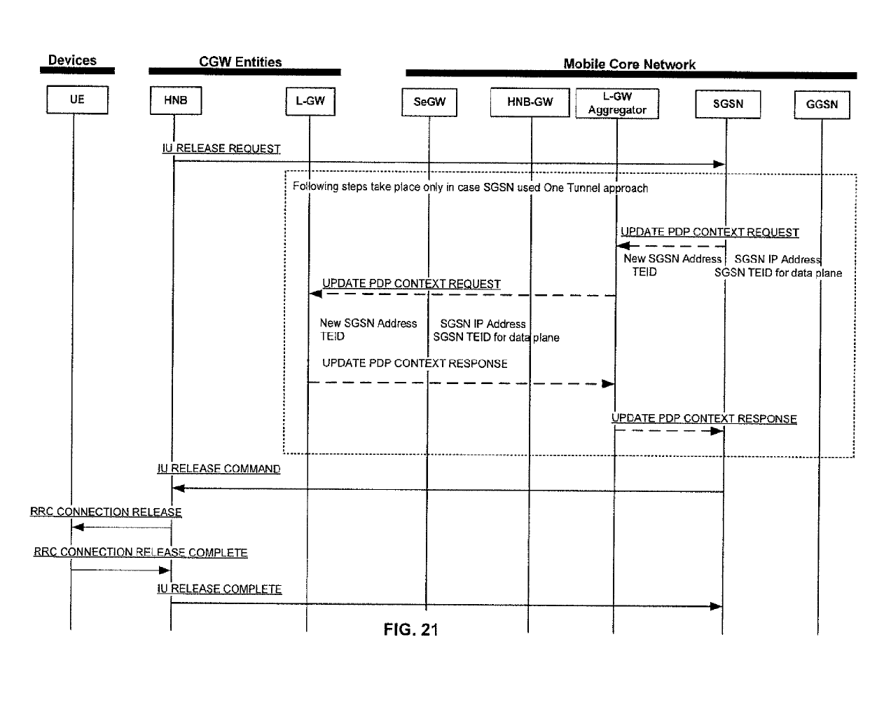

The simple LIPA MSCs, as shown in FIG. 13 thru FIG. 21, are exemplary illustrations of setup of the LIP A path and local data transfer, including transition to idle mode during periods of data inactivity with preservation of PDP context and subsequent paging with connection/tunnel re-establishment for resumption of downlink initiated LIPA sessions. FIG. 13 is an exemplary illustration of a procedure for a UE attached to its home LGW and accessing a device on its home network. FIG. 14 is an exemplary illustration of a procedure for a LIPA path setup and data transfer. FIG. 15 is an exemplary illustration of a procedure for a UE that goes into IDLE state while preserving its PDP context. FIG. 16 is an exemplary illustration of a procedure for a UE previously attached to its home LGW and the network initiates a data transfer. FIG. 17 is an exemplary illustration of a procedure for PDP context creation. FIG. 18 is an exemplary illustration of a procedure for RAB setup and user plane tunnel establishment for one tunnel. FIG. 19 is an exemplary illustration of a procedure for RAB setup and user plane tunnel establishment for two tunnels. FIG. 20 is an exemplary illustration of a procedure for RAB release and PDP context preservation. FIG. 21 is an exemplary illustration of a procedure for Iu release and PDP context preservation.

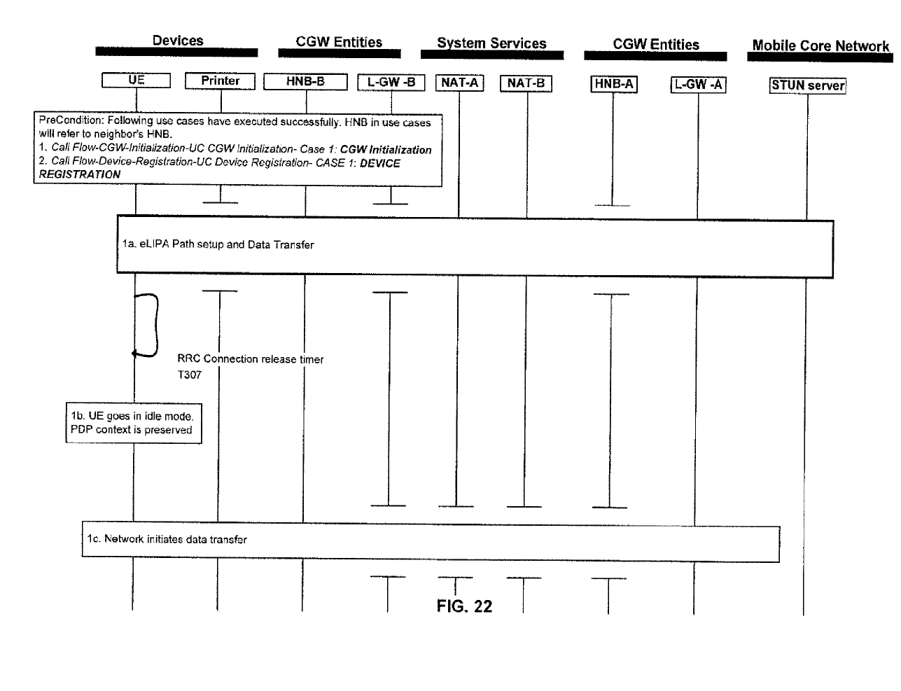

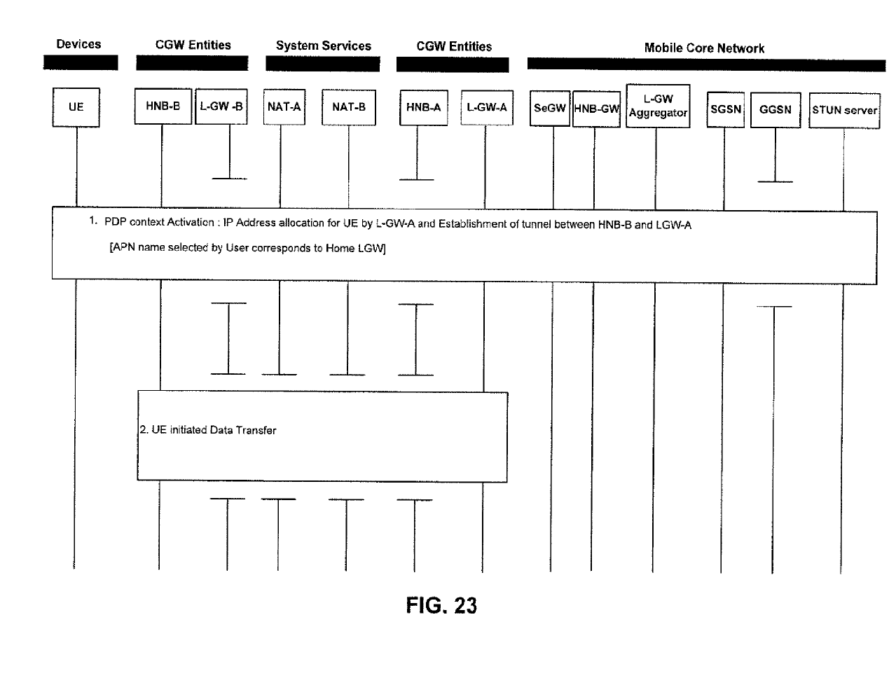

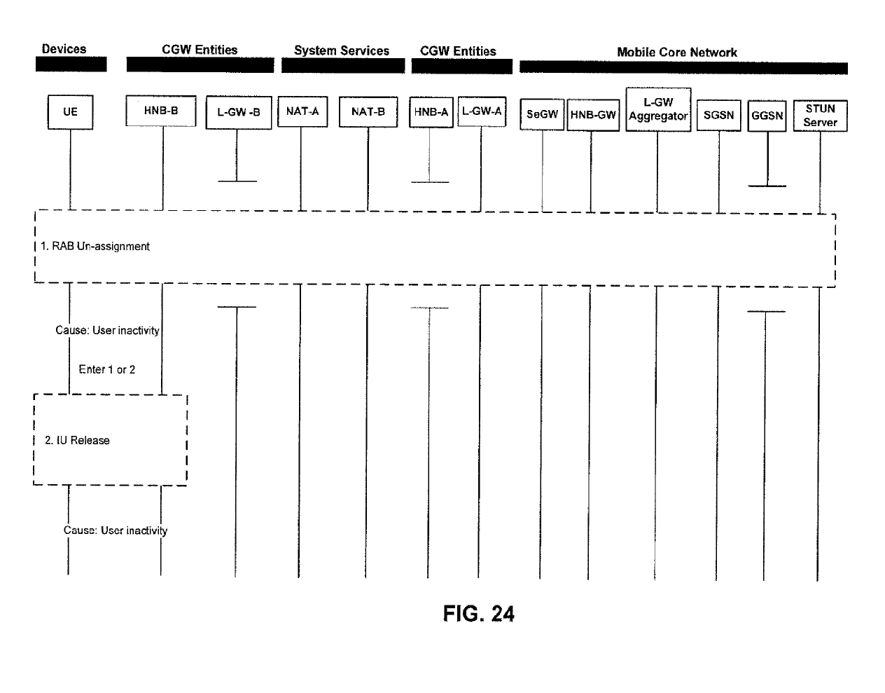

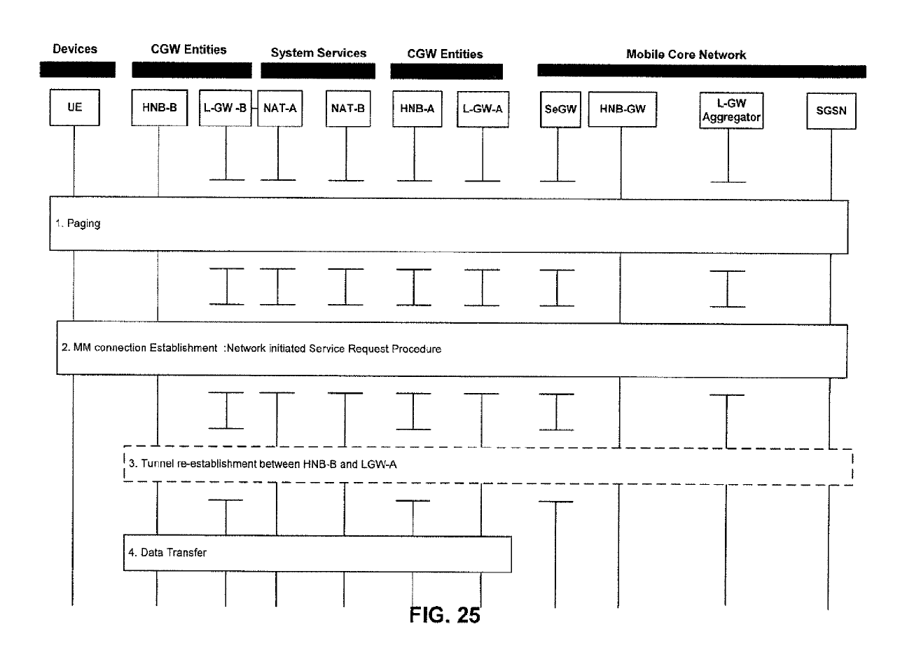

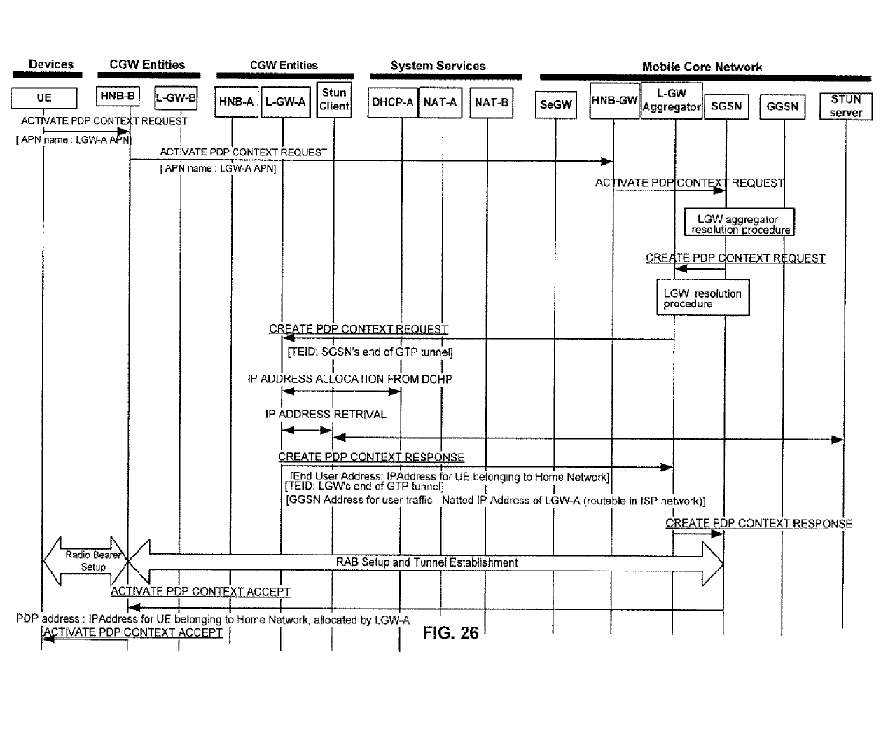

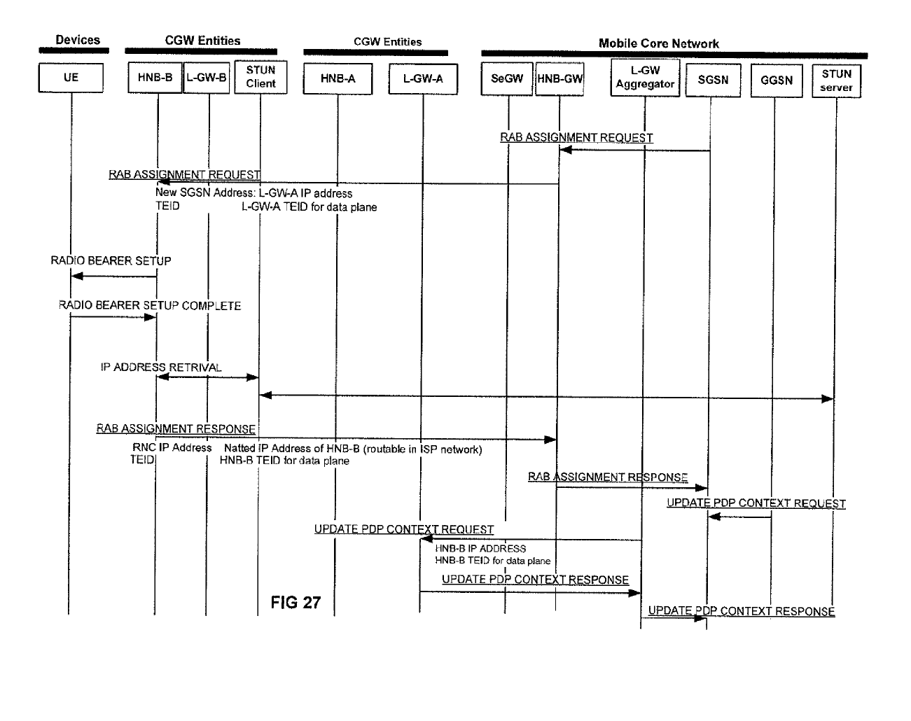

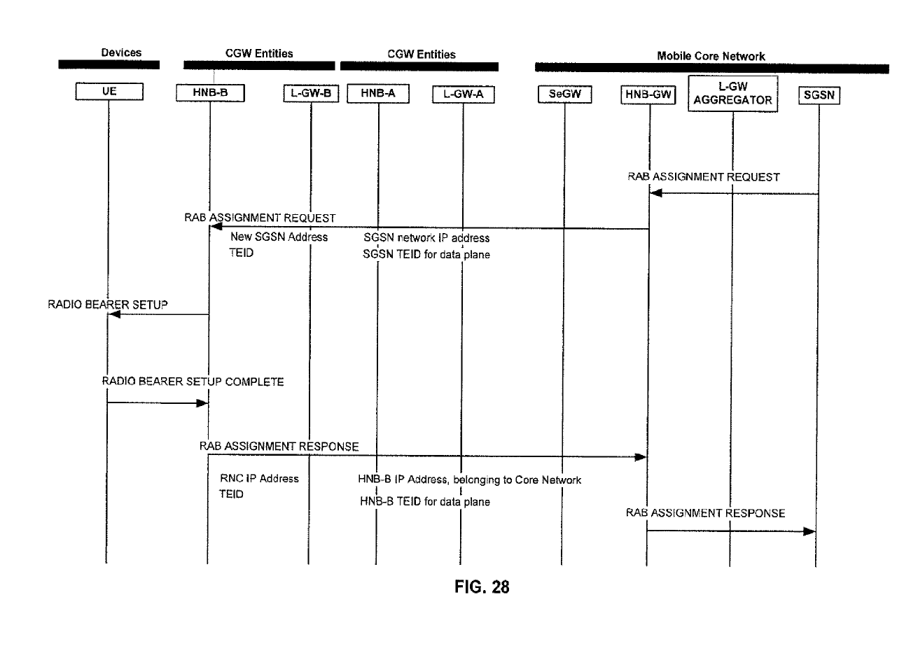

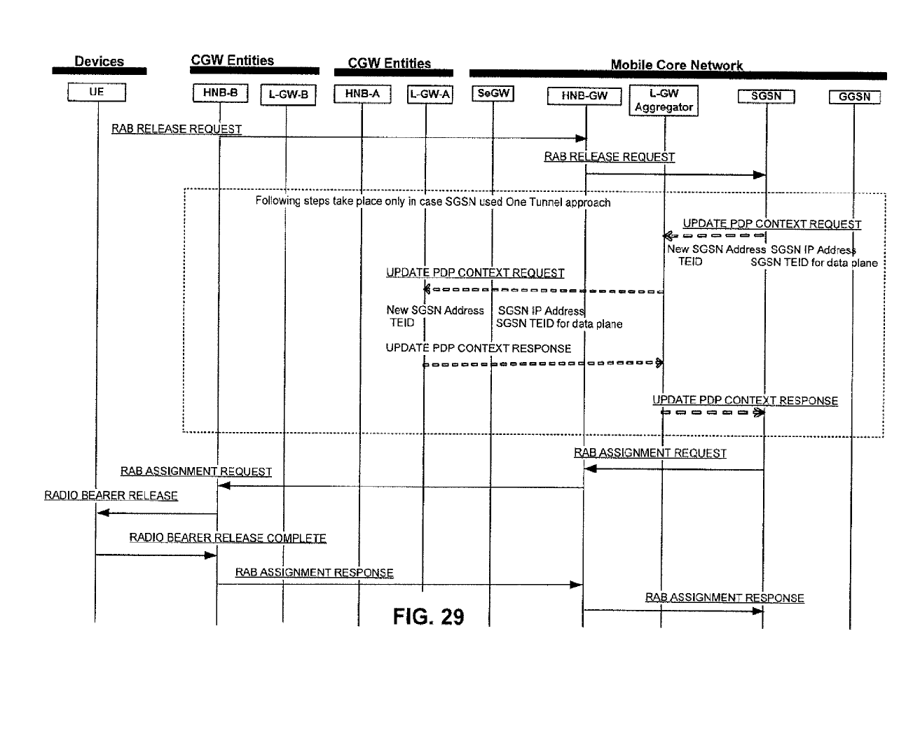

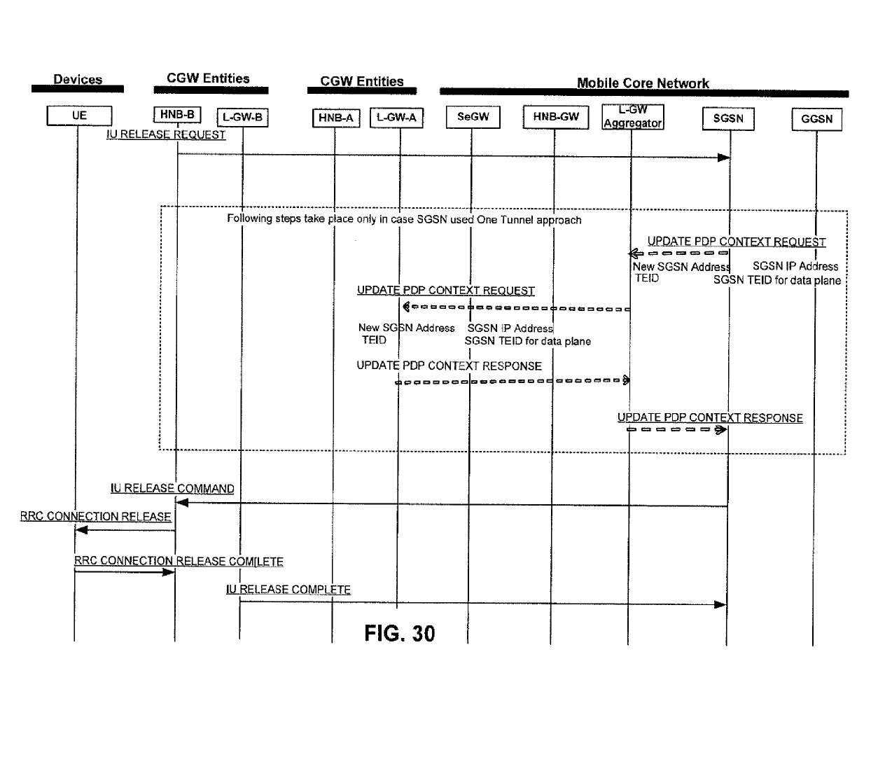

The “Extended” LIPA (E-LIPA) MSCs, as shown in FIG. 22 thru FIG. 30, are exemplary illustrations of setup of the E-LIPA path and local data transfer, including transition to idle mode during periods of data inactivity with preservation of PDP context and subsequent paging with connection/tunnel re-establishment for resumption of downlink initiated E-LIPA sessions. FIG. 22 is an exemplary illustration of a procedure for a UE attached to a neighbor's HNB accessing a device on the UE's home network. FIG. 23 is an exemplary illustration of a procedure for ELIPA path setup and data transfer. FIG. 24 is an exemplary illustration of a procedure for an attached UE going into IDLE state while its PDP context is preserved. FIG. 25 is an illustration of a procedure for a UE previously attached to its home LGW and a network initiates a data transfer. FIG. 26 is an exemplary illustration of a procedure for PDP context creation. FIG. 27 is an exemplary illustration of a RAB setup and user plan establishment with one tunnel. FIG. 28 is an exemplary illustration of a RAB setup and user plane tunnel with two tunnel establishment. FIG. 29 is an exemplary illustration of procedure for RAB release and PDP context preservation. FIG. 30 is an exemplary illustration of an Iu release and PDP context preservation.

The topology of a cellular network may be changing such that HNB devices may be available and deployed in homes (e.g., most homes). The HNB devices may be offered to the end-consumer by the cellular operator or may be sold by equipment manufactures and may utilize the consumers' broadband to connect the HNB to the MCN (MCN). The consumers' broadband modem may use a number of technologies, which may provide a conduit from the broadband modem to the MCN. As UMTS and LTE become more popular, traffic may be offloaded from the MCN. LIPA may be one method to offload local traffic from using bandwidth on the core network. There may be times when two HNB devices that are in close proximity might have to communicate. For example, each HNB may be connected to devices that are to communicate with each other. The data that may be passed during this communication may take many different paths.

The data passed between the HNB devices may travel from each HNB, through the respective broadband modems, the IP backhaul and may then enter the MCN. Once in the MCN, the data may be routed to an SGSN (or SGW) which may route the data back through the MCN to the IP backhaul. Once in the IP backhaul, the data may be routed to the proper broadband modem and then may be delivered to the target HNB. The target HNB may deliver the data to the proper device within its sphere. This approach may be less efficient because bandwidth which may be devoted to other activities may be used for this reflected data. Since more network nodes may be traversed in these operations, there may be a higher likelihood of data being delayed or not delivered at all. Alternatives operations may allow for data to be reflected to its intended target by traversing fewer nodes. These alternatives may be described as “Extended LIPA” or “ELIPA” and may perform inter-HNB communication in a more efficient manner. E-LIPA may allow devices camped on (e.g., registered, connected or join to) different HNB devices to communicate with minimal involvement from the complete MCN.

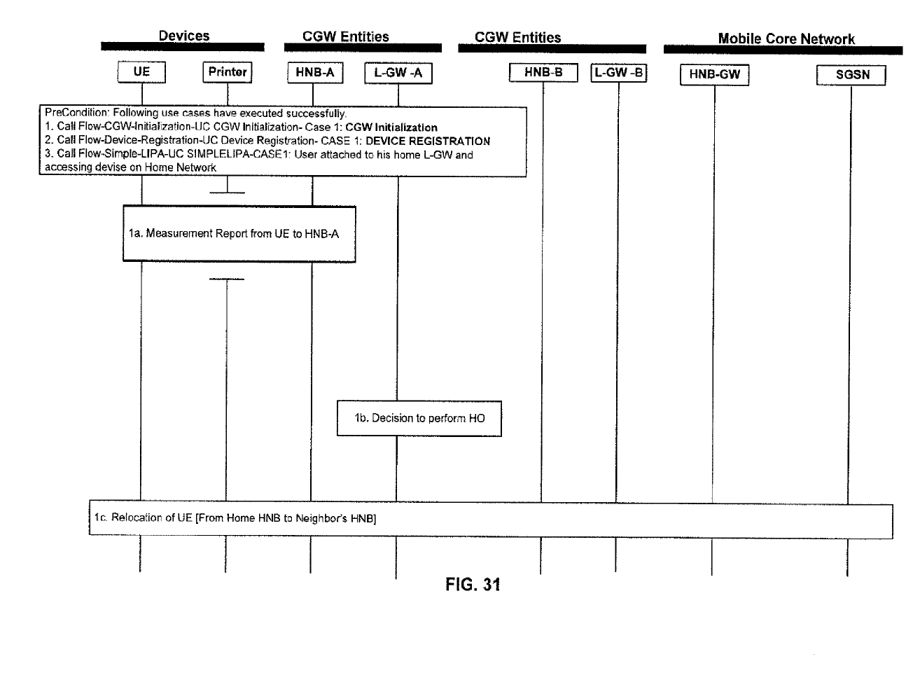

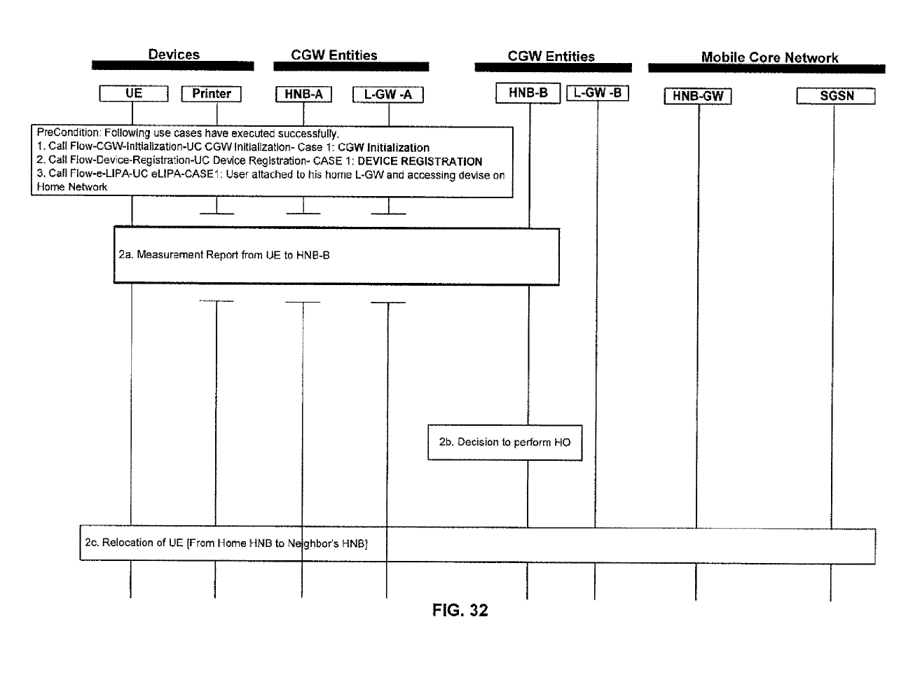

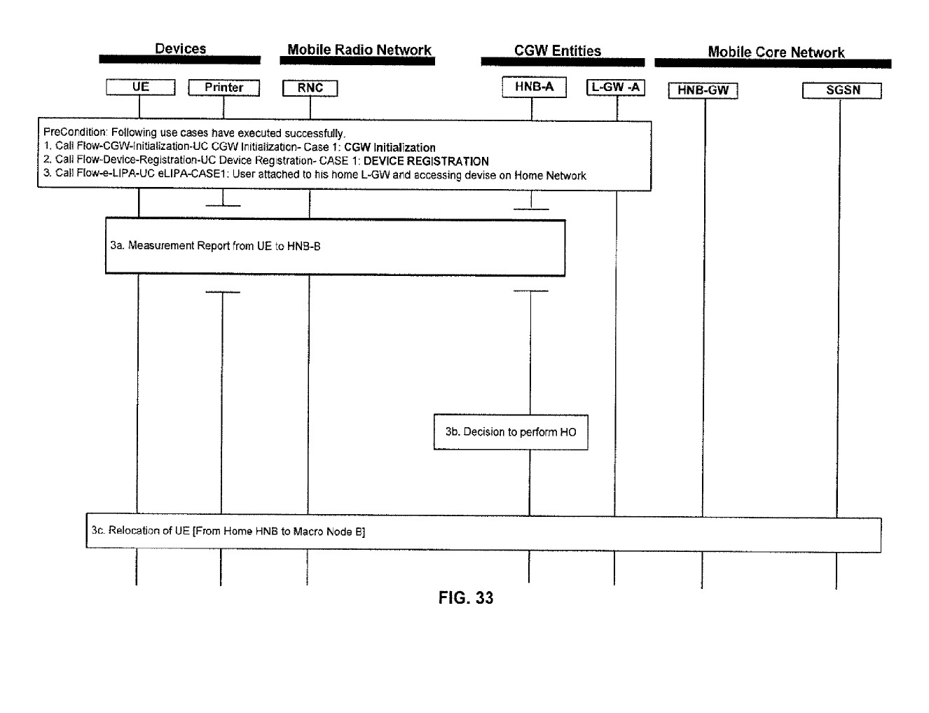

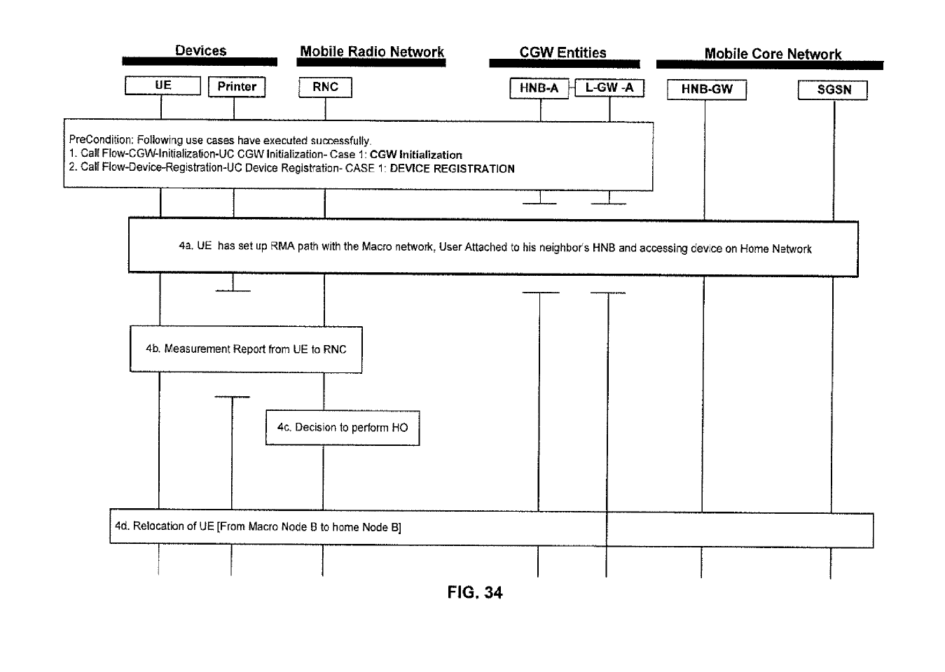

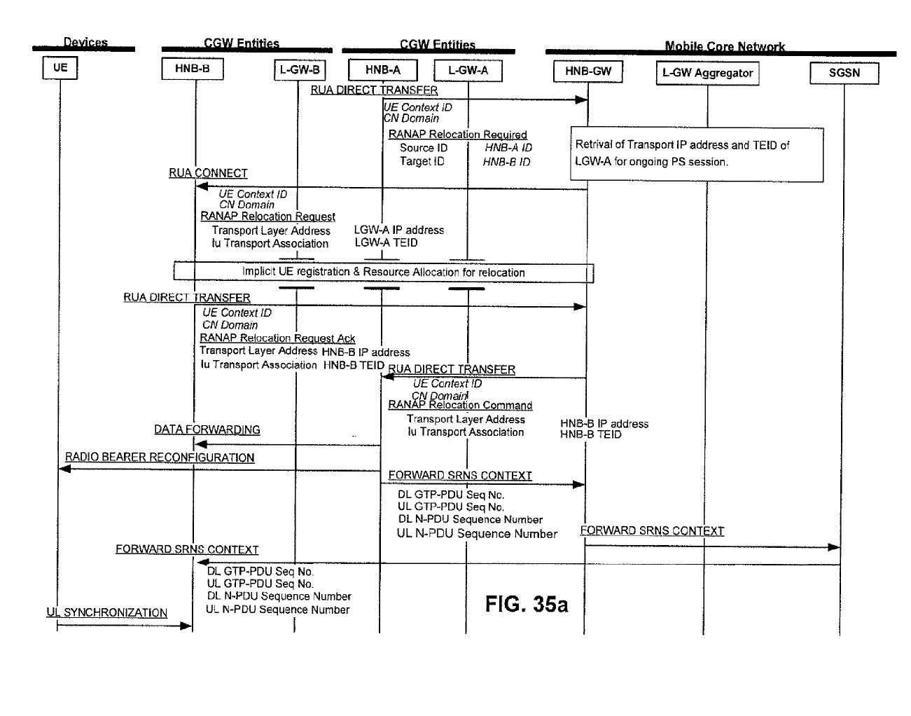

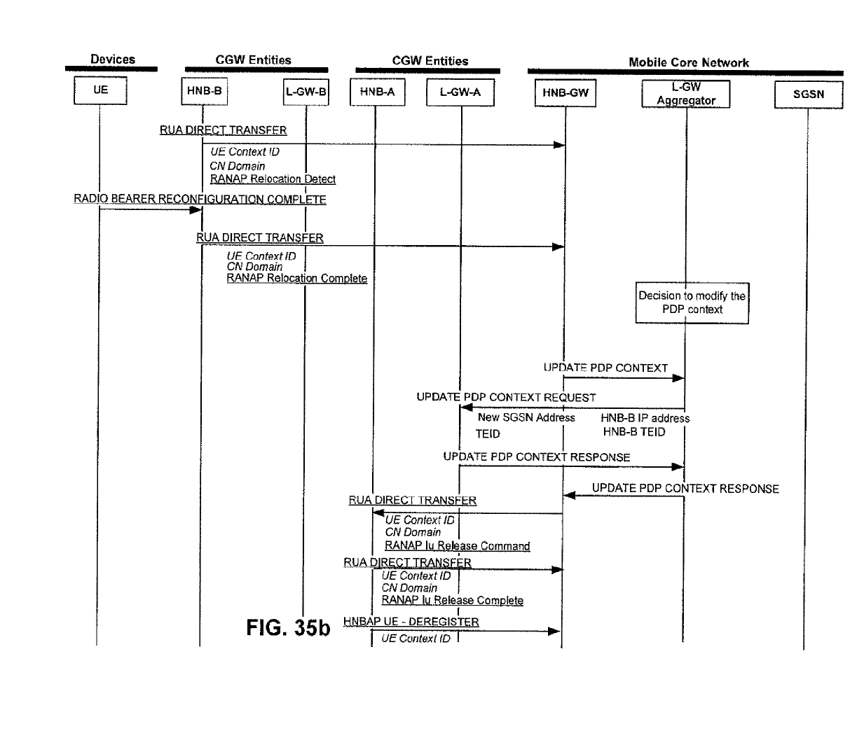

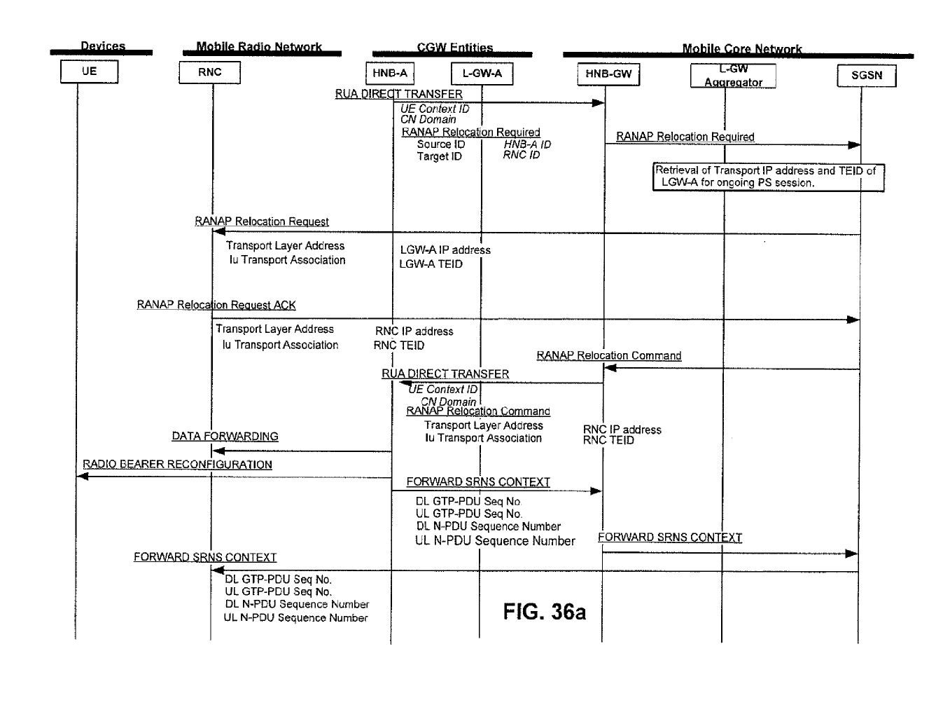

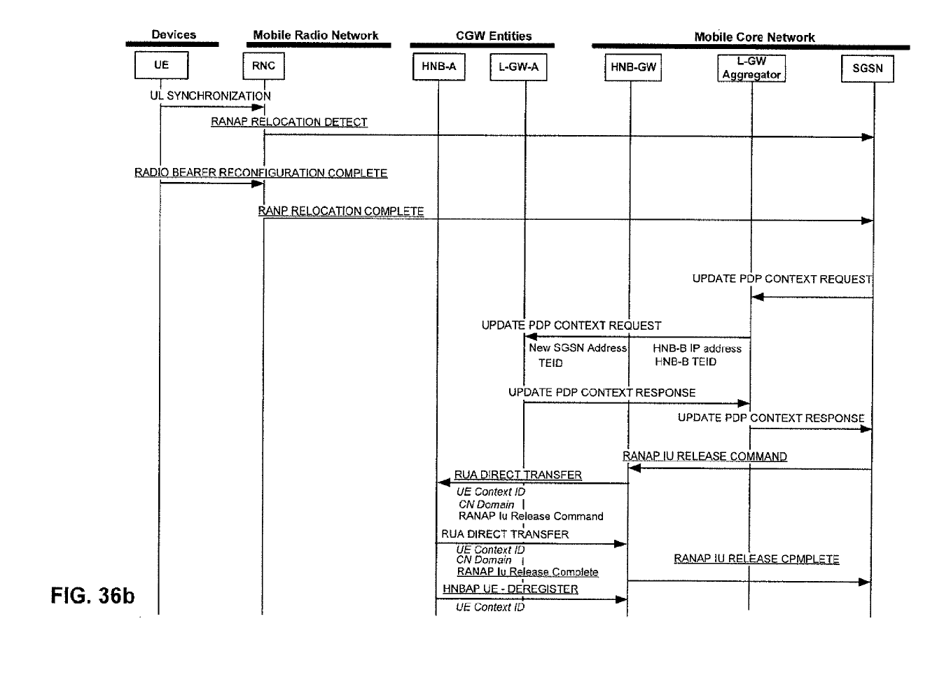

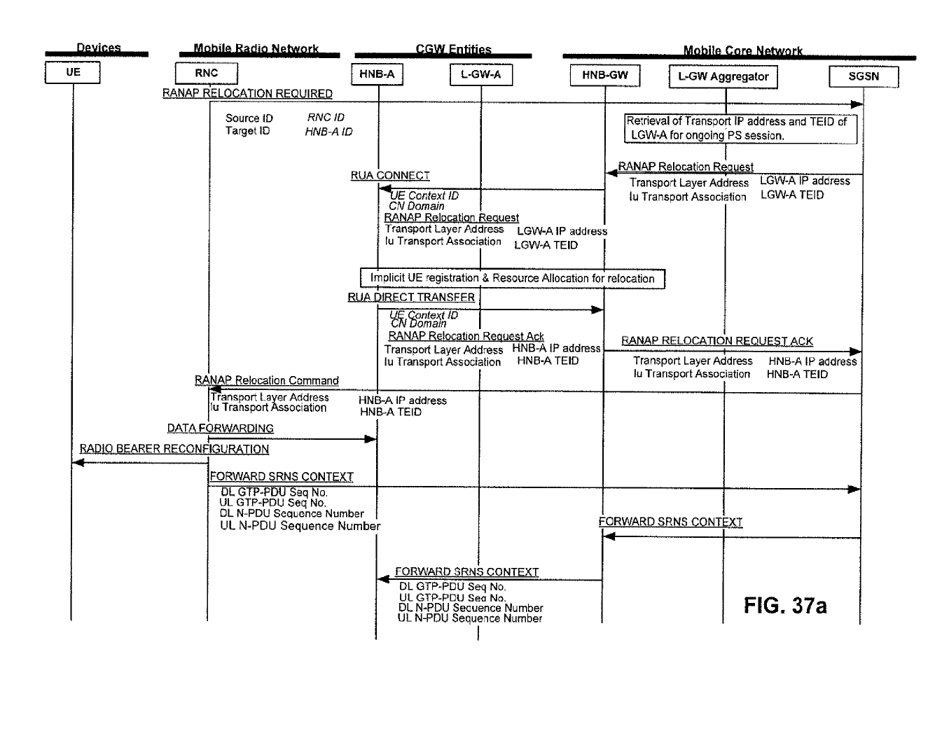

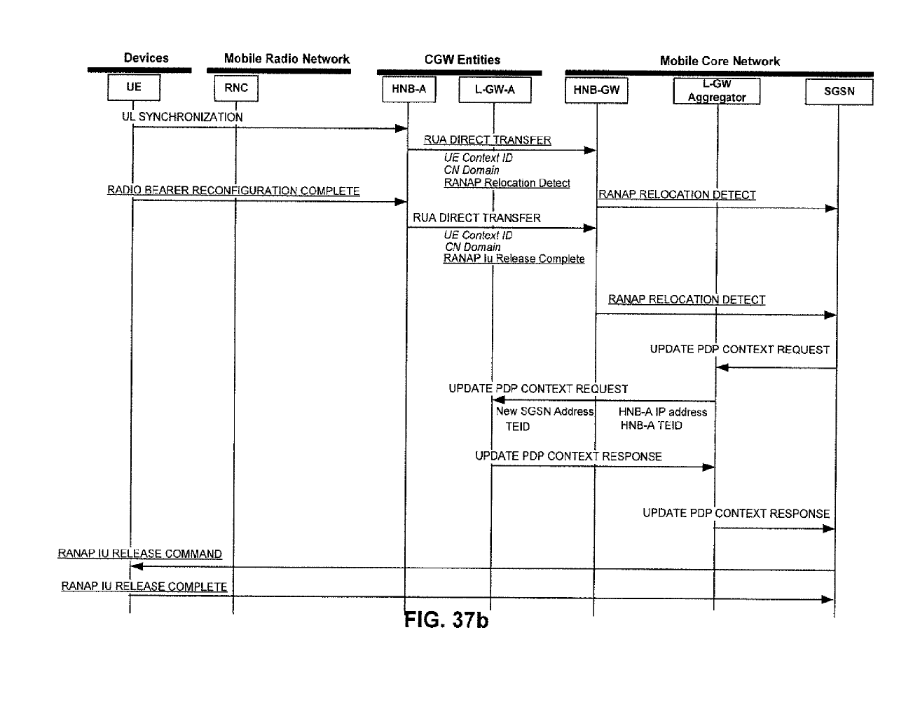

The HNB Handover MSCs, as shown in FIG. 31 thru FIG. 37B are exemplary illustrations of the active handover of packet switched (PS) sessions between HNBs, from HNB-to-macrocell, and from macrocell-to-HNB. FIG. 31 is an exemplary illustration of a procedure for a UE moving to a neighbor's HNB after being attached to the UE's home LGW and the UE accessing a device its home network. FIG. 32 is an exemplary illustration of a procedure for a UE moving to its home node B during a timeframe the UE is accessing its home network while attached to a neighbor's HNB. FIG. 33 is an exemplary illustration of a procedure wherein a UE attached to its home HNB and accessing a device on its home network, moves to a macro network. FIG. 34 is an exemplary illustration of a procedure wherein a UE attached to a macro network and accessing a device on its home network moves to its home network. FIG. 35A and FIG. 35B are an exemplary illustration of a procedure for intra HNBGW mobility (LIPA to ELIPA), wherein FIG. 35B is a continuation of FIG. 35A. FIG. 36A and FIG. 36B are an exemplary illustration of a procedure a UE accessing a home device and moving to a macro network (LIPA to MRA), wherein FIG. 36B is a continuation of FIG. 36A. FIG. 37A and FIG. 37B are an exemplary illustration of a procedure for a UE accessing a home device via a macro network and moving to a femto network (RIMA to LIPA), wherein FIG. 37B is a continuation of FIG. 37A.

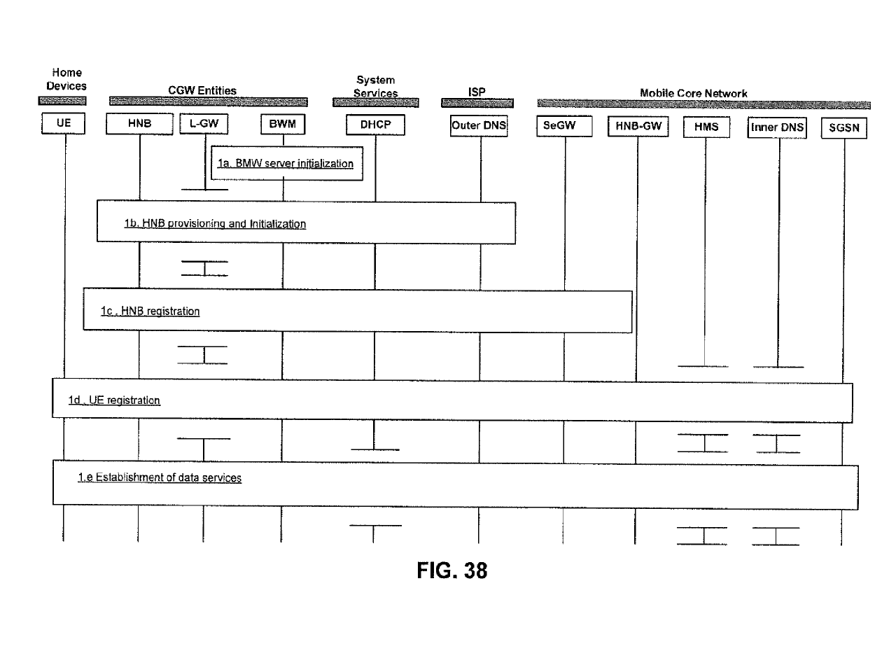

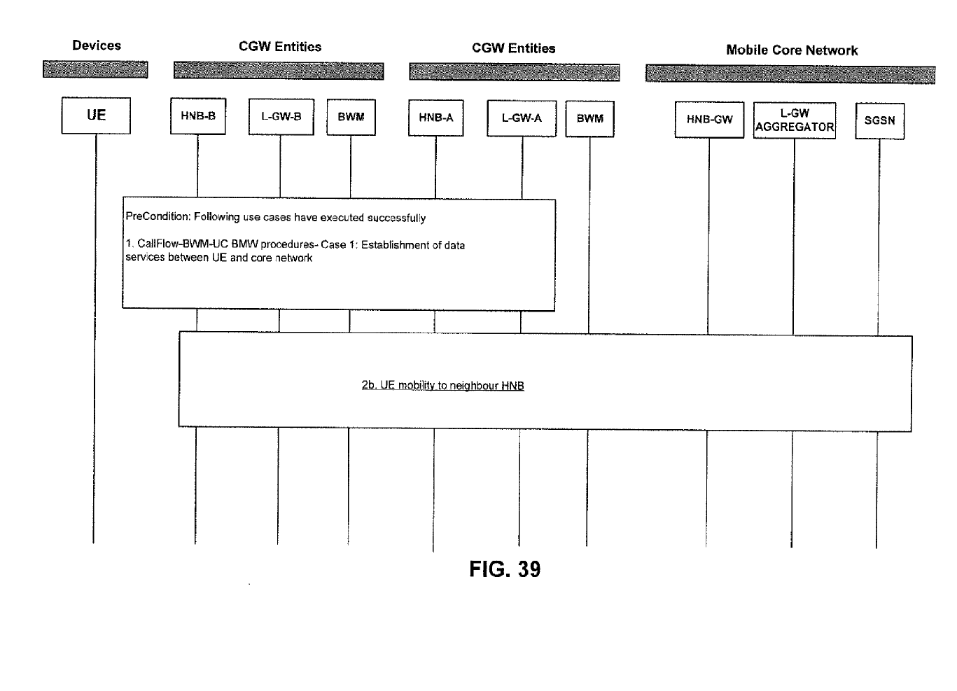

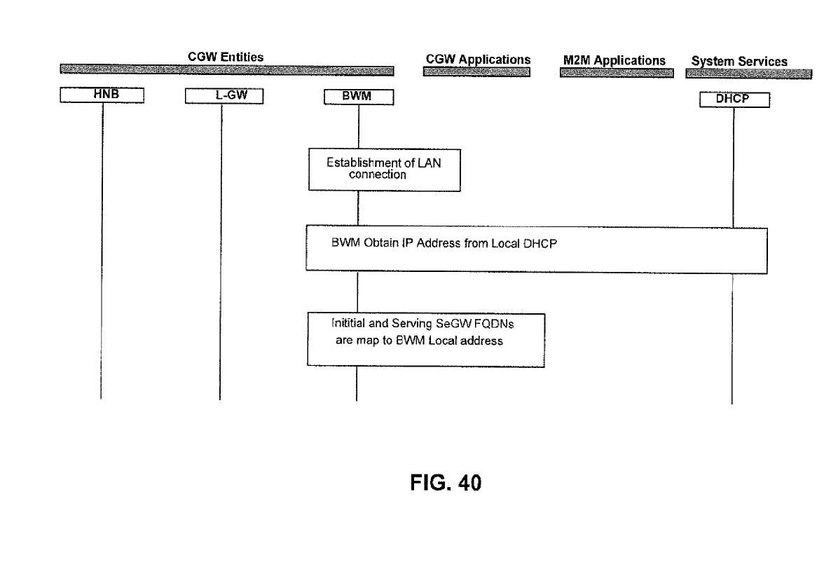

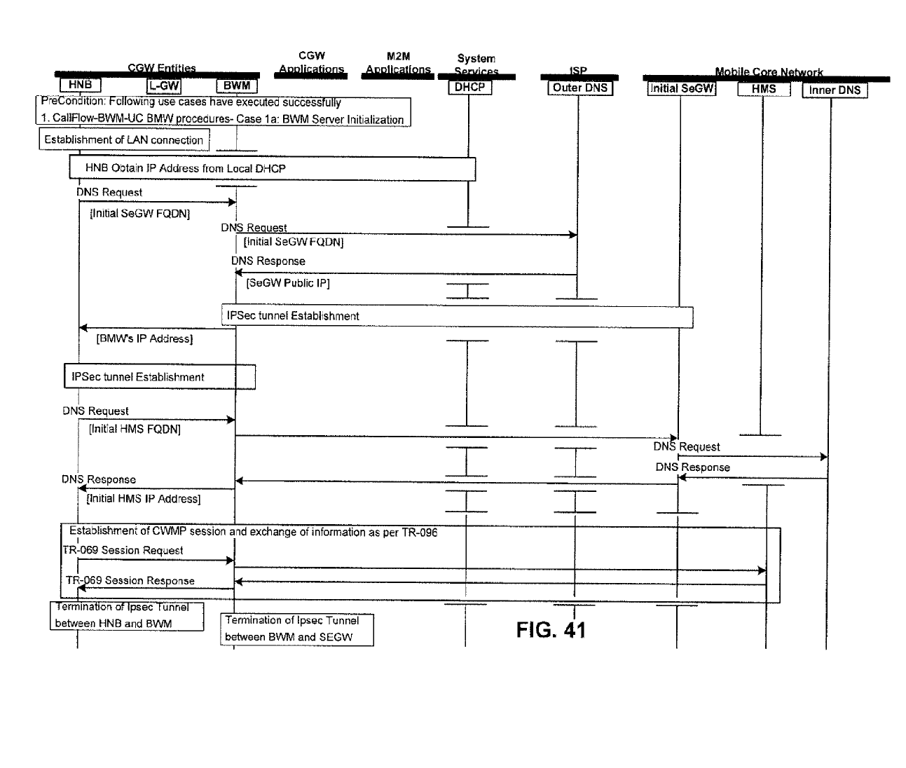

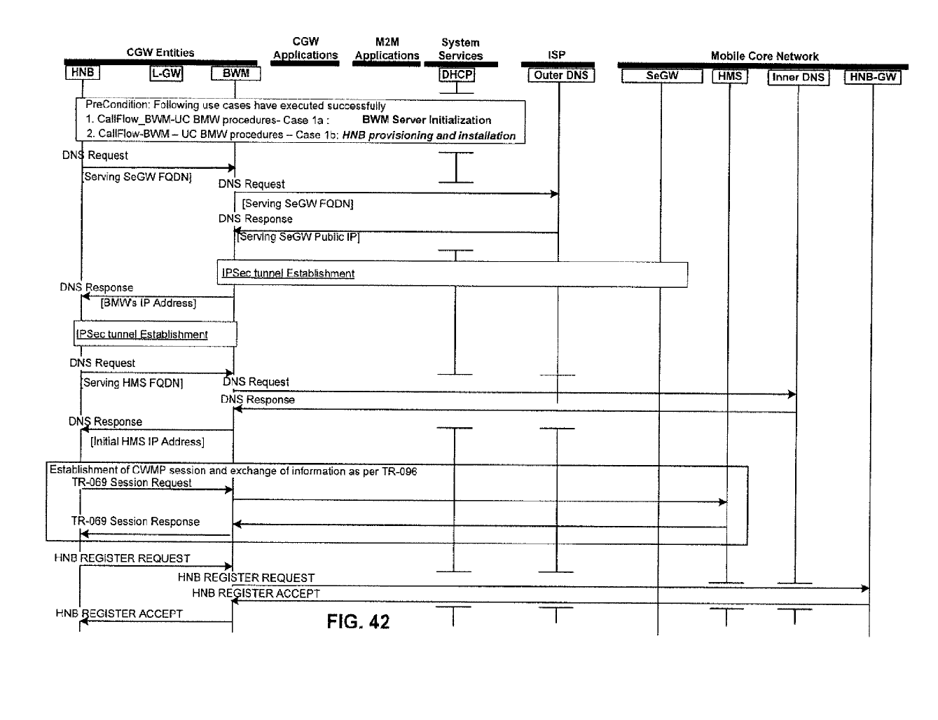

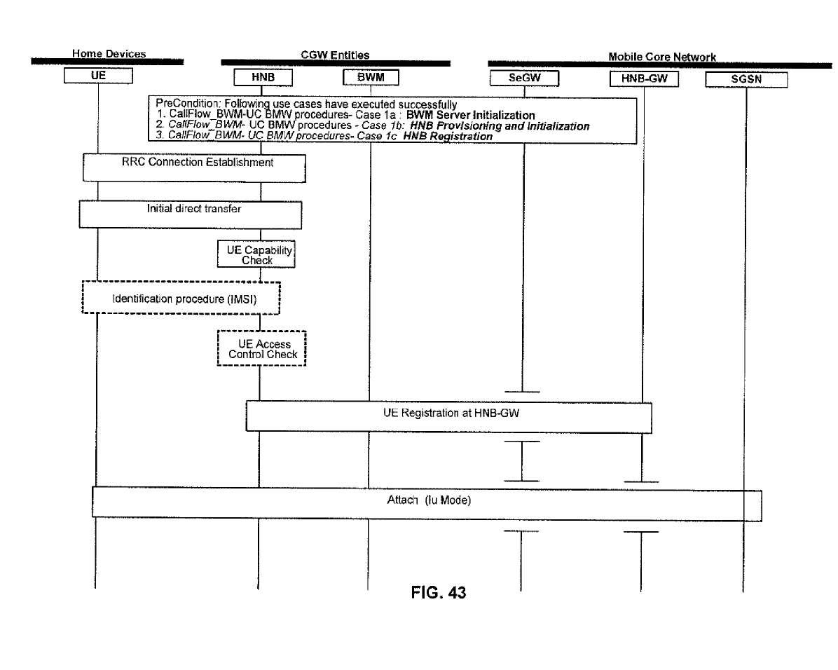

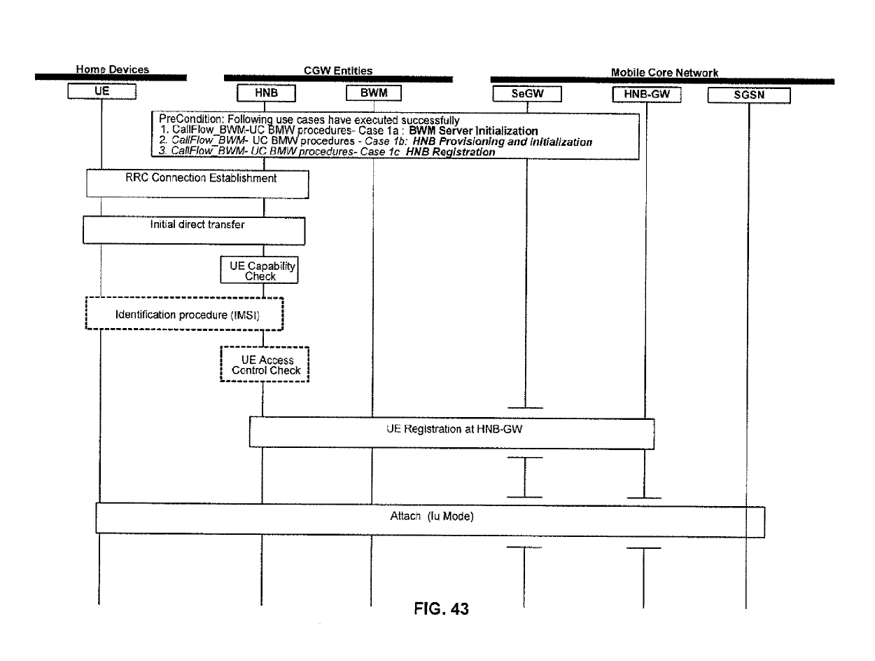

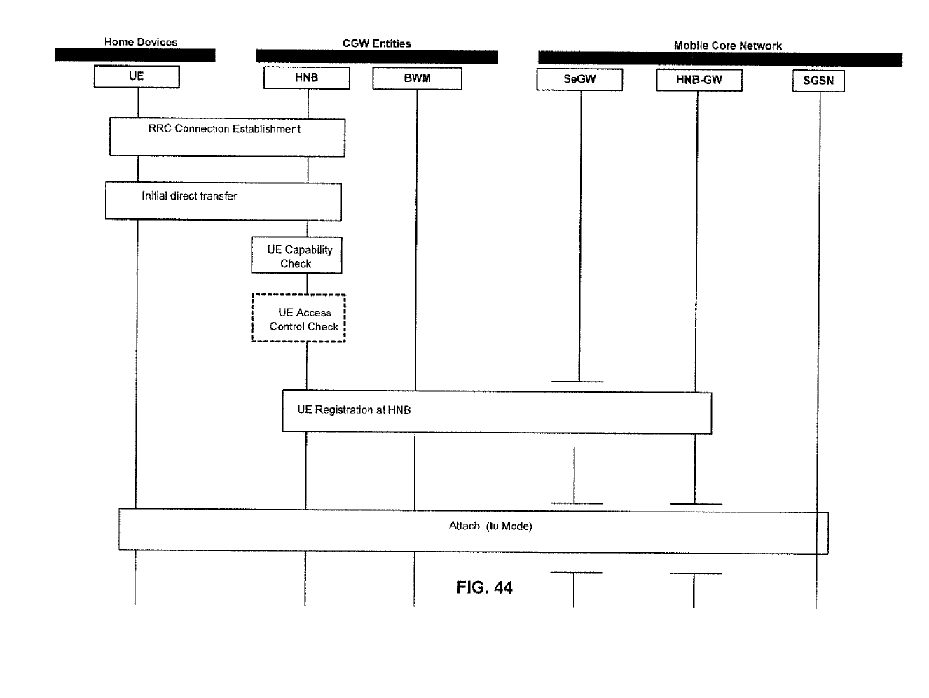

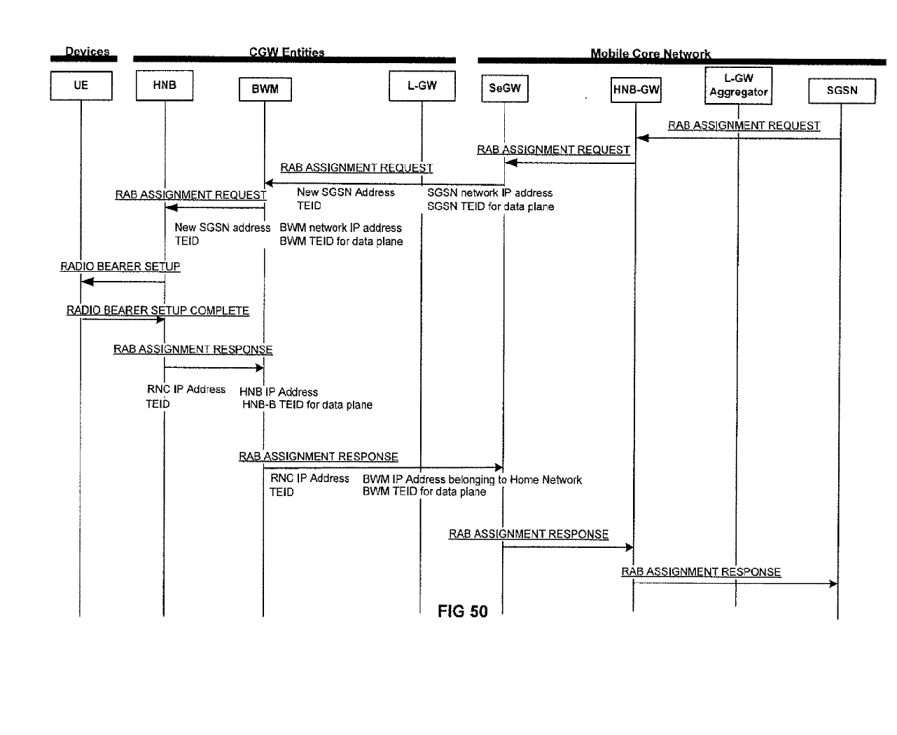

The BWM MSCs, as shown in FIG. 38 thru FIG. 50, are exemplary illustrations of the initialization, session establishment, and mobility procedures associated with the introduction of the BWM server within the CGW between the HNB and the MCN. FIG. 38 is an exemplary illustration of a procedure for the establishment of data services between a UE and core network. FIG. 39 is an exemplary illustration of a procedure for the mobility of UE connected to one HNB to a neighbor's home network, wherein the neighbor is connected to another HNB. FIG. 40 is an exemplary illustration of a procedure for BWM initialization. FIG. 41 is an exemplary illustration of a procedure for CGW initialization in the presence of BWM. FIG. 42 is an exemplary illustration of a procedure for HNB registration. FIG. 43 is an exemplary illustration of UE registration (Non closed subscriber group (CSG) UE). In FIG. 43, messages (e.g., all messages) between the HNB and MCN elements may pass through the HNBGW. The role of the BWM server will be to unpack messages from one IPSec tunnel and then repack them on the other IPSec tunnel. FIG. 44 is an exemplary illustration of UE registration for a CSG UE.

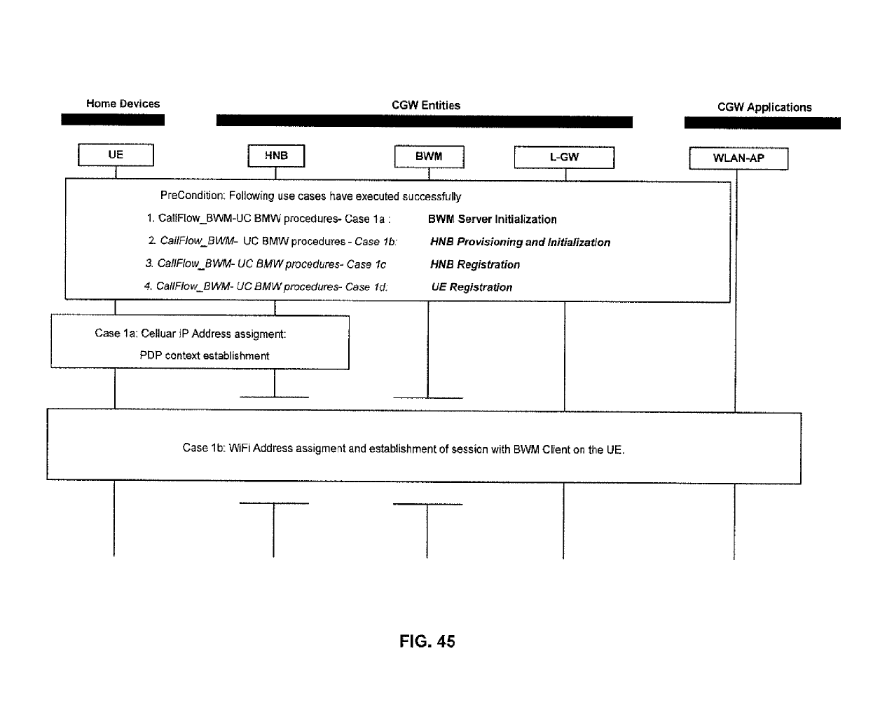

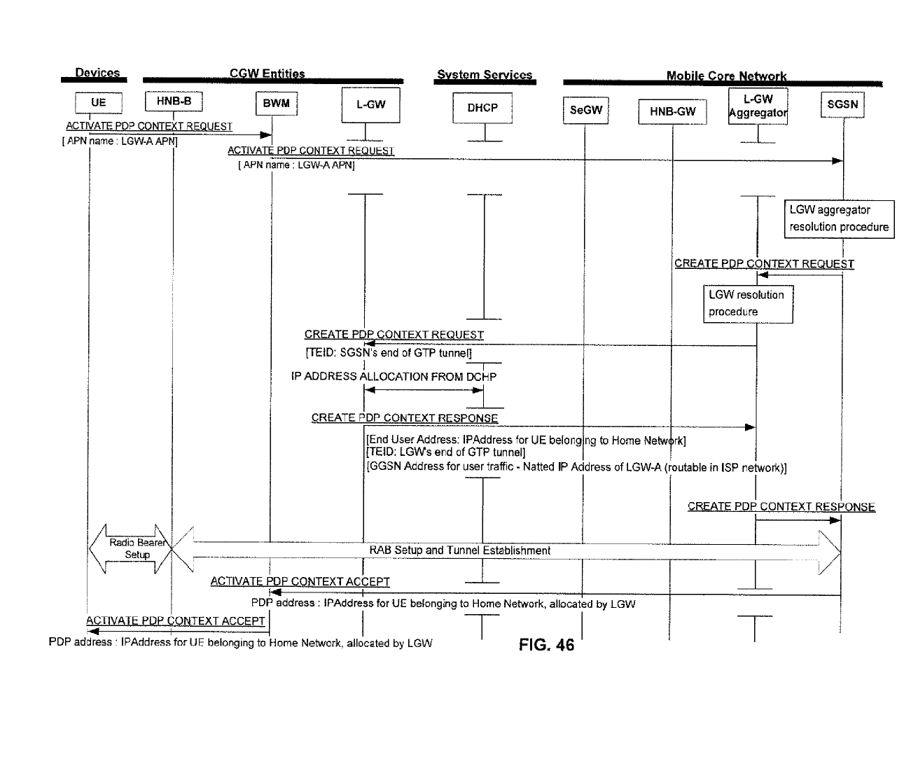

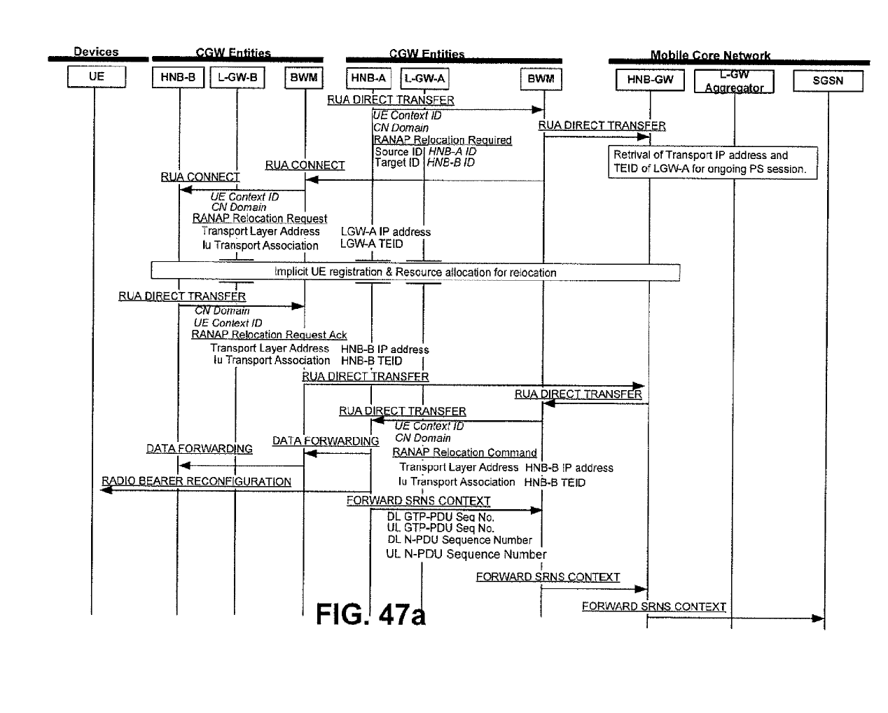

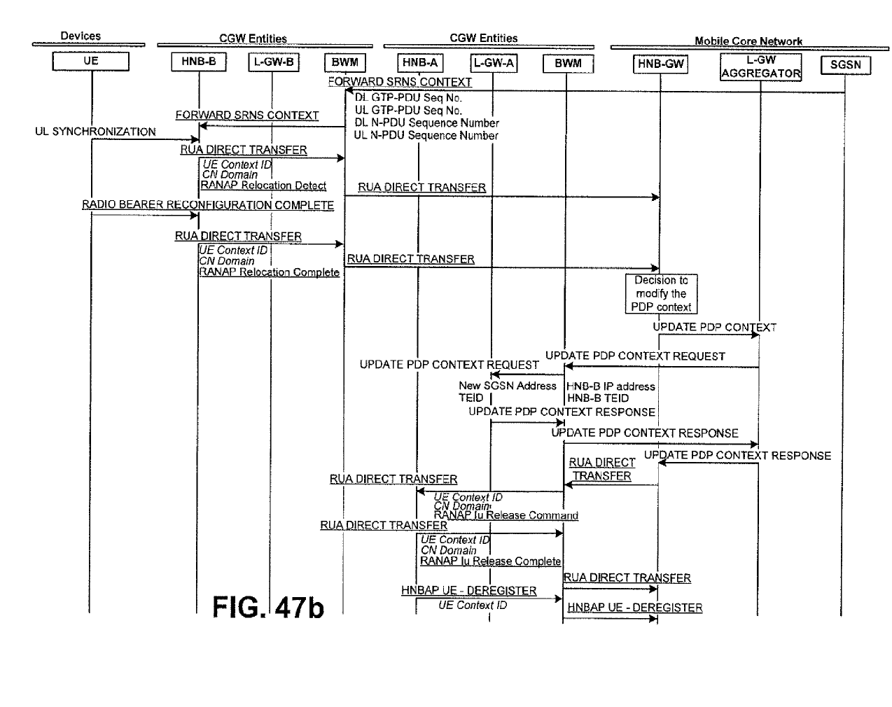

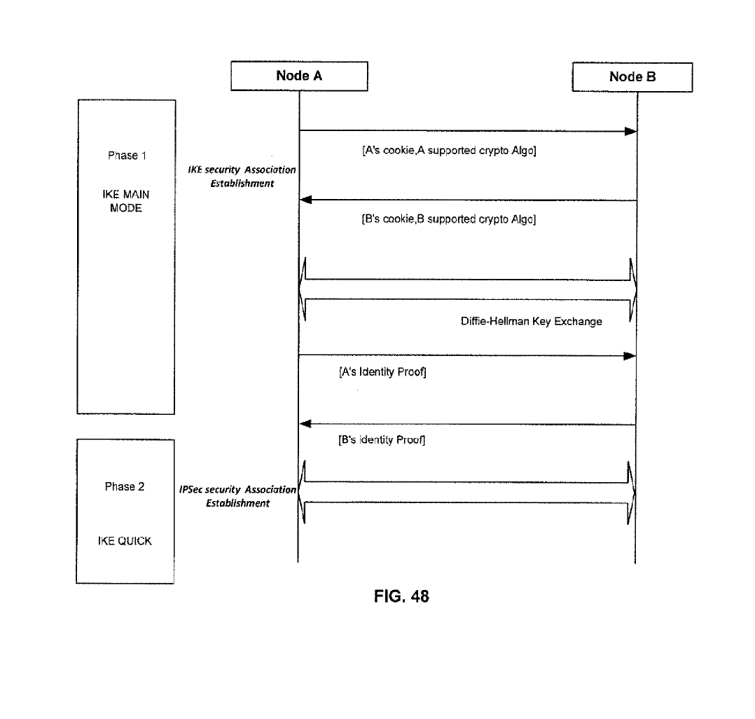

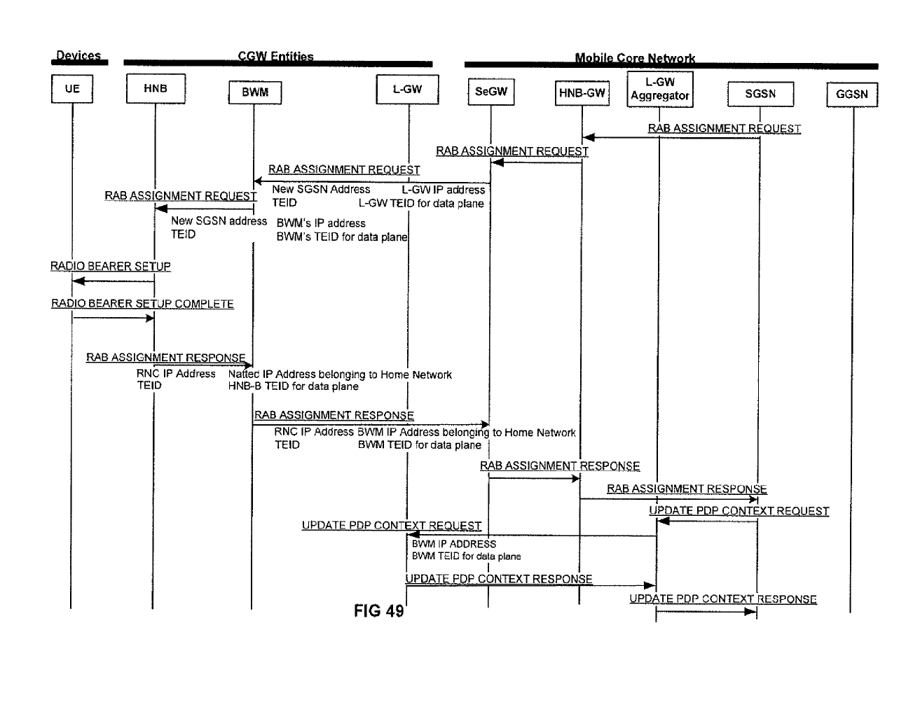

FIG. 45 is an exemplary illustration of packet switched (PS) data services establishment. FIG. 46 is an exemplary illustration of cellular PDP context establishment. FIGS. 47A and 47B are an exemplary illustration of procedures for intra HNBGW mobility (LIPA to ELIPA), wherein FIG. 47B is a continuation of FIG. 47A. FIG. 48 is an exemplary illustration of IKE IPSec procedures between BWM and SeGW. FIG. 49 is an exemplary illustration of procedures for RAB Setup and user plane establishment with one tunnel establishment. FIG. 50 is an exemplary illustration of procedures for RAB setup and user plane tunnel establishment with two tunnel establishment.

Assigning unique APNs to each LGW may lead to a large number of entries in an SGSN APN database. In certain exemplary embodiments, the LGW's IP address may be resolved at runtime based on logic provided by the core network. Typically, each LGW may have a unique identity pre-determined in a manner similar to a HNB. Also, a user profile in the HLR may have entries for the home HNB and/or the home LGW. Under this scheme, the address resolution process may incorporate the following scenarios: (1) the user may be latched to the home HNB and may desire to connect to the home network—the network may resolve the IP address of user's home LGW; (2) the user may be latched to neighbor A's HNB and may desire to connect to the home network—the network may resolve the IP address of user's home LGW; and/or (3) the user may be latched to neighbor A's HNB and may desire to connect A's network—the network may resolve the IP address of Neighbor's LGW.

Many different “digital home” uses may be enabled by the Hybrid Network Converged Gateway architecture. Since Wi-Fi and Cellular accesses is expected to be available within the Integrated Home Network, one use includes the device being a Multi-RAT (e.g., dual mode Wi-Fi & Cellular) device. The data transfer between such a device and the CGW may take place in parallel on both RATs. The parallel transmission may be used to provide higher data rates or improved robustness (by providing multi-RAT diversity) or to provide flexibility (by mapping data packets appropriately and adaptively onto each RAT depending upon various characteristics such as security, data rates, QoS, cost, robustness, and channel quality, among others).

In certain exemplary embodiments, a smartphone may communicate with the CGW using the Cellular RAT (so that QoS is guaranteed, as opposed to the Wi-Fi RAT), and the CGW may communicate with the STB over Ethernet. Following the accessing of the TV Program Guide, the smartphone user may initiate a viewing session. The content, in this example, may be streaming from the WAN. A variation may include the content residing in a DVR unit, which may be connected (or coupled) to the STB. In this example, the video transfer may be local to the IHN.

The CGW architecture may have the following use case categories: (1) local access, (2) remote access, (3) lawful interception, (4) mobility, (5) home security, (5) enterprise (small business), (6) enterprise (network operator), (7) enterprise (home office), (8) self-configuration, (9) store, (10) carry and forward, and/or (11) bandwidth aggregation.

Examples of local access may include session push, local based access to network for LIPA (through the CGW and/or peer-to-peer) and non-LIPA services, mobility within home/enterprise, parental control and guest access, support of legacy devices (non-IMS), session modification, content sharing/multicast, inter-CGW coordination, and get nearest copy.

Examples of remote access may include remote access of media data, media services, and media devices within the home, remote access of security devices within the home, and/or remote access of appliances within the home.

Examples of lawful interception may include lawful interception under LIPA scenarios, surveillance—presence, and/or content protection/digital rights management.

Examples of mobility may include inbound mobility (macrocell-to-CGW), outbound mobility (CGW-to-macrocell) and/or inter-CGW mobility. An example of home security may include notification to remote stakeholders.

Examples of a small business enterprise may include customer guide in shopping center using LIPA access, IP-PABX and/or mobile IP-PABX.

Examples of a network operator enterprise may include new operator offers NW whose capabilities are IMS capable (e.g., only IMS capable—no CS domain), operator removes legacy services (removes CS domain), open access mode, hybrid access mode, offload of CS domain congestion, offload of PS domain congestion—SIPTO, improved coverage, and/or interoperability across providers.

Examples of a home office enterprise may include access to home based content and devices, and/or access to outside home services.

Examples of self-configuration may include built-in test/diagnostics, self healing, energy savings, self-configuration upon power up of CGW, and/or self configuration upon power up of devices which may access the CGW.

An example of store, carry and forward may include a stationary device that may use the CGW to hold data until the CGW can forward the data to its destination.

Examples of bandwidth aggregation may include mega-data transfers, a security function that may break (or divide) the data over several RATs to hide traffic, and/or minimal error—redundant transmissions.

The term “Bandwidth Management (BWM)” may be used to refer to various ways to control multiple, simultaneously active radio links between a WTRU and a MCN. For example, the multiple radio links may be a cellular radio link and a Wi-Fi radio link. The control schemes may include aggregation of the bandwidths provided by the individual radio links to serve a high bandwidth application, which may not be able to be sustained by any of the individual links. The control schemes may include steering of individual traffic flows to different radio links, so that a better match may exist between or among the QoS, security and/or some other attribute of the radio link and the corresponding requirement of the traffic flow. The control schemes may include switching over a traffic flow from one radio link to another in cases of failure and/or excessive degradation of a particular radio link. The control schemes may include highly dynamic steering of individual traffic packets, for example IP packets, across the multiple radio links in concert with the changing temporal fading characteristics of the radio links.

Although the BWM capability and/or control schemes may be described in relation to certain embodiments, it should be appreciated that the BWM capability and/or control schemes may be applicable to a wide variety of uses beyond the described embodiments.

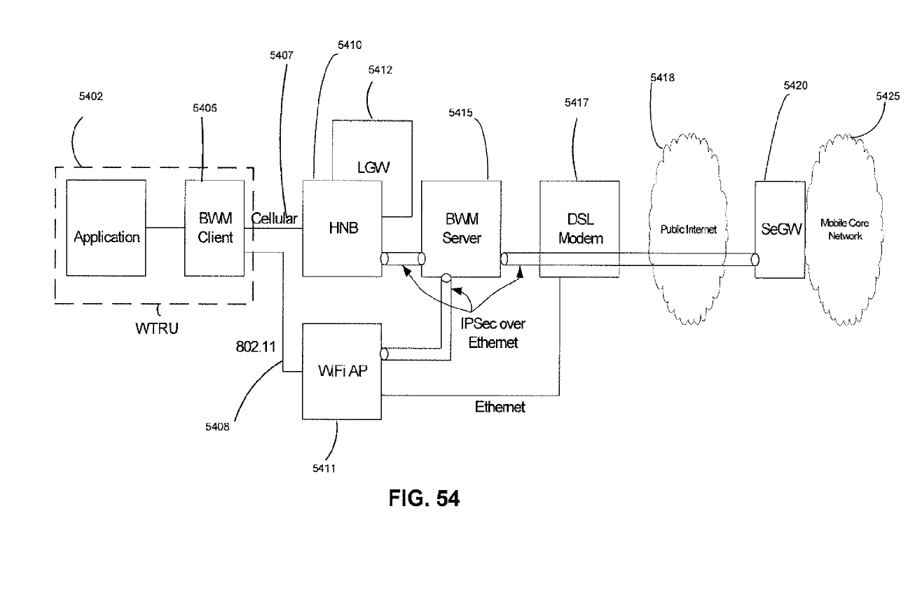

By way of example, a MultiRAT BWM system may be an ‘anchor’ point of the various radio links and another anchor point may be the MultiRAT WTRU itself. In certain exemplary embodiments other anchor point may also exist within the network. FIG. 54 illustrates one option, where the network anchor point may be between the HNB (or femto access point) and the MCN—viewed as a ‘Local-MultiRAT-BWM system’—for example. The anchor-point may be within the HNB itself, which may lead to a modified HNB architecture and may be viewed as an ‘HNB-integrated-MultiRAT-BWM system’. As another example, the anchor-point may be outside the MCN itself, which may lead to a configuration that may be viewed as a Macro MultiRAT-BWM system.

For the Local-MultiRAT-BWM system, in addition to using the cellular network between the MCN and WTRU, some data may be routed between the MCN and WTRU via, for example, a Wi-Fi connection (or other RAT). This traffic offloading may be done at the IP packet level, and one IP flow may be broken up (segregated or divided) using multiple RATs for approximately simultaneous transmission. For example, as shown in FIG. 54, a BWM system may include a BWM server 5415 and a BWM client 5405. The BWM server may be placed between the HNB 5410 and SeGW edge 5420 of the MCN 5425. The BWM client 5405 may be placed within the WTRU device 5402. A local gateway (LGW) 5412, which may be a functional entity for the purposes of local IP connectivity, may be between the WTRU device 5402 and other IP devices (e.g., the BWM server 5415). A Wi-Fi AP 5411 may have an 802.11 interface 5408 that may connect to the WTRU device 5402, and additional interfaces that may connect to the BWM server 5415 and a DSL modem 5417. The BWM server 5415 may have connections to the HNB 5410 and/or LGW 5412, the Wi-Fi AP 5411 and/or the DSL modem 5417. The DSL modem 5417 may connect to the public internet 5418.

A BWM server and BWM client may form an association that may denote the available transports that exist between the client and server. In certain exemplary embodiments, the transports may be one cellular transport and one Wi-Fi transport. A WTRU device may be capable of using multiple transports, but if only one transport is available, using the BWM to perform bandwidth aggregation (BWA) may allow for handoff scenarios when another transport type become available. Multiple cellular and multiple Wi-Fi transports may also exist, such as the following exemplary transport pairs: Cellular+Wi-Fi, Cellular+Cellular, or Wi-Fi+Wi-Fi, among others. It is also contemplated that wired transports such as Ethernet may be used with the BWM and/or the CGW.

When an association is performed, a policy entity within the BWM server and client may decide how best to deliver packets to the other entity (e.g., the BWM server may decide the “best” transport to use to deliver a packet to the BWM client). Both the BWM server and client may have a common requirement to perform this segregation/aggregation of packets between the available RATs.

As shown in FIG. 54, the BWM server 5415 may be located in between the HNB 5410 and the SeGW 5420. Other requirements (e.g., additional requirements) may be imposed on the BWM server 5415 based on its location (e.g., logical location) between the HNB 5410 and the SeGW 5415. The BWM server 5415 may appear as the HNB 5410 to (towards) the SeGW 5420 and appear as the SeGW 5420 to (towards) the HNB 5410. In addition to BWM server's duties regarding the handling of data packets, it may terminate IPSec tunnels that may be in-place between the HNB 5410 and the SeGW 5420 and may terminate GTP tunnels between the SGSN (not shown, but may be located in the MCN 5425) and the HNB 5410. As the termination point for the IPSec and/or the GTP (or both), the BWM server 5415 may perform the “un-IPSecing” and “re-IPSecing” of packets that pass between the HNB 5410 and the SeGW 5420 and may perform the “un-GTPing” and “re-GTPing” of packets that pass between the HNB 5410 and the SGSN (not shown, but may be located in the MCN 5425). Deep packet inspection and the modification of message contents may be performed by the BWM server 5415.

Incorporation of the BWM within the MCN may provide one or more benefits. From an end-user point of view, the BWM may provide a better user experience by realizing higher throughput and/or continued connectivity (even in the face of environmental factors such as interference). For the operator, the BWM, which may rely on BWA, may provide a premium service that may result in higher revenues and the offloading of traffic from the HNB cellular infrastructure. The MCN operator may offer a Wi-Fi access point to offload traffic from the HNB access point which may allow the MCN operator control of the Wi-Fi access point into the home or enterprise. The MCN operator may become the provider of the Wi-Fi access point, which may allow the operator to charge the home owner a premium. By using the BWM, the femtocell may appear to be providing higher throughput from a user perspective. The femtocell may be able to deliver a certain maximum throughput and support a maximum number of users. With the addition of the BWM, the HNB may appear to offer a higher throughput and may support more users. The added throughput may go through (traverse) the Wi-Fi transport, but from a user standpoint, a higher throughput may be enabled and more users can use the HNB.

A protocol to enable a communication session over multiple networks may be used in multiRAT BWM. The protocol may be configured to manage communications over multiple data links (e.g., radio access links) to a data network transparently to the communicating device. For example, the protocol may be a Multi-Network Transport Protocol (MNTP), such as the MNTP developed by. Attila technologies.

The MNTP may be run over (executed in) a “transparent” UDP layer. Similar transparent UDP layer protocols may be used. By using MNTP, a client may be allowed to effectively utilize its multiple data links (e.g., radio access links) to a data network that the MNTP client (e.g., WTRU device) has available in a way that may be transparent to a peer. The MNTP may provide a way of doing so while preserving and enhancing numerous performance characteristics of transmission control protocol (TCP). A description of how the MNTP protocol may be used in an end-to-end MultiRAT BWM system is disclosed herein.

Implementing BWM server systems may include: (1) BWM server initialization; (2) HNB initialization/provisioning; (3) HNB registration; (4) GPRS attach; (5) establishment of data services using BWM aggregation; (6) data transfer using BWM aggregation; (7) DSM interaction with the BWM server; (8) Mobility; and/or (9) CS Voice, among others.

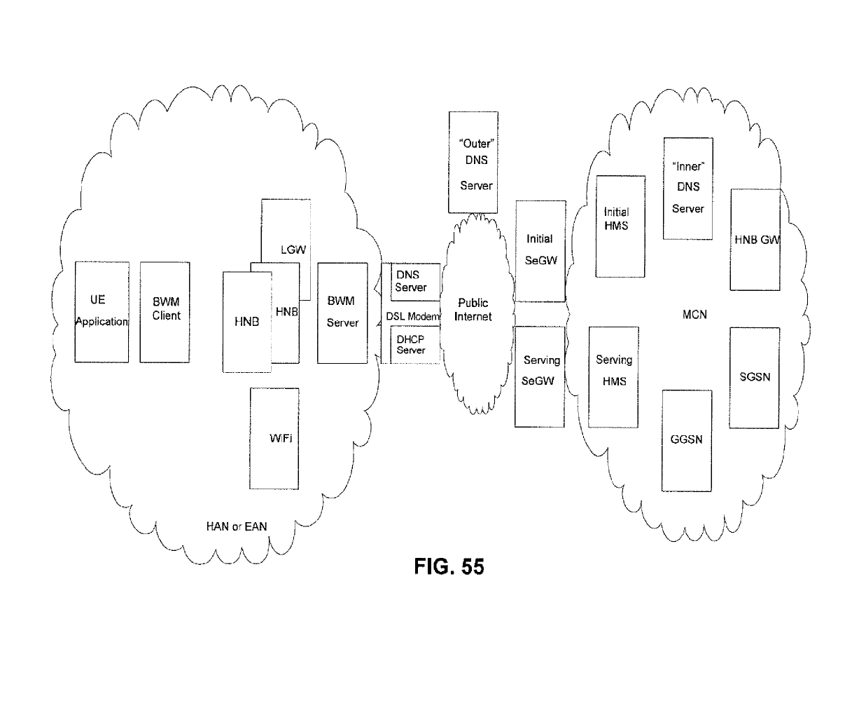

Enterprise scenarios may be implemented in which more than one HNB communicate with the MCN through a single BWM server or multiple BWM servers. FIG. 55 is an exemplary illustration of elements used in such an architecture.

Although the following discussion may focus on a PDP context through the MCN (e.g., remote IP access (RIPA), the use of the PDP context may be applied to other systems, such as an LIPA connection. For an LIPA connection, the SGSN may be replaced by the LGW, which may be local within a home. It is also contemplated that multiple PDP contexts may be established (e.g., some combination of LIPA and RIPA) for a single WTRU device.

If a WTRU device supports cellular (e.g., may only support cellular) or if a Wi-Fi AP is not available, for whatever reason, then the BWM may become a pass-through. For example, the data stream may not be bifurcated and may be delivered via the cellular transport. If the cellular service is not available, no data session may exist because the solution makes use of the MCN. That is, if there is no cellular service, there may be no data connection through the MCN.

Some exemplary implementation of BWM operation when the BWM is located between the HNB and the MCN may include: (1) the BWM may replicate many of the NW and HNB functions; (2) the BWM may route and selectively modify signals between the HNB and the MCN; and/or (3) the HNB may register normally and then may provide information to the BWM. For example regarding operation (3) above the following may occur: (a) the HNB may register with the core network normally as defined in standards; (b) once HNB is “operational”, the HNB may share to the BWM via signaling or via some API the network information received during the HNBGW discovery, provisioning and HNB registration process; (c) the HNB to SeGW IP Sec tunnel may then be torn down; and/or (d) two new IPSec tunnels may be put into place (one between the HNB and the BWM and another between the BWM and the SeGW), among others. Once the tunnels are set up, the method may be the same as the other (1) and (2) above. Details regarding different methods are disclosed herein.

A BWM server may be initialized (e.g., upon power-up). For example, the BWM server may perform a dynamic host configuration protocol (DHCP) discovery procedure. Once this is complete, the BWM server may have a local IP address and may have its DHCP server established with an entry for the Initial SeGW.

A local IP address may be acquired by performing the following operations, resulting in the BWM server having a local IP address on the EAN and/or HAN. The BWM server may broadcast a DHCP Discovery message requesting a local IP address, which may be received by a home or enterprise modem (cable/DSL). A DHCP server within the home or enterprise modem may respond with a DHCP offer message comprising the local IP address being offered by the home or enterprise modem. This offer may include information for a DNS server on the public Internet (“Outer” DNS server). The BWM server may broadcast a DHCP request indicating that the offer from the above has been accepted (since multiple DHCP servers can offer an IP address). The DHCP server within the home or enterprise modem may respond with a DHCP acknowledgment message.

The BWM server, having a local IP address, may populate a lookup table within its DNS server (or equivalent) that may have a mapping between the Initial SeGW (in memory) and the local IP address provided by the DHCP server. Table 1 illustrates such functionally.

TABLE 1

| FQDN | IPAddress |
|---|---|
| Initial SeGW | Local IP address assigned by DHCP Server in |
| | home or enterprise modem |

The mapping may enable the HNB to regard the BWM server as the Initial SeGW. The above describes the use of a DNS server within the BWM server, however, one skilled in the art understands that other methods may be used to perform the DNS server function. For example, the BWM server may have a full DNS server or the BWM server may act as a proxy DNS server by listening to the DNS response for the Initial and Serving SeGW from the “Outer” DNS server and may modify the address for these entities in the messages sent to the HNB. From a functionality standpoint, these operations may bring about the same result. There are different types of DNS requests that may be made by the HNB which is discussed herein.

Initializing and provisioning the HNB (e.g., upon power-up) may provide for the HNB to know (or determine) the FQDN and/or IP address of the MCN entities that the HNB may communicate with during it operations (e.g., the normal course thereof). The HNB may know (or determine) its environment and may be provided the information to the Initial HMS, as well. The HNB may use a local IP address. In order to acquire an IP address the HNB may perform the DHCP discovery procedure.

A local IP address may be acquired for the HNB by performing a combination of the following, resulting in the HNB having a local IP address on the EAN and/or the HAN. The BWM server may broadcast a DHCP Discovery message requesting a local IP address, which may be received by a home or enterprise modern (cable/DSL). The DHCP server within the home or enterprise modern may respond with a DHCP Offer message comprising the local IP address being offered by the home or enterprise modem. This offer may include information for the DNS server on the public Internet (“Outer” DNS Server). The BWM server may broadcast a DHCP Request indicating that the offer from the above has been accepted (since multiple DHCP servers can offer an IP address) and the DHCP server within the home or enterprise modem may respond with a DHCP Acknowledgment message.

As part of the power on and/or initialization sequence, the HNB may attempt to discern information about its environment. There are many ways for the HNB to learn about its environment. For example, the HNB may listen for macrocells and other HNBs in the area by enabling its cellular receiver (e.g., 2G, 3G, and/or 4G). The HNB may determine its location by enabling its GPS receiver or, the HNB may know (or determine) its location based on the public IP address of the home or enterprise modem to which it is connected. Any of these may be sufficient for the HNB to identify its location.

The HNB may communicate with the Initial SeGW after the device has been energized. The HNB may attempt to resolve the FQDN of the Initial SeGW that was pre-burnt within the HNB. This resolution may be performed with a DNS Request/Response. The BWM server may act as a DNS server (or equivalent) to the HNB for this purpose. The BWM server may resolve the Initial SeGW FQDN by sending a DNS Request to the “Outer” DNS server on the public Internet.

The Initial SeGW discovery may be accomplished by performing one or more of the following. The HNB may send a DNS Request to the DNS server (or BWM server) to resolve the Initial SeGW FQDN that was pre-burnt within the HNB. The DNS server within the BWM server may look up the Initial SeGW FQDN in its database and retrieve its local IP address. The DNS server within the BWM server may send this information to the HNB. The BWM server may send a DNS Request to the “Outer” DNS server on the public Internet with the Initial SeGW FQDN that it received from the HNB and the “Outer” DNS server may respond to the BWM server with the public IP address of the Initial SeGW.

In order to provide secure communications between the HNB and the Initial SeGW, an IPSec tunnel may be established between the two entities. The process may include a pre-shared key and agreement of security algorithms between the two entities. Since the BWM server, for example, may be placed between the HNB and Initial SeGW, two IPSec tunnels may be established (e.g., BWM server-to-initial SeGW and HNB-to-BWM server).

An exchange of messages may allow the formation of an IPSec tunnel. For an IPSec tunnel establishment between the BWM server and Initial SeGW, one or more of the following may be performed. The BWM server may send an IKE_SA_INIT message to the Initial SeGW (e.g., to request certain encryption algorithms, authentication algorithms and/or DH groups). The Initial SeGW may respond with an IKE_SA_INT response (e.g., may respond with a selected encryption algorithm, authentication algorithm and/or CH group). The BWM server may send an IKE_AUTH message to the Initial SeGW. The BWM server IKE_AUTH message may include a request for an MCN IP address. The Initial SeGW may respond with an IKE_AUTH response. The Initial SeGW IKE_AUTH may include an MCN IP address. The BWM server may send a CREATE_CHILD_SA message to the Initial SeGW. The Initial SeGW may respond with a CREATE_CHILD_SA response.

For IPSec tunnel establishment between the HNB and the BWM server, the same or a similar process may be followed. The BWM server may use the MCN IP address prior to the HNB requesting it. The HNB may use the MCN IP address so that it can use the MCN IP address as the source address for IP packets that it sends to entities within the MCN.

The HNB may be used to communicate with the Initial HMS (e.g., after establishing an IPSec tunnel). The HNB may attempt to resolve the FQDN of the Initial HMS with the “Inner” DNS server located within the MCN network. In the absence of a BWM server, the HNB may send a request to the Initial SeGW via the IPSec tunnel established previously. The Initial SeGW may un-IPSec the request and may send the packet to the “Inner” DNS server for resolution. In the presence of a BWM server, the process may be the same or similar from the point of view of the HNB and/or the Initial SeGW. The BWM server may un-IPSec and then may re-IPSec the signaling between the HNB and Initial SeGW and the HNB may know or determine the MCN IP address of the Initial HMS.

Initial HMS discovery may be accomplished by performing one or more of the following. The HNB may send a DNS request to the “Inner” DNS server located within the MCN to resolve the Initial HMS FQDN pre-burnt within the HNB. The request may be sent through the IPSec tunnel to the BWM server. The BWM server may unpack the DNS Request and then pack it to go into the IPSec tunnel between the BWM server and the Initial SeGW. The Initial SeGW may unpack the DNS Request and push it into the local MCN IP network to the “Inner” DNS server. The “Inner” DNS server may resolve the FQDN of the Initial HMS to an MCN IP address. The “Inner” DNS server may create the DNS Response with this information and push it to the Initial SeGW. The Initial SeGW may put the packet into the IPSec tunnel between it and the BWM server. The BWM server may unpack this DNS Response and then pack it to go into the IPSec tunnel between the BWM server and the HNB. The HNB may unpack this DNS Response.

The HNB may establish a TR-069 CWMP session with the Initial HMS (e.g., once the IP address of the Initial HMS is known). The session may be established so the Initial HMS can provide the IP address or FQDN of some of the MCN entities to the HNB. In the presence of the BWM server, the signaling between the HNB and the Initial HMS may pass through the BWM server which may un-IPSec and re-IPSec each packet. The BWM server may modify or decode the Set Parameter Value message from the Initial HMS. If the Initial HMS supplies the IP Address of the Serving SeGW, the BWM server may modify the value to be that of its local IP address. If the Initial HMS supplies the FQDN of the Serving SeGW, the BWM server may update its DHCP server table by adding the Serving SeGW FQDN and the BWM server local IP address as follows in Table 2:

TABLE 2

| FQJJN | IPAddress |
|---|---|
| Initial SeGW | Local IP address assigned by DHCP Server |
| | in home or enterprise modem |
| Serving SeGW | Local IP address assigned by DHCP Server |
| | in home or enterprise modem |

MCN entities discovery may be accomplished by performing one or more of the following. The HNB may establish a TR-069 CWMP session with the Initial HMS. The HNB may send Inform Request with the location information determined above (macro-cell info, geolocation, and IP address). The Initial HMS may respond that it received the message. The Initial HMS may send a Set Parameter Value message with the following IP addresses or FQDN: 1) the Serving SeGW (may be the same as the Initial SeGW); 1a) If IP address, BWM server may be modify to be its own local IP address; 1b) If FQDN, BWM server may add entry to its DHCP server table for this FQDN and its local IP address; 2) the serving HMS; and 3) the HNBGW. The HNB may send a Set Parameter Response message to indicate to the Initial HMS that it received the message and, the TR-069 session may be terminated. The IPSec tunnels may be destroyed (e.g., once the above steps have been concluded). Even if the Serving SeGW is the same as the Initial SeGW, the tunnels still may be destroyed.

The HNB may be registered with the HNB GW in the presence of the BWM. The registration may achieve one or more of the following. The HNB may have an IPSec tunnel established with the BWM server, the BWM server may have an IPSec tunnel established with the Serving SeGW, the HNB may have the MCN provided IP address and the HNB may know (determine) the IP address of the MCN entities.

The HNB may be used to communicate with the Serving SeGW after the initialization and provisioning of the HNB. This operation may be skipped, for example, if the Initial HMS provided the IP address of the Serving SeGW; or, may not be skipped if the Initial HMS provided the FQDN of the Serving SeGW. If resolution occurs, it may be with a DNS Request/Response. The BWM server may act as a DNS server (or equivalent) to the HNB for such purposes. The BWM server may resolve the Serving SeGW FQDN by sending a DNS Request to the “Outer” DNS Server on the public Internet. The Serving SeGW discovery may be accomplished by performing one or more of the following. The HNB may send a DNS Request to the DNS server (BWM server) to resolve the Serving SeGW FQDN that was provided as noted above. The DNS server within the BWM server may look up the Serving SeGW FQDN in its database and retrieve its local IP address. The DNS server within the BWM server may send this information to the HNB. The BWM server may send a DNS Request to the “Outer” DNS server on the public Internet with the Serving SeGW FQDN that it received from the HNB and the “Outer” DNS server may respond to the BWM server with the public IP address of the Serving SeGW.

The following procedure is similar to that associated with the HNB Initialization/Provisioning. One exception may be that the Serving SeGW may replace the Initial SeGW. In order to provide secure communications between the HNB and the Serving SeGW, an IPSec tunnel may be established between the two entities. This process may include a pre-shared key and agreement of security algorithms between the two entities. Since the BWM server is being placed between the HNB and Serving SeGW, two IPSec tunnels may be established (e.g., the BWM server-to-Serving SeGW and the HNB-to-BWM server).

An exchange of messages may allow the formation of an IPSec tunnel, which is described. For an IPSec tunnel establishment between the BWM server and Serving SeGW, one or more of the following may be performed. The BWM server may send an IKE_SA_INIT message to the Serving SeGW (e.g., that may request certain encryption algorithms, authentication algorithms and/or DH groups). The Serving SeGW may respond with an IKE_SA_INT response (e.g., that may respond with a selected encryption algorithm, authentication algorithm and/or CH group). The BWM server may send an IKE_AUTH message to the Serving SeGW. This may include a request for a MCN IP address. The Serving SeGW may respond with an IKE_AUTH response, which may include an MCN IP address. The BWM server may send a CREATE_CHILD_SA message to the Serving SeGW. The Serving SeGW may respond with a CREATE_CHILD_SA response.

For IPSec tunnel establishment between the HNB and BWM server, the same process may be followed. The BWM server may use the MCN IP address prior to the HNB requesting it. The HNB may use the MCN IP address as the source address for IP packets that it sends to entities within the MCN. Once these tunnels are established, they may be used going forward to provide secure communication between the HNB and BWM server and the BWM server and the Serving SeGW.

The HNB may be used to communicate with the Serving HMS (e.g., after the establishment on an IPSec tunnel). To do this, the HNB may attempt to resolve the FQDN of the Serving HMS with the “Inner” DNS Server located within the MCN network. In the absence of a BWM server, the HNB would make this request to the Serving SeGW via the IPSec tunnel established previously. The Serving SeGW may un-IPSec this request and may send the packet to the “Inner” DNS Server for resolution. In the presence of the BWM server, the process may be the same from the point of view of the HNB and the Serving SeGW. The BWM server may un-IPSec and then re-IPSec the signaling between the HNB and the Serving SeGW and the HNB may know (or determine) the MCN IP address of the Serving HMS.

The Initial HMS discovery may be accomplished by performing one or more of the following. The HNB may send a DNS request to the “Inner” DNS Server located within the MCN to resolve the Serving HMS FQDN determined as described above. The request may be sent through the IPSec tunnel to the BWM server. The BWM server may unpack the DNS Request and then pack it to go into the IPSec tunnel between the BWM server and the Serving SeGW. The Serving SeGW may unpack the DNS Request and push it into the local MCN IP network to the “Inner” DNS Server”. The “Inner” DNS server may resolve the FQDN of the Serving HMS to an IP address. The “Inner” DNS server may create the DNS Response with this information and push it to the Serving SeGW. The Serving SeGW may put the response packet into the IPSec tunnel between it and the BWM server. The BWM server may unpack this DNS Response and then pack it to go into the IPSec tunnel between the BWM server and the HNB. The HNB may unpack the DNS Response.

The HNB may establish a TR-069 CWMP session with the Serving HMS (e.g., once the IP address of the Serving HMS is known or determined). This session may be established so the Serving HMS can provide the operating configuration to the HNB and the HNB can transfer its location information to the Serving HMS. In the presence of a BWM server, the signaling between the HNB and Serving HMS may pass through the BWM server which may un-IPSec and re-IPSec each packet.

The HNB Operating Configuration discovery may be accomplished by performing one or more of the following. The HNB may establish a TR-069 CWMP session with the Serving HMS. The HNB may send an Inform Request with the location information determined above (macro-cell info, geo-location, and IP address). The Serving HMS may responds that it received the message. The Serving HMS may send a Set Parameter Value message with the operating configuration in the following areas: CN, RF and/or RAN. The HNB may send a Set Parameter Response message to indicate to the Serving HMS that it received the message. The TR-069 session may be terminated.

A similar procedure may be followed to resolve the FQDN of the HNB GW to an IP address, if necessary, as was done for the discovery of the Serving HMS IP address.

The HNB may register with the HNB GW by exchanging a series of messages (e.g., once the HNB knows or determines the IP address of the HNB GW). The registration message and response may pass through the BWM server. The BWM server's role may be to un-IPSec and/or re-IPSec each message as it passes through the BWM server. Once the HNB is registered with the HNB GW, the HNB may begin radiating and may be “open for business” to allow the WTRUs to access the operator provided network.

Registration may be accomplished by performing one or more of the following. The HNB may send to HNB GW the HNB Register Request message with location information, identity, and operating parameters. In the location information element (IE), the HNB may use the information determined during the HNB initialization/Provisioning procedure. In the operating parameters, the HNB may use the information received from the Serving HMS above. The HNB GW may respond to the HNB with a HNB Register Accept message. In the location information IE, the HNB may use the information determined during the HNB Initialization/Provisioning procedure. In the operating parameters, the HNB may use the information received from the Serving HMS above. The HNB may begin radiating and may be available for use by a WTRU.

An GPRS Attach procedure may be used for a WTRU registering with the MCN in the presence of the BWM server/Client. Although the following discussion is based on a PS Attach procedure, other standard procedures (such as CS attach or combined CSIPS attach) may be used. One role of a BWM server may be to un-IPSec packets and re-IPSec packets that comprise the signaling communication between the HNB and Serving SeGW during this procedure.

Synchronization between a WTRU and the HNB and the GPRS Attach procedure may be accomplished by performing one or more of the following. The WTRU may be powered on and go through the normal procedure of synchronizing to the synch channels. The WTRU may read and perform cell search and read broadcast channel (BCH) data. And then the WTRU may start the GPRS attach procedure. It may be assumed that powering on the WTRU also powers on the BWM client. If the WTRU and BWM client are different physical entities, they may need to both be powered up. It may be sufficient to power them on separately, without coordination of time or sequence, for example, if they are powered on “at about the same time.”

The GPRS Attach procedure may include one or more of the following. The WTRU may send an RRC Connection Request message to the HNB (e.g., cause set to Initial Registration). The HNB may send an RRC Connection Setup message to the WTRU. The WTRU may establish the DCH and send an RRC Connection Setup Complete message to the HNB. The WTRU may, over this DCH, send a GPRS Attach message to the HNB. This may cause the HNB to send the WTRU Registration message to HNB GW. The HNB GW may send a WTRU Registration Accept message to the HNB. The HNB may then send a Connect message to SGSN with the Initial WTRU Message to establish the signaling connection through HNB GW. The HNB GW may forward this message to the SGSN. The SGSN may respond to the message sent to the HNB GW. At this point, there may be a signaling connection between the WTRU and SGSN. Authentication and other signaling may then occur between the SGSN and the WTRU. The SGSN may send the Attach Accept to the WTRU. The WTRU may respond with the Attach Complete to the SGSN. The HNB may send an RRC Connection Release to the WTRU. The WTRU may respond with an RRC Connection Release Complete to the HNB.

Data services may be established on the BWM equipment. As part of the procedure, the WTRU may get three IP addresses: an MCN provided IP address (RIPA), a local IP address (LIPA), and a Wi-Fi address.

For the WTRU to acquire these three IP addresses, the WTRU may be used to perform the following: establish a RIPA PDP Context, which, as explained below, shows the workings of the PDP context with the BWM server/Client in place; establish a LIPA PDP Context; and establish an association with the Wi-Fi access point located in the CGW.

Once the WTRU has the three IP addresses (RIPA, LIPA, and Wi-Fi), the BWM client may form an association with the BWM server. The BWM client may use the Wi-Fi IP address and at least one of the two cellular IP addresses (multiple radio access technologies for bandwidth aggregation). The BWM client may share this IP address information with the BWM server indicating that it wishes to form an association. The BWM client may use the IP address of the BWM server to form the association. The BWM client may determine the association by performing a DNS Request of the BWM server. The DNS server within the DSL modem may respond with the local IP address of the BWM server. In certain exemplary embodiments, the BWM server may be placed at a static IP address within the enterprise or home and the BWM client may be preconfigured with this information. Regardless of the method used, the BWM client may form an association with the BWM server to perform BWM aggregation.

Although bandwidth aggregation and segregation is shown using a BWM client and server, it is contemplated that other configurations are possible including integrating the functionality of the BWM solution into the CGW.

For both the RIP A and LIP A PDP context activations, the BWM server may unIPSec and then re-IPSec the signaling that traverses between the HNB and the MCN. The WTRU may have a PDP context with the MCN for RIPA, a local IP address for LIPA and a Wi-Fi address.

RIPA PDP Context activation may be accomplished by performing one or more of the following. The WTRU may send an Activate PDP Context Request message. APN may be a GGSN located within the MCN. If the APN was a LGW, the same procedure may work as it is agnostic in regard to the location of the GGSN. The SGSN may derive GGSN from APN name. The SGSN may create TEID for the requested PDP context. The SGSN may send a Create PDP Context Request message to the GGSN. This may establish a GTP tunnel between the SGSN and GGSN. If the APN was local, the GTP tunnel may be between the SGSN and LGW within the home. If the WTRU has requested a dynamic address, the GGSN may create an entry in the PDP context table and establish a charging ID. The entry may allow GGSN to route data between the SGSN and PDN and may allow the NW to charge the user. The GGSN may select the IP address. The GGSN may send the Create PDP Response to the SGSN. The RAB Assignment may be performed between the SGSN and WTRU. The SGSN may send an Activate PDP Context Accept to the WTRU. The WTRU may now have a PDP context through the MCN and an IP address assigned by the GGSN.

The RAB Assignment performed between the SGSN and WTRU for the above RIPA PDP Context activation may be performed by using one or more of the following. The purpose of these steps may be to establish a GTP tunnel between the SGSN and the HNB and a radio bearer between the HNB and the UE. In this case, the purpose may be modified to establish two GTP tunnels, between the SGSN and the BWM server and between the BWM server and the HNB and the establishment of a radio bearer between the HNB and the WTRU. The RAB Assignment Request/Response message pair may set up a GTP tunnel between the two entities that are exchanging this request/response pair. The SGSN may send an RAB Assignment Request to the BWM server. The BWM server may un-IPSec this message and may replace the following fields with its own addresses: New SGSN Address and TEID. The BWM server may re-IPSec this modified message to send the message to the HNB. The HNB may send a Radio Bearer Setup message to the WTRU. The WTRU may respond with a Radio Bearer Setup Complete message to the HNB after the WTRU sets up the radio bearers. The HNB may send an RAB Assignment Response to the BWM server. The BWM server may un-IPSec this message and may replace the following fields with its own information: a RNC IP Address and a TEID. The BWM server may re-IPSec this modified message to send the message to the SGSN. At the end of the RAB Assignment request/response signaling that passed through the BWM server, two GTP tunnels may be established (e.g., between the BWM server and the SGSN and between the BWM server and the HNB and one radio bearer between the WTRU and the HNB. The SGSN may send an Update PDP Context Request to the GGSN. The GGSN may respond with an Update PDP Context Response to the SGSN. The Update PDP context request/response pair of messages may allow the SGSN to inform the GGSN if the QoS was modified during the radio bearer setup process between the HNB and the WTRU. If the original QoS was maintained, these two messages may not be exchanged.

There may be data transfer across the BWM aggregation. After the PDP context is established, where the MCN and the BWM server and client may have associated, the WTRU may desire (want) to send and receive data from sources on the network. The following describes the flow of downlink data from the SGSN to the WTRU and the flow of uplink data from the WTRU to the SGSN. For each direction an example is provided in which a fixed number of packets may be passed and the BWM server or BWM client decides on which RAT to transmit each packet. This discussion contemplates that in-sequence delivery may be used flow/stream recovery.

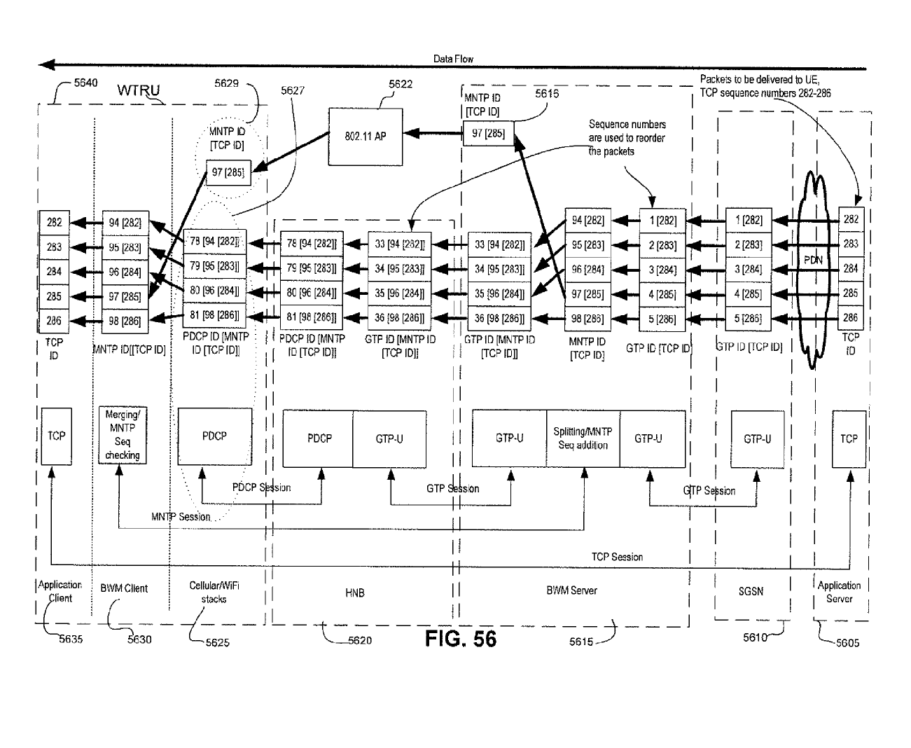

FIG. 56 illustrates a data transfer example. The example contemplates that five downlink packets may be sent to the WTRU from the SGSN and that four of the five packets may be delivered to the WTRU by the cellular RAT and one packet may be delivered to the WTRU by Wi-Fi. In the absence of the BWM or CGW, the GTP entities in the HNB and SGSN may be in-synch with regard to GTP sequence numbers and the PDCP entities within the HNB and the WTRU may be in-synch with regard to PDCP sequence number. In the presence of the BWM server placed between the HNB and the MCN, the sequence number consistency may no longer be maintained. For the non-mobility case, this lack of consistency may not present a problem. However, this may introduce an issue when mobility occur in the presence of an in-sequence PDP context as discussed herein.

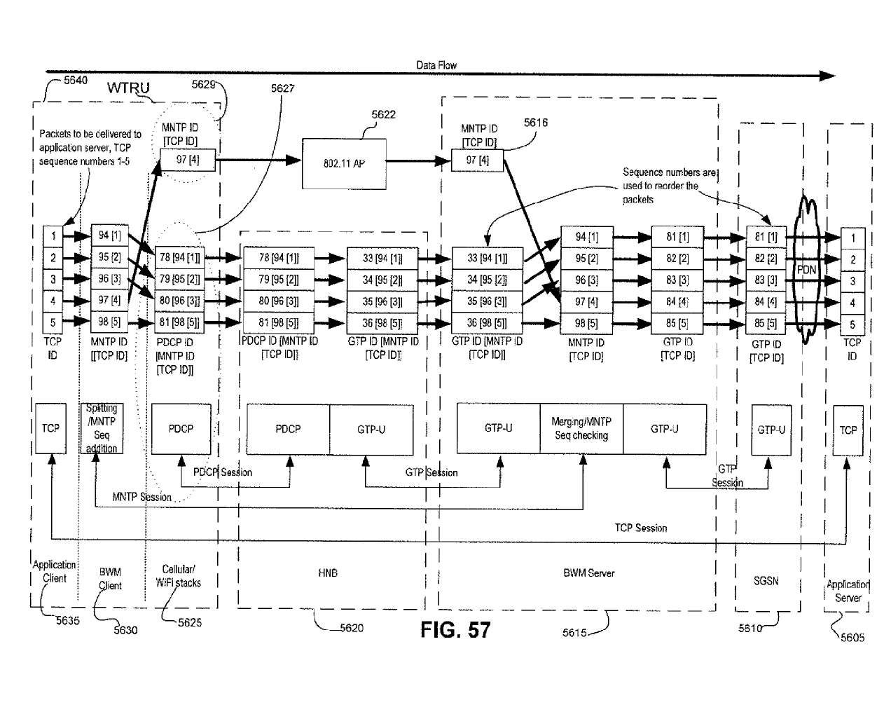

As shown in FIGS. 56 and 57, the ID's for each session may be listed in order as depicted in the figure (e.g., MNTP [TCP ID]). For example, packet 5616 is numbered 97 [285], wherein the MNTP ID is 97 and the TCP ID is 285 in this example. Also note that different sequence numbers are used for each GTP tunnel. FIG. 56 details a flow. The application server 5605, which may be running TCP, may send five TCP packets into the MCN. Eventually, these packets may be received by the SGSN 5610. The five packets may be passed over a GTP-U tunnel between the BWM server 5615 and the SGSN 5610. As shown in FIG. 56, the sequence number of these five packets is 1-5. When the packets are received by the BWM server 5615, the GTP entity within the BWM server 5615 may reorder the packets based on their sequence numbers. The BWM server 5615 processing may then decide to vector one packet (here, packet 5616) to the 802.11 link and the rest through the HNB 5620. For illustrative purposes, the fourth packet was selected to be routed to the 802.11 AP 5622. The BWM server 5615 may then send the remaining four packets to be delivered over the cellular link to the HNB 5620 (e.g., packets 1, 2, 3, and 5). The GTP entity within the BWM server may issue these packets consecutive sequence numbers. These packets may be delivered to the GTP entity within the HNB 5620, which may reorder the packets based on the GTP sequence numbers. As the packets are reordered, they may be delivered, in order, to the PDCP entity within the HNB 5620. The packets may be assigned a PDCP sequence number which may be used to synchronize the communication between the PDCP entities within the HNB 5620 and the WTRU 5640. The BWM client 5630 may then place packets received from the WI-FI and cellular network, as recombined, into their original order (e.g., 1, 2, 3, 4, 5) and forward the sequence of packets to the Application client 5635 that is within the WTRU 5640.

FIG. 57 illustrates another data transfer example. This example contemplates five uplink packets to be sent from the WTRU to the SGSN and that four of the five packets may be delivered to the BWM server 315 by the cellular RAT (the HNB 5620 may receive the four packets) and one packet may be delivered to the BWM server 5615 by Wi-Fi (802.11 AP 5622 may receive one packet). In the absence of the BWM, the GTP entities in the HNB and the SGSN may be in-synch with regard to GTP sequence numbers and the PDCP entities within the HNB and the WTRU may be in-synch with regard to the PDCP sequence number. In the presence of the BWM server placed between the HNB and the MCN, the sequence number for the GTP packets, for example, may be changed. For the non-mobility case, this may not be a problem. However, this may introduce an issue when mobility occurs in the presence of an in-sequence PDP context as discussed herein.

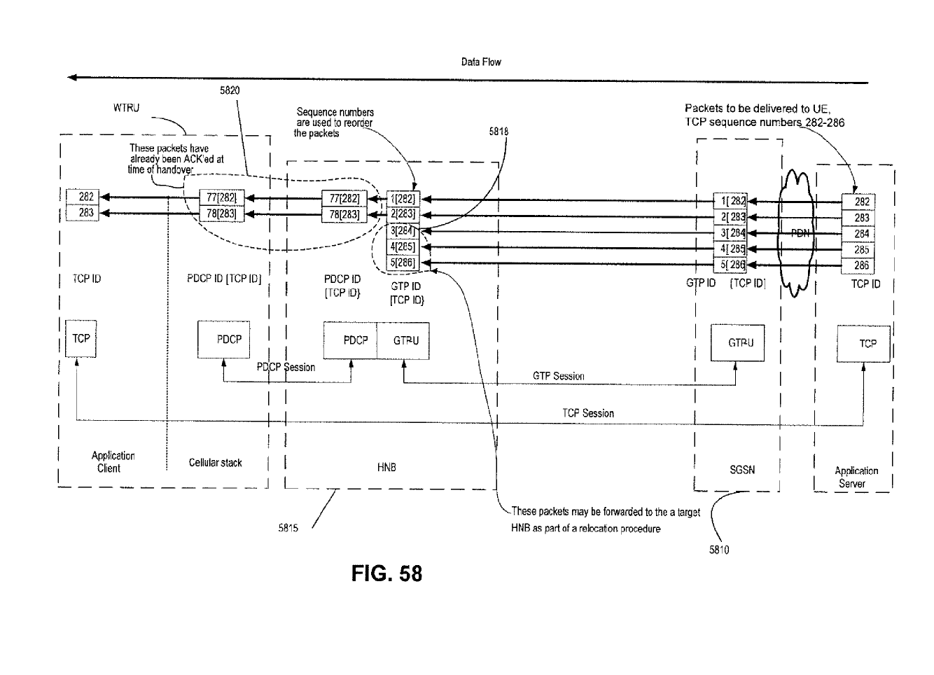

FIG. 58 illustrates an exemplary uplink flow. The application client 5635 may be using TCP and may wish to send five packets to the application server 5605 on the public internet. The BWM client 5630 may decide to pass one packet to the 802.11 interface 5629 and four packets to the cellular stack 5627. The packet that may be delivered to the 802.11 AP 5622 may then be passed to the BWM server 5612. The four packets that may be passed to the cellular stack 5627 may enter the PDCP entity within the WTRU 5640. The PDCP may assign the packets a PDCP sequence number and the packets may be sent to the PDCP entity within the HNB 5620. When the PDCP entity in the HNB 5620 receives these packets, it may reorder the packets based on the PDCP sequence number. The PDCP entity within the HNB 5620 may pass these packets to the GTP entity within the HNB 5620. The PDCP entity may assign GTP sequence numbers and may pass the GTP sequence numbers to the GTP entity within the BWM server 5615. When these packets are received by the GTP entity within the BWM server 5615, they may be reordered based on the GTP sequence numbers assigned by the HNB 5620. The BWM server aggregation “functionality” may merge these four packets with the one packet received over the 802.11 connection, being recombined into their original order (1, 2, 3, 4 and 5). These packets may then be passed to the GTP entity within the BWM server 5615 that is connected to the SGSN 5610. This process may assign GTP sequence numbers to these packets and may send them to the SGSN 5610. The GTP entity within the SGSN 5610 may accept the five packets and may reorder the packets based on the GTP sequence numbers assigned by the GTP entity within the BWM server 5615. The SGSN 5610 may then forward these packets to the GGSN (not shown) in accordance with standard procedures.

There may be DSM interaction with the BWM server. The DSM component of the CGW may perform an analysis of the spectrum within the home or enterprise. Based on this analysis the DSM component may decide which portions of the spectrum are occupied and which are not in use (e.g., currently in use). Given that the BWM entities may be used to make decisions on how to segregate the data between the cellular and Wi-Fi RATs for example, the DSM may be used to communicate this information to the BWM server.

When the BWM server possesses this information, the BWM server may share the information with the BWM client. When the BWM client possesses this information, the BWM client may decide the segregation of the uplink data between the cellular and Wi-Fi RATs, for example.

The DSM information dissemination from the DSM to the BWM server and the BWM client may be accomplished by performing one or more of the following. If the DSM module is a standalone, IP addressable device, the BWM server may perform a DNS Request to learn the IP address of the DSM module. If it is a module within the CGW, the BWM server may take appropriate means to learn the “address” of the DSM device. The BWM server may send a request to the DSM module requesting the DSM module to subscribe to the frequency use information within the DSM module. The DSM module may respond to the BWM server by accepting this request. The DSM module may send its learned spectrum usage information to the BWM server. This may be done periodically, or may be done once. The BWM server may share this information with the BWM client and the BWM entities may use this information as appropriate to help determine the segregation of the uplink data between the cellular and Wi-Fi RATs.

Several types of mobility are contemplated including the following examples: a Macrocell or a HNB without the BWM server-to-HNB with or without the BWM server (Inbound) and a HNB with the BWM server-to-macrocell or HNB with or without the BWM server (Outbound).

For inbound mobility, from a macrocell or HNB without the BWM server, if the target CGW does not have the BWM server, the standard mobility procedures may be used to complete the handover. Once the handover is complete, if the new HNB has a BWM server, the BWM server in the new HNB and the BWM client in the WTRU may attempt to perform an association. If the target CGW does have a BWM server, the standard mobility procedures may be used to complete the handover, as well. However, the BWM server in the target CGW may be aware of this handover and may establish a GTP tunnel between itself and the target HNB. This may be accomplished by performing deep packet inspection of the RANAP signaling from the SGSN to the target HNB which may perform the handover. When the handover is complete, if the new HNB has a BWM server, the BWM server in the new HNB and the BWM client in the WTRU may attempt to perform an association.

For outbound mobility, the standard mobility procedures may be used, but may be augmented with several possible alternatives to allow for a (near or substantially seamless) transition from the source HNB to the macrocell or other HNB.

The BWM server may be involved with the handling of GTP sequence numbers during mobility to enable the GTP sequence number be maintained between the HNB and the SGSN to allow for an in-sequence, lossless link. However, the introduction of the BWM server may introduce factors that make this maintenance a challenge. First, the introduction of the BWM server may cause two GTP tunnels to be in place, each with their own GTP sequence number. Were it not for the addition of an 802.11 RAT to either remove (for DL) or add (for UL) packets, there would be a 1-to-1 correspondence between the GTP tunnels. Software may be used to maintain the 1-to-1 mapping or the sequence numbers of a specific packet in either GTP tunnel at the same. However, with the addition of the 802.11 RAT, a 1-to-1 relationship between the packets in the two GTP tunnels may no longer exist. The GTP tunnel between the HNB and the BWM server may have fewer packets than the GTP tunnel between the BWM server and the SGSN, as was shown in FIG. 3C and FIG. 4C.

In the absence of the BWM server, for downlink data, the sequence numbers are shown in FIG. 58. The maintenance of the sequence numbers between the source HNB 5815, target HNB (not shown), and SGSN 5810 may be used to allow for the target HNB to “pick-up” the data connection where the source HNB 5815 “left off.” In FIG. 58, for example, two packets 5820 have already been Ack'd at time of handover. Three packets 5818 may be forwarded to the target HNB as part of the relocation procedure. The GTP sequences in the three packets 5818 are used because both the target HNB and the source HNB 5815 and the SGSN 5810 may use (and/or may all have) a common sequence number basis. The source HNB 5815 may send the target HNB the Forward SRNS Context which may contain the following: (1) the next DL PDCP sequence number equals 79; and/or (2) the next GTP sequence number equals 6. However, the introduction of the BWM server with multiple RATs may violate this tenant unless the BWM server acts to correct the GTP sequence numbers to a common basis with the SGSN and the target HNB.

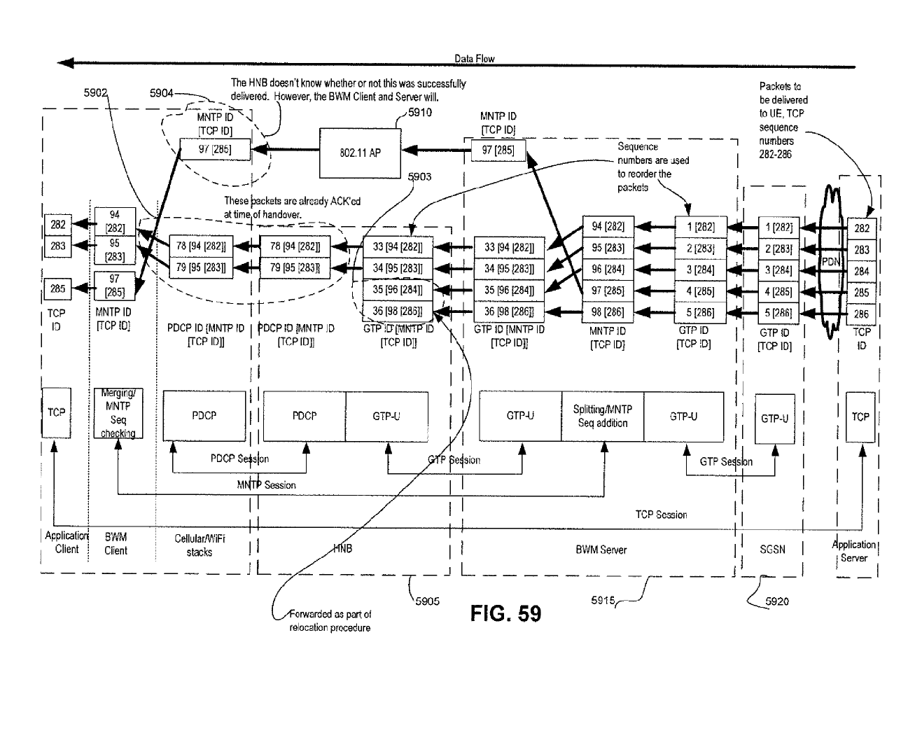

FIG. 59 is an exemplary illustration of the BWM with mobility for downlink data. In the presence of a BWM server, for downlink data, possible sequence numbers are illustrated in FIG. 59. As shown in FIG. 59, one packet may be vectored to the 802.11 AP 5910 for delivery while the other four packets may be sent to the HNB 5905 using the BWM server 5915 to HNB 5905 GTP tunnel. The GTP sequence numbers may not map 1-to-1 since one packet in the middle of the GTP stream received from the SGSN 5920 had been split off to the 802.11 AP 5910. When relocation occurs, the HNB 5905 may forward packet 35 and 36 (reference 5903) to the BWM server 5915 since those may be the packets that were not delivered. However, the BWM server 5915 may not just forward these packets. If the BWM server 5915 just forwarded the packets, the SGSN 5920 and the target HNB (not shown) may think (determine) that the data session can resume at the wrong place in its GTP sequence. If the BWM server 5915 just modified the GTP sequence number as the packets pass through it, then the GTP sequence numbers may not be consecutive (in-sequence lossless data may use consecutive GTP sequence numbers). The BWM server 5915, as shown in FIG. 59, may be used to detect the first forwarded data message (e.g., by performing deep packet inspection), extract the GTP sequence number, look up the sequence number in its list of sequence number mapping between the two GTP tunnels and forward the packets (e.g., all of the packets) to the SGSN 5920 from this sequence number to the end of what it currently has received from the GTP tunnel with the SGSN 5920. The 802.11 routed packet 5904 may be dealt with as the HNB 5905 may not know whether or not the 802.11 packet 5904 was successfully delivered, however the BWM client and server may know otherwise. The 802.11 packet 5904 may be part of the group of forwarded packets during relocation. In this case, the packet may get forwarded to the target HNB and may be delivered via cellular. If the 802.11 packet 5902 is not in the group of forwarded packets, the packet may be lost and a higher layer retransmission scheme (TCP, for example) may correct the problem. If so, the BWM server may not be used to forward the other forwarded data messages received from the HNB 5905. These HNB 5905 data messages may be discarded. The Forward SRNS Context message may pass through the BWM server 5915 and may be modified. The next expected GTP DL sequence number may be changed to the GTP sequence number used in the first forwarded data message by the BWM server 5915 similar to what is described above.

The forwarding procedure as just illustrated may use the maintenance of a buffer of packets received on the GTP tunnel between the BWM server 5915 and the SGSN 5920. Since there may be no feedback from the HNB 5905 as to the delivery of packets, a large buffer may be used and may be configured to wrap-around to save a certain number of the latest packets. In certain exemplary embodiments, the BWM server 5915 may use the acknowledged information from the BWM server/client to know (determine) which MNTP packets were received by the BWM client and which may be left unacknowledged at the time of relocation. The BWM server 5915 may create the messages with the packets which have not yet been acknowledged by the BWM server 5915 and forward these to the target HNB (not shown).

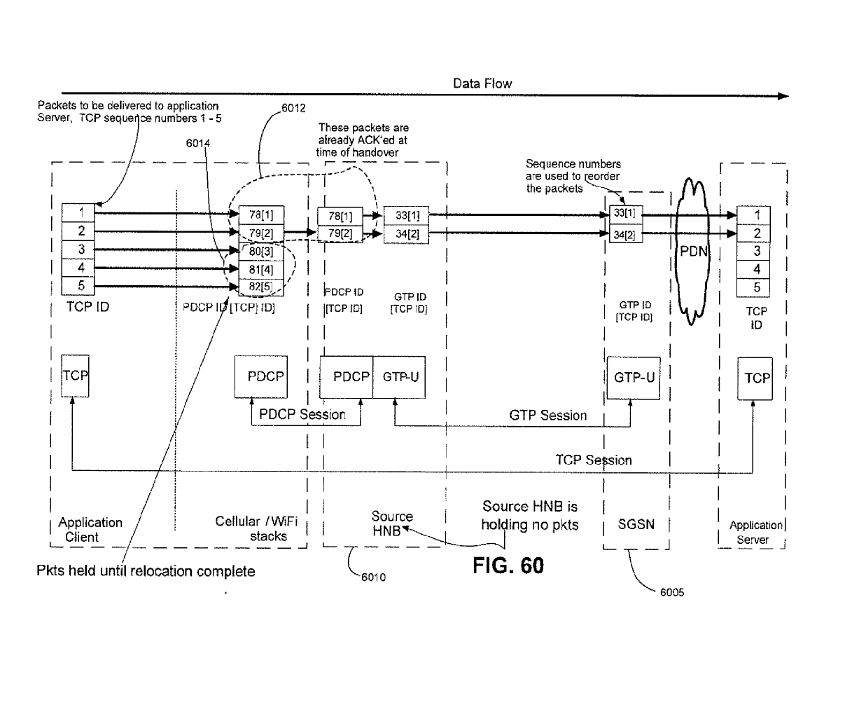

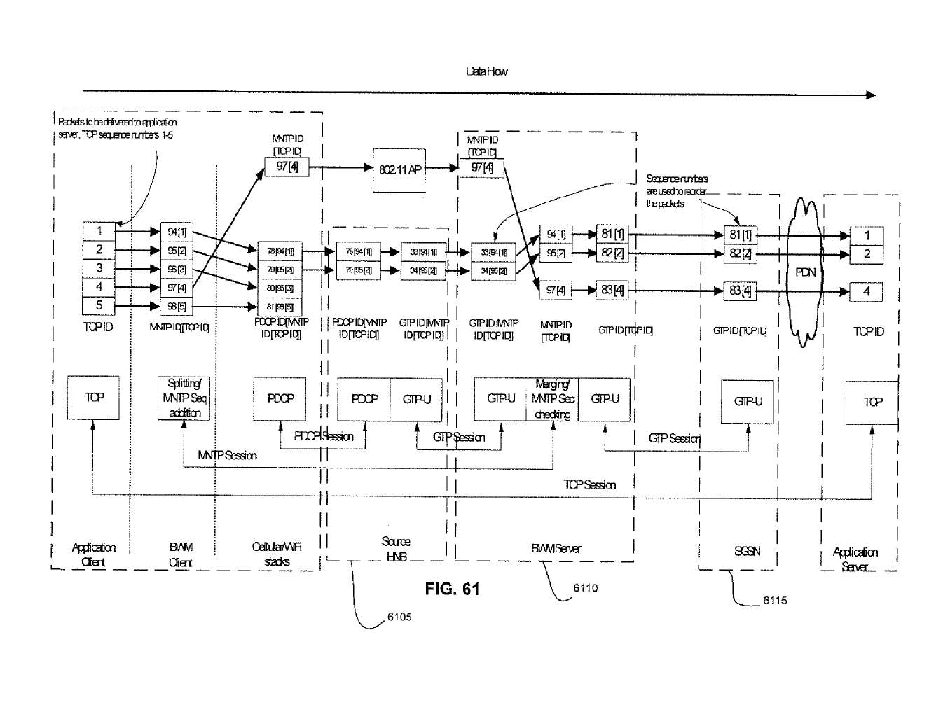

In the absence of the BWM server, for uplink data, a sequence numbering example is illustrated in FIG. 60. If there are no uplink packets held within the source HNB 6010 at relocation, the process may be simpler for uplink data. Packets 6012 may already be ACK'ed at time of handover, while packets 6014 which include PDCP sequence number packets 80, 81, and 82 may be held in the WTRU until the relocation has been completed. For UL, the source HNB 6010 may be holding no packets that may be forwarded as part of the relocation process. At the time of relocation, the source HNB 6010 may create and may send the Forward SRNS Context message, which may comprise the next PDCP UL sequence number and the next GTP UL sequence number. For example in FIG. 60, the next PDCP UL sequence number may be 80 and the next GTP UL sequence number may be 35. As is the case for downlink, the maintenance of the same GTP sequence number basis may be used so that the source HNB 6010, target HNB (not shown), and the SGSN 6005 may be synchronized to provide in-sequence, lossless delivery of the uplink data. However, the introduction of a BWM server with multiple RATs may violate the sequencing unless the BWM server acts to fix the GTP sequence numbers to a common basis with the SGSN 6005 and the target HNB.

FIG. 61 is an exemplary illustration of the BWM with mobility for downlink data. In the presence of the BWM server, for uplink data, possible sequence numbers are illustrated in FIG. 61. As shown in FIG. 61, when relocation occurs, the source HNB 6105 may, create the Forward SRNS Context message with the next expected PDCP UL sequence number and the next expected GTP UL sequence number based on its GTP tunnel with the BWM server 61 10. If the BWM server 61 10 were to forward this message to the SGSN 6115 and target HNB (not shown) unaltered, the target HNB may think (determine) the next UL packet it may acquire may be incorrect. Therefore, the BWM server 6110 may capture this message and modify it such that the next expected GTP UL sequence number field was set based on the BWM server 6110 to SGSN 6115 GTP tunnel sequence numbers.

Possible alternatives as to how to solve the problem of maintaining GTP sequence numbers are found herein. If a PDP Context is established with in-sequence lossless delivery being selected, the BWM server may become a pass through and packets (e.g., all packets) to and from the WTRU are delivered via the cellular link. In this way, there is a 1-to-1 mapping between the GTP tunnels between the HNB and the BWM server and the BWM server and the SGSN. This alternative may be simpler and more limiting as it excludes certain traffic from benefiting from BWM. The changes to the described procedures may be that the BWM server may recognize the PDP Context and then not perform BWM, if in-sequence loss less delivery is selected. The mobility procedure used for this alternative may be standard (e.g., a default mode of operation).

If a PDP Context is established as in-sequence lossless delivery is selected, an alternative may be that the BWM server/client may perform their normal function of steering packets between the 802.11 AP and the cellular link. The BWM server may perform the corrections to the GTP sequence numbers as described above. This alternative may be more complex but more encompassing as traffic can benefit from BWM. The promulgated procedure may delineate processes to perform mobility in the presence of a BWM server from one HNB (with a BWM server) to another HNB (without a BWM server) or to a macrocell (without a BWM server). The procedure may be based on internal LIPA call flow message sequence charts.

When a WTRU begins to move away from a HNB (source HNB) to which it is connected, the WTRU may be configured to perform measurements. Once the measurements are taken by the WTRU, the measurements may be sent to the source HNB. The source HNB may decide to initiate a handover and may begin the handover process.

Once the source HNB decides to initiate the handover, it may originate the signaling used to effectuate the handover. These steps are as per the defined standards. However, the BWM server may be cognizant of the relocation to prepare for the extinguishment of the BWM session. The BWM server may be used to un-IPSec and re-IPSec each signal that passes through the BWM server.

This relocation preparation may be accomplished by performing one or more of the following. The source HNB may decide to provide a relocation to the target HNB. The HNB may send a RANAP Relocation Required message to the HNB GW. The BWM server may recognize this message and may inform the BWM client to begin shutting down the session, which may comprise the following. The BWM server may not accept anymore DL packets to send to the BWM client. The BWM server may, however, continue to send whatever packets it currently possesses to the BWM client and may continue to accept whatever UL packets may be received from the BWM client. The BWM client may not accept anymore UL packets to send to the BWM server. The BWM client may, however, continue to send whatever packets it currently possesses to the BWM server and may continue to accept whatever DL packets may be received from the BWM server. The BWM session may end. If there is a large amount of data, it may take some time to clear out what is left. The BWM server/client may possess the ability to set a maximum time that the BWM session has until it ends and whatever is not cleaned up in that time may be dropped.

Regarding the relocation preparation, the HNB GW may send an HNB application part (HNBAP) WTRU Registration Request message to the target HNB. The target HNB may respond with an HNBAP WTRU Register Accept message. The HNB GW may send an RANAP Relocation Request to the target HNB. The target HNB may send an RANAP Relocation Request Ack to the HNB GW. The HNB GW may send an RANAP Relocation Command to the source HNB. The HNB may stop data transfer with the WTRU. The source HNB may begin replicating and sending the unacknowledged downlink packets it possesses to the target HNB (as per the standards). This may be done at the IP layer. Since both the source and target HNB have IP addresses on the MCN, these packets may be routed. Packets received by the source HNB from this point until the WTRU has been de-registered may be forwarded to the target HNB. The BWM server may act at this point to “fix” the sequence numbers as described above, such as when the BWM server/client performs its normal function of actively organizing and steering packets to/from the 802.11 AP and the cellular link.

When the MCN components have been configured for handover, a source HNB may command a WTRU to relocate to the target HNB. The WTRU may reconfigure to the target HNB parameters and synchronize to it. Once synchronized at the physical layers, the WTRU and target HNB may exchange the last received PDCP sequence information to synchronize the PDCP entities in the HNB and the WTRU. These processes, with perhaps the exception of the addition of the BWM server and client actions, may be accomplished per the standards. In addition, the BWM server may be used to un-IPSec and re-IPSec each signal that passes through the BWM server.

WTRU relocation may be accomplished by performing one or more of the following. The source HNB may send a Physical Channel Reconfiguration to the WTRU. The source HNB may send the Forward SRNS Context message to the target HNB. The BWM server may “fix” the GTP sequence numbers as described above. The WTRU may perform synchronization to the target HNB. The PDCP in the WTRU may send the PDCP in the target HNB the PDCP sequence number of the last received DL packet. This may allow the target HNB to know (determine) the last DL packet actually received by the WTRU. The PDCP in the target HNB may send the PDCP in the WTRU the PDCP sequence number of the last received UL packet. This may allow the WTRU to know the last UL packet actually received by the UTRAN. The target HNB may send an RANAP Relocation Detect to the HNB GW. The WTRU may complete the synchronization to the target HNB.

When a WTRU has synchronized to the target HNB, the relocation process may be complete. The resources on the source HNB may be released and the WTRU may be deregistered from the source HNB. The PDP context may be updated in the SGSN so that the GTP tunnel has been moved to the target HNB. The BWM server may be used to un-IPSec and re-IPSec each signal that passes through the BWM server.

Relocation completion may be accomplished by performing one or more of the following. The target HNB may send an RANAP Relocation Complete message to the HNB GW. The HNB GW may send an Update PDP Context Request to the SGSN. This may indicate the GTP endpoint has changed from the source HNB (the BWM server) to the target HNB. The SGSN may update the PDP context. The SGSN may send a PDP Context Response to the HNB GW. The SGSN may no longer send downlink packets to the source HNB (BWM server). The HNB GW may send an RANAP Iu Release Command to the source HNB. The source HNB may send an RANAP Release Complete message to the HNB GW and the HNB GW may send an HNBAP WTRU De-Register message to the source HNB.

The BWM server may support CS voice. In this mode, the function of the BWM server may be to act as a pass-through between the HNB and the Serving SeGW. For packets flowing in either direction, the BWM server may un-IPSec the packets that maybe received from either the HNB or the Serving SeGW, or, re-IPSec these packets and send them to their destination (either the HNB or the Serving SeGW).

Establishing a Mobile Originated (MO) CS voice call may comprise one or more of the following actions. The WTRU may send an RRC Connection Request message to the HNB. The Cause may be set to mobile originated (MO) voice call. The HNB may send an RRC Connection Setup message to the WTRU. The WTRU may establish the DCH and may send an RRC Connection Setup Complete message to the HNB. The WTRU may send a connection management (CM) Service Request to the HNB. The HNB may send a RANAP Initial WTRU message, encapsulating the CM Service Request, to the BWM server. The BWM server may unIPSec and re-IPSec this message as it is sent to the Serving SeGW. The Serving SeGW may unIPSec this message and send it to the MSC/VLR/HLR within the MCN. The MSC/VLR/HLR within the MCN may send a RANAP Direct Transfer message, encapsulating an Authentication Request, to the Serving SeGW. The Serving SeGW may IPSec this message and send it to the BWM server. The BWM server may un-IPSec and re-IPSec this message as it is sent to the HNB. The HNB may un-IPSec this message and send it over the air to the WTRU. The WTRU may perform the needed authentication and send an Authentication Response to the HNB. The HNB may encapsulate this response in a RANAP Direct Transfer message and send it to the BWM server. The BWM server may un-IPSec and re-IPSec this message as it is sent to the Serving SeGW. The Serving SeGW may un-IPSec this message and send it to the MSC/VLR/HLR within the MCN.

Continuing the above regarding the establishment of a MO CS voice call, the MSC/VLR/HLR within the MCN may send a RANAP Security Mode Command to the Serving SeGW. The Serving SeGW may IPSec this message and may send it to the BWM server. The BWM server may un-IPSec and re-IPSec this message as it is sent to the HNB. The HNB may unIPSec this message and may send it over the air to the WTRU. The WTRU may perform security functions and may send a Security Mode Complete message to the HNB. The HNB may IPSec this message and may send it to the BWM server. The BWM server may un-IPSec and reIPSec this message as it is sent to the Serving SeGW. The Serving SeGW may un-IPSec this message and may send it to the MSC/VLR/HLR within the MCN. The MSC/VLR/HLR within the MCN may send a RANAP Direct Transfer message, encapsulating the TMSI Reallocation Command message, to the Serving SeGW. The Serving SeGW may IPSec this message and may send it to the BWM server. The BWM server may un-IPSec and re-IPSec this message as it is sent to the HNB. The HNB may un-IPSec this message and may send the TMSI Reallocation Command to the WTRU. The WTRU may respond with the TMSI Reallocation Complete message to the HNB. The HNB may IPSec this message and may send it to the BWM server. The BWM server may un-IPSec and re-IPSec this message as it is sent to the Serving SeGW. The Serving SeGW may un-IPSec this message and may send it to the MSC/VLR/HLR.

Continuing the above regarding the establishment of a MO CS voice call, the WTRU may send a Setup message to the HNB. The HNB may send a RANAP Direct Transfer message, which encapsulates the Setup message, to the BWM server. The BWM server may un-IPSec and re-IPSec Direct Transfer message, which may encapsulate the Setup message as it is sent to the Serving SeGW. The Serving SeGW may un-IPSec Direct Transfer message, which may encapsulate the Setup message and may send it to the MSC/VLR/HLR. The MSC/VLR/HLR may respond with a RANAP Direct Transfer message, encapsulating the Call Proceeding message, to the Serving SeGW. The Serving SeGW may IPSec RANAP Direct Transfer message which may encapsulate the Call Proceeding message and send it to the BWM server. The BWM server may un-IPSec and re-IPSec this message as it is sent to the HNB. The HNB may un-IPSec this message and may send the Call Proceeding message to the WTRU. The MSC/VLR/HLR may send a RANAP RAB Assignment Request message to the Serving SeGW. The Serving SeGW may IPSec this message and may send it to the BWM server. The BWM server may un-IPSec and re-IPSec this message as it is sent to the HNB. This RAB Assignment Request message may not be used by the BWM server in a similar manner to the RAB Assignment Request message that is sent to the HNB during the establishment of a packet switched service. The BWM server may ignore the RAB Assignment Request message when it is used to setup a CS service, such as a voice call. The HNB may un-IPSec this message and send a Radio Bearer Setup message to the WTRU over the air.

Continuing the above regarding the establishment of a MO CS voice call, the WTRU may setup the radio bearers and may reply with the Radio Bearer Setup Response to the HNB. The HNB may send the RANAP RAB Assignment Response message to the BWM server. The RAB Assignment Response message may not be heeded by the BWM server for the same reasons as set for the RAB Assignment Request message process above. The BWM server may un-IPSec and re-IPSec this message as it is sent to the Serving SeGW. The Serving SeGW may un-IPSec this message and may send it to the MSC/VLR/HLR. The MSC/VLR/HLR may then setup the call with the other device being called, e.g., the device of the dialed number. The MSC/VLR/HLR may send a RANAP Direct Transfer message, encapsulating an Alert message, to the Serving SeGW. The Serving SeGW may IPSec the RANAP Direct Transfer message which is encapsulating the Alert message and may send it to the BWM server. The BWM server may un-IPSec and re-IPSec the RANAP Direct Transfer message which is encapsulating the Alert message as it is sent to the HNB. The HNB may un-IPSec the Direct Transfer message and may send the Alert message to the WTRU over the air. As the call is being answered on the device being called, the MSC/VLR/HLR may send a RANAP Direct Transfer message, encapsulating a Connect message, to the Serving SeGW. The Serving SeGW may IPSec the RANAP Direct Transfer message, which is encapsulating the Connect message, and may send it to the BWM server. The BWM server may un-IPSec and re-IPSec the RANAP Direct Transfer message, which is encapsulating the Connect message, and may send it to the HNB. The HNB may un-IPSec Direct Transfer message and may send the Connect message to the WTRU over the air. The WTRU may send a Connect Acknowledge message to the HNB. The HNB may send a RANAP Direct Transfer message, encapsulating the Connect Acknowledge message, to the BWM server. The BWM server may un-IPSec and re-IPSec this message as it is sent to the Serving SeGW. The Serving SeGW may un-IPSec this message, and may send it to the MSC/VLR/HLR. The call is now “up” and adaptive multi rate (AMR) packets may flow between the two devices, via the HNB to the BWM server to the Serving SeGW to the MSC path. The BWM server may un-IPSec and re-IPSec each AMR packet as it passes between the HNB and the Serving SeGW. At some point, either the WTRU or the device to which the voice call is made may end the call. The signaling that travels between the MCN and the WTRU may be passed through the BWM server. The BWM server may un-IPSec and re-IPSec each of these messages as it travels between the HNB and the Serving SeGW. Upon establishing a Mobile Originated (MO) CS voice call, a WTRU may have a voice call in place on the MCN through the BWM server.

The systems and methods described herein may allow multiple HNBs to communicate with the MCN without a one to one mapping of HNBs to BWM servers. For example, multiple HNBs may communicate with the MCN through a single BWM server. Also, multiple HNBs may communicate with the MCN through multiple BWM servers, where there may be multiple HNBs to each BWM server.

Enterprise scenarios to implement the disclosed systems and methods may include non-BWM scenarios and BWM scenarios. Although the use of one or more BWM servers is being introduced, legacy configurations may continue to be used. For example, a nonBWM scenario may be implemented (e.g., when one or more BWM servers are not used or become unavailable).

In a non-BWM scenario (i.e., a non-BWM enterprise scenario), relating to the MCN's SeGW, multiple HNBs may be directly connected to the MCN's SeGW(s). The SeGW(s) may be in the Internet and may act as an entry point into the MCN. The MCN may allocate the SeGW(s) to the enterprise HNBs. Each HNB may establish a secure tunnel directly with an allocated SeGW. Multiple SeGWs may be considered for reasons of load balancing, or for reasons of discriminating Initial and Serving SeGWs, or for both.

In another non-BWM scenario, relating to a SeGW chain in the enterprise and MCN, multiple HNBs may be connected to enterprise SeGW(s) (it may also be viewed as enterprise Femto aggregator(s)). Each HNB may establish a secure tunnel directly with the allocated enterprise SeGW. The enterprise SeGW(s) in turn may multiplex the HNB traffic over secured tunnels to the MCN's SeGW(s). Again, multiple SeGWs (both within the enterprise and in the Internet/MCN) may be considered for reasons of load balancing, or for reasons of discriminating Initial and Serving SeGWs, or for both.

In a BWM scenario (i.e., a BWM enterprise scenario), relating to the MCN's SeGW, multiple HNBs may be connected to a BWM server, and, the BWM server may be connected to multiple SeGWs (for load balancing or for Initial/Serving SeGW). The BWM server may be manifest as the enterprise SeGW (femto aggregator).

In another BWM scenario, relating to the MCN's SeGW, multiple HNBs may be connected to multiple BWM servers, and, the BWM servers may be connected to multiple SeGWs (e. g., for load balancing or for Initial/Serving SeGW). The BWM servers may manifest as the enterprise SeGWs.

In another BWM scenario, relating to a SeGW chain in the enterprise and MCN, instead of having 3-stage security tunnels between HNB←→BWM, BWM←→enterprise SeGW and enterprise SeGW←→MCN SeGW, the BWM may manifest itself as the enterprise SeGW or as an application on enterprise SeGW/femto aggregator.

In the above scenarios, each enterprise BWM server may manifest as an enterprise-level SeGW. Modifications and/or changed/added configurations may be used to support multiple HNBs connecting through a single BWM server to the MCN through multiple (MCN) SeGWs. Possible modifications and/or configurations may include one or more of the following: (1) the modification of the Internet Key Exchange (IKE) protocol; (2) the configuration of the “Outer” DNS Server(s) response to an HNB request to resolve SeGW FQDN (Initial and Serving); (3) the configuration of the DNS server (within DSL modem) response to the HNB request to resolve the BWM server FQDN when a BWM server is available; and/or (4) the HNB configured with burnt-in FQDN for the Initial SeGW, for example, “operatorX-segw.”

As part of a HNB bringup, the HNB may initiate IKE message exchange with a SeGW. As part of the BWM scenarios, a HNB may initiate the IKE message exchange with a BWM server—the BWM server may be manifest as the enterprise SeGW or an application over enterprise SeGW. However, the BWM server may know with which MCN SeGW it may create a secure association. One possibility is that the enterprise SeGW (BWM server) may include its own policies as to how it may “broker” traffic to/from HNB security associations with traffic to/from MCN SeGW security associations. This may imply that the MCN SeGW “attempted” by the HNBs, which may be known to the HNB through preburnt Initial SeGW FQDN configuration or through dynamic TR69 discovery of Serving SeGW FQDN, may be overridden by policies in the BWM server. In such a case, the BWM server may have a separate OAM interface (e.g., TR69) with the MCN that may enable the MCN to influence the SeGW selection policy at the BWM server and thereby orchestrate the SeGW selection by the BWM server. Enhancements to the MCN (and its protocols) may realize the BWM server as an Access Network entity within the enterprise.

Another possibility, for determining which MCN SeGW the BWM server may create a secure association, which may avoid enhancements in the MCN, may be for the BWM server to honor the HNB's existing policies/mechanisms to select the MCN SeGW—although “brokered” through the BWM server. The HNB may include the MCN SeGW information (preburnt Initial SeGW FQDN and/or dynamically discovered Serving SeGW through TR69) and the IKE protocol may be modified to inform the BWM server of this information. The IKE protocol may be modified in such a way as to add an information element to an existing message. When the HNB initiates the IKE process, it may inform the BWM server of the FQDN of the MCN SeGW (Initial or Serving) to which it wishes to connect. The BWM server may then use this information to create a secure association with the “intended” MCN SeGW or multiplex if a secure association already exists with the “intended” MCN SeGW. However, in the “non-BWM scenario,” when a HNB initiates an IKE process directly to a MCN SeGW, the MCN SeGW may receive this additional information element and discard it. This makes the IKE protocol change local between the HNB and the BWM server.

The protocol change in the IKE process at the HNB and the BWM server may proceed as follows. As per IKEv2 protocol (RFC 4306) the Configuration Payload (CP) in the IKE process may be used to exchange configuration information between IKE peers during the process where the IRAC requests a TP address from the IRAS. Configuration payloads may be of type CFG_REQUEST/CFG_REPLY or CFG_SET/CFG_ACK. CFG_REQUEST and CFG_SET payloads may be added to an IKE request. They may allow an IKE endpoint to request data from its peer. “CFG_SET/CFG_ACK” may allow an IKE endpoint to push configuration data to a peer. RFC 4306 may define Configuration Attributes that may be exchanged in the Configuration Payload. RFC 4306 may also provide mechanisms to extend the Configuration Attributes in the Configuration Payload. While Configuration Attribute values 0-15 may be specifically defined in RFC 4306, values 16-16383 may be reserved to JANA and values 16384-32767 may be for private use among mutually consenting parties.

Relating to the disclosed systems and methods, the HNB (the IRAC) may make use of the Configuration Payload CFG_SET in the IKE_AUTH message to convey the target MCN SeGW FQDN in a new Configuration Attribute to the BWM server (the IRAS). This may be a IANA registered Configuration Attribute value or a Configuration Attribute value of private use. This may mean that the HNB IRAC, in its IKE exchange, may inform the destination domain with which it wants to connect, where the BWM IRAS is the gateway to multiple MCN SeGWs.

| Attribute Type | Value | Multi-valued | Length |
|---|---|---|---|
| TARGET_SECURITY | xxxx | No | 0 or more |
| DOMAIN | | | octets |

TARGET_SECURITY_DOMAIN may be a string of printable ASCII characters that is not NULL terminated.

The change in the IKE process at MCN SeGW (but as per existing protocol, i.e., no change in the IKE protocol) may proceed as follows. RFC 4306 may provide mechanisms for the IRAC to request multiple private addresses from the IRAS, so that the BWM may use them to reserve a pool of private addresses from MCN SeGW and allocate them one-by-one to the HNBs in their respective IKE requests. The MCN SeGW may be able to handle this. During IKE_AUTH exchange, the IKE IRAC (BWM server) may request a range of IP addresses to be allocated to it by the IRAS (the MCN SeGW) through mechanisms facilitated by the Traffic Selector (TS) Payload. The TS Payload may allow the MAC to specify TS_IPV4_ADDR_RANGE as the TS type and the IRAS to return an address range bounded within a Starting Address and an Ending Address.

Configuration changes for transactions with the “Outer” DNS may be a configuration level change. A protocol change may or may not be appropriate. The operator may register its FQDN names for the SeGWs with the “Outer” DNS servers. Currently, the operators may have a public IP address mapped to the FQDN name for each SeGW (Initial and Serving). The HNB may perform an ‘A’ type Resource Record (RR) query that the “Outer” DNS may resolve to an IPv4 address (the IPv4 address of the MCN SeGW).

With regard to the configuration changes for transactions with the “Outer” DNS, the HNB may make a NAPTR query for the MCN SeGW FQDN. The “Outer” DNS server configuration may be modified so that it is able to handle a NAPTR query and may be capable of translating the MCN SeGW FQDN into two FQDNs, the FQDN for the BWM server and the FQDN of the MCN SeGW. The BWM server FQDN may be the same for all HNBs for enterprises. The two FQDNs may include different “ORDER” values or the same “ORDER,” but different “PREFERENCE” values, so as to provide higher priority to the BWM server FQDN. As an outcome of the NAPTR query, the HNB may first try to resolve the FQDN of the BWM server CA′ type RR query). If a BWM server is present within the premise, then this attempt may be successful. The local DNS server within an enterprise may respond to the query and resolve it to the IP address of the BWM server. If a BWM server is not present within a premise, then this attempt may fail (in the absence of a BWM server, the local DNS server may not respond and the “Outer” DNS server may also return a failure), and, the HNB may attempt to resolve the FQDN of the MCN SeGW.

The DNS server within the DSL modem (local DNS server) may be configured such that it can resolve the FQDN of the BWM server to the BWM server's local IP address. If more than one BWM server is present, the DNS server within the DSL modem may be configured to return the local IP address of the BWM servers present within the premise. This may invoke configuration issues and with no change to behavior of local DNS server.

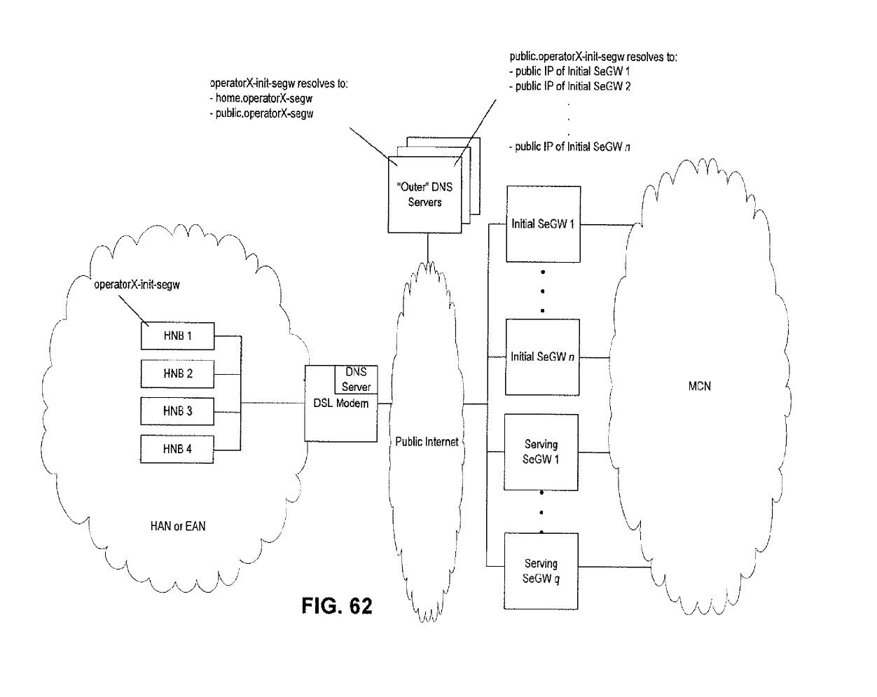

As discussed above, there may be no BWM server within the home or enterprise (e.g., it may not exist or it may not be available, etc.) and the HNBs may connect to the SeGWs using the IP addresses as provided by the “Outer” DNS Server. FIG. 62 illustrates an exemplary enterprise scenario with no BWM server. The operator may have several Initial and Serving SeGWs which the HNB may attach to and each of the public IP addresses of these may have been registered with the “Outer” DNS servers. The “Outer” DNS server may be configured to handle both ‘A’ type and ‘NAPTR” type DNS RR queries. Types of HNBs may be: (1) HNBs which make ‘A’ type DNS RR queries; and/or (2) HNBs that have been enhanced to make “NAPTR” type DNS RR queries (although there is no BWM server in this scenario).

Connecting one or more HNBs to the MCN in a no BWM server scenario may comprise one or more of the following. An HNB may have initial SeGW burnt-in, assume “operatorX-init-segw.” When the HNB is powered on, it may broadcast a DNS Request to resolve the “operatorX-init-segw.” This may be an “A” type query or a “NAPTR” type query. The DNS server in the DSL modem may not resolve this, so it may be broadcast onto the public internet and may be seen by the “Outer” DNS servers. Depending on the DNS RR query type, the “Outer” DNS servers may resolve this to: 1) two FQDNs and return a ‘NAPTR’ type RR DNS Response to the HNB containing 1a) a home.operatorX-init-segw—primary and/or 1b) public.operatorX-init-segw—secondary; or 2) an IP address of a MCN SeGW and return an ‘A’ type RR DNS Response to the HNB. If it was an ‘A’ type RR response, the HNB may be able to create an IPSec tunnel with the Initial SeGW. If it was a ‘NAPTR’ RR response, the HNB may attempt to resolve home.operatorX-init-segw by broadcasting an ‘A’ type RR DNS Request to the DNS server in the DSL modem.

Continuing the above regarding connecting one or more HNBs to the MCN in a single BWM server scenario, the DNS server within the DSL modem may attempt to resolve the home.operatorX-init-segw. Since the home.operatorX-init-segw may not exist, there may be no response and the request may get broadcast onto the public internet where the response may be seen by the “Outer” DNS servers. The “Outer” DNS servers may also not be able to resolve the home.operatorX-init-segw. The HNB may receive no response to the DNS Request and may then try to resolve the public.operatorX-init-segw by broadcasting a DNS Request. The DNS server within the DSL modem may attempt to resolve the public.operatorX-init-segw and may be unable to. The DNS server may then send the DNS Request on the public internet where the DNS Request may be seen by the “Outer” DNS Servers. The “Outer” DNS servers may resolve this to a list of IP addresses of the Initial SeGWs and may return this information to the HNB via a DNS Response. The “Outer” DNS servers may use whatever technique is typically used to ensure load balancing, such as, but not limited to, ordering the list of IP address in a round-robin fashion. The HNB may now be able to create an IPSec tunnel with the Initial SeGW. When the HNB has this tunnel in place with the Initial SeGW, it may go through the initialization and provisioning steps outlined earlier. The MCN may provide the information on the Serving SeGW to the HNB. It may not matter whether or not the Serving SeGW is unique since each HNB may individually go through the above steps to connect with the network.

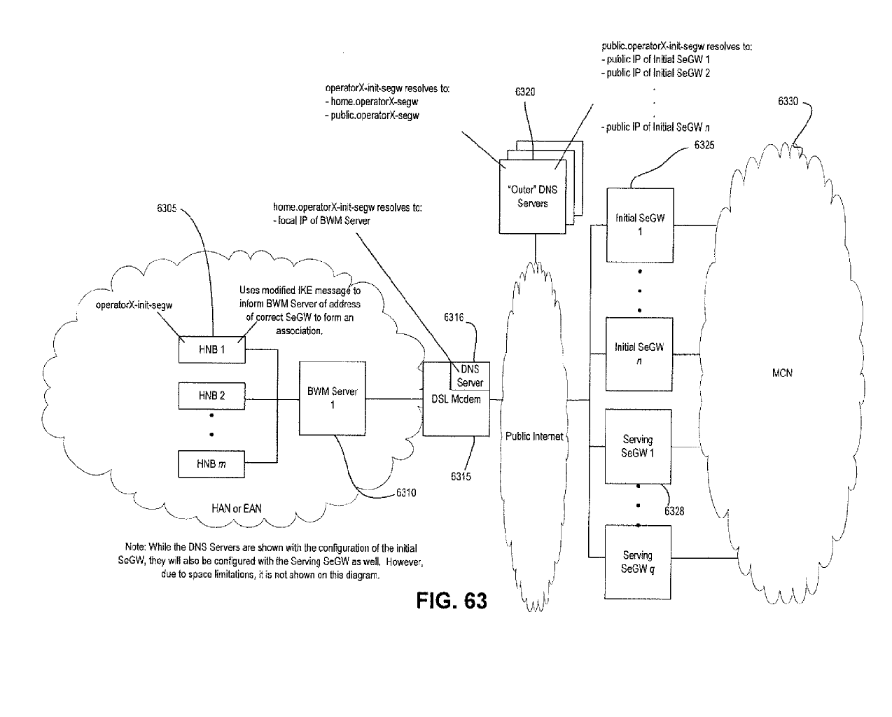

There may be just one BWM server within the home or the enterprise. FIG. 63 illustrates an exemplary enterprise scenario with one BWM server. There may be one BWM server within the home or the enterprise and the HNBs may connect to the SeGWs using the IP addresses as provided by the “Outer” DNS server by going through the BWM server. The BWM server may be able to attach to the correct Initial SeGW since the HNB may pass this IP address to it by the modified IKE protocol message. The operator may have several Initial and Serving SeGWs that the HNB can attach and each of the public IP addresses of these may have been registered with the “Outer” DNS servers.

For example, with reference to FIG. 63, connecting one or more HNBs to the MCN in a single BWM server scenario may comprise one or more of the following. A BWM server 6310 may be powered on, and may retrieve a local IP address from the DSL Modem 6315. The DNS server 6316 within the DSL Modem 6315 may register the local IP address with an association between the FQDN and local IP address. The HNB 6305 may have initial SeGW burnt-in, assume “operatorX-init-segw.” When the HNB 6305 is powered on, it may broadcast a “NAPTR” type RR DNS Request to resolve the operatorX-init-segw. The DNS server 6316 in the DSL modem 6315 may be unable to resolve this, so the DNS server may broadcast onto the public interne where it may be seen by one or more “Outer” DNS servers. An “Outer” DNS server 6320 may resolve “operatorX-init-segw” to two FQDNs and may return a DNS Response to the HNB 6305: (1) home.operatorX-init-segw—primary and/or (2) public.operatorX-init-segw—secondary. The HNB 6305 may then attempt to resolve the home.operatorX-init-segw by broadcasting an ‘A’ type RR DNS Request to the DNS server 6316 in the DSL modem 6315. The DNS server 6316 within the DSL modem 6315 may attempt to resolve the home.operatorX-init-segw. Since DNS server 6316 may be able to resolve the FQDN, it may create and send a DNS response with the local IP address of the BWM server 6310.

Continuing the above regarding connecting one or more HNBs to the MCN in a single BWM server scenario, the HNB 6305 may now be able to create an IPSec tunnel with the BWM server 6310. The HNB 6305 may initiate creation of a secure association between itself and the BWM server 6310, the HNB 6305 may include the public.operatorX-init-segw FQDN that may be part of the enterprise solution. This may be associated with the change that may be needed to the current IKE procedures. Essentially, the change may allow a ‘first node,’ during the security association process, to inform a ‘second node’ of the name (FQDN) of a ‘ third node,’ which may be used for establishing another security association with the second node. This mechanism may allow a chain of security associations to be established, thereby extending the capability of the existing IKE procedure to establish a security association between two nodes via a set of intermediate nodes. In other words, the enhanced IKE may establish a secure ‘path’ as opposed to a secure ‘link.’ This information may be retained, while in the non-BWM scenario mentioned herein the information may not be retained.

Continuing the above regarding connecting one or more HNBs to the MCN in a single BWM server scenario, the BWM server 6310 may attempt to resolve the public.operatorX-init-segw by broadcasting an ‘A’ type RR DNS Request. The DNS server 6316 within the DSL modem may attempt to resolve the public.operatorX-init-segw and may be unable to resolve it. The DNS server may then send the DNS Request on the public interne where the DNS Request may be seen by the “Outer” DNS Server 6320. The “Outer” DNS server 6320 may resolve the public.operatorX-init-segw to a list of IP addresses of the Initial SeGWs and may return this information to the HNB 6305 via a DNS Response. The “Outer” DNS Server 6320 may use whatever technique is typically used to ensure load balancing, such as, but not limited to, ordering the list of IP address in a round-robin fashion. The BWM server 6310 may now be able to create an IPSec tunnel with the Initial SeGW 6325, for example. The MCN may provide a MCN IP address, or range of MCN IP addresses, to the BWM server 6310. When the BWM server 6310 has an IPSec tunnel established with the Initial SeGW 6325, it may complete the establishment of the IPSec tunnel with the HNB 6305. The BWM server 6310 may use the MCN provided IP address while the HNB 6310 may use the Local IP address provided by the DHCP server within the DSL modem 6315. For a message sent from the HNB 6305 to the MCN 6330, the BWM server 6310 may change the source IP address to the MCN 6330 provided IP address. For a message sent from the MCN 6330 to the HNB 6305, the BWM server 6310 may change the destination IP address to the local IP address of the HNB 6305. The HNB 6305 may connect to the MCN 6330 elements that provide the FQDN of the Serving SeGW 6328, for example, as discussed earlier, assume “operatorX-serving-segw.” The HNB 6305 may tear-down the IPSec tunnel between itself and the BWM server 6310. The BWM server 6310 may tear-down the IPSec tunnel between itself and the Initial SeGW 6325. The HNB 6305 may go through the same process as discussed in the paragraphs above, for example, to resolve the FQDN of the Serving SeGW 6328 and for the establishment of an IPSec tunnel between the HNB 6305 and the BWM server 6310 and the BWM server 6310 and the Serving SeGW 6328.

Continuing the above regarding connecting one or more HNBs to the MCN in a single BWM server scenario, each HNB may go through the same process to connect to the MCN. The process may allow for flexibility of different HNBs connecting to different SeGWs through the same BWM server. The MCN may be given a single MCN IP address or may be given a range of MCN IP addresses. A BWM server may manage and may allocate these MCN-allocated IP addresses from the pool or IP range that it is provided. As and when the HNBs connect/disconnect, the BWM server may manage the allocation pool. During a first contact between a SeGW and a BWM server, the BWM server may request the pool of addresses or a single address. If the BWM server is already connected to the SeGW, then the BWM server may already have a pool of addresses that it may assign to a HNB that initiates contact. If it does not have the pool of addresses, then the BMW server may request a MCN allocated IP address from the MCN.

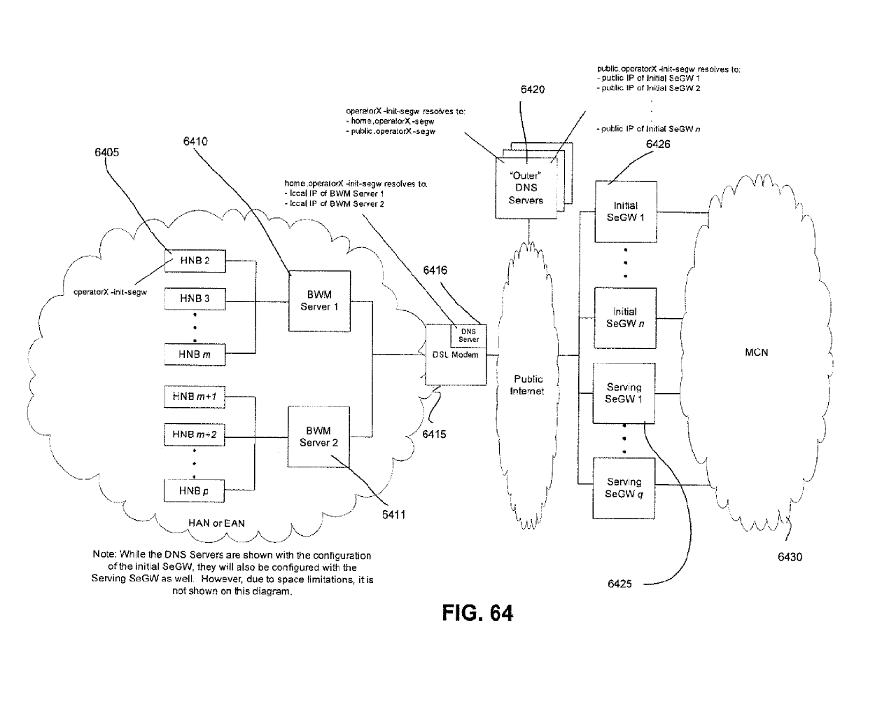

There may be multiple BWM servers within the home or enterprise. FIG. 64 illustrates an exemplary enterprise scenario with multiple BWM servers. The HNBs may connect to the SeGWs using the IP addresses as provided by the “Outer” DNS server by going through these BWM servers. The selection of which BWM server the HNB may attach to may be handled as part of the normal DNS process. The BWM servers may be powered on and registered with the DNS server within the DSL modem, and, the DNS server may use whatever technique is typically used to ensure load balancing, such as, but not limited to, ordering the list of IP address in a round-robin fashion. When a BWM server has been selected, the BWM server may be able to attach to the correct Initial SeGW since the HNB may pass this IP address or FQDN to it by the modified IKE protocol message. Also, it is contemplated that the operator has several Initial and Serving SeGWs which the HNB may attach and each of the public IP addresses of these may have been registered with the “Outer” DNS servers (see FIG. 64).

For example, with reference to FIG. 64, connecting one or more HNBs to the MCN in a multiple BWM server scenario may comprise one or more of the following. BWM servers, for example BWM server1 6410 and BWM server2 6411, may be powered on and may get a local IP address from a DSL Modem 6415. A DNS server 6416 within the DSL Modem 6415 may register these local IP addresses with an association between the FQDN and local IP addresses. An HNB2 6405, for example, may have an initial SeGWI 6426 burnt-in, assume “operatorX-init-segw.” When an HNB is powered on, it may broadcast a “NAPTR” type RR DNS Request to resolve “operatorX-init-segw.” The DNS server 6416 in the DSL modem 6415 may resolve the operatorX-init-segw, so it may be broadcast onto the public interne where it may be seen by an “Outer” DNS server 6420. The “Outer” DNS server may resolve the operatorX-init-segw to two FQDNs and may return a DNS Response to the HNB2 6405: (1) home.operatorX-initsegw—primary and/or (2) public.operatorX-init-segw—secondary. The HNB2 6405 may then attempt to resolve the home.operatorX-init-segw by broadcasting an ‘A’ type RR DNS Request to the DNS server 6416 in the DSL modem 6415. The DNS server 6416 within the DSL modem 6415 may attempt to resolve the home.operatorX-init-segw. Since the DNS server 6416 may be able to resolve the FQDN, it may create and may send a DNS Response with the local IP addresses of the BWM server1 6410 and the BWM server2 6411. The DNS server 6416 within the DSL modem 6415 may use whatever technique is typically used to ensure load balancing, such as, but not limited to, ordering the list of IP address in a round-robin fashion.

In addition, with reference to FIG. 64, connecting one or more HNBs to the MCN in a multiple BWM server scenario, the HNB2 6405 may be able to create an IPSec tunnel with the selected BWM server (for example BWM server1 6410 may be selected). When the HNB2 6405 initiates the creation of a secure association between itself and the BWM server1 6410, the HNB2 6405 may include the public.operatorX-init-segw FQDN that is part of the enterprise solution. This information may be retained, while in the non-BWM scenario it may not be retained. The selected BWM server 6410 may attempt to resolve the public.operatorX-init-segw by broadcasting an ‘A’ type RR DNS Request. The DNS server 6416 within the DSL modem 6415 may attempt to resolve the public.operatorX-init-segw and may be unable to resolve it. The DNS server 6416 may then send the DNS Request on the public internet where it may be seen by the “Outer” DNS Server 6420. The “Outer” DNS server 6416 may resolve this to a list of IP addresses of the Initial SeGWs and may return this information to the HNB 6405 via a DNS Response. The “Outer” DNS server 6420 may use whatever technique is typically used to ensure load balancing, such as, but not limited to, ordering the list of IP address in a round-robin fashion. The selected BWM server 6410 may now be able to create an IPSec tunnel with the Initial SeGW 6426, for example. The MCN 6430 may provide a MCN IP address, or range of MCN IP addresses, to the BWM server1 6410. When the selected BWM server 6410 has an IPSec tunnel established with the Initial SeGW 6426, the selected BWM server 6410 may complete the establishment of the IPSec tunnel with the HNB2 6405. The MCN IP address may be provided to the HNB 6405. The HNB2 6405 may connect to the MCN 6430 elements which may provide the FQDN of the Serving SeGW 6425, for example, as discussed earlier, assume “operatorX-serving-segw.” The HNB2 6405 may tear-down the IPSec tunnel between itself and the selected BWM server 6410. The selected BWM server 6410 may tear-down the IPSec tunnel between itself and the Initial SeGW 6426. The HNB2 6405 may go through a similar process as defined earlier regarding the Initial SeGW 6426 to resolve the FQDN of the Serving SeGWI 6425 and for the establishment of an IPSec tunnel between the HNB2 6405 and the selected BWM server and the Serving SeGWI 6425. Each HNB can go through a similar process to connect to the MCN. The above process may allow for the flexibility of different HNBs connecting to different SeGWs through the different BWM servers.

The following illustrates exemplary source and destination addresses of packets that may be routed between a WTRU and a BWM server, either through a Wi-Fi or cellular connection, and between the BWM server and the application to which the WTRU is communicating:

For packets routed through the MCN:

Uplink
MNTP/IP Packets over Wi-Fi
   Source=WTRU Wi-Fi
   Destination=BWM server
   MNTP/IP Packets over Cellular
      Source=WTRU Cellular
      Destination=BWM server
   TCP/IP Packets to the Core Network
   Source=WTRU Cellular
   Destination=Application Server

Downlink
TCP/IP Packets from the Core Network
   Source=Application Server
   Destination=WTRU Cellular
MNTP/IP Packets over Cellular
   Source=BWM server
   Destination=WTRU Cellular
MNTP/IP Packets over Wi-Fi
   Source=BWM server
   Destination=WTRU Wi-Fi

For packets routed directly to the public Internet from the BWM server:

Uplink
MNTP/IP Packets over Wi-Fi
   Source=WTRU Wi-Fi
   Destination=BWM server
TCP/IP Packets to the Core Network
   Source=BWM server
   Destination=Application Server

Downlink
TCP/IP Packets from the Core Network
   Source=Application Server
   Destination=BWM server
MNTP/IP Packets over Wi-Fi
   Source=BWM server
   Destination=WTRU Wi-Fi

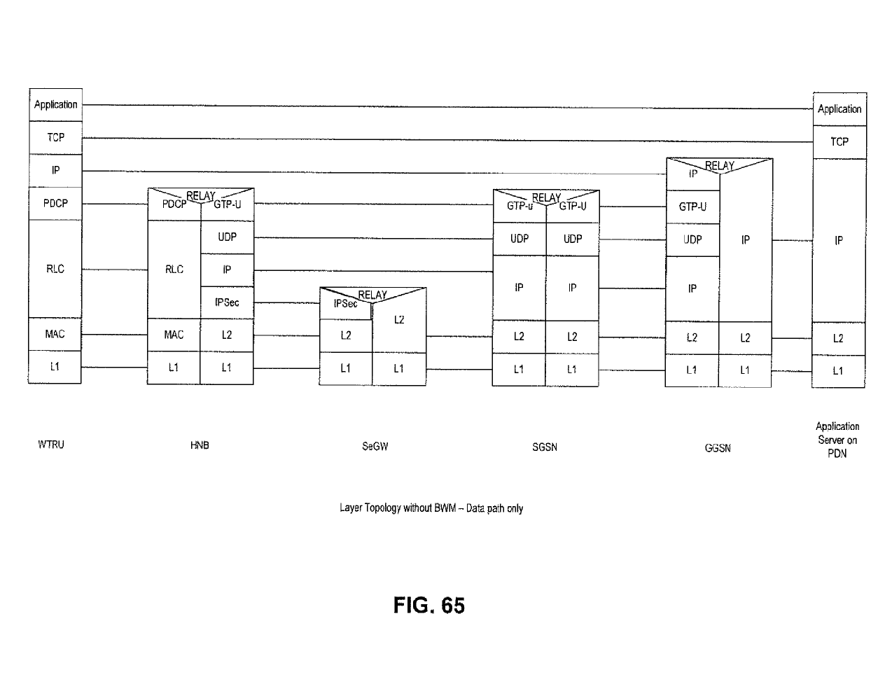

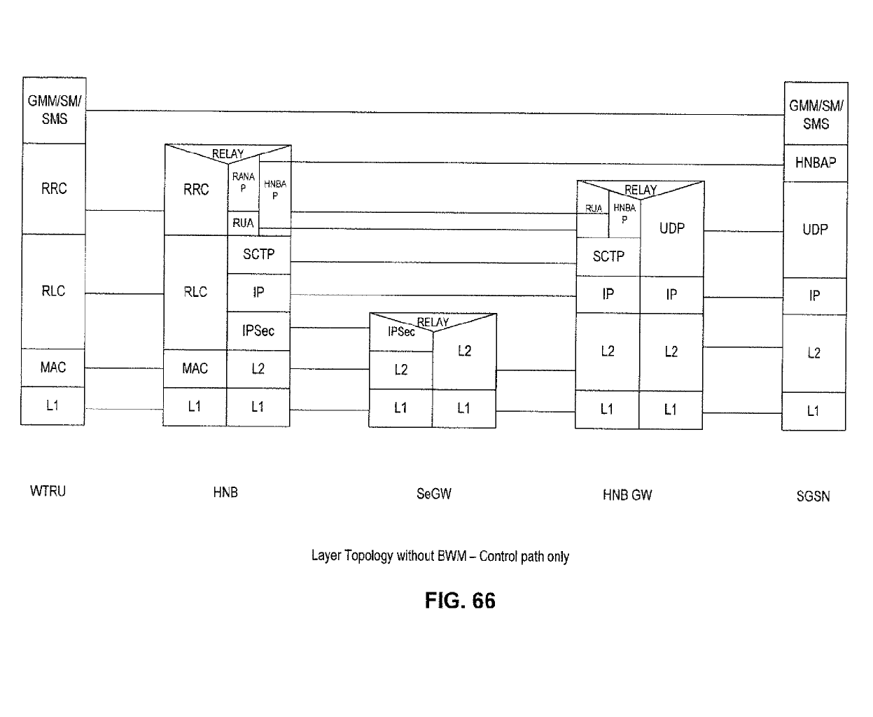

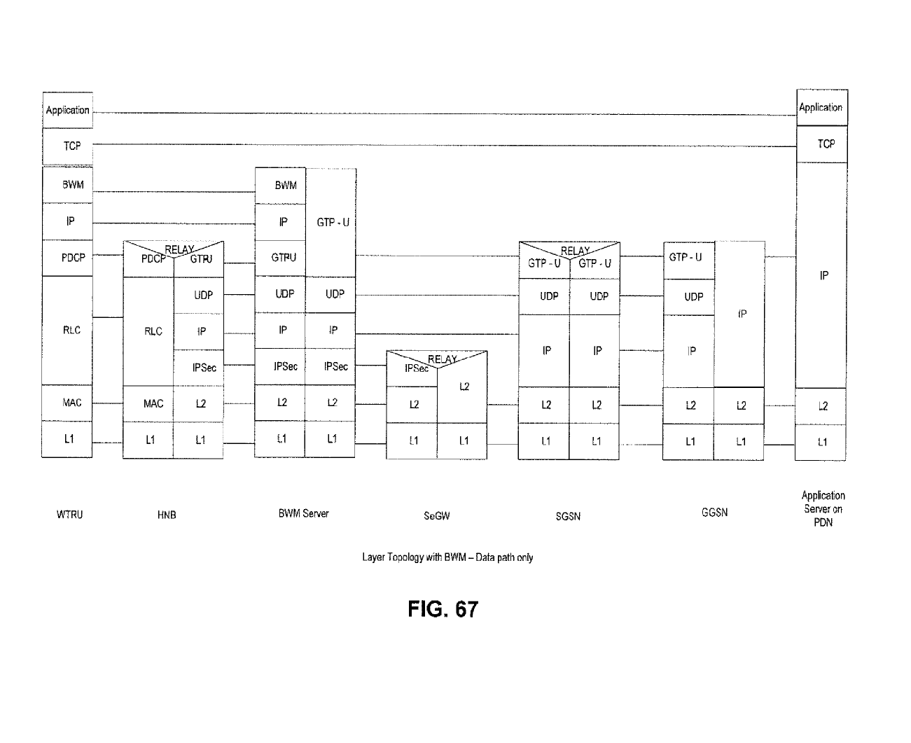

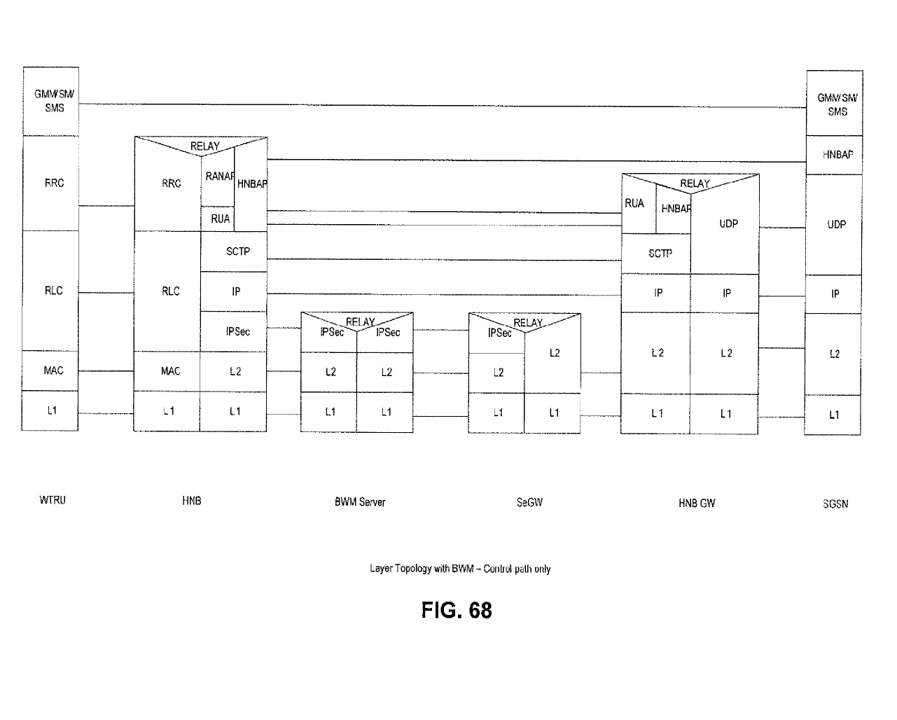

FIGS. 65 and 66 show an exemplary topology of entities in the absence of the BWM. FIGS. 67 and 68 show an exemplary topology of entities in the presence of the BWM. A data path is shown in FIGS. 65 and 67, while a control path is shown in FIGS. 66 and 68. FIG. 67 illustrates an exemplary implementation of a BWM protocol and other protocols mentioned herein to assist in the implementation of the BWM.

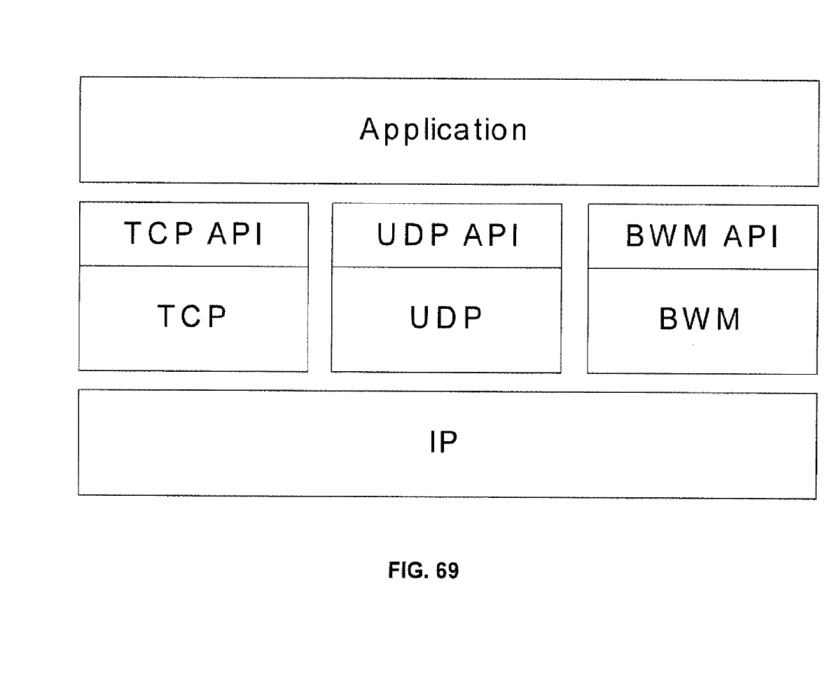

In porting the BWM client to a single device (e.g., a smartphone), various ways to insert the BWM protocol into the existing internet protocol stack exist. Several options are identified herein. One option may be to add the BWM as a separate Transport Layer protocol with its own API as shown in FIG. 69. Applications desiring to use the BWM may do so explicitly, calling its API instead of, for example, the TCP or UDP API. This may not allow legacy applications to use BWM without being modified. If a session is started using BWM, and subsequently the device loses access to the BWM server, the session may be terminated.

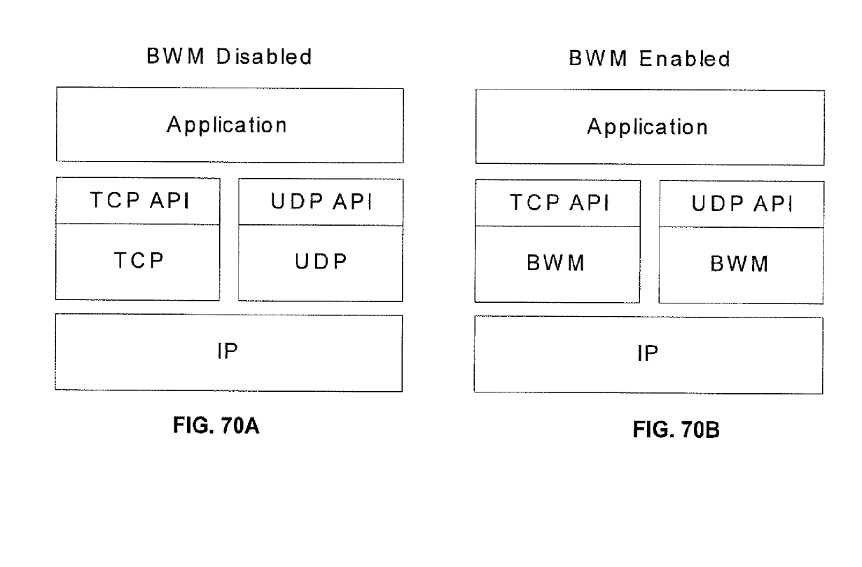

BWM may be added as a transport layer protocol, as shown in FIG. 70B. This may allow it to be enabled (FIG. 70B) or disabled at run time (FIG. 70A). When enabled, calls to TCP and/or UDP API's may be intercepted and the BWM transport layer protocol may run in TCP/UDP's place. Applications may think they are using TCP or UDP. Legacy application may continue to work seamlessly. If BWM is enabled, and a session is started, the session may use the enabled BWM, and may continue to do so until the session terminates. If the enabled BWM is subsequently disabled, any ongoing session may be terminated. If a device loses access to the BWM server, any ongoing session may be terminated. If BWM is disabled, and a session is started, the session may use TCP or UDP, and may continue to do so until the session terminates. If the BWM is subsequently enabled, any ongoing session may be terminated.

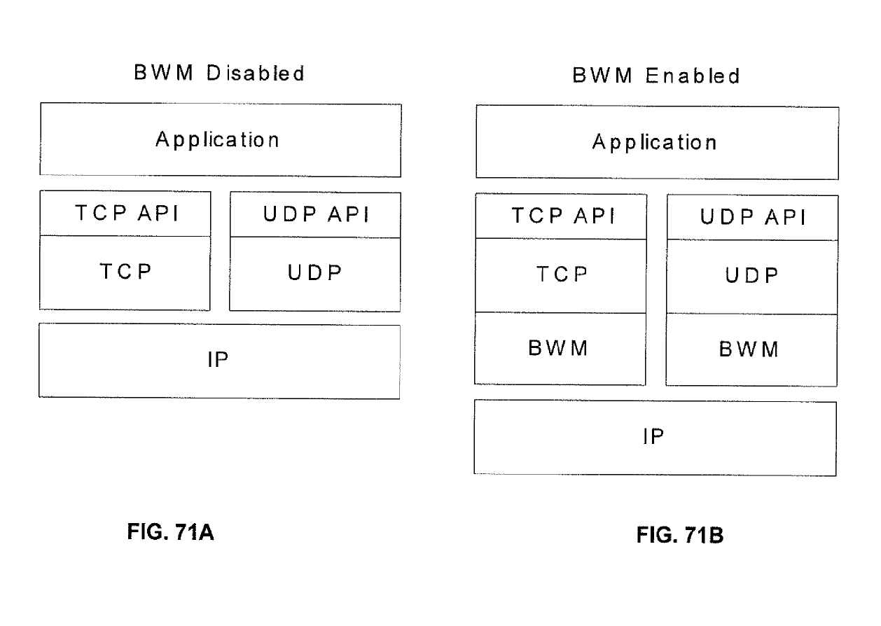

BWM may be added between the transport and internet layers. This may allow it to be enabled (FIG. 71B) or disabled (FIG. 71A) at run time. When enabled, the BWM may run underneath TCP or UDP, as shown in FIG. 71B. Applications may use TCP and/or UDP. Legacy applications may continue to work seamlessly. If the BWM is enabled, and a session is started, the session may use the BWM underneath TCP or UDP. If the enabled BWM is subsequently disabled, any ongoing session may revert to using straight TCP or UDP. If the device loses access to the BWM server, ongoing sessions may revert to using just TCP or UDP. If the BWM is disabled, and a session is started, it may use just TCP or UDP. If BWM is subsequently enabled, any ongoing session may be using the BWM underneath TCP or UDP.

The IPSec tunnel establishment may be used with BWM architecture. A BWM server may establish an IPSec tunnel with a SeGW (as a HNB may) and may interact with the HNB when the BWM server attempts to establish the IPSec tunnel. This behavior imitates what the SeGW does when the HNB attempts to create an IPSec tunnel in the absence of the BWM server.

The BWM server may support 3GPP TS 33.210, v9.0 and IETF RFC 4306. Described below are processes between a HNB and a SeGW that may be performed to establish an IPSec tunnel. Messages may be sent via UDP/IP between the two entities that wish to establish a security association. The BWM server may support these steps.

Six messages may be used to create the IPSec tunnel, three requests from the HNB and three responses from the SeGW. Each pair of these messages (request/response pair) may have specific functions. The first pair may be sent in the clear (no encryption) and the HNB may send a suite of proposed security parameters. The SeGW may respond with its choice for the security parameters, from those offered by the HNB. The second pair may also be sent in the clear and may consist of a request.

For IKEv2, the sequence may be as follows:

HNB may send an IKE_SA_INIT message to the SeGW with the following parameters:
IKE Header
   Exchange type=34 (IKE_SA_INIT)
   Initiator bit=TRUE (Initiator of the request/reply pair)
   Response bit=FALSE
Security Association Payload
   Encryption Algorithm: 3DES in CBC mode or AES in CBC mode
   Pseudo-Random function (hash algorithm): HMAC-SHA 1
   Integrity Algorithm: HMAC-SHA 1-96
   Diffie-Hellman group: Group 2 Or Group 14
Key Exchange Payload
   DH Group #=2 (1024-bit MODP) or 14 (2048-bit MODP)
   Key Exchange Data=DH Public Value
Nonce Payload
   Ni/Nr=Values used to ensure liveness

SeGW may respond with an IKE_SA_INIT message to the HNB with the following parameters:
IKE Header
   Exchange type=34 (IKE_SA_INIT)
   Initiator bit=FALSE
   Response bit=TRUE (Responder of the request/reply pair)
Security Association Payload
   For each area (encryption, integrity, DH group, and hash), the SeGW may select one of the proposed options by the HNB. This message indicates to the HNB which was selected.
Key Exchange Payload
   DH Group #=May be the same as the IKE_SA_INIT message from the HNB
   Key Exchange Data=DH Public Value
Nonce Payload
   Ni/Nr=Values used to ensure liveness

HNB may send an IKE_AUTH message to the SeGW with the following parameters:
IKE Header
   Exchange type=35 (IKE_AUTH)
   Initiator bit=TRUE (Initiator of the request/reply pair)
   Response bit=FALSE

SeGW may respond with an IKE_SA_INIT message to the HNB with the following parameters:
IKE Header Exchange type=35 (IKE_AUTH)
Initiator bit=FALSE
Response bit=TRUE (Responder of the request/reply pair)

HNB may send a CREATE_CHILO_SA message to the SeGW with the following parameters:
IKE Header
   Exchange type=36 (CREATE_CHILD_ID)
   Initiator bit=TRUE (Initiator of the request/reply pair)
   Response bit=FALSE

SeGW may respond with a CREATE_CHILO_SA message to the HNB with the following parameters:
IKE Header
   Exchange type=36 (CREATE_CHILD_ID)
   Initiator bit=FALSE
   Response bit=TRUE (Responder of the request/reply pair)

An exemplary listing of protocol and ports used to send and receive specific information is shown below.
GTP-C—UDP/IP using port number 2123
GTP-U—UDP/IP using port number 2152
GTP′—TCP/IP or UDP/IP using port 3386
DHCP data to server—UDP/IP using port number 67
DHCP data to client—UDP/IP using port number 68
DNS—Usually UDP/IP using port number 53, but if the DNS response is large enough,

TCP/IP using port number 53 is employed
FTP—TCP/IP using port 21 for control and port 20 for data
BGP—TCP/IP using port 179 HTTP—TCP/IP using port 80
IMAP—TCP/IP or UDP/IP using ports 143, 220, and 993
IRC—TCP/IP using ports 113, 194, 531, 6679 through 6697, and 31456
NNTP—TCP/IP using port 119 NNTPS—TCP/IP using port 563
NTP—UDP/IP using port 123
POP—TCP/IP using ports 109, 110, 995, and 1109
RIP—UDP/IP using port 520
RTP—UDP/IP using ports between 1024 and 65535
RTSP—TCP/IP or UDP/IP using port 554
SIP—TCP/IP, UDP/IP, or SCTP/IP using ports 5060, 5061, or 5070
SMTP—TCP/IP using ports 25, 465, or 587
SNMP—UDP/IP using ports 161, 162, or 199

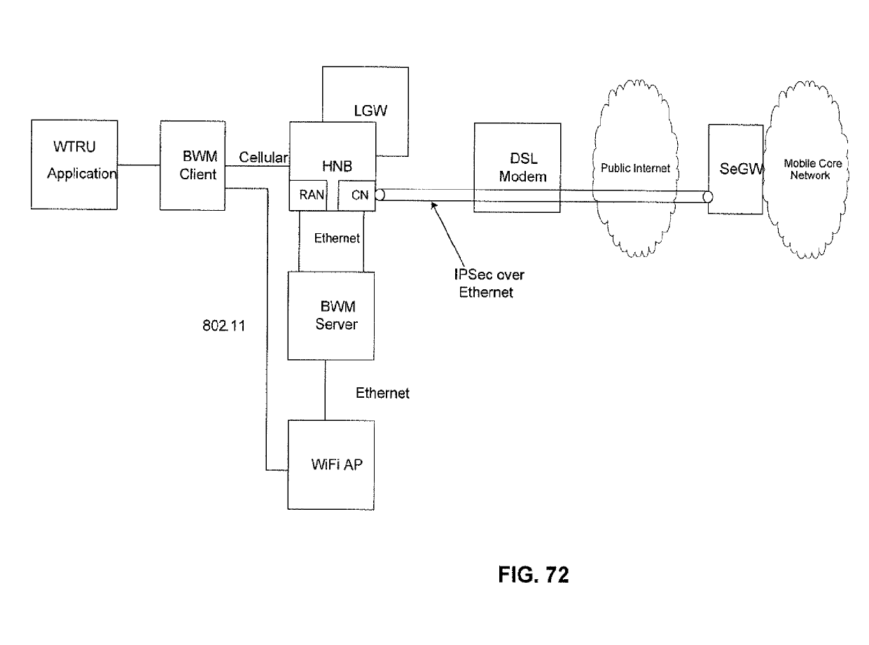

Other possible architectures may be used to effectuate BWM within the HNB environment. One exemplary architecture is shown in FIG. 72. In this configuration, the BWM server may sit (be located logically or physically) between the CN and RAN portions of the HNB. An advantage of this configuration may be that the HNB is allowed to naturally terminate the IPSec and GTP tunnels that exist between the HNB and the SeGW and SGSN, respectively. A disadvantage of this configuration may be that it is customized to the specific HNB implementation and may not be an agnostic solution.

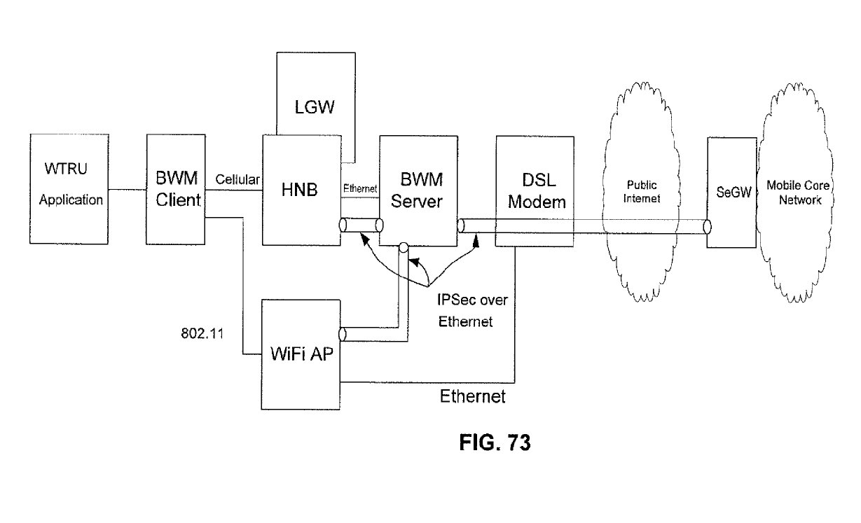

Another exemplary architecture is shown in FIG. 73. In this configuration, the BWM server may sit between the HNB and the SeGW of the MCN. However, a difference with earlier configurations may be that the BWM server may act as a pass through during the HNB configuration and may then be informed of the network supplied configuration by the introduction of a new protocol between the HNB and the BWM server. An advantage of this configuration may be that the HNB may be allowed to perform its function without the imposition of the BWM server between it and the SeGW of the MCN. A disadvantage of this configuration may be that the HNB now may support the new protocol that may be used to ferry (transfer) configuration information from it to the BWM server. Unlike other architectures, the HNB may have to be modified to implement this configuration.

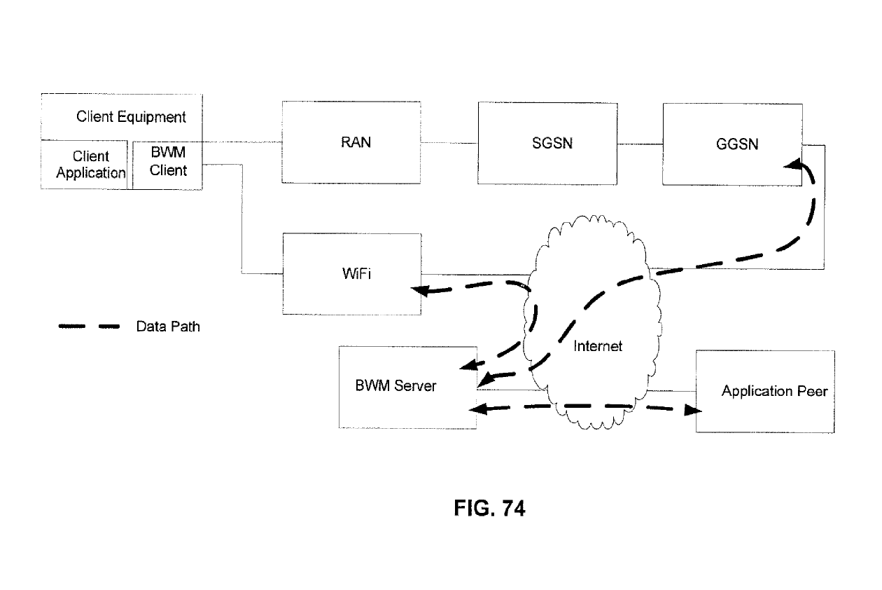

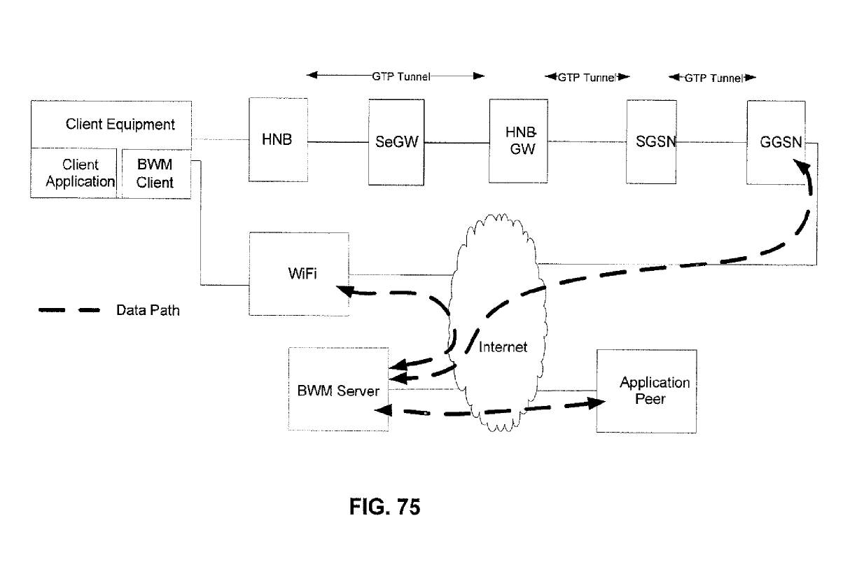

FIGS. 74-76 are additional exemplary illustrations of implementations of BWM architectures. In FIG. 74, the BWM client may be connected to the Internet via cellular and 802.11 based links. The BWM server may reside somewhere in the Internet. When the Client Application sends packets to the Peer, the packets may be intercepted by the BWM client. The BWM client may decide which connections to use to route this data to its destination. The BWM server may receive these packets from the multiple IP connections and forward the packets to the Application Peer using a standard Transport Layer protocol (e.g. TCP). To both the Client Application and the Application Peer, the actions of the BWM client and the BWM server may be transparent. When the Peer sends packets to the Client, the process described above may be performed in reverse. FIG. 75 is similar to FIG. 74, but has extra equipment and shows that a tunneling protocol may be used between the BWM server and the BWM client.

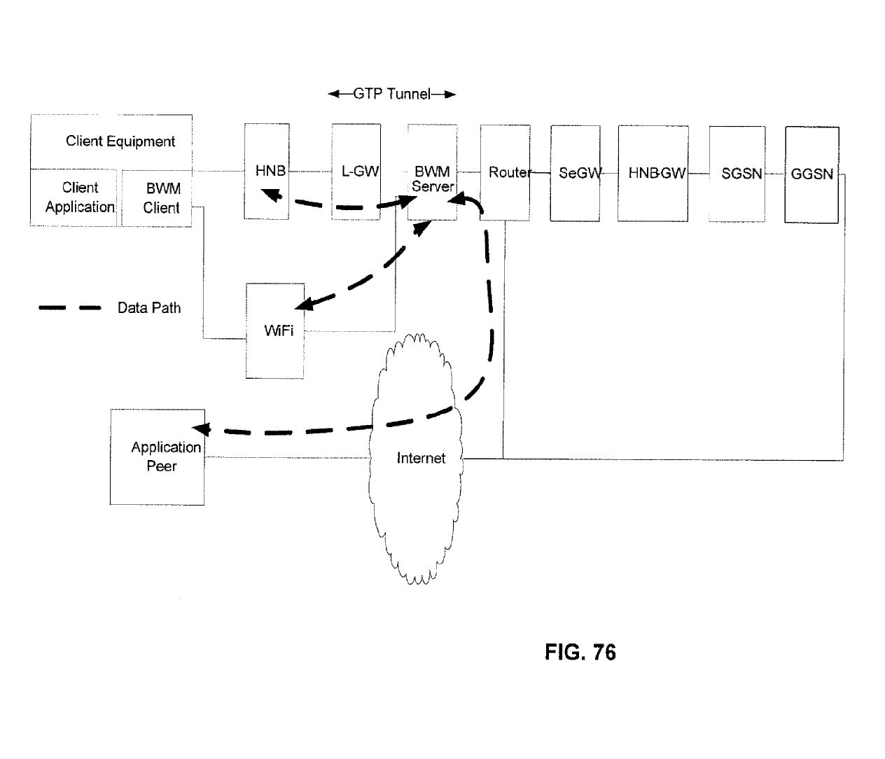

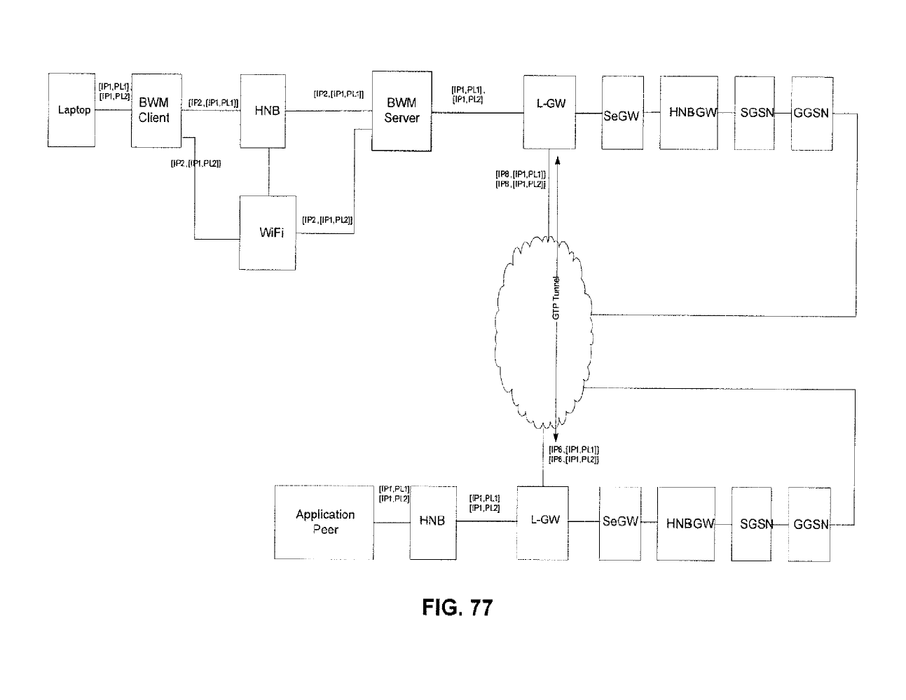

FIG. 76 is an exemplary illustration of a configuration for the placement of BWM technology when SIPTO is present within the cellular network. The placement of the SIPTO breakout point within the cellular network allows the data to bypass (and as a result offload) the core network from moving data packets between devices on the mobile network and the Internet. The placement of the BWM server may be between the router that performs the SIPTO and the local gateway (LGW) which is part of the home network. The BWM server may perform the same function as described in previous sections. FIG. 77 is an exemplary illustration of the BWM implemented in an ELIPA case.

According to example embodiments, systems and methods described herein (e.g. a converged gateway (CGW)) may provide a mechanism to segregate data based on criteria specified in an operator provided policy using a mechanism similar to Deep Packet Inspection (DPI) followed by policy-based assignment with flow mobility provided by IFOM. Generally, packet inspection may use both the 5-tuple in the IP Header and the IP Data itself to identify an IP Flow as being a specific type (such as video, or FTP). An IP flow may be a set of packets that have the same 5-tuple. The data to be segregated may originally destined to be delivered to a wireless terminal device via a HNB. Generally, IP Flow Segregation may be the ability to send an IP Flow to a destination over a policy-defined interface. According to example embodiments, the systems and methods herein may be provided and/or used with both static segregation and dynamic segregation. With static segregation, the same policy may remain in effect for the entire duration the wireless terminal may be connected to the CGW and the transport selections may remain the same for the life of IP Flows once the IP Flows have each been identified as being a specific type. With dynamic segregation, the same policy may remain in effect for the entire duration the wireless terminal may be connected to the CGW. However, the transport selections may not remain the same for the life of one or more IP Flows once the IP Flows may have each been identified as being a specific type. Thus, IP Flow Mobility (e.g. the ability to seamlessly move an IP Flow between interfaces) may be induced for at least a portion of the IP Flows based on conditions (such as throughput).

As described herein, a converged gateway (CGW) may be provided. According to an example embodiment, the CGW described herein may support IFOM. The CGW may include or be in communication with a Wi-Fi access point (AP), a home NodeB (HNB), and the like. In an embodiment, the CGW may get a public IP address from an ISP Modem via DHCP or any other suitable technique that may be provided by an ISP vendor. Additionally, in example embodiments, IPv4 may be used and/or supported by, for example, the CGW.

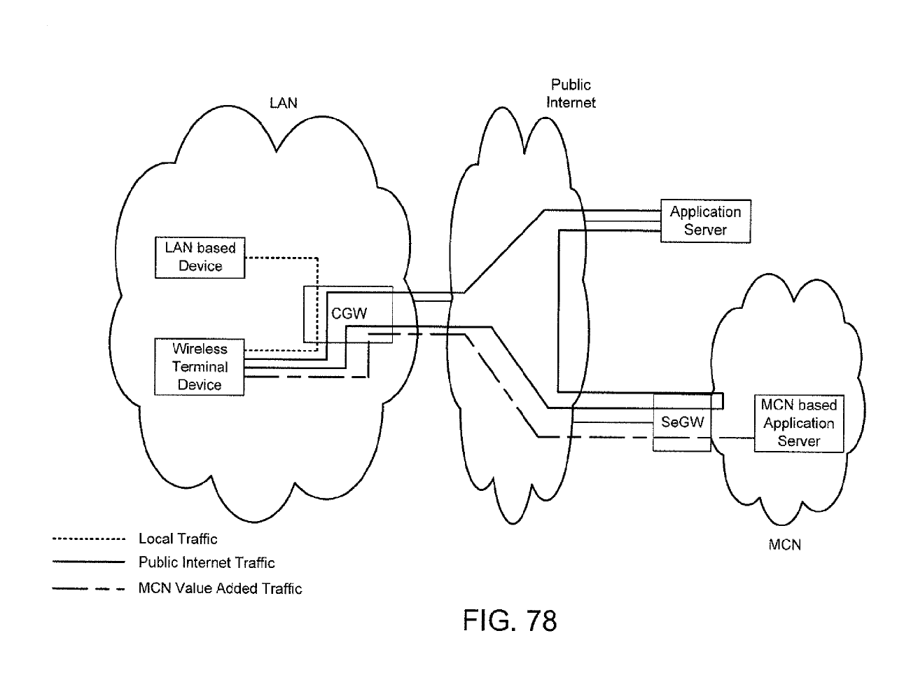

According to an embodiment, various data traffic may be provided and/or used in a communication network that may include a CGW. Such data traffic may be routed through the CGW or through other components in the communication network (e.g. that may be in communication with the CGW). FIG. 78 illustrates an example embodiment of data traffic that may be provided and/or supported in a communication network that may include a CGW. As shown in FIG. 1, local traffic such as Wi-Fi-to-Wi-Fi, Ethernet-to-Wi-Fi, Wi-Fi-to-Ethernet, Ethernet-to-Ethernet, and the like within a LAN may be supported and/or provided. For example, the local traffic such as the Wi-Fi-to-Wi-Fi, Ethernet-to-Wi-Fi, Wi-Fi-to-Ethernet, Ethernet-to-Ethernet, and the like may include data plane traffic to and/or from a non-3G terminal device to another non-3G device within the LAN. An example of such data traffic may be data from a wireless terminal device to a local printer. In such an embodiment, the printer is connected to the LAN either through Wi-Fi or Ethernet.

Additionally, local traffic such as LIPA that may include 3G-to-3G, 3G-to-Wi-Fi, 3G-to-Ethernet, and the like within the LAN may be supported and/or provided. LIPA, which may be defined within, for example, 3GPP, may include a cellular device connecting through a HNB and a local gateway (LGW) to access a device within the LAN that includes the HNB and LGW. An example of such data traffic may include data from a 3G terminal device to a local printer. In such an embodiment, the printer may be connected to the LAN either through Wi-Fi or Ethernet.

According to another embodiment, public internet traffic such as Wi-Fi-to-public Internet, Ethernet-to-public Internet, Internet traffic through a mobile core network (“MCN”), MCN-based SIPTO, CGW-based SIPTO, and the like may be provided and/or supported. The Wi-Fi-to-public Internet and/or the Ethernet-to-public Internet may include data plane traffic to and/or from a non-3G terminal device on the LAN within a premise to a device on the public Internet. An example of Wi-Fi-to-public Internet and/or Ethernet-to-public Internet may be a terminal device connected to Wi-Fi (e.g. via a Wi-Fi AP) in communication with a CGW within the LAN (e.g. via the Wi-Fi and Wi-Fi AP). According to an embodiment, data that may be passed between the terminal device and the public internet device through the CGW may use the public Internet without passing through the through the MCN.

The internet traffic through the MCN may include data plane traffic to and/or from a wireless terminal device on the LAN within a premise to a device on the public Internet that may pass through the MCN. For such a traffic type, at least one 3G connection and/or one or more Wi-Fi connections may be used. An example of internet traffic through the MCN may be a wireless terminal device connected to Wi-Fi (e.g. via a Wi-Fi AP) and a cellular network (e.g. via a HNB) and in communication with a CGW within the LAN. In such an embodiment, there may be at least one PDP context through the CGW to, for example, the MCN. Additionally, data between the wireless terminal device and an application server on the public internet may traverse the MCN.

The MCN-based SIPTO may include data plane traffic to and/or from a wireless terminal device that may offloaded from within the MCN to the public Internet. For MCN-based SIPTO, there may be at least one 3G PDP context. Additionally, the CGW such as the CGW described herein may not have knowledge of which traffic may be offloaded within the MCN.

The CGW-based SIPTO may include data plane traffic to and/or from a wireless terminal device on the LAN within a premise to a device on the public internet. Such a CGW-based SIPTO may be similar to MCN-based SIPTO except where the data may be broken out to the public internet. For CGW-based SIPTO, there may be at least one 3G PDP context. An example of CGW-based SIPTO may include a wireless terminal device connected to Wi-Fi (e.g. via a Wi-Fi AP) and a cellular network (e.g. via a HNB) in communication with a CGW within the LAN. In an embodiment, there may be at least one PDP context through the CGW to the MCN. Additionally, the CGW may be pre-configured to send selected IP data of a specific data type to the public internet (e.g. bypassing the MCN) based on identifying and tagging the specific data type. Such data passed between the wireless terminal device and the public internet device through the CGW may bypass the MCN by using the public internet.

The MCN value added traffic may be used, when, for example, an application server may be located within the MCN and may include data plane traffic to and/or from a wireless terminal device on the LAN within a premise to a device within the MCN. For such an embodiment, a cellular connection such as a 2G, 3G, and/or 4G connection may be used. An example of MCN value added traffic may be a wireless terminal device connected to Wi-Fi (e.g. via a Wi-Fi AP) and a cellular network (e.g. via a HNB) in communication with a CGW within the LAN. In an embodiment, there may be at least one PDP context through the CGW to the MCN. Additionally, data between the wireless terminal device and the application server within the MCN may enter the MCN and may be destined for the application server.

As described herein, the CGW and/or other components of the communication network may further be in communication, support, provide, and/or use one or more of the following: local Wi-Fi such as a Wi-Fi AP and a Wi-Fi cloud within a premise; a local HNB such as a HNB and a HNB cloud within a premise; a wireless terminal or a device that may include one or more modems such as a Wi-Fi modem and a cellular modem such as a 3G modem, or a combination thereof; a 5-tuple that may include one or more parameters from an IP Packet Header such as a Source IP Address, Destination IP Address, Source Port Number, Destination Port Number, IP Protocol, and the like; an IP Flow or a set of packets that may have the same 5-tuple; a Deep Packet Inspection such as a packet inspection that may use both the 5-tuple in the IP Header and the IP Data itself to identify an IP Flow as being a specific type including, for example, video, FTP, and the like; a Shallow Packet Inspection such as a packet inspection that may use a 5-tuple in the IP Packet Header to identify an IP Flow as being a specific type including, for example, video, FTP, and the like; a Packet Inspection such as a packet inspection that may use either a Deep Packet Inspection or Shallow Packet Inspection; IP Flow Segregation such as an ability to send an IP Flow to a destination over a policy-defined interface; Bandwidth Aggregation such as sending a single IP Flow over multiple interfaces; IP Flow Mobility such as an ability to seamlessly move an IP Flow between interfaces; Packet Tagging such as recognizing packets as being a specific type based on their 5-tuple; Packet Identification; 3G Mobility such as an ability to seamlessly handover from a HNB to a macro cell or another HNB; Mobility; Static Segregation where, for example, the same policy may remain in effect for the duration a wireless may be connected to the CGW and a transport selection may remain the same for the life of one or more IP Flows once the IP Flows may each be identified as being a specific type; Dynamic Segregation where, for example, the same policy may remain in effect for the duration a wireless terminal may be connected to the CG, but a transport selection may not remain the same for the life of one or more IP Flows once the IP Flows may each be identified as being a specific type; a Data Type including data discriminated based on one or more of the following a specific data traffic type such as Public Internet Traffic, a specific transport layer protocol, such as TCP or UDP, a specific application layer protocol such as SIP or RTP, specific application server or endpoint; and the like; VoIP such as an IP flow that may use one or more of the following application layer protocols: SIP, RTP, IAX; and the like; HTTP Video such as an IP flow within an HTTP session that may have a content-type of video; Streaming Video such as an IP flow that may use application layer protocol RTSP to establish a media session and may use an application layer protocol RTP for content delivery; FTP such as an IP flow that may use an application layer protocol FTP to transfer files between an FTP Server and FTP Client; and the like.

Additionally, based on conditions such as throughput, IP Flow Mobility that may be supported by the CGW may be induced for one or more IP Flows that may also be supported by the CGW.

According to example embodiments, the CGW, terminal device, and/or components described herein may also support one or more of the following: circuit switched (CS) voice; data traffic types such as local traffic including Wi-Fi-to-Wi-Fi, Ethernet-to-Wi-Fi, Wi-Fi-to-Ethernet, and Ethernet-to-Ethernet within a LAN and public Internet including Wi-Fi-to-public Internet, Ethernet-to-public Internet, Internet traffic through MCN; MCN-based SIPTO (e.g. that may not pose a condition or obligation on the CGW or terminal device other than to not adversely affect SIPTO done within a MCN); MCN Value Added Traffic including an application server that may be located within a MCN (e.g. an endpoint of data may be in the MCN); and the like.

The CGW, terminal device, and/or components described herein may further support policy-based Static Segregation for downlink IP flows within the CGW including, for example, HTTP Video, Streaming Video, FTP, VoIP, and the like; CGW identification of LIF-enabled and non LIF-enabled terminals (e.g. without imposing a condition or obligation on the terminals that may adversely impact their operation in a non-CGW environment); LIF-enabled terminal identification of the CGW by the terminal (e.g. if the terminal device may decide initiate IFOM) and/or the CGW; an ability to exclude transports such as Wi-Fi, 3G, neither, and the like for packet switched data.

According to additional embodiments, the CGW, terminal device, and/or components described herein may support a policy per user or data type within the CGW to perform Static Segmentation of downlink IP flows. The policy within the CGW may be hardcoded. Additionally, the terminal may get the policy from a server outside the MCN or CGW. In such an embodiment, an entity operating the system (e.g. the communication system) may ensure that the CGW, UE, and/or a terminal device may have the same policy. The policy per user with in the CGW that may be supported may include IMSI and the policy per data type may include FTP, for example, from a specific FTP server.

Additionally, the CGW, terminal device, and or components described herein may support Cellular Mobility (e.g. 3G or 4G Mobility) including Outbound (e.g. HNB-to-Macro) and Inbound (Macro-to-HNB or HNB-to-HNB) mobility and an ability to change Deep Pocket Inspection (DPI) engines including, for example, the CGW being able to replace a DPI function.

According to embodiments, the CGW, terminal device, and/or components described herein may also support or provide policy-based dynamic segregation for downlink IP flows within CGW. In some embodiments, a Media Independent Handover (MIH) may be used to provide at least one measurement between the terminal device and the CGW such that the CGW may dynamically perform IP Flow Mobility. The CGW, terminal device, and/or components described herein may further support or provide policy-based aggregation for downlink IP flows within CGW. Policy-based aggregation may include, for example, adding aggregation to the IFOM based CGW, adding segregation to the Multi-Connection Network Transport Protocol (MNTP) based CGW, and/or merging the CGW and MNTP-based CGW architectures.

The CGW, terminal device, and/or components described herein may also support various types of policy dissemination including dissemination of a policy for a specific user to the CGW and/or dissemination of a policy for a specific user to that specific user device.

The various implementations of the system including the CGW, terminal device, and/or components and methods described herein may include one or more of the functions/features listed below and described herein, for example, above and below. For example, in one embodiment, the CGW may support or provide CS Voice, local data traffic, public interne traffic, MCN value added traffic. Public internet traffic may include, for example, internet traffic through the MCN, MCN-based SIPTO, Wi-Fi-to-Wi-Fi, Ethernet-to-Wi-Fi, Wi-Fi-to-Ethernet, and/or Ethernet-to-Ethernet within LAN as described.

The CGW may also support policy-based static and/or dynamic segregation for downlink IP flows within the CGW. For downlink traffic through the CGW, policy-based flow identification may be used (e.g. via some type of packet inspection, for example, such as deep or shallow). The policy may define the data type that may be used for flow identification. The policy may be hardcoded within the CGW as described above. Additionally, various types of packets may be identified such as video data, FTP-based data, and VoIP data, for example, by the CGW. In some embodiments, various types of video data may be identified, such as HTTP video and/or streaming video, for example. HTTP Video may include an IP flow within an HTTP session that may have a content-type of video. Streaming Video may include an IP flow that uses application layer protocol RTSP to establish a media session and may use an application layer protocol RTP for content delivery. FTP-based data may include an IP flow that may use an application layer protocol FTP to transfer files between an FTP Server and FTP Client.

Additionally, for downlink traffic through the CGW, policy-based packet segregation of flows between a first Radio Access Technology (RAT) such as local Wi-Fi and a second RAT such as local HNB may be used. As described above, the local Wi-Fi may include, for example, a Wi-Fi AP and a Wi-Fi cloud within a premise and the local HNB may include, for example, a HNB and the HNB cloud within a premise. In some embodiments, the policy may be per user and/or per flow type or service type. The policy may also identify characteristic triggers for Quality of Service (QoS) enforcement of user/data type priorities. For example, if throughput may exceed a limit (e.g. either below minimum or above maximum), a specific flow may be moved from one transport to another.

For uplink traffic at the CGW, the CGW may dispatch the uplink traffic received from a local device on the LAN appropriately.

In one embodiment, as described above, the CGW may support or provide CGW identification of LIF-enabled and non LIF-enabled terminals. Address Resolution Protocol (ARP) may be used for CGW identification of LIF-enabled and non LIF-enabled terminals. Additionally, the CGW identification of LIF-enabled and/or non LIF-enabled terminals may not preclude and/or interfere with a LIF-enabled terminal from working in a non-CGW environment or system.

Additionally, a terminal device that may be provided and/or used herein (e.g. with the CGW) may support or provide LIF-enabled terminal identification of the CGW. According to example embodiments, ARP and/or Ping may be used for LIF-enabled terminal identification of the CGW. The LIF-enabled terminal identification of the CGW may not preclude and/or interfere with a LIF-enabled terminal from working in a non-CGW environment or system.

In one embodiment, the CGW may also support or provide an ability to exclude various transports for packet switched data such as Wi-Fi, 3G, or neither, for example. For example, if user selects Wi-Fi, then both public Internet and Local traffic may be supported. If user select 3G, the CGW may provide connectivity to MCN and support MCN traffic. If user allows both Wi-Fi and 3G, for example, the CGW may perform policy-based IFOM-like functionality to manage flow between the CGW and wireless terminal device based on, for example, a policy, if it may exist and an awareness of LIF-enabled capabilities of the wireless terminal device.

According to additional embodiments, the CGW may also support policy dissemination to the CGW (e.g. downloaded from the MCN or acquired from outside the MCN). When a terminal device acquires a policy from some entity outside the CGW and the MCN, in some embodiments, the GCW may also contact the same entity (e.g. server) and obtain the same policy that may be sent to the terminal device.

Additionally, the CGW, terminal device, and/or components described herein may support or provide a limit on the number of users connected to cellular components in the communication system. For example, the number of simultaneous users that may be connected to a HNB within a premise may be limited (e.g. by the CGW) based on the HNB functionality or criteria associated therewith including the sum of modems across wireless terminals and/or limitations of the HNB for an activity. In some embodiments, the number of simultaneous users may be four, while in other embodiments the number of simultaneous users may be greater, such as ten or more. For example, the number of simultaneous users may be scalable such that the CGW may increase the number.

According to another embodiment, the CGW, terminal device, and/or components described herein may support or provide a limit on the number of users connected to Wi-Fi components in the communication system. For example, the number of simultaneous users that may be connected to a Wi-Fi AP may be limited (e.g. by the CGW) based on the functionality of the Wi-Fi AP or criteria associated therewith including a sum of Wi-Fi modems across wireless terminals and/or interference such as Wi-Fi interference, for example. In some embodiments the number of simultaneous users may be for, while in other embodiments the number of simultaneous users may be greater than four, such as ten or more. For example, as described above, the number of simultaneous users may be scalable such that the CGW may increase the number.

In one embodiment, the CGW may also support policy-based aggregation for downlink IP flows within the CGW. For downlink traffic through the CGW, the CGW may use Multi-Connection Network Transport Protocol (MNTP) for aggregation. Policy-based flow identification, such as deep or shallow packet inspection, may be used with the policy defining the data type to be used for flow identification. Example types of packets that may be identified include HTTP video, streaming video, FTP, and VoIP. A policy-based packet aggregation of flows may be between RATs such as between local Wi-Fi and local HNB, for example. In some embodiments, the data aggregation policy may be per user and/or the policy may be per flow type or service type. In some cases, a characteristic of the data flow triggers for QoS enforcement of user/data type priorities. For example, when throughput may exceed certain limits (e.g. either below minimum or above maximum), a specific flow may be moved from one transport to another. Similar to the measurements discussed above with regard to segregation, various measurements (e.g. throughput, latency) may be performed at the terminal device and CGW. Measurements may be exchanged using MIH, for example, between the terminal device and the CGW.

In one embodiment, the CGW, terminal device, and/or components described herein may also support and/or provide dynamic flow mobility. For example, outbound and/or inbound flow may be dynamically moved from one transport to another transport. Outbound dynamic flow mobility may include, for example, HNB-to-Macro and inbound dynamic flow mobility may comprise macro-to-HNB and/or HNB-to-HNB.

The CGW, terminal device, and/or components described herein may further support and/or provide CGW initialization, HNB initialization/provisioning, HNB registration, wireless terminal device GPRS attach, Wi-Fi association, Wi-Fi/3G (e.g. a first and second RAT) association, and the like.

The CGW, terminal device, and/or components and methods described herein may be used to support and/or provide various services, features, and/or embodiments. For example, as described herein the CGW may support or provide circuit switched (CS) voice as described above. In an embodiment, to support and/or provide CS voice (e.g. using the CGW), a user may be connected to an HNB with his or her wireless terminal that may include at least one cellular modem (e.g. 2G, 3G, 4G, and the like) such that the user may place a mobile originated (MO) call through the MCN. In another embodiment, to support and/or provide CS voice (e.g. using the CGW), a user may be connected to the HNB with his or her wireless terminal that may include at least one cellular modem such that the user may receive a mobile terminated (MT) call from the MCN.

The CGW, terminal device, and/or components and methods described herein may be used to support or provide transport selection for packet switched services. For example, in one embodiment, a user may not want to use mobility and a MCN (e.g. while at home). As such, the user may turn off a cellular interface or cellular RAT such as a 2G, 3G, and/or 4G interface or any other cellular interface or RAT of a device that may provide multiple interfaces or RATs such as a dual mode Wi-Fi and cellular interface or RATs using a connection manager that may be provided on the device. By turning off the cellular interface, circuit switched (CS) voice calls may be disabled. In another embodiment, the user may also disable PDP contexts such as 3G PDP contexts rather than turning off a cellular interface. By disabling PDP contexts rather than turning off the cellular interface, the cellular interface or RAT such as a 3G modem may attach and may be used for CS voice calls. In either embodiment, the other interfaces or RATs that may be provided on the device such as Wi-Fi interface or RAT may be enabled for packet switched services and may be associated with, for example, a local Wi-Fi AP that may be connected to a CGW.

Additionally, to support or provide transport selection for packet switched services (e.g. using the CGW, terminal device, and/or components and methods described herein), a user of a device that may support or provide multiple interfaces or RATs such as cellular interfaces or RATs (e.g. 2G interfaces, 3G interfaces, 4G interfaces, and the like) and/or Wi-Fi interfaces or RATs may wish to conserve battery power (e.g. if the user may not have a battery charger and/or the user may be at home). As such, to conserve battery power, the user may decide to turn off an interface or RAT such as a Wi-Fi interface or RAT and connection established therewith that may drain the battery. By turning off an interface or RAT such as a Wi-Fi interface or RAT, the device may connect to the MCN through the CGW such the user may have connectivity while using less battery power.

In another embodiment, to support or provide transport selection for packet switched services (e.g. using the CGW, terminal device, and/or components and methods described herein), a user of a device that may support or provide multiple interfaces or RATs such as cellular interfaces or RATs (e.g. 2G interfaces, 3G interfaces, 4G interfaces, and the like) and/or Wi-Fi interfaces or RATs may start downloading media such as videos before leaving a location such as home. To take advantage of the a Wi-Fi connection established via a Wi-Fi interface or RAT in the device (e.g. while at home) and the continuous connectivity that may be provided by cellular mobility such as 3G mobility (e.g. when the user may mobile), the device and the user thereof may employ or use both the Wi-Fi and cellular interfaces or RATs and connections associated therewith such that the device and the user thereof may take advantage of the IFOM-like and mobility solutions that may be provided or offered by the CGW.

The CGW, terminal device, and/or components and methods described herein may be used to support or provide local traffic such as source and/or destination traffic that may be local to a LAN. For example, in one embodiment, a device or wireless terminal and a user thereof may be associated with a LAN and may connect to a CGW via a Wi-Fi AP (e.g. the user may turn off 3G or other cellular interfaces or RATs or the 3G connection or connections associated with other cellular interfaces or RATs may not available due to conditions such as poor coverage). The user of the device or wireless terminal may then send media such as a video to a DLNA television or device that may be on the same LAN.

FIG. 79 illustrates an example embodiment of data traffic that may be provided through devices such as a CGW that may be included in a LAN. For example, as shown in FIG. 79, a wireless terminal device 7905 and a user thereof may be associated with a LAN 7900 and may connect to a CGW 7915 via a Wi-Fi AP 7920. According to an example embodiment, the DLNA device 7910a, 7910b such as a DLNA television may be connected to the Wi-Fi AP 7920 and may be connected to the CGW 7915 via Wi-Fi or Ethernet. For example, the CGW 7915 and the DLNA device 7910a, 7910b may communicate using either Wi-Fi or Ethernet (e.g. the CGW 7915 may communicate with the DLNA device 7910a via Wi-Fi and the CGW 7915 may communicate with the DLNA device 7910b via Ethernet). Additionally, the wireless terminal device 7905 may be connected to the DLNA device 7910a, 7910b and/or the CGW 8005 via Wi-Fi (e.g. via the Wi-Fi AP 7920). The user of the wireless terminal device 7905 may send media or other data such as a video to the DLNA device 7910a, 7910b such as a DLNA television that may be on the same LAN 7900. As shown in FIG. 79, the traffic (e.g. associated with the data or media that may be sent) may remain with the LAN and may not involve MCN, HNB, and/or public Internet in an embodiment. For example, the traffic to DLNA device 7910a from the wireless terminal device 7905 may be through the Wi-Fi AP 7920 and the traffic to the DLNA device 7910b from the wireless terminal device 7905 may be through the Wi-Fi AP 7920 and the CGW 7915 as shown in FIG. 79.

In another embodiment, to support or provide local traffic such as source and/or destination traffic that may be local to a LAN, a device or wireless terminal may be associated with a LAN and may connect to a CGW via a Wi-Fi AP and may connect to a CGW/MCN via a cellular interface and connection such as 3G. The user of the device or wireless terminal may then send media or data such as a video to a DLNA device such as a DLNA television on the same LAN.

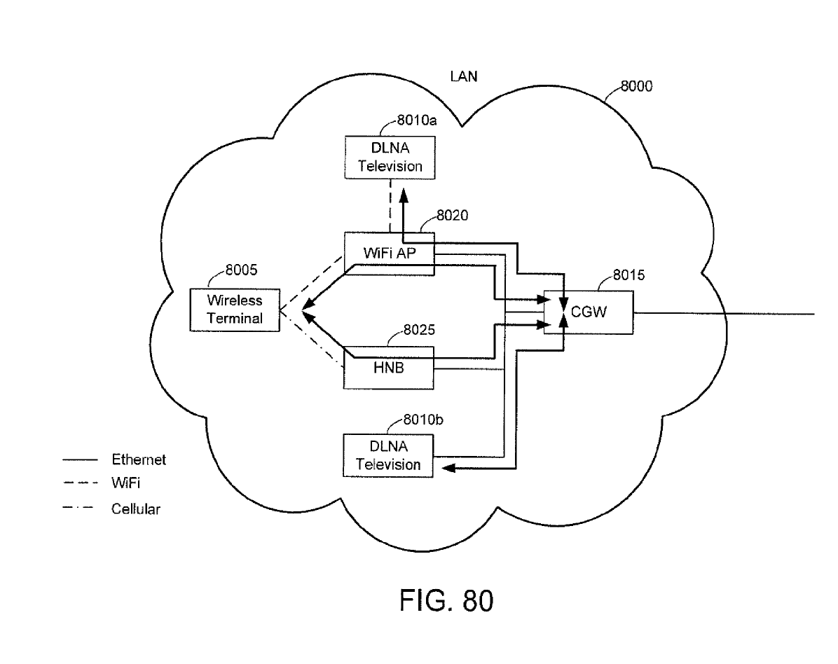

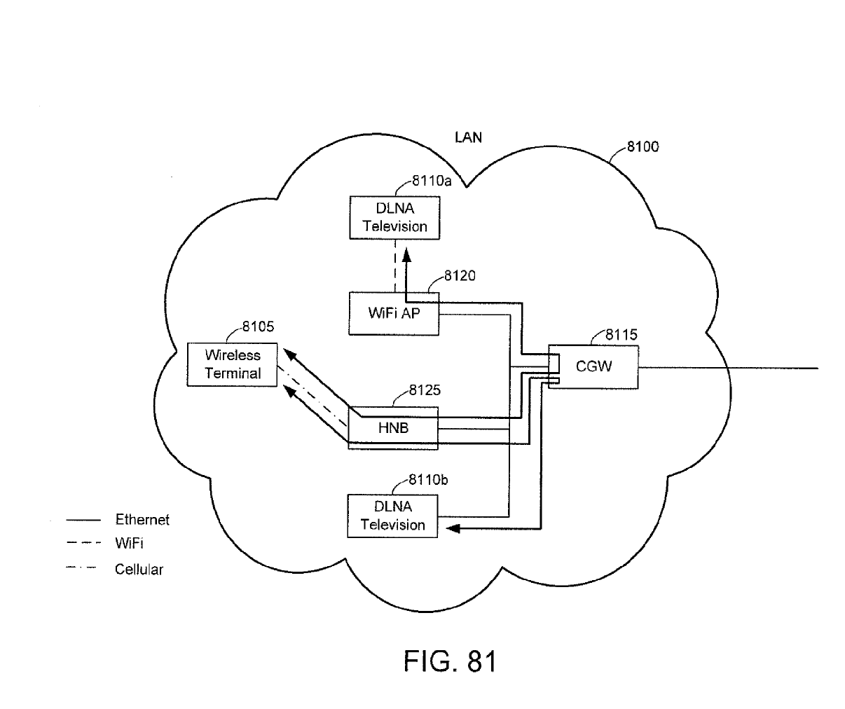

FIG. 80 illustrates another example embodiment of data traffic that may be provided through devices such as a CGW that may be included in a LAN. For example, a wireless terminal device 8005 may be associated with a LAN 8000 and may connect to a CGW 8015 via a Wi-Fi AP 8020 and may connect to a CGW/MCN (e.g. the CGW 8015 and MCN that may be connected thereto) via a cellular interface and connection such as 3G. The user of the wireless terminal device 8005 may then send media or data such as a video to a DLNA device 8010a, 8010b such as a DLNA television on the same LAN 800. According to an example embodiment, the DLNA device 8010a, 8010b such as a DLNA television may be connected to the Wi-Fi AP 8020 and may be connected to the CGW 8015 via Wi-Fi or Ethernet. For example, the CGW 8015 and the DLNA device 8010a, 8010b may communicate using either Wi-Fi or Ethernet. Additionally, the wireless terminal device 8005 may be connected to the CGW 8015 via Wi-Fi (e.g. via the Wi-Fi AP 8020) or cellular (e.g. via HNB 8025) such that the traffic (e.g. the data) between the CGW 8015 and the wireless terminal device 8005 may be either Wi-Fi or cellular. For the uplink traffic, a logical interface (LIF) (e.g. that may be included in the CGW 8015 and/or the wireless terminal device 8005) may decide or determine which interface (e.g. Wi-Fi or cellular) to use. For the downlink traffic, an interface that may be used may be decided or determined based on or by a segregation policy (e.g. that may be included in the CGW 8015) and an ability of a CGW such as the CGW 8015 to determine that such a flow may be video or another data or media type, for example. The CGW such as the CGW 8015 may identify such a flow via packet inspection and may then tag packets in the flow. If a policy for a device may indicates that Wi-Fi may be the transport for video or data packets, the CGW such as the CGW 8015 may send (or receive) these packets through a Wi-Fi connection (e.g. via the Wi-Fi AP 8020) if available. On the other hand, if a policy for a device may indicate that cellular may the transport for video or other data packets, the CGW such as the CGW 8015 may deliver (or receive) these packets through a cellular connection (e.g. via the HNB 8025) if available. As shown in FIG. 80, the traffic (e.g. the data packets associated with the video, data, or media) may remain in the LAN 8000. For example, as shown in FIG. 80, the traffic may pass through both the Wi-Fi AP 8020 and HNB 8025 (e.g. based on a policy as described above) from the wireless terminal device 8005 to the CGW 8015 and/or from the CGW 8015 to the wireless terminal device 8005. Additionally, as shown in FIG. 80, the traffic may pass through the Wi-Fi AP 8020 (e.g. via a Wi-Fi interface or RAT) from the DLNA device 8010a to the CGW 8015 and from the CGW 8015 to the DLNA device 8010a. The traffic may also pass directly from the DLNA device 8010b to the CGW 8015 and from the CGW 8015 to the DLNA device 8010b via an Ethernet interface or RAT as shown in FIG. 80.

In another embodiment, to support or provide local traffic such as source and/or destination traffic that may be local to a LAN, a device or wireless terminal device may be associated with a LAN and may connect to the CGW/MCN via a cellular connection and interface or RAT such as 2G, 3G, 4G, and the like. The user of the device or wireless terminal device may then send a video to a DLNA device such as a DLNA television on the same LAN.

FIG. 81 illustrates another example embodiment of data traffic that may be provided through devices such as a CGW that may be included in a LAN. For example, a wireless terminal device 8105 may be associated with a LAN 8100 and may connect to the CGW/MCN (e.g. the CGW 8115 and MCN that may be connected thereto) via a cellular connection and interface or RAT such as 2G, 3G, 4G, and the like. The user of the wireless terminal device 8105 may then send a video to a DLNA device 8110a, 8110b such as a DLNA television on the same LAN 8100. According to an example embodiment, the DLNA device 8110a, 8110b such as a DLNA television may be connected to the Wi-Fi AP 8120 and may be connected to the CGW 8115 via Wi-Fi or Ethernet. For example, the CGW 8115 and the DLNA device 8110a, 8110b may communicate using either Wi-Fi or Ethernet. Additionally, the wireless terminal device 8005 may be connected to the CGW 8115 via cellular (e.g. via HNB 8125) such that the traffic (e.g. the data) between the CGW and the wireless terminal device may be cellular via the HNB 8125. As shown in FIG. 81, the traffic (e.g. the data packets associated with the video, data, or media) may remain in the LAN 8100. For example, as shown in FIG. 81, the traffic may pass through both the HNB 8125 from the wireless terminal device 8005 to the CGW 8015 and/or from the CGW 8015 to the wireless terminal device 8005. Additionally, as shown in FIG. 81, the traffic may pass through the Wi-Fi AP 8120 (e.g. via a Wi-Fi interface or RAT) from the DLNA device 8110a to the CGW 8115 and from the CGW 8115 to the DLNA device 8110a. The traffic may also pass directly from the DLNA device 8110b to the CGW 8115 and from the CGW 8115 to the DLNA device 8110b via an Ethernet interface or RAT as shown in FIG. 81.

The CGW, terminal device, and/or components and methods described herein may be used to support or provide public Internet traffic. For example, in one embodiment, a device or wireless terminal device that may support multiple interfaces or RATs such as Wi-Fi and/or cellular interfaces or RATs may be associated with a LAN and may connect to a CGW via a Wi-Fi AP (e.g. may turns off a cellular interface or RAT such as 3G or a cellular connection such as 3G may not available, for example, due to a condition or such as poor coverage). The user of the device or wireless terminal device may then connect to an application server such as YouTube, and the like that may be on the public Internet.

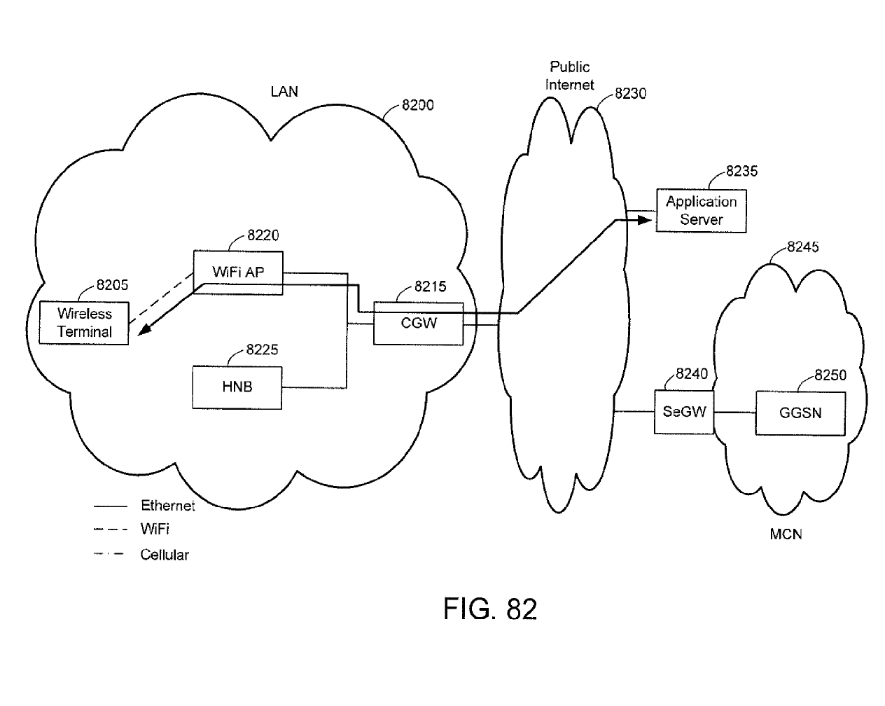

FIG. 82 illustrates an example embodiment of data traffic that may be provided through devices such as a CGW that may be included in a communication network. For example, a wireless terminal device 8205 that may support multiple interfaces or RATs such as Wi-Fi and/or cellular interfaces or RATs may be associated with a LAN 8200 and may connect to a CGW 8215 via a Wi-Fi AP 8220 (e.g. a user may turn off a cellular interface or RAT such as 3G or a cellular connection such as 3G may not available, for example, due to a condition or such as poor coverage). The user of the wireless terminal device 8205 may then connect (e.g. through the Wi-Fi AP 8220 and CGW 8215) to an application server 8235 such as YouTube, and the like that may be connected to or on a public Internet 8230. As shown in FIG. 82, traffic (e.g. data packets associated with media such as a video and/or other data) between the CGW 8215 and the wireless terminal device 8205 may be over Wi-Fi via the Wi-Fi AP 8220 and traffic between the CGW 8125 and the application server 8235 may use the public Internet 8230 such that the traffic may not be routed through a MCN such as MCN 8245.

In another embodiment, to support or provide public Internet traffic, a device or wireless terminal device that may support or provide multiple interfaces or RATs such as Wi-Fi and/or cellular interfaces or RATs may be associated with a LAN and may be connected to a CGW via a Wi-Fi AP and may be connected to a MCN through the CGW (e.g. a CGW/MCN) via a cellular interface or connection such as 3G (e.g. that may be provided by a HNB). The user of the device or wireless terminal device may then connect to an application server such as Google, and the like that may be connected to or on a public Internet.

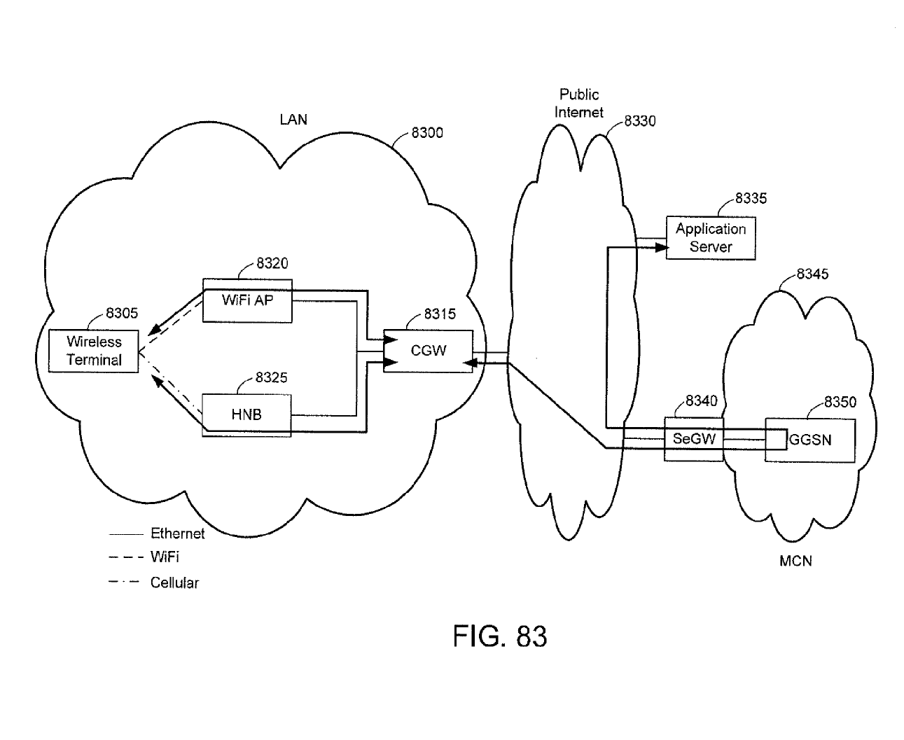

FIG. 83 illustrates another example embodiment of data traffic that may be provided through devices such as a CGW that may be included in a communication network. For example, a wireless terminal device 8305 that may support or provide multiple interfaces or RATs such as Wi-Fi and/or cellular interfaces or RATs may be associated with a LAN 8300 and may be connected to a CGW 8315 via a Wi-Fi AP 8320 and may be connected to a MCN 8345 through the CGW 8315 (e.g. a CGW/MCN) via a cellular interface or connection such as 3G (e.g. that may be provided by a HNB 8325). The user of the wireless terminal device 8305 may then connect to an application server 8335 such as Google, and the like that may be connected to or on a public Internet 8330. As shown in FIG. 83, traffic between the CGW 8315 and the wireless terminal device 8305 may be either Wi-Fi via the Wi-Fi AP 8320 or cellular via the HNB 8325. Additionally, as shown in FIG. 83, traffic between the CGW′ 8315 and the application server 8338 based on or connected to the public Internet 8330 may be through the MCN 8345 including through a SeGW 8340 and a GGSN 8350 that may be included in the MCN 8345 (e.g. and to and/or from the application server 8335 after the MCN 8345). For uplink traffic, a LIF (e.g. that may be included in the CGW 8315 and/or the wireless terminal device 8305) may decide or determine based on a policy which interface (e.g. the Wi-Fi AP 8320 and/or the HNB 8325) to use between the wireless terminal device 8305 and the CGW 8315. Additionally, for downlink traffic, an interface (e.g. the Wi-Fi AP 8320 and/or the HNB 8325) between the CGW 8315 and the wireless terminal device 8305 may be decided or determined by a segregation policy and an ability of the CGW 8315 to identify such a flow via packet inspection and tagging. For traffic between the MCN 8345 and the CGW 8315 shown in FIG. 83, IPSec/GTP tunnels may be used. Additionally, static segregation, dynamic segregation, and/or aggregation described above may be used via one or more of the components or devices shown in FIG. 83.

In another embodiment, to support or provide public Internet traffic, a device or wireless terminal device may be associated with a LAN and may be connected to a MCN through a CGW (e.g. a CGW/MCN) via a cellular interface such as 3G that may be provided by a HNB. The user may then connect to an application server such as a Library of Congress public FTP site or other FTP site, and the like on the public Internet.

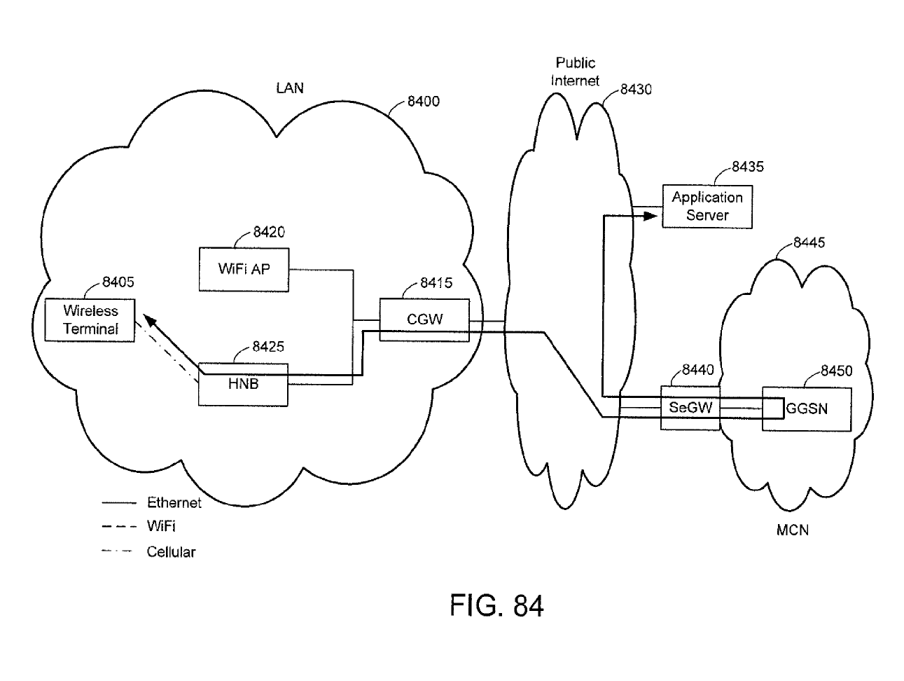

FIG. 84 illustrates another example embodiment of data traffic that may be provided through devices such as a CGW that may be included in a communication network. For example, a wireless terminal device 8405 may be associated with a LAN 8400 and may be connected to a MCN 8445 through a CGW 8415 (e.g. a CGW/MCN) via a cellular interface such as 3G that may be provided by a HNB 8425. The user may then connect to an application server 8435 such as a Library of Congress public FTP site or other FTP site, and the like on a public Internet 8430. As shown in FIG. 84, traffic between the CGW 8415 and the wireless terminal device 8405 may be cellular via the HNB 8425. Additionally, traffic between the CGW 8415 and the application server 8435 connected to or on the public Internet 8430 (e.g. the public Internet based application server) may be through the MCN 8445 including through a SeGW 8440 and a GGSN 8450 that may be included in the MCN 8445 (e.g. and to/from the public Internet based application server after the MCN). For traffic between the MCN 8445 and the CGW 8415, IPSec/GTP tunnels may be used.

In another embodiment, to support or provide public Internet traffic, a device or wireless terminal device may be associated with a LAN and may connect to a CGW via a Wi-Fi AP and a MCN through the CGW (e.g. a CGW/MCN) via cellular interface such as a 3G that may be provided by a HNB. In such embodiment, a policy may provide or indicate that data or media such as video may bypass the MCN and may use the public Internet.

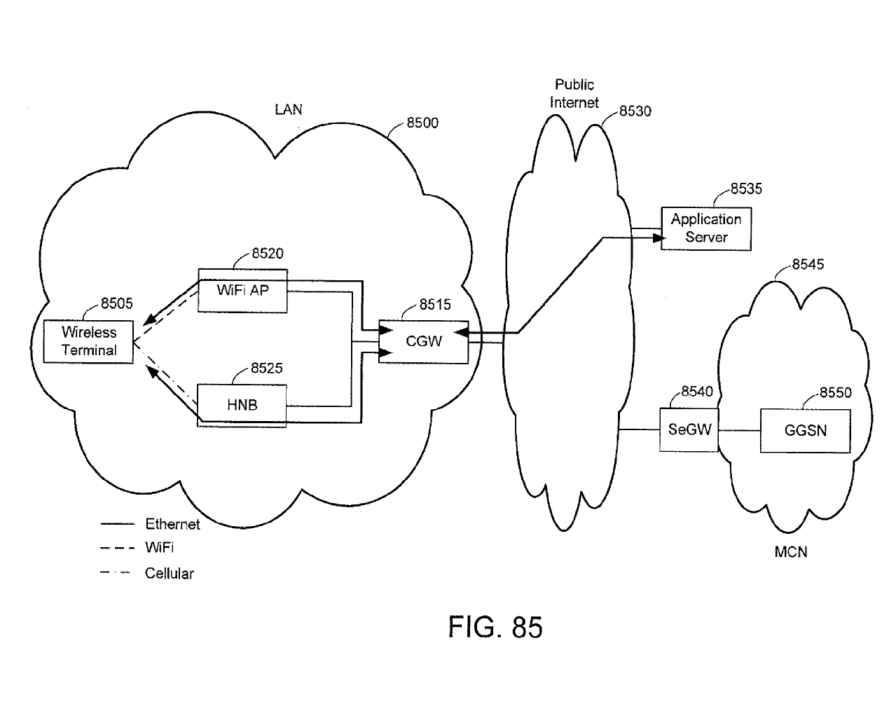

FIG. 85 illustrates another example embodiment of data traffic that may be provided through devices such as a CGW that may be included in a communication network. For example, a wireless terminal device 8505 may be associated with a LAN 8500 and may connect to a CGW 8515 via a Wi-Fi AP 8520 and a MCN 8545 through the CGW 8515 (e.g. a CGW/MCN) via a cellular interface such as a 3G that may be provided by a HNB 8525. In such embodiment, a policy may indicate that data or media such as video may bypass the MCN 8545 and may use the public Internet 8530. For example, in an embodiment, the user may want to download data or a video from an application server 8535 such as MetaCafe, and the like connected to or on the public Internet 8530. The request (e.g. for such data or a video) from the wireless terminal device 8505 may arrive at the CGW 8515 and the CGW 8515 may examine the request. The packet inspection function that may be included within the CGW 8515 may determine that the request may be related to video or data and may send it to an application server 8535 or the appropriate application server such as MetaCafe over the public Internet 8530 bypassing the MCN 8545 in accordance with the policy. As the packet associated with the request for the video or data may pass through the CGW 8515, the packet may get Network Address Translated (e.g. NAT'ed) and may be sent with the CGWs public IP address as the source address. The application server 8535 such as MetaCafe may receive or get the request and may start sending the video or data to the public address of the CGW 8515. The CGW 8515 may then route the video or data to the wireless terminal device 8505.

According to another embodiment, a wireless terminal device may be associated with a LAN and may be connected to a CGW via a Wi-Fi AP and a MCN through the CGW (e.g. a CGW/MCN) via cellular interface such as 3G provided by a HNB (e.g. similar to the configuration illustrated in FIG. 85). In such an embodiment, the policy may be setup such that video may bypass the MCN and use the public Internet. For example, the user may want to download a video or data from an application server (e.g. a public Internet application server) such as MetaCafe. The request for the video and/or data may get to the CGW (e.g. may be received by the CGW) and the CGW may look at or inspect the request to identify a flow. The packet inspection function that may be included within the CGW may not be able to identify the packet (e.g. associated with the data or video) and may send the packet to the MCN. In an embodiment, the packet may go through the MCN and may land in the Gateway GPRS Support Node (GGSN) after which the packet may be dropped onto the public Internet. The source address may be the GGSNs public IP address and the destination may be the application server such as MetaCafe. The application server such as MetaCafe may start sending the video or data with the destination address as the GGSN. The packet associated with the video or data may get to the GGSN and may then get routed to the CGW. The packet inspection function in the CGW may use a handful of packets to determine whether the packets may be associated with a video or data (e.g. a particular video or data). Once the flow may be tagged, the flow from the GGSN may be moved to the public IP address of the CGW.

The CGW, terminal device, and/or components and methods described herein may be used to support or provide MCN value added traffic. For example, in one embodiment, a device or wireless terminal device may be associated with a LAN and may connect to a CGW via a Wi-Fi AP and may connect to a MCN through the CGW (e.g. a CGW/MCN) via a cellular interface such as 3G that may be provided by a HNB. The user of the device or wireless terminal device may then connect to an application server within the MCN such as a Video On Demand Premium Server.

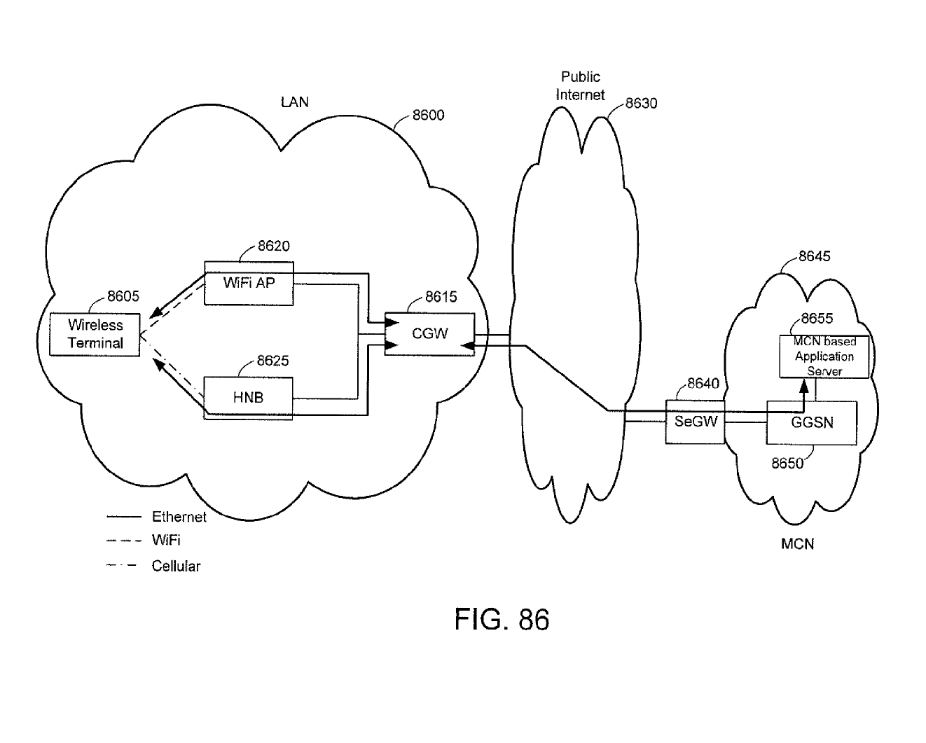

FIG. 86 illustrates another example embodiment of data traffic that may be provided through devices such as a CGW that may be included in a communication network. For example, in one embodiment, a wireless terminal device 8605 may be associated with a LAN 8600 and may connect to a CGW 8615 via a Wi-Fi AP 8620 and may connect to a MCN 8645 through the CGW 8615 (e.g. a CGW/MCN) via a cellular interface such as 3G that may be provided by a HNB 8625. The user of the wireless terminal device 8605 may then connect to an application server 8655 within the MCN 8645 such as a Video On Demand Premium Server. As shown in FIG. 86, traffic between the CGW 8615 and the wireless terminal device 8605 may be either Wi-Fi or cellular. Additionally, traffic between the CGW 8615 and the MCN based application server 8655 may terminate within the MCN 8645. According to an embodiment, for uplink traffic, a LIF (e.g. that may be included in the CGW 8615 and/or the wireless terminal device 8608) may decide or determine based on a policy which interface (e.g. the Wi-Fi AP 8620 and/or the HNB 8625) to use between the wireless terminal device 8605 and the CGW 8615. For downlink traffic, an interface (e.g. the Wi-Fi AP 8620 and/or the HNB 8625) between the CGW 8615 and the wireless terminal device 8605 may be decided or determined by or based on a segregation policy and an ability of the CGW 8615 to identify such a flow via packet inspection and tagging. For traffic between the MCN 8645 and the CGW 8615, IPSec/GTP tunnels may be used.

In another embodiment, to support or provide MCN value added traffic, a device or wireless terminal device may be associated with a LAN and may connect to a MCN through a CGW (e.g. a CGW/MCN) via a cellular interface such as 3G that may be provided by a HNB. The user of the wireless terminal then connects to an application server within the MCN.

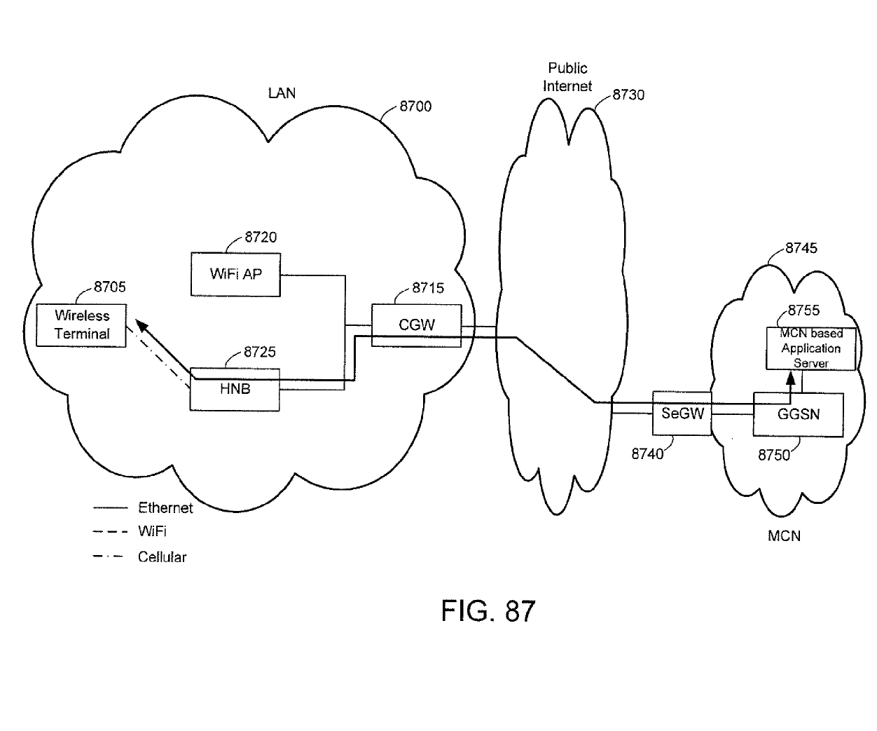

FIG. 87 illustrates another example embodiment of data traffic that may be provided through devices such as a CGW that may be included in a communication network. For example, in one embodiment, a wireless terminal device 8705 may be associated with a LAN 8700 and may connect to a MCN 8745 through a CGW 8715 (e.g. a CGW/MCN) via a cellular interface such as 3G that may be provided by a HNB 8725. The user of the wireless terminal device 8705 may then connect to an application server 8755 within the MCN 8745. As shown in FIG. 87, traffic between the CGW 8715 and the wireless terminal device 8705 may be cellular. Additionally, traffic between the CGW 8715 and the application server 8755 such as a MCN based application server may terminate within the MCN. For traffic between the MCN 8745 and the CGW 8715, IPSec/GTP tunnels may be used.

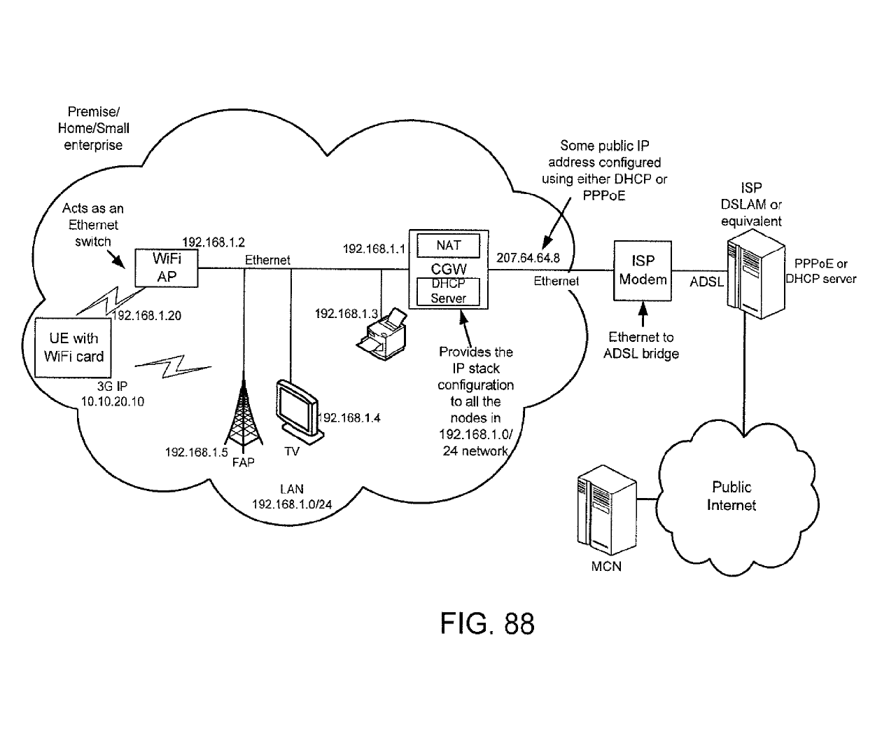

FIG. 88 illustrates an example embodiment of a topology of a LAN with a CGW that may be included in a communication network. As shown in FIG. 88, a LAN 8800 may be provided. The LAN 8800 may be associated with a premise, home, small enterprise, and the like. The LAN 8800 may include user equipment (UE) 8805, a Wi-Fi AP 8820, a CGW 8820 that may include a NAT component and a DHCP server, and other components or devices such as a FAP, TV or monitor, printer, and the like that may be in communication with each other via Wi-Fi or Ethernet connections and interfaces. As shown in FIG. 88, the CGW 8815 may be in communication with an ISP modem or device that may be external to the LAN such as the ISP modem 8860. According to an example embodiment, the Wi-Fi AP 8820 may act as an Ethernet Bridge and may have its DHCP Server disabled. Additionally, as described above, the CGW 8815 may have a DHCP Server that may assign addresses on the LAN 8800. The CGW 8815 may also perform NAT′ing (e.g. via the NAT component) when packets may be exchanged between the LAN 8800 and the ISP Modem 8860. As shown in FIG. 88, the ISP Modem 8860 may be in communication with an ISP DSLAM or component 8865 including a PPOE or DCHP server, the public Internet 8870, and a MCN such as a MCN 8875.

According to an example embodiment, source and destination addresses of packets that are received from/sent to a wireless terminal may be defined (e.g. for the topology shown in FIG. 88). For uplink packets, in accordance with a CGW environment such as the CGW 8815 shown in FIG. 88, Table 3 shows an example IP addressing that may occur within a wireless terminal such as a UE 8805 for various embodiments.

TABLE 3

| | Device | Physical | | |
|---|---|---|---|---|
| Case | Type | Interface | Source | Destination |
| 1 | Non-LIF | Wi-Fi | Local Wi-Fi IP | |
| | Wi-Fi | | address that may | |
| | | | be assigned by | |
| | | | the DHCP Server | |
| | | | in CGW | |
| 2 | Non-LIF | Wi-Fi | Local Wi-Fi IP | |
| | both | | address that may | |
| | Wi-Fi/3G | | be assigned by | |
| | | | the DHCP Server | |
| | | | in CGW | |
| 3 | Non-LIF | 3G | 3G IP address | |
| | 3G | | that may be | |
| | | | assigned by | |
| | | | MCN | |
| 4 | Non-LIF | 3G | 3G IP address | |
| | both | | that may be | |
| | Wi-Fi/3G | | assigned by | |
| | | | MCN | |
| 5 | LIF Wi-Fi | Wi-Fi | Local Wi-Fi IP | Local IP address, |
| | | | address that may | Public Internet IP |
| | | | be assigned by | address, MCN |
| | | | the DHCP Server | Value add IP |
| | | | in CGW | address |
| 6 | LIF both | Wi-Fi | Local Wi-Fi IP | Local IP address |
| | Wi-Fi/3G | | address that may | |
| | | | be assigned by | |
| | | | the DHCP Server | |
| | | | in CGW | |
| 7 | LIF both | Wi-Fi | 3G IP address | Public Internet IP |
| | Wi-Fi/3G | | that may be | address, MCN |
| | | | assigned by | Value add IP |
| | | | MCN | address |
| 8 | LIF 3G | 3G | 3G IP address | Public Internet IP |
| | | | that may be | address, MCN |
| | | | assigned by | Value add IP |
| | | | MCN | address |
| 9 | LIF both | 3G | 3G IP address | Public Internet IP |
| | Wi-Fi/3G | | that may be | address, MCN |
| | | | assigned by | Value add IP |
| | | | MCN | address |

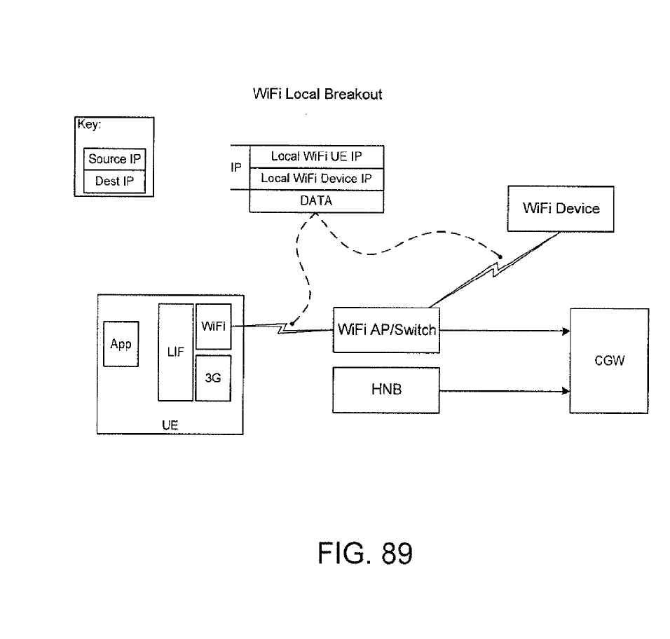

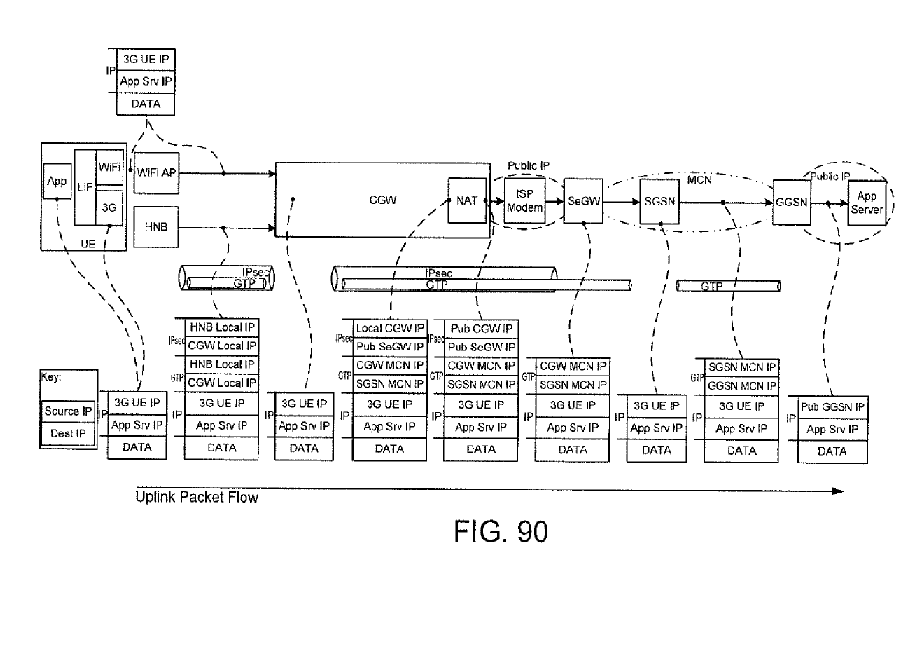

Cases 1 through 4 shown in Table 3 may be non-LIF enabled wireless terminals. Cases 5 and 8 may be used when one interface may be in use. In both embodiments, a source address of uplink packets may be the IP address assigned to each of these interfaces. In Case 5, the source address may be the local Wi-Fi IP address assigned by the DHCP Server within the CGW. In Case 8, the source address may be the 3G IP address as assigned by the MCN. Cases 6, 7, and 9 may be embodiments where a wireless terminal may be LIF enabled and both a Wi-Fi and 3G connection may exist. For Case 9, the source address may be the 3G IP address that may be assigned by the MCN. For Cases 6 and 7, the source address may be a function of the destination address. For Case 6, the destination may be local to the LAN and the IP addressing may be shown in FIG. 89. For Case 7, the destination may be outside the LAN and the IP addressing may be shown in FIG. 90.

For downlink packets, in accordance with a CGW environment such as the CGW 8815 shown in FIG. 88, Table 4 shows an example IP addressing that may occur within a CGW such as the CGW 8815 for various embodiments.

TABLE 4

| | | Physical | | |
|---|---|---|---|---|
| Case | Device Type | Interface | Source | Destination |
| 1 | Non-LIF | Wi-Fi | Local IP address, | Local Wi-Fi IP |
| | Wi-Fi | | Public Internet IP | address that may |
| | | | address | be assigned by the |
| | | | | DHCP Server in |
| | | | | CGW |
| 2 | Non-LIF | Wi-Fi | Local IP address, | Local Wi-Fi IP |
| | both | | Public Internet IP | address that may |
| | Wi-Fi/3G | | address | be assigned by the |
| | | | | DHCP Server in |
| | | | | CGW |
| 3 | Non-LIF 3G | 3G | Public Internet IP | 3G IP address that |
| | | | address, MCN | may be assigned |
| | | | Value add IP | by MCN |
| | | | address | |
| 4 | Non-LIF | 3G | Public Internet IP | 3G IP address that |
| | both | | address, MCN | may be assigned |
| | Wi-Fi/3G | | Value add IP | by MCN |
| | | | address | |
| 5 | LIF Wi-Fi | Wi-Fi | Local IP address, | Local Wi-Fi IP |
| | | | Public Internet IP | address that may |
| | | | address | be assigned by the |
| | | | | DHCP Server in |
| | | | | CGW |
| 6 | LIF both | Wi-Fi | Local IP address | Local Wi-Fi IP |
| | Wi-Fi/3G | | | address that may |
| | | | | be assigned by the |
| | | | | DHCP Server in |
| | | | | CGW |
| 7 | LIF both | Wi-Fi | Public Internet IP | 3G IP address that |
| | Wi-Fi/3G | | address, MCN | may be assigned |
| | | | Value add IP | by MCN |
| | | | address | |
| 8 | LIF 3G | 3G | Public Internet IP | 3G IP address that |
| | | | address, MCN | may be assigned |
| | | | Value add IP | by MCN |
| | | | address | |
| 9 | LIF both | 3G | Public Internet IP | 3G IP address that |
| | Wi-Fi/3G | | address, MCN | may be assigned |
| | | | Value add IP | by MCN |
| | | | address | |

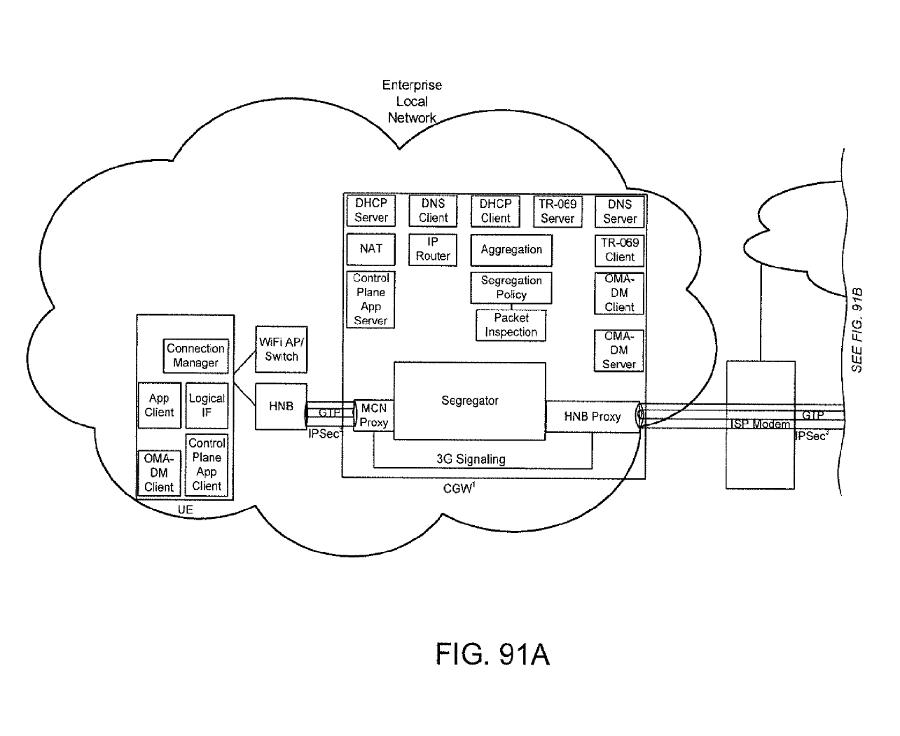

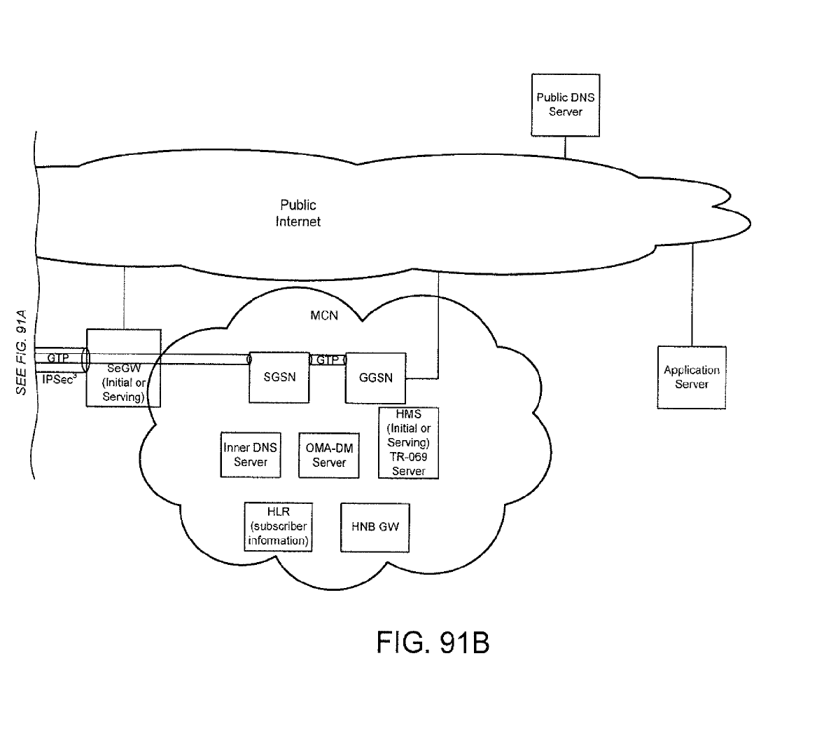

FIGS. 91A-91B illustrate example embodiments of a functional architecture of a CGW and wireless terminal device such as a UE disclosed herein. As shown in FIGS. 91A-91B, a wireless terminal device such as a UE 9105 may have a Logical Interface (LIF) that may provide the capability of using physical interfaces to support IFOM within the wireless terminal device. The wireless terminal device such as the UE 9105 may also have a Connection Manager that may provide, among other functions, an ability for a user to selectively disable certain connections, such as disabling the Wi-Fi connection or interface or RAT on the terminal device.

Still referring to FIGS. 91A-91B, in various embodiments, a CGW such as the CGW 9115 may have a DHCP Server. The DHCP Server may have the ability to respond to DHCP messages from a device located within a LAN such as the LAN 9100 that may requests a local IP address. The CGW such as the CGW 9105 may also have a DHCP Client that may have an ability to request a local IP address from an ISP Modem. The CGW such as the CGW 9115 may also have a DNS Server that may be configured to resolve the Fully Qualified Domain Name (FQDN) of the Initial Secure Gateway (SeGW) to the local IP address of the CGW. In an embodiment, the DNS Server may also have the ability to accept queries to resolve a FQDN and respond thereto. The CGW such as the CGW 9115 may further have a DNS Client. The DNS Client may be used to issue requests to resolve FQDNs and hostnames to perform the functions defined and described herein. According to another embodiment, the CGW may include a Segregator that may be used to support the IFOM-like segregation. For example, for segregation, the Segregator may be the focal point within the CGW where uplink and downlink packets congregate before being dispatched to their proper destination. In additional embodiments, as shown in FIGS. 91A-91B, the CGW may include a TR-069 server, a TR-069 client, an OMA-DM server, a OMA-DM client, a NAT component, an IP router, an MCN proxy, a HNB proxy, a segregation policy component, a packet identification component, an aggregation component, a control plane application server, and the like as described herein.

A CGW such as the CGW 9115 may also include a processor and a computer memory or other computer-readable media in communication with the processor. Software with instructions for execution by the processor may be stored on the computer memory. The processor may execute the software to perform various functions, such as the dynamic spectrum management described herein. The processor may be implemented as an integrated circuit (IC) having one or multiple cores. The computer-readable media or memory may comprise volatile and/or non-volatile memory units. Volatile memory units may comprise random access memory (RAM), for example. Non-volatile memory units may comprise read only memory (ROM), for example, as well as mechanical non-volatile memory systems, such as, for example, a hard disk drive, an optical disk drive, etc. The RAM and/or ROM memory units may be implemented as discrete memory ICs, for example.

While the CGW, the Wi-Fi AP and HNB may be shown as separate devices in the illustrated embodiments (e.g. in FIGS. 91A-91B), in additional embodiments, such components may be integrated into one physical device. Moreover, if a functional block may be included within the CGW, the entire function may not be used. For example, the CGW 9115 shows a TR-069 Client included therein. However, various system architectures may use a portion or some portions of a TR-069 client to be implemented. Furthermore, in some embodiments, such functionality may not be used.

Additionally, various features within the functional architecture illustrated in FIGS. 91A-91B (e.g. within the CGW 9115 and/or the UE 9105) may include one or more of the following features: CGW initialization and provisioning; Wi-Fi AP initialization; HNB initialization and provisioning; HNB registration, GPRS attach, PDP context activation; wireless terminal device Wi-Fi association; Wi-Fi and/or cellular (e.g. 3G) association at the CGW; CGW discovery; LIF; control plane application client and/or server; a segregation policy; segregation policy dissemination; deep packet identification and/or flow identification; packing tagging and/or delivery; IP routing; NAT; DHCP server; cellular mobility such as 3G mobility; transport selection and/or availability; MCN proxy; HNB proxy; a segregator; emergency services; a debug; a Wi-Fi authentication; and the like.

For example, one feature that may be provided and/or used may be CGW initialization and provisioning. In one embodiment, CGW initialization and provisioning may be handled similarly as discussed above with regard to FIGS. 2, 40 and 41.

Another feature that may be provided and/or used may be Wi-Fi AP initialization. For example, in some embodiments, the Wi-Fi AP may be configured such that its DHCP Server may be disabled. Upon power-up, the Wi-Fi AP may request, and be given, an IP address on the LAN within the premise. Furthermore, in additional embodiments, the Wi-Fi AP IP address may be used for Operations, Administration, and Maintenance (OAM) of the AP, and may not be used for other CGW features.

According to an embodiment, HNB initialization and provisioning and HNB registration may be additional features that may be provided and/or used herein. In embodiments, HNB initialization and provisioned may be handled as described above with regard to FIG. 3, for example. According to an example embodiment, HNB registration may be handled as described above with regard to FIG. 42, for example.

GPRS attach may be another feature that may be provided and/or used. In some embodiments, attaching the GPRS may be handled as described above.

In another embodiment, a feature that may be provided and/or used may be PDP context activation. PDP context activation may be handled as described above with regard to FIG. 17. At the end of such a method or procedure, a wireless terminal device may have one or more cellular (e.g. 3G) based IP addresses depending on how many PDP contexts may be activated during the method or procedure. During the signaling between the HNB and MCN, an IP address or IP addresses that may be assigned to a wireless terminal device may be passed through the CGW such as the CGWs described herein. The CGW may have to extract this IP address from the signaling in an embodiment.

Wireless terminal device Wi-Fi association may also be a feature that may be provided and/or used. For example, when a Wi-Fi physical layer of a wireless terminal device may be enabled or when the device and the Wi-Fi physical layer thereof may come into range of the Wi-Fi AP, the device and Wi-Fi physical layer thereof may associate with the Wi-Fi AP. As part of the association, the device and Wi-Fi physical layer thereof may be given an IP address by the DHCP Server within a CGW. The IP address that may be assigned may be on the LAN that may include the CGW and the Wi-Fi AP (and any other local devices such as the HNB). In addition, the device and Wi-Fi physical layer thereof may be given the CGW local IP address as the Default Gateway.

The features may further include a Wi-Fi and/or 3G association at the CGW. For example, in an embodiment, once a device may have requested and received an address from a DHCP Server within the CGW, the DHCP Server within the CGW may know both the locally assigned IP address and the MAC address of the Wi-Fi interface. To link these parameters to the 3G IP address or cellular IP address that may be assigned by the MCN, the CGW may issue an ARP Request using the 3G IP address or cellular IP address that may be assigned by the MCN. The Wi-Fi within the wireless device may respond with its MAC address. At this point, the CGW may know that the Wi-Fi MAC address, local Wi-Fi IP address, and 3G IP address or cellular IP address may be associated with the same device. To ensure that it may be the same device, the CGW may send an ICMP Echo Request message through the local LAN with the source IP address set to the CGWs LAN IP address and the destination IP address set to the 3G IP address extracted during the setup of the PDP context.

If the wireless terminal device may be connected through the Wi-Fi AP, the device may respond with an ICMP Echo Response message with the source and destination IP addresses reversed to, for example, inform or tell the CGW that the terminal device has both the 3G and local Wi-Fi connection “active.” The CGW may also periodically issue the ARP Request and ICMP Echo Request messages. For example, if the 3G PDP context may be activated after the Wi-Fi may be or may have been associated, in an embodiment, an operating system (OS) that may be included in the in the CGW may manage linking such information (e.g. that may be used for Wi-Fi and/or 3G association).

CGW discovery may be another feature that may be provided and/or used herein according to an embodiment (e.g. by a wireless terminal device and/or a CGW). For example, in one embodiment, once a terminal device may have requested and received an address from the DHCP Server within a LAN, a wireless terminal device may issue an ICMP Echo Request message through a Wi-Fi interface with a source IP address set to the 3G IP address or cellular IP address and a destination IP address set to the Default Gateway IP address that may be obtained from the DHCP Server. If the LAN may have a CGW, the CGW may respond with an ICMP Echo Response with the IP addresses reversed. If the LAN may not have a CGW, a default gateway configured by the DHCP Server may not be aware of the 3G IP address or cellular IP address. Upon receipt of the ICMP Echo Request message, the default gateway may attempt to send the message to the 3G IP address or the cellular IP address that may not be within the LAN. The message may get discarded and the wireless terminal device may not receive a response to the ICMP Echo Request message. As such, in one embodiment, the terminal device may learn about or determine an existence of the CGW by receipt or non-receipt of an ICMP Echo Response. There may be multiple ways for the wireless terminal to know it may be in the presence of a CGW. For example, the wireless terminal may sense the ARP request from the CGW with the 3G IP address and then know that the CGW may exist.

Other features that may be provided and/or used may include a logical interface (LIF) and/or a control plane application server and/or client. According to an example embodiment, the LIF may accept downlink packets from a CGW and send uplink packets to a CGW. Additionally, in embodiments, a control plane application may be provided and may be used to perform measurements of characteristics of the transports (e.g. throughput, round trip time, and the like) and may further be used to provide and/or accept feedback to and/or from the CGW of such characteristics (e.g. to the CGW). Additionally, MIH information and event service information may be used and/or evolved to support and/or be used in, for example, the control plane application.

A segregation policy and segregation policy dissemination may be additional features that may be provided and/or used (e.g. in a CGW and/or wireless terminal device). In an example embodiment, a policy that may be used for segregation may include one or more of the following parameters: a UE ID; a segregation enable/disable indicator or indication; a DL policy; an UL Policy; and the like. The DL policy may provide one or more of the following parameters: a UE Relative Priority; a default interface or RAT (e.g., cellular, Wi-Fi, no preference, and the like); services; thresholds such as override thresholds; and the like. According to an example embodiment, the services parameter may identify the number of services and, for each service, the type, preference (e.g., cellular, Wi-Fi, no preference, and the like), and relative priority may be identified. The DL policy may also include and establish thresholds such as override thresholds, including a bits/sec rate for cellular, a bits/sec rate for Wi-Fi, a bits/sec rate for cellular differential, and a bits/sec rate for Wi-Fi differential.

The UE ID parameter may include an IMSI or other suitable identifier of a device or wireless terminal device. Additionally, the Segregation Enable/Disable parameter may be used to either enable or disable the segregation functionality in the CGW for a particular user and/or device or wireless terminal device such that segregation may be disabled via a network based policy.

For downlink data, a CGW may use the relative priority of a device or wireless terminal device to decide or determine which order to service the packets associated with the device or wireless terminal device. Additionally, in an embodiment, for downlink data, there may be a default policy that may indicate which transport(s) to use before DPI may be able to determine how to segregate a flow of data or if DPI may not be able to identify a flow. For the service parameters, the type of service, the preferred transport and the relative priority may be included.

After flows may be or may have been tagged, the flows may be serviced in relative user and service priority order. In an embodiment, there may be no services listed if the default policy may be used. Additionally, the thresholds such as the override thresholds may be used to adjust which transports may be used to send data. For example, the CGW may measure the performance of the different transports and, in conjunction with the thresholds, adjust which transport may be used to deliver data to a device or wireless terminal device.

As described above, the segregation policy may be disseminated (e.g. a feature may include dissemination of the segregation policy). For example, in an embodiment, a policy for each terminal device may be stored locally in the CGW. As such, the CGW may be configured to accommodate multiple policies and/or one per terminal device. When a wireless terminal device such as a cellular device including a 2G device, 3G device, 4G device, and the like may register through a HNB to a MCN, the CGW may use the IMSI to “read in” the policy stored locally for that specific device. The CGW may have this table stored locally as the “Segregation Policy” table. In some embodiments, a policy may be delivered to the terminal device from the CGW. Additionally, if no policy may be available for a specific device or user, a default policy may be used.

Another feature that may be provided and/or used herein may include deep packet identification and/or flow identification. For example, in one embodiment, when a downlink flow starts, the CGW performs packet inspection to identify the flow type as there may be distinct types of data and flow types over the Internet. Table 5 may identify groups of Internet traffic.

TABLE 5

| Type | Detailed Type |
|---|---|
| Data (video or data) | HTTP |
| File Sharing | P2P |
| File Sharing | Web Based |
| Online Video | Streaming |
| Online Video | Flash |
| Online Video | Streaming P2P |
| Online Video | Audio |

The data types (e.g. shown in Table 5) may account for about 95% of Internet traffic such that the CGW (or other components) may identify one or more of these data types for segregation. In an embodiment, three types of “flows” including HTTP video, streaming video, and/or FTP may be identified and/or tagged in the CGW. Additionally, other types of data that may or may not be in in Table 5 may be identified and/or tagged in the CGW.

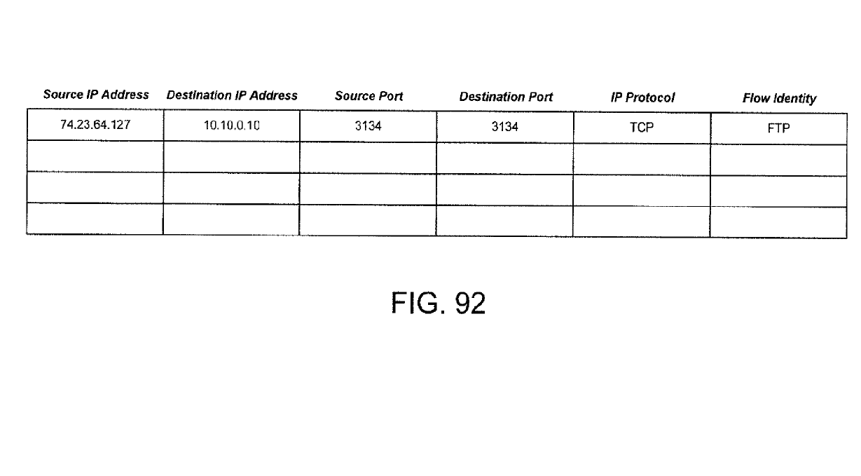

In some embodiments, within the CGW, DPI may be run on downlink packets that may not be part of flows that may have either been classified as a specific type or classified as unknown. Once the DPI functionality within the CGW may be able to identify a 5-tuple as a specific type of data, CGW and/or the DPI functionality included therein may record this as an entry in the “Downlink Flow Routing” table. An example Downlink Flow Routing table may be shown in FIG. 92 with one row populated with example data.

According to an embodiment, if the DPI (e.g. in the CGW) may look at a flow and may not be able to determine the type of data, the DPI and/or the CGW may record this flow as unknown in the table. Regardless of the DPI functions ability to identify a flow, the segregation functionality may use such information (e.g. 5-tuple and flow identity from the DPI function) to route packets. Periodically, the CGW may parse the Downlink Flow Routing table to remove stale information. In various embodiments, the CGW may perform no packet inspection for uplink data.

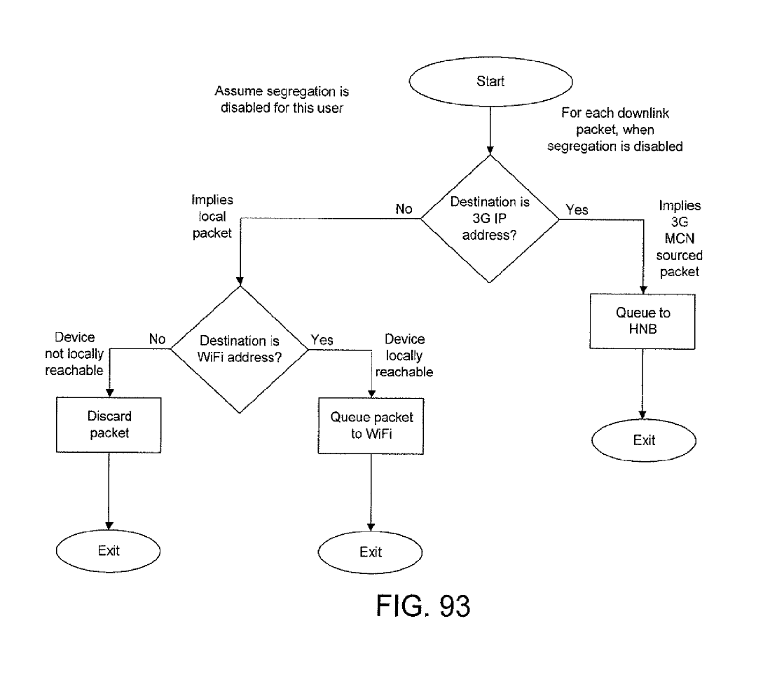

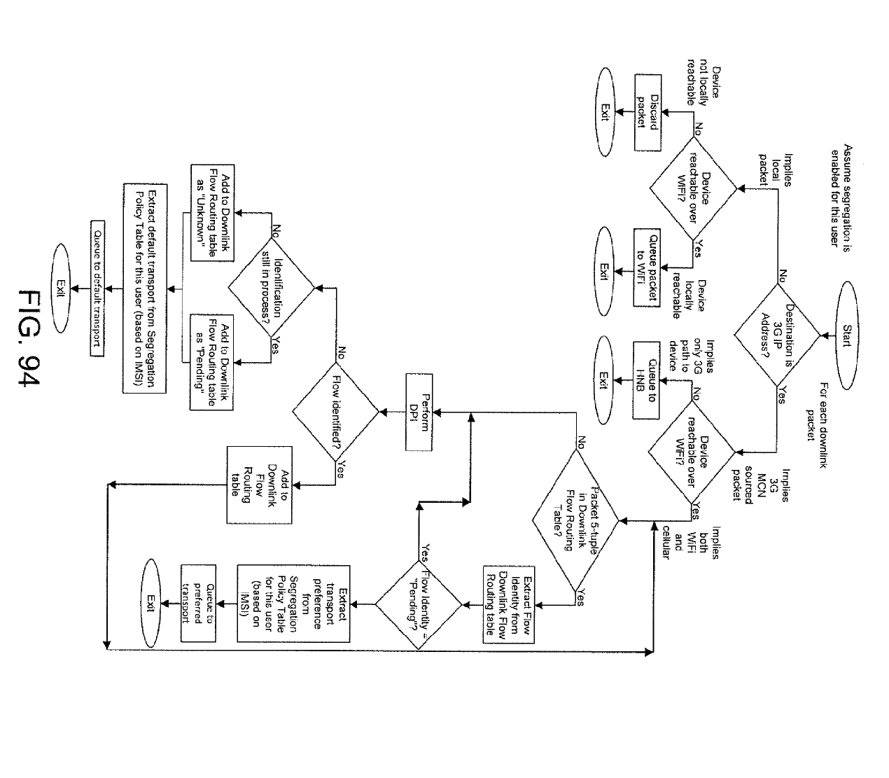

Packet tagging and/or delivery may be yet another feature that may be provided and/or used. For example, in some embodiments, packets that may be destined for a device or wireless terminal device that may have segregation enabled within the policy may be reviewed. Otherwise, such packets may be sent based on destination addresses within the packets themselves. For example, if segregation may be disabled and a packet may arrive in a CGW with a cellular (e.g. 3G) destination address, the packet may be sent to the HNB for delivery to the device or wireless terminal device. Furthermore, if a packet may arrive in the CGW with a destination address on a LAN, the packet may be routed onto the LAN for delivery to the device or wireless terminal device. An example of such functional logic may be shown in FIG. 93 and an explanation of the routing may be described in table form as shown in Table 6 below.

TABLE 6

| | | Available | How delivered |
|---|---|---|---|
| Segregation | Destination Address | Interfaces | to device |
| Disabled | 3G IP address that | 3G | Via HNB |
| | may be assigned by | | |
| | MCN | | |
| Disabled | 3G IP address that | Both 3G | Via HNB |
| | may be assigned by | and Wi-Fi | |
| | MCN | | |
| Disabled | 3G IP address that | Wi-Fi | Discarded |
| | may be assigned by | | |
| | MCN | | |
| Disabled | Wi-Fi address that | 3G | Discarded |
| | may be assigned by | | |
| | DHCP Server within | | |
| | CGW | | |
| Disabled | Wi-Fi address that | Both 3G | Via Wi-Fi AP |
| | may be assigned by | and Wi-Fi | |
| | DHCP Server within | | |
| | CGW | | |
| Disabled | Wi-Fi address that | Wi-Fi | Via Wi-Fi AP |
| | may be assigned by | | |
| | DHCP Server within | | |
| | CGW | | |

An example of functional logic when segregation may be enabled may be shown in FIG. 94 and an explanation of the routing may be described in table form as shown in Table 7 below. For example (as shown in Table 7 and FIG. 94), when a downlink packet may be destined for a device or wireless terminal device, a CGW may determine whether or not the destination may be reachable via either a Wi-Fi or 3G connection. If a destination may be reachable over one connection (e.g. it may have either a cellular such as a 3G connection or a Wi-Fi connection, but may not have both), the packet may be dispatched via that connection. If a destination may be reachable over multiple connections (e.g. both a cellular and Wi-Fi connection), the packet to be delivered may be tagged (or attempted to be tagged) and may then be delivered over the transport indicated in a policy (e.g. associated with the user and/or the device thereof). If a packet may be part of an already identified flow, that packet may be dispatched based on its 5-tuple and/or policy (e.g. the user policy or device policy). If a packet may not be part of an existing flow, the DPI function (or other flow identification technique) may be invoked (e.g. by the logic in FIG. 94) in an attempt to classify it. If the DPI may be successful in identifying the type of flow, the 5-tuple and the type may be noted for future use and the packet may be routed as per the user policy for this specific type of traffic. If DPI may not yet be successful, the 5-tuple may be noted as “pending” and the packet may be routed as per the default policy for the user and/or device. If DPI may determine or decide that it may not identify the flow, the 5-tuple may be noted as “unknown” for future use and the packet may be routed as per the default policy for the user and/or device. The DPI may also determine or decide (e.g. after examining some number of packets in a specific 5-tuple flow and being unable to classify the flow) that the DPI may not classify the flow and, as such, the flow may be marked as “unknown.”

TABLE 7

| | Destination | Available | How delivered |
|---|---|---|---|
| Segregation | Address | Interfaces | to device |
| Enabled | 3G IP address that | 3G | Via HNB |
| | may be assigned by | | |
| | MCN | | |
| Enabled | 3G IP address that | Both 3G | CGW may determine |
| | may be assigned by | and Wi-Fi | based on policy for |
| | MCN | | specific user and type |
| | | | and an ability of CGW |
| | | | to identify packet as |
| | | | belonging to a specific |
| | | | type or IP flow. |
| Enabled | 3G IP address that | Wi-Fi | Discarded |
| | may be assigned by | | |
| | MCN | | |
| Enabled | Wi-Fi address that | 3G | Discarded |
| | may be assigned by | | |
| | DHCP Server within | | |
| | CGW | | |
| Enabled | Wi-Fi address that | Both 3G | Via Wi-Fi AP |
| | may be assigned by | and Wi-Fi | |
| | DHCP Server within | | |
| | CGW | | |
| Enabled | Wi-Fi address that | Wi-Fi | Via Wi-Fi AP |
| | may be assigned by | | |
| | DHCP Server within | | |
| | CGW | | |

After the foregoing may be performed, prioritization of the downlink packets within each queue may occur. In an embodiment (e.g. after prioritization), there may be a set of data that may be delivered to a HNB for delivery to a device or wireless terminal device over a cellular connection or interface and there may be another set of data that may be delivered to the Wi-Fi AP for delivery to the device or wireless terminal device over a Wi-Fi connection. If there may be a small amount of data, prioritization may not be performed. However, if there may be an abundance of data, the data may be prioritized based on relative priorities of the user and/or by type.

In an embodiment, the packets that may be queued to be delivered to a device or wireless terminal device may be prioritized first by the user relative priority and then by service type relative priority. For example, if two users and devices associated therewith may both have packets that may be waiting to be delivered, the packets may be pushed through the transport based on their relative user or device priorities. If the first user may have a higher relative priority than the second user, the data associated with the first user may be given priority over the data associated with the second user. However, while the first user may be given priority, the first user may not be given priority to the point where the second user may be starved. As such, in an embodiment, the CGW may engage in a form of fair queuing that may ensure that no user may be starved. Conversely, if the second user may have a higher relative priority, the CGW may behave similar to that described above (e.g. the second user may be given priority over the first, but may not be given priority to the point where the first user may be starved). If both users may have the same relative priority, the CGW may randomly determine or decide which user to prioritize while ensuring that no user may be starved.

For example, two users and/or the devices associated therewith may have unique policies as follows. The policy for the first user (e.g. user 1) may establish a user relative Priority of 1; a cellular default; and may identify the following services: FTP, Cellular, Relative Priority 1; HTTP video, Wi-Fi, Relative Priority 2; and Streaming Video, Wi-Fi, Relative Priority 3. The policy for the second user (e.g. user 2) may establish a user Relative Priority of 10; a Wi-Fi default; and may identify the following services: FTP, Wi-Fi, Relative Priority 1; HTTP video, Wi-Fi, Relative Priority 2; and Streaming Video, Cellular, Relative Priority 3.

In an embodiment, both users may be streaming HTTP video through the CGW and each user (e.g. user 1 and user 2) may have both their Wi-Fi and cellular connections available. After downlink packets may be queued to be delivered over the Wi-Fi connection to each device, the downlink packets may be prioritized based on each user's priority relative to the other. In such an embodiment, since user 1 may have a higher priority than user 2, packets that may be waiting to be delivered to user 1 may be pushed out of the CGW before packets that may be waiting to be delivered to user 2 as long as user 2 may not be starved of bandwidth.

According to another embodiment, user 1 may be downloading an HTTP video and downloading a file via FTP at the same time. Both HTTP video and FTP packets may be queued to be delivered to user 2 within the CGW. Since FTP may have a higher priority than HTTP video within the policy associated with user 2, the FTP packets may be pushed out of the CGW before the HTTP video packets as long as the HTTP video may get some bandwidth so as to not be starved.

Additionally, for uplink packets that may be received at the CGW (e.g. from the user 1 or user 2 and/or the devices associated therewith), no packet tagging may occur and packets may be routed by the CGW towards the MCN or the public Internet.

Other features that may be provided and/or used as described herein (e.g. by a CGW) may include IP routing, a NAT function, and/or a DHCP server. For example, in an embodiment, the CGW may act as a de-facto router within the LAN such that upon receipt of a packet, the CGW may look at the destination and may determine or decide where to route the packet. Additionally, in another embodiment, the CGW may have a NAT function. For example, when packets may traverse between a LAN within a premise and an ISP Modem, a NAT function that may be included within the CGW may perform public and/or private address translation to facilitate the arrival of packets at their destinations. In yet another embodiment, the CGW may have or include a DHCP Server. For example, when a device on a LAN may request a local IP address, the DHCP Server that may be included within the CGW may provide that address and may provide its local IP address as the Default Gateway.

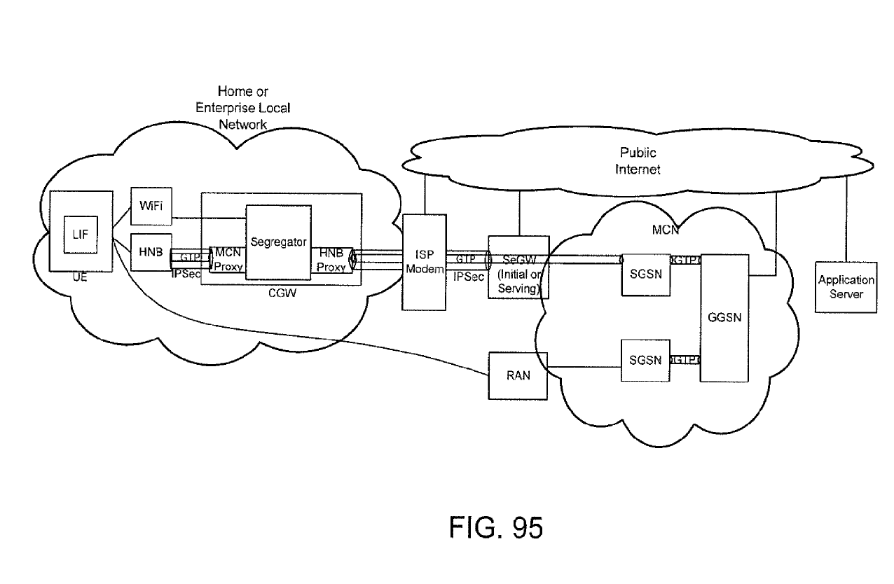

Cellular mobility such as 3G mobility that may include outbound mobility and/or inbound mobility may also be provided and/or used (e.g. as a feature of the CGW). Outbound mobility that may be provided and/or used as described herein may be a mobility where a device or wireless terminal device that may be attached to a HNB may be handed-over to a macro cell RNC as shown in FIG. 95. As part of initial stages of a handover procedure, a Wi-Fi connection that may be part of an IFOM “session” between a device or wireless terminal device and CGW may end. Additionally, the CGW may recognize specific signals that may be exchanged during a handover between a HNB and a MCN realizing that a handover may be occurring. Upon identifying the specific signals during the handover process, the CGW may further remove the Wi-Fi interface from the list of possible interfaces that a segregator may use for downlink traffic. In an embodiment, once a Wi-Fi interface may be removed, the cellular (e.g. 3G) interface may be available. Additionally, once the handover (e.g. the handover procedure) may conclude, a device or wireless terminal device may attempt to locate a segregator as described above.

According to an example embodiment, information or details of the signaling and which signals a CGW may be cognizant of may be when the handover is from one HNB to another. For example, when a source HNB may determine or decide that it may attempt to perform a handover to another HNB (e.g. a target HNB), the source HNB may signal this to a HNBGW and SGSN via, for example, RANAP Relocation Required message. The CGW may then enable or allow this message to pass through to the MCN. The HNBGW and SGSN may signal the handover to the target HNB via the RANAP Relocation Request message. The target HNB may then respond with a RANAP Relocation Request Acknowledgement message. In an embodiment, once a device or wireless terminal device may be synchronized to the target HNB, the target HNB may send a RANAP Relocation Detect and RANAP Relocation Complete message to the HNBGW and SGSN. Once the handover may be completed, the HNBGW and SGSN may inform or tell the source HNB to release the radio resources that may be assigned to an end-wireless terminal device by sending a RANAP Iu Release Command signal or message. Such a signal or message may pass through the CGW as it may travel from the HNBGW and SGSN to the source HNB. As such a signal or message may pass through the CGW, the CGW may remove the Wi-Fi interface from the IFOM “session” between the CGW and the device or wireless terminal device. Since the RANAP Iu Release Command may be encapsulated within a RUA message, it may include the context ID of the device or wireless terminal device such that this may be used as a key within the Device Linkage table to remove the associated Wi-Fi interface that may be no longer reachable by a cellular IP address such as a 3G IP address. However, the end-to-end session between the application client and application server may remain intact. Additionally, once the source HNB may have released the radio resources, the source HNB may send a RANAP Iu Release Complete to the MCN.

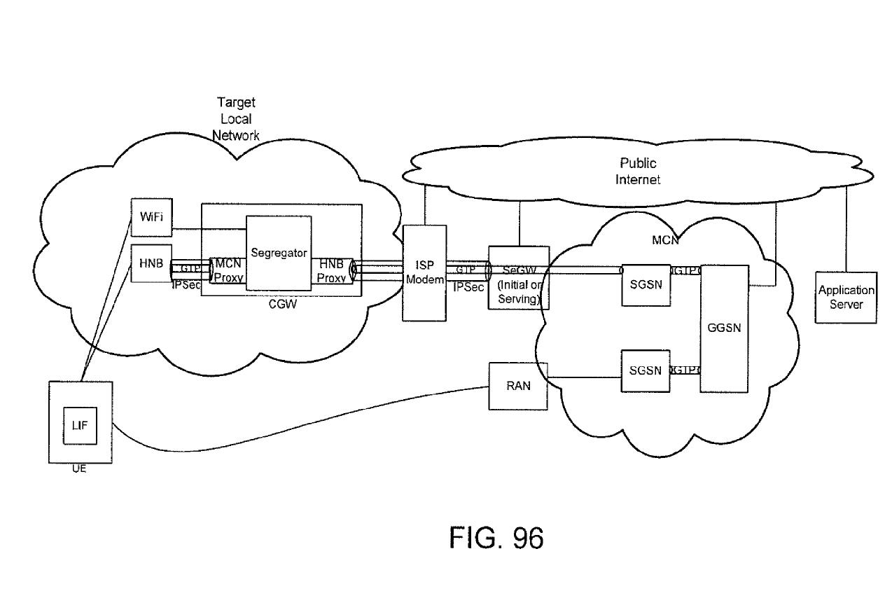

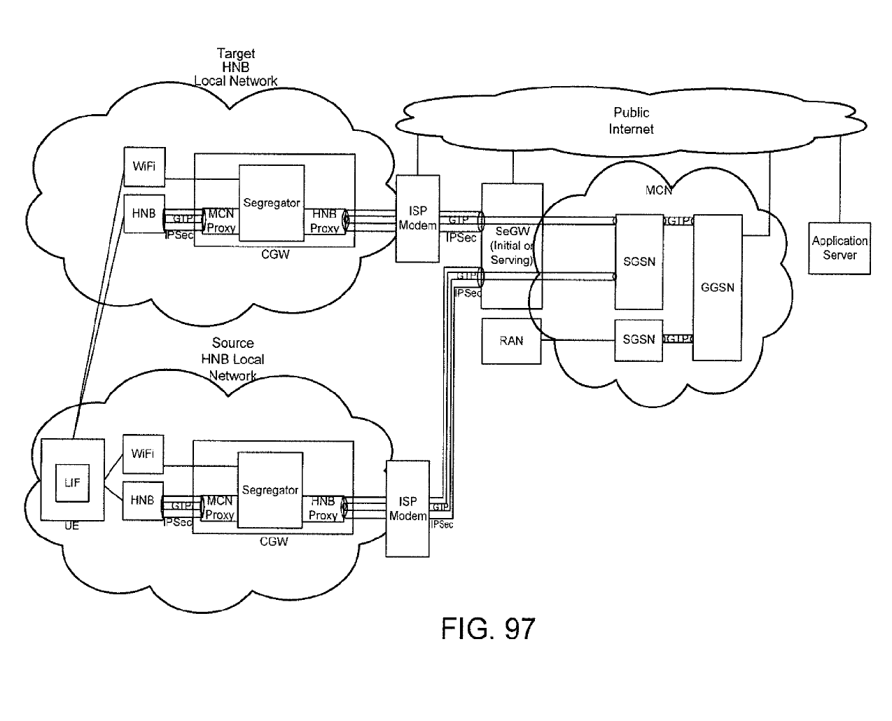

Inbound mobility that may be provided and/or used as described herein may be a mobility where a device or wireless terminal device may move from a macro cell environment or another HNB to a target HNB as shown in FIG. 96 and FIG. 97 respectively. If the target HNB may not be connected to a CGW, cellular mobility such as 3G mobility may occur organically such that the IP address that may be assigned to the device or wireless terminal device may be a MCN assigned IP address that may remain with the device or wireless terminal device as it may hand over from the macro environment to the HNB environment. If the target HNB may be connected to a CGW, cellular mobility such as 3G mobility may occur normally and the CGW may act as a HNB Proxy towards the MCN and as a MCN Proxy to the HNB. After the handover may have occurred, the device or wireless terminal device may attempt to locate a CGW via a CGW discovery procedure. If the discovery may be successful, the device or wireless terminal device may be reachable via both the cellular (e.g. 3G) and Wi-Fi connections.

Another feature that may be provided and/or used (e.g. by the CGW) may include transport selection and/or availability. For example, a connection manager may enable or allow an end user some control over which connections may be available. Therefore, in various embodiments, the connection manager may allow the user perform one or more of the following: to disable and/or not use a Wi-Fi device which may have the effect of turning off the Wi-Fi device; to disable and/or not use the cellular (e.g. 3G, and the like) device which may the effect of turning off the cellular device; to enable and/or use the Wi-Fi device; to enable and/or use the cellular device; and the like.

According to additional embodiments, a HNB proxy and/or a MCN proxy may be provided and/or used as features (e.g. by a CGW). For example, a MCN Proxy may satisfy an interface to a HNB. The MCN proxy may provide a GTP tunnel endpoint for GTP tunnels that may be established by the HNB towards the CGW similar to GTP tunnel capabilities that may be provided by a SGSN. Furthermore, the MCN proxy may provide an IPSec tunnel endpoint for an IPSec tunnel that may be established by the HNB towards the CGW similar to the IPSec tunnel capabilities that may be provided by a SeGW. Additionally, a HNB proxy may satisfy an interface to a MCN. The HNB proxy may provide a GTP tunnel endpoint for GTP tunnels that may be established with the SGSN similar to GTP tunnel capabilities that may be provided by a HNB. Furthermore, the HNB proxy may provide an IPSec tunnel endpoint for an IPSec tunnel that may be established with the SeGW similar to IPSec tunnel capabilities that may be provided by a HNB.

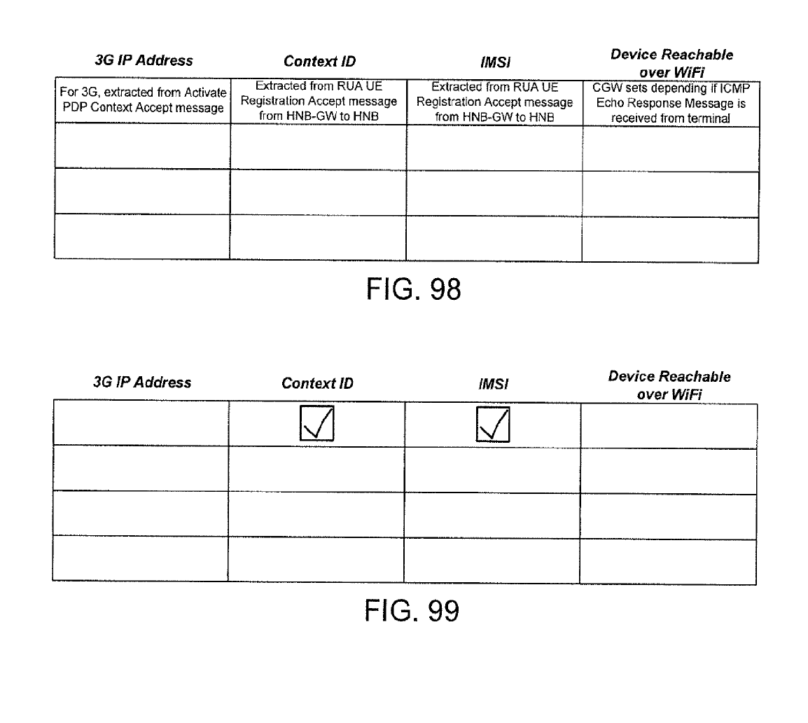

As described above, a segregator may be provided and/or used (e.g. by a CGW that the segregator may be included in). The Segregator may maintain a “Device Linkage” table that may include (e.g. for each device or wireless terminal device) a cellular IP address such as a 3G IP address, Context ID, IMSI, whether the device may reachable over Wi-Fi, and other relevant information. An example of a Device linkage table and/or information that may be included therein may be shown in FIG. 98. In an example embodiment, 3G devices and dual mode devices (e.g. devices that may support a Wi-Fi and cellular interface or RAT) may be listed in such a table. For a cellular device (e.g. a 3G device) that may have an active PDP context, the cellular IP address or 3G IP address, Context ID and IMSI fields may be populated. For a cellular (e.g. a 3G) device without a PDP Context, the Context ID and IMSI fields may be populated. When a cellular modem (e.g. or interface or RAT) such as a 3G modem of a device or wireless terminal device may connect to a HNB, the HNB may register the UE with a HNB-GW by providing the IMSI. The HNB-GW may assign a context ID to uniquely identify the device. According to an example embodiment, RUA signaling between the HNB and HNB-GW may use the context ID. This may also include RANAP messages between the HNB and the MCN that may be encapsulated by RUA and NAS messages between the MCN and the UE encapsulated within RANAP messages (e.g. which may then be encapsulated by RUA messages). After the registration of the UE with the HNB-GW, the information that the segregator may include or possess may be shown in FIG. 99.

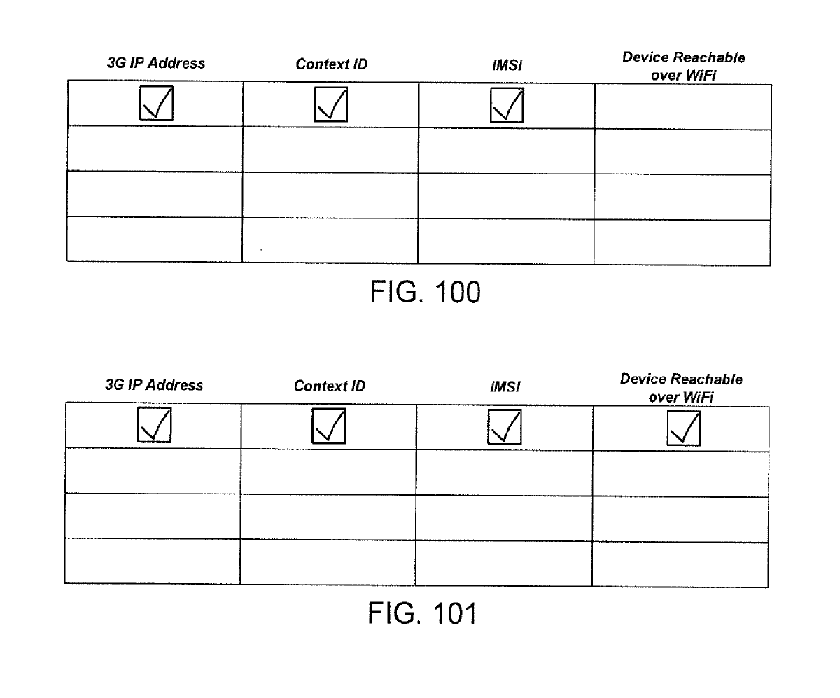

The PDP context may then be set up. When an Activate PDP Context Accept message may be sent from the SGSN to the UE, the Active PDP Context Accept message may include an IP address assigned to the cellular (e.g. 3G) connection. The Active PDP Context Accept message may also be encapsulated within a RUA Direct Transfer message that may have the context ID assigned to the device or wireless terminal device. If a CGW may examine such a message, the CGW may learn the IP Address that may be assigned by the cellular (e.g. 3G) network and may know which wireless terminal device it (e.g. the IP address) may be assigned as shown in FIG. 100. At this point, a determination (e.g. by the CGW) may be made regarding whether a cellular IP address such as a 3G IP address may also be reachable via the local Wi-Fi connection.

Then, in an embodiment, the Wi-Fi card within a device or wireless terminal device may associate with a local Wi-Fi AP and may be assigned a local IP address. After requesting a local TP address from the DHCP Server within the CGW, the CGW may send an ARP Request message to the cellular (e.g. 3G) IP address. If the device or wireless terminal device may have both Wi-Fi and cellular active, the Wi-Fi within the device or wireless terminal device may respond. If the terminal device may not have the cellular active (e.g. the 3G active), the Wi-Fi within the device or wireless terminal device may not respond. Depending on receiving or not receiving an ARP Response message from the device or wireless terminal device, the CGW may set the “reachable” field as shown in FIG. 101.

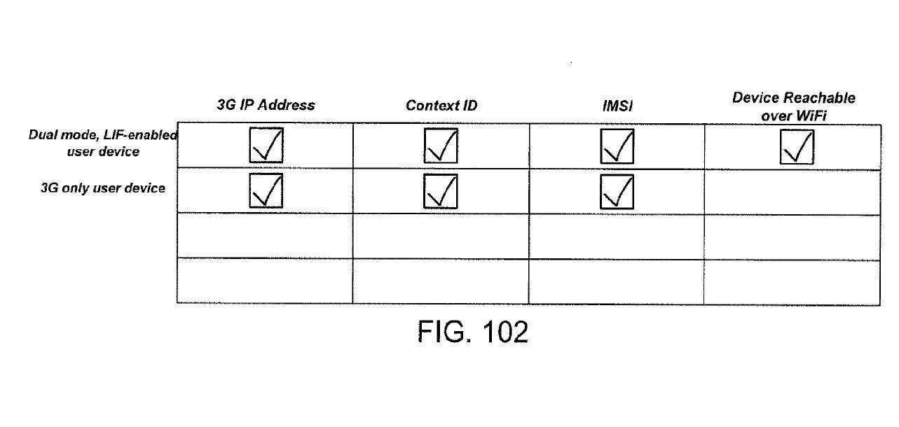

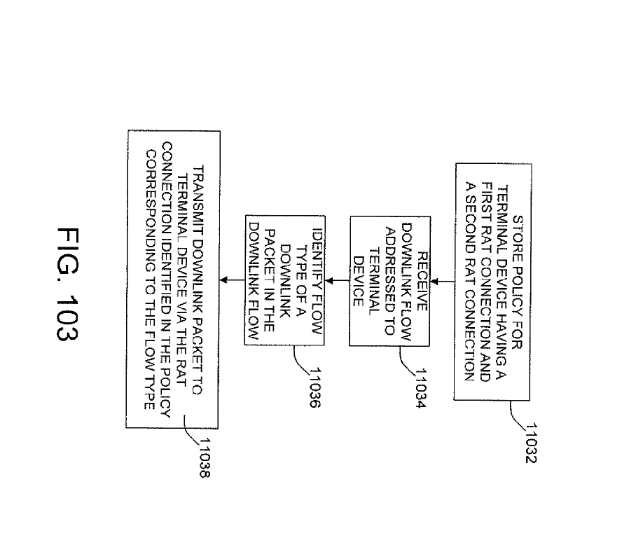

Additionally, according to an example embodiment, the CGW may periodically perform maintenance on such a list. For example, if a device or wireless terminal device may not have both interfaces or connections (e.g. Wi-Fi and cellular connections), parts of the table may be filled out or populated as described above for the specific device as shown in FIG. 102.

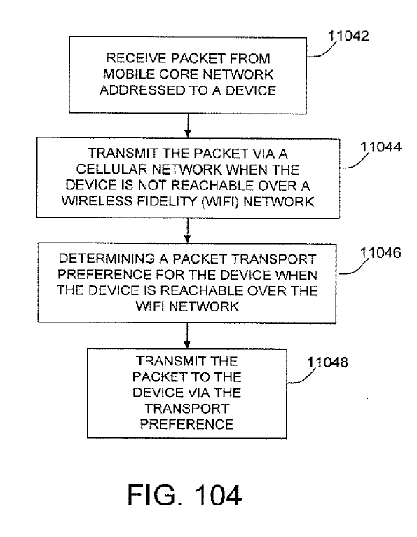

FIGS. 103 and 104 depict flow charts of example methods for segregating a flow of data. As shown FIG. 103, at 11032 a policy for a terminal device may be stored where the terminal device may have a first interface or radio access technology (RAT) connection and a second interface or RAT connection (e.g. a Wi-Fi and cellular connection). At 11034, a downlink flow addressed to the terminal device may then be received. At 11036, the flow type of a downlink packet in the downlink flow may be identified. At 11038, when the terminal device may be reachable by both the first and second RAT connections, the downlink packet may be transmitted to the terminal device via the transport RAT identified in the policy corresponding to the flow type. Referring to FIG. 104, at 11042 a packet may be received from a mobile core network addressed to a device where the packet may include or have a cellular (e.g. a 3G) IP destination address. At 11044, when the device may not be reachable over a Wireless Fidelity (Wi-Fi) network, the packet may be transmitted via a cellular network. At 11046, when the device may be reachable over the Wi-Fi network, a packet transport preference for the device may be determined. At 11048, when the device may be reachable over the Wi-Fi network, the packet may be transmitted to the device via the transport preference where the transport preference may be one of the cellular network and the Wi-Fi network.

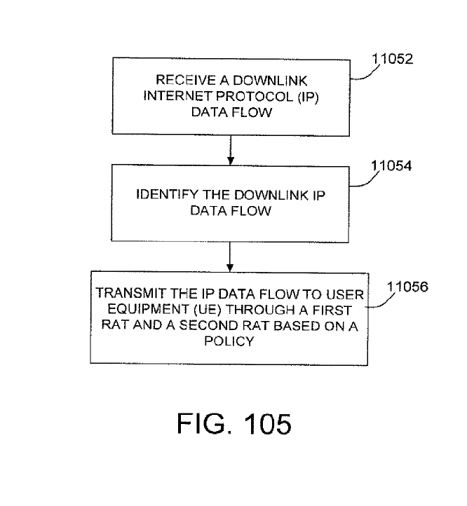

FIG. 105 depicts a flow chart of example method for aggregating bandwidth. At 11052, a downlink Internet Protocol (IP) data flow may be received. At 11054, the downlink IP data flow may be identified and, at 11056, the IP data flow may be transmitted to user equipment (UE) through a first interface or RAT and a second interface or RAT (e.g. a Wi-Fi and a cellular interface or RAT) based on a policy.

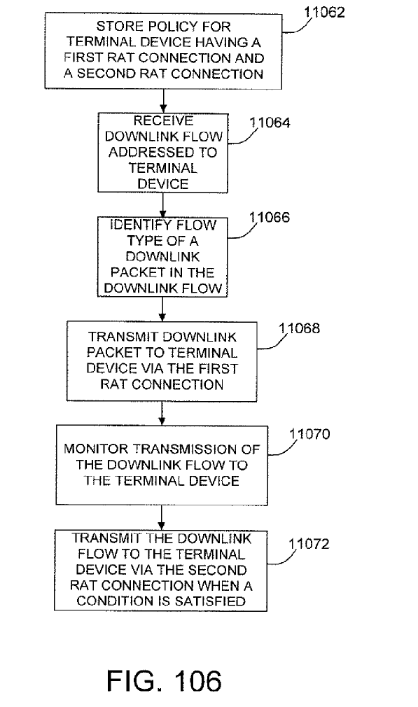

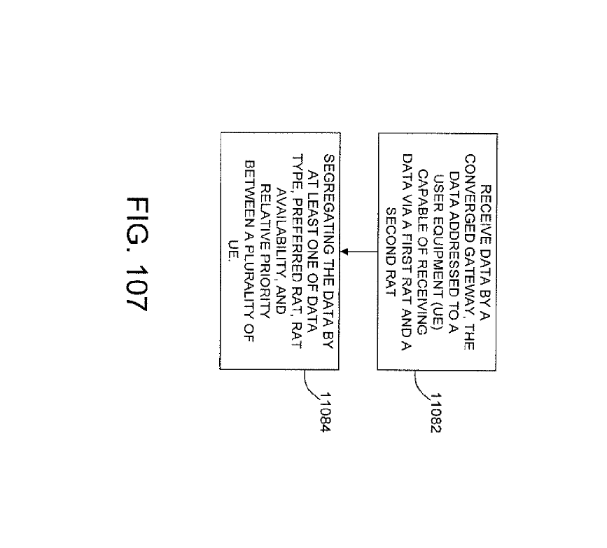

FIG. 106 depicts a flow chart of an example method for dynamic flow mobility. At 11062, a policy for a terminal device may be stored. The terminal device may have a first interface or RAT connection and a second interface or RAT connection (e.g. a Wi-Fi and cellular connection). At 11064, a downlink flow that may be addressed to the terminal device may be received. The downlink flow may include a downlink packet. At 11066, a flow type of a downlink packet may then be identified. At 11068, the downlink packet to the terminal device may be transmitted via the first interface or RAT connection. At 11070, the transmission of the downlink flow to the terminal device via the first interface or RAT connection may be monitored. At 11072, when a condition may be satisfied, the downlink flow may be transmitted to the terminal device via the second interface or RAT connection.

FIG. 107 depicts a flow chart of an example method for segregating a flow of data. As shown in FIG. 107, at 11082, data may be received by a converged gateway (CGW). The data may be addressed to a user equipment (UE) capable of receiving data via a first interface or RAT and a second interface or RAT (e.g. Wi-Fi and cellular). At 11084, the data may be segregated by at least one of data type, preferred interface or RAT, interface or RAT availability, and relative priority between a plurality of UEs.

The systems and methods described herein (e.g. the CGW) may further support and/or provide various mechanisms to perform IP Flow Segregation such as Dynamic Flow Management (DFM) (e.g. moving a given IP Flow from one physical transport to another) and Dynamic Flow Aggregation (DFA) (e.g. splitting a given IP Flow over multiple transports for a bandwidth “boost”). For example, in an embodiment, the IP Flow Segregation may be performed within a Mobile Core Network (MCN) such as an LTE MCN that may include a node, or collection of nodes including a Converged Gateway (CGW) that may perform or implement the IP Flow Segregation. IP Flow Segregation (e.g. bandwidth management) may be the ability to send an IP Flow to a destination over a policy-defined interface. The transport selections, however, may not remain identical for the life of IP Flows once the IP Flows may each be identified as being a specific type. As such, IP Flow Mobility may be induced for the IP Flows (e.g. some or all of the IP Flows) based on conditions such as, for example, throughput, content type, operator policy, local environment operating conditions, subscription plan of a user, power usage policies of the WTRU, available access points, and the like with the ability to seamlessly move an IP Flow between interfaces or RATs via the CGW located within the MCN. For example, the data to be segregated may originally be destined to be delivered to a WTRU associated with the LTE network via an eNode B or a Home eNode B (HNB or HeNB). In accordance with the systems and methods described herein, the CGW may route (e.g., “offload”) at least a portion of the data to the WTRU via an alternative interface or RAT such as through a Wi-Fi access point, WiMAX access point, a Bluetooth interface, and/or other non-cellular radio access technology, for example.

In example embodiments, incorporation of the CGW within the MCN may provide one or more benefits. For example, from an end-user point of view, the CGW may provide a better user experience by realizing higher throughput and/or continued connectivity (e.g. even in the face of environmental factors such as interference). For the operator, the CGW that may rely on bandwidth management (BWM) may provide a premium service that may result in higher revenues and the offloading of traffic from an eNode B or HNB cellular infrastructure. In some example implementations, a MCN operator may offer a Wi-Fi access point to offload traffic from a HNB access point that may allow or enable the MCN operator control of the Wi-Fi access point into the home or enterprise. As such, in an embodiment, the MCN operator may become the provider of the Wi-Fi access point thereby allowing the operator to charge the home owner a premium. By using the CGW in coordination with a femtocell (e.g. a HNB or eNB), the femtocell may appear to be providing higher throughput from a user perspective. The femtocell may be able to deliver a certain maximum throughput and support a maximum number of users. With the addition of the CGW to the MCN, the HNB may appear to offer a higher throughput and may support more users. The added throughput may go through (e.g. traverse) the Wi-Fi transport, but from a user standpoint, a higher throughput may be enabled and more users can use the HNB.

According to example embodiments, the CGW may be incorporated into the MCN as a largely transparent entity relative to the other components of the MCN. For example, existing interfaces (e.g. the eNode B to SGW interface, eNode B to MME gateway, and the like) of the MCN may not be altered to accommodate the CGW. Instead, the CGW may generally serve as a pass-through for various control signaling of the MCN as described herein. In some embodiments, the CGW may also modify various control signaling as it passes through the CGW.

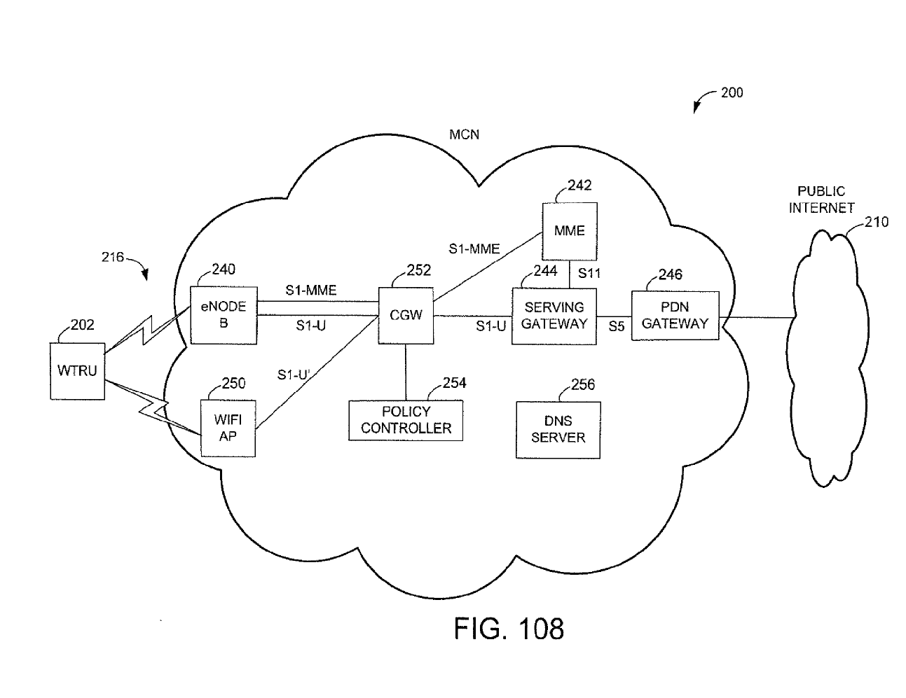

FIG. 108 illustrates a mobile core network (MCN) architecture such as an LTE MCN that may include a converged gateway (CGW) such as the CGW described herein. As shown in FIG. 108, a MCN 200 may include a CGW such as a CGW 252 that may support bandwidth management (BWM) such as dynamic flow management and dynamic flow aggregation at the MCN. BWM may be used to refer to various ways to control multiple, simultaneously active radio links between a WTRU and a MCN. For example, the multiple radio links may be a cellular radio link, a Wi-Fi radio link, and the like. The control schemes may include aggregation of the bandwidths provided by the individual radio links to serve a high bandwidth application that may not be able to be sustained by the individual links. The control schemes may include steering of individual traffic flows to different radio links, so that a better match may exist between or among the QoS, security and/or some other attribute of the radio link and the corresponding requirement of the traffic flow. The control schemes may further include switching over a traffic flow from one radio link to another in cases of failure and/or excessive degradation of a particular radio link. Additionally, the control schemes may include highly dynamic steering of individual traffic packets, for example, IP packets, across the multiple radio links in concert with the changing temporal fading characteristics of the radio links.

As shown in FIG. 108 (e.g. similar to FIG. 1C and/or 1D), the MCN 200 may include a mobility management gateway (MME) 242, a serving gateway 244, and a packet data network (PDN) gateway 246. While each of the foregoing elements is depicted as part of the MCN 200, it will be appreciated that any one of these elements may be owned and/or operated by an entity other than the core network operator. Additionally, as shown in FIG. 108, one or more WTRUs 202 may be in communication with the MCN 200 via various air interfaces 216. The WTRU 202 may be capable of using multiple transports. For example, the WTRU 202 may be in communication with one or more eNode Bs 240 and one or more Wi-Fi Access Points (APs) 250. The eNode B 240 may include one or more transceivers for communicating with the WTRU 202 over an air interface. In one embodiment, the eNode B 240 may implement MIMO technology. Thus, the eNode B 240, for example, may use multiple antennas to transmit wireless signals to, and receive wireless signals from, the WTRU 202. The eNode B 240 may be associated with a particular cell (not shown) and may be configured to handle radio resource management decisions, handover decisions, scheduling of users in the uplink and/or downlink, and the like. Although an eNode B 240 and Wi-Fi AP 250 may be illustrated in FIG. 108, it may be appreciated that the systems and methods described herein may be applicable to a variety of network architectures, including architectures having multiple eNode Bs and/or multiple APs (or other non-cellular radio access technologies).

In an example embodiment, as shown in FIG. 108, the CGW 252 may be positioned between the eNode B 240 and the MME 242 and the service gateway 244. The CGW 252 may also be associated with a policy controller 254 that may generally provide the CGW 252 with data routing policies. The high level components of the CGW infrastructure network may be separate entities or modules, however, commercial implementations of the generic architecture may combine various components for improved performance and reduced size/cost/energy consumption. To support the CGW functions, various nodes such as servers, databases, and/or storage facilities may be used. For example, the nodes may include: (1) personal media and/or data content; (2) identification and/or addressing registries; and/or (3) security and/or access control policies.

In an embodiment, the CGW 252 may appear as the eNode B 240 to (e.g. towards) the MME 242 and 244. Thus, the CGW 252 may support both a S1-U and S1-MME interface that the SGW 244 and MME 242 may maintain, respectively, with an eNode B. The CGW 252 may appear as a MME 242 and serving gateway 244 to (e.g. towards) the eNode B 240 and may support both the S1-U and S1-MME interface that the eNode B 240 may support. According to an example embodiment, neither the S11 nor S5 interfaces between the SGW and other MCN 200 components may be altered to support the addition of the CGS 252 to the MCN 200. Furthermore, MCN components may not be changed to support this architecture and the benefits it may provide. As such, the CGW 252 may be logically transparent to the other nodes of the MCN 200 in both the control plane and the data plane.

As illustrated in FIG. 108, the MME 242 may be connected to the eNode B 240 via an S1-MME interface routed through the CGW 252. As described above with respect to MME 142 shown in FIG. 1C, the MME 242 in FIG. 108 may be responsible for authenticating users of the WTRU 202, bearer activation/deactivation, selecting a particular serving gateway during an initial attach of the WTRU 202, and the like. The MME 242 may also provide a control plane function for switching between various radio technologies such as GSM or WCDMA.

The serving gateway 244 may be connected to the eNode B 240 via an S1-U interface routed through the CGW 252. As illustrated, the WTRU 202 may be in communication with a Wi-Fi AP 250. Additionally, the CGW 252 may be connected to the Wi-Fi AP 250 via an S1-U′ interface that may carry user traffic (e.g. offloaded data), as routed by the CGW 252. The relationship between the various S1-U interfaces, in accordance with one embodiment, may be represented as follows:

S1-U_{CGW/SGW}=S1-U_{eNode B/CGW}+S1-U′. (Equation 1)

As such, in an embodiment, the data coming from the serving gateway 244 to the CGW 252 via the interface connecting them may be selectively split between the S1-U interface between the CGW 252 and the eNode B 240 and the S1-U′ interface between the CGW 252 and the Wi-Fi AP 250.

A DNS Server 256 that may be within the MCN 200 may perform DNS queries to resolve hostnames and FQDNs to an IP address and the MCN 200 components may use this mechanism to discover other components within the MCN 200. While not illustrated in FIG. 108 for the purposes of simplicity and clarity, it may be appreciated that a DHCP server may be local to the MCN 200 that furnishes local IP addresses to those devices within the MCN.

In example embodiments, the DNS Server 256 may be configured such that queries to resolve a hostname or FQDN of “eNode B” (or equivalent) may return the local IP address of the CGW 252. Similarly, the DNS Server 256 may also be configured such that queries to resolve a hostname or FQDN of “MME” (or equivalent) may return the local IP address of the CGW 252. Alternatively, in some embodiments, the MME 242 and eNode B 240 may be configured to replace the hostname or FQDN of “eNode B” and “MME” (or equivalents) with “CGW.” Regardless, when a MME 242 may query for an eNode B, such a query may be directed to the CGW 252 and when an eNode B such as the eNode B 240 may query for a MME, such a query may be directed to the CGW 252.

As described above, the CGW 252 may support various types of data traffic. For example, the CGW systems and methods described herein may support the following: Circuit Switched (CS) voice, public Internet data traffic, and MCN value added traffic as described herein. The CGW 252 (e.g. and the systems and methods described herein) may also support policy-based static segregation for downlink IP flows such as HTTP video, streaming video, FTP, and VoIP, for example. According to embodiments, the CGW 252 (e.g. and the systems and methods described herein) may also support the ability to exclude transports such as Wi-Fi, cellular (e.g. 2G/3G/4G, and the like), or neither, for example, for packet switched data.

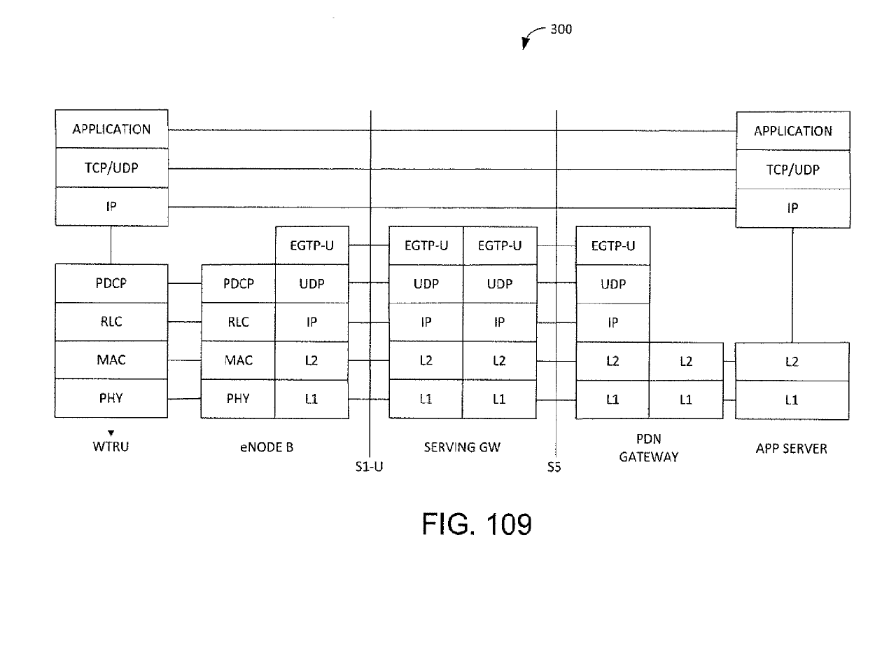

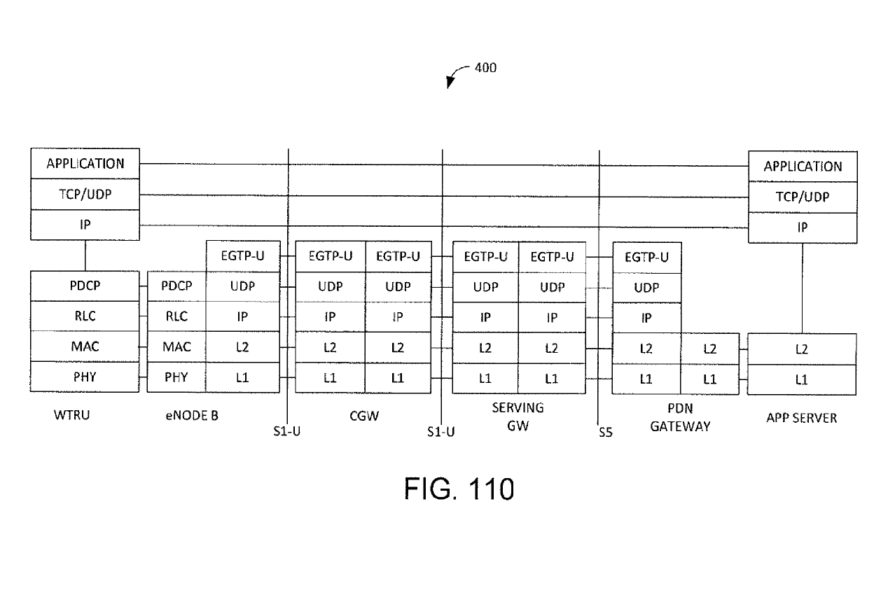

FIG. 109 depicts an example embodiment of a data plane 300 that may be between an SGW and an eNode B (e.g. such as the SGW 144 and eNode B 140a-c (FIG. 1C or 1D) and/or the SGW 244 and eNB 240) without a CGW. In comparison, FIG. 110 illustrates an example embodiment of a data plane 400 that may include a CGW positioned intermediate an eNode B and a serving gateway (SGW). As illustrated in FIG. 110, the data plane interface protocol to the SGW and the eNode B shown in FIG. 109 may be maintained. Thus, the eNode B and SGW may not be impacted with the insertion of the CGW.

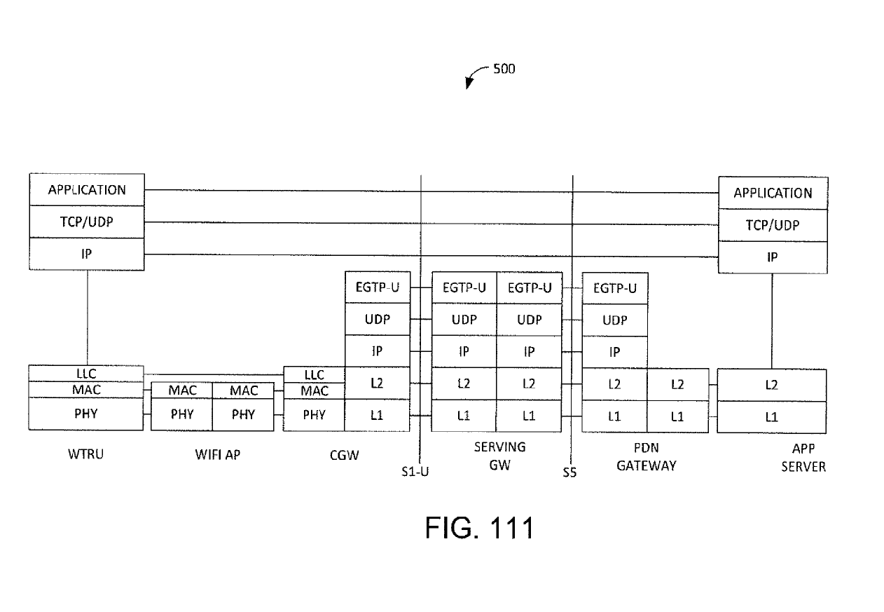

As a result of the DFM and/or DFA (e.g. that may be associated with BWM) that may be performed by the CGW, data between the SGW and the WTRU may be routed by the CGW through a non-cellular interface or RAT such as Wi-Fi. The protocol and/or transport associated with such an embodiment may be illustrated by a Wi-Fi data plane 500 shown in FIG. 111. As illustrated, the existing data plane interface protocol to the SGW may be maintained even with the presence of the CGW.

Referring to FIGS. 108, 110 and 111, for downlink data, a CGW such as the CGW 252 may determine or decide on a method to use to route or steer data to a user device such as the WTRU 202. For DFM, for example, the data may be routed via a Wi-Fi radio access technology or interface (or other non-cellular technology) and/or a cellular radio access technology or interface. For DFA, for example, the CGW such as the CGW 252 may determine a mix between one or more non-cellular radio access technologies or interfaces (e.g. Wi-Fi, WiMAX, Bluetooth, and the like) and cellular radio access technologies or interface to use. For uplink data, the CGW such as the CGW 252 may accept data from a device such as the WTRU 202 either from a Wi-Fi AP such as the Wi-Fi AP 250 or an eNodeB or HNB such as the eNode B 240 and may send it to a serving gateway such as the serving gateway 244. In another example embodiment, the CGW such as the CGW 252 may also accept data from other radio access technologies (e.g. non-cellular and cellular) and send it to a serving gateway such as the serving gateway 244.

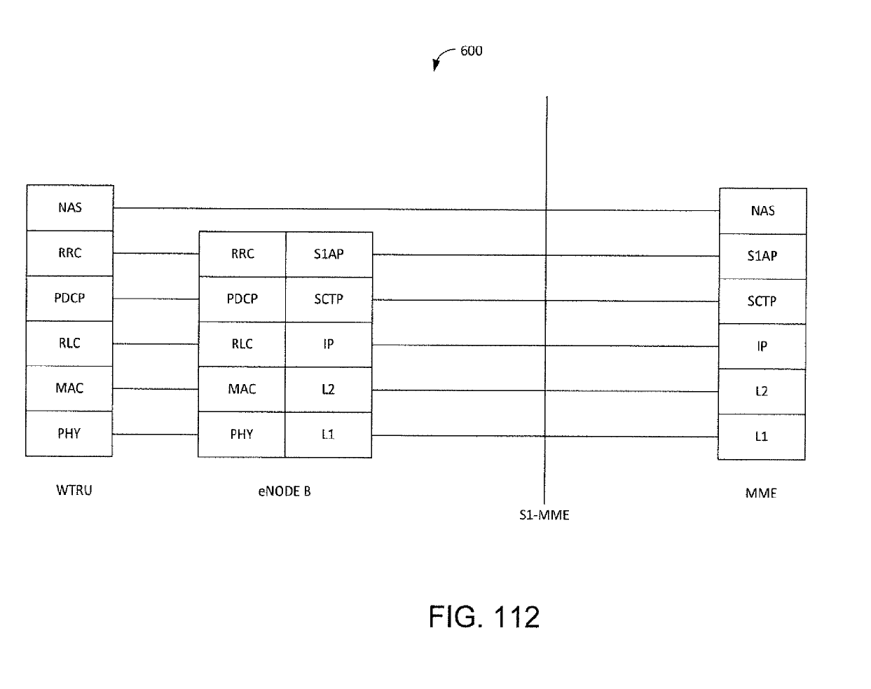

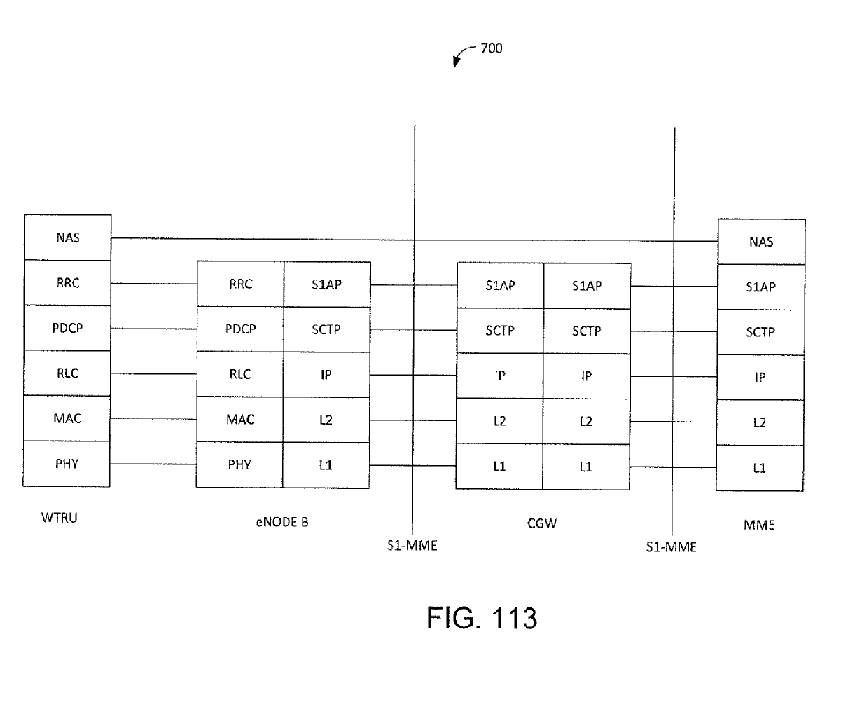

FIG. 112 illustrates an example embodiment of a control plane 600 between a MME and an eNode B (e.g. such as the MME 142 and eNode B 140a-c (FIG. 1C or 1D) and/or the MME 242 and the eNode B 240 (FIG. 108)) without a CGW. In comparison, FIG. 113 illustrates an example embodiment a control plane 700 such as a cellular control plane that includes a CGW positioned intermediate the eNode B and the MME. As illustrated in FIG. 113, the control plane protocol to the MME and the eNode B shown in FIG. 112 may be maintained in the presence of the CGW. Thus, in some embodiments, a control plane of the eNode B and MME may not be impacted with the insertion of the CGW.

According to example embodiments, a number of procedures and/or methods may be used for an establishment and maintenance of a connection between a MME and eNode B. Such procedures or methods (e.g. related to the establishment and maintenance of a connection between the MME and eNode B) may be separate and distinct from procedures and/or methods that may involve MME and eNode B interactions to support an actual UE or device connection. The systems and methods described herein may support non-UE specific procedures and/or methods including one or more of the following: Reset; Error Indication; S1 Setup; eNode B Configuration Update; MME Configuration Update; Overload Start; Overload Stop; Write Replace Warning; Kill; eNode B Direct Information Transfer; MME Direct Information Transfer; eNode B Configuration Transfer; MME Configuration Transfer; and the like.

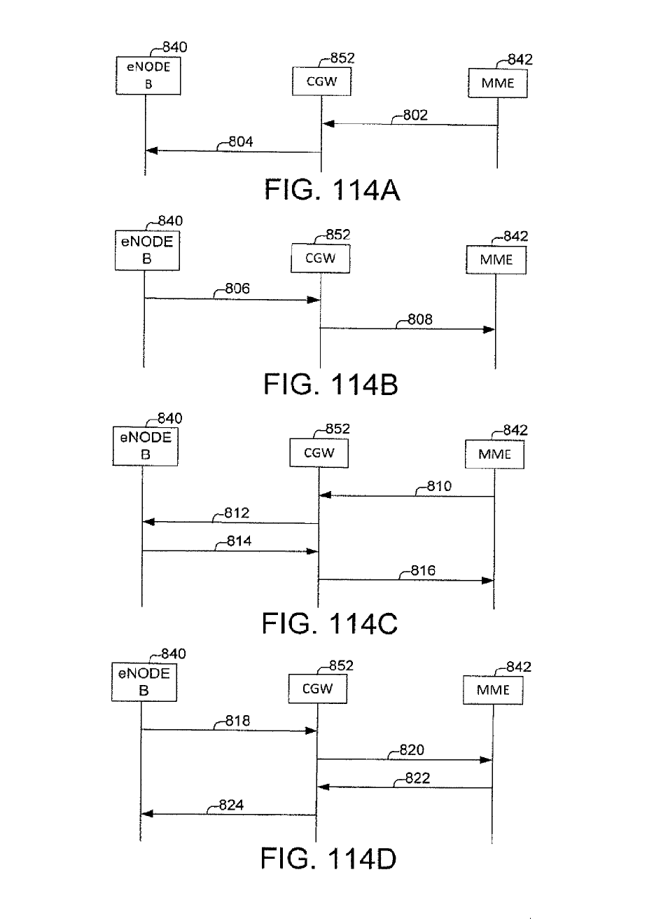

The systems and methods described herein (e.g. a CGW) may support one or more of the following paradigms (e.g. that may be associated with the aforementioned procedures, but may be unique in the associated signal names): a MME sending a signal to an eNode B, but no response from the eNode B; an eNode B sending a signal to a MME, no response from the MME; a MME sending a signal to an eNode B and the eNode B responding with a signal; an eNode B sending a signal to a MME and the MME responding with a signal; and the like as shown in FIGS. 114A, 114B, 114C and 114D. For example, as shown in FIG. 114A, a MME 842 may send a signal to an eNode B 840 with no response from the eNode B 840. As illustrated, a first signal 802 may be sent from the MME 842 to a CGW 852 and a second signal 804 may be sent from the CGW 852 to the eNode B 840. In FIG. 8B, the eNode B 840 may send a signal to the MME 842 with no response from the MME 842. As illustrated, a first signal 806 may be sent from the eNode B 840 to the CGW 852 and a second signal 808 may be sent from the CGW 852 to the MME 842. In FIG. 8C, the MME 842 may send a signal to the eNode B 840 and the eNode B 840 may respond with a signal. As illustrated, a first signal 810 may be sent from the MME 842 to the CGW 852 and a second signal 812 may be sent from the CGW 852 to the eNode B 840. In response, a third signal 814 may be sent from the eNode B 840 to the CGW 852 and a fourth signal 816 may be sent from the CGW 852 to the MME 842. In FIG. 8D, the eNode B 840 may send a signal to MME 842 and the MME 842 may respond with a signal. As illustrated, a first signal 818 may be sent from the eNode B 840 to the CGW 852 and a second signal 820 may be sent from the CGW 852 to the MME 842. In response, a third signal 822 may be sent from the MME 842 to the CGW 852 and a fourth signal 824 may be sent from the CGW 852 to the eNode B 840. As such (e.g. as illustrated by the signaling diagrams shown FIGS. 8A, 8B, 8C, and 8D), the CGW 852 may be transparent to the signaling procedures utilized by the MME 842 and the eNode B 842.

In addition to non-UE specific procedures and/or methods, UE specific procedures and/or methods may be provided and/or used such as: E-RAB Setup; E-RAB Modify; E-RAB Release; Initial Context Setup; UE Context Release Request—eNode B Initiated; UE Context Release—MME Initiated; UE Context Modification; Handover Preparation; Handover Resource Allocation; Handover Notification; Path Switch Request; Handover Cancellation; eNode B Status Transfer; MME Status Transfer; Paging; NAS Transport; UE Capability Information; Location Reporting Control; Location Report Failure Indication; Location Report; Trace Start; Trace Failure Indication; Deactivate Trace; Cell Traffic Trace; and the like. The same transfer of messages or signals shown in FIGS. 8A, 8B, 8C, and 8D between the MME and eNode B via the CGW may also be used to support the UE specific procedures and/or methods.

In an example embodiment, for procedures and/or methods between the MME and eNode B, a determination may be made regarding which messages may get sent to which eNode B (e.g. if there may be multiple eNode Bs). The systems and methods described herein (e.g. the CGW) may address such an embodiment by configuring the DNS Server within the MCN to map each unique eNode B hostname or FQDN to one of the CGW's local IP addresses. Thus, the CGW may have several unique local IP addresses, each identified by a different hostname or FQDN (eNode B 1, eNode B 2, and the like). When the CGW may receive a message from the MME, the CGW may know which of the local IP addresses may have been used and may subsequently dispatch the message to the correct eNode B. Using such a method, the CGW may transparently vector messages to and from the correct eNode B and MME.

In some embodiments, the CGW may be presented as a single eNode B to the MME and the CGW may manage one or more eNode Bs that may be under its purview. In such an embodiment, logic within the CGW may be used such that the CGW may know how to configure each eNode B (e.g. such as the RAN settings) and may know which messages from the MME may be sent to one or more eNode Bs and which may be sent to a specific eNode B. For example, the signaling associated “Overload Start” and “Overload Stop” procedures and/or methods may be sent by the CGW to eNode Bs under the control of the CGW while the signaling with the “Initial Context Setup” procedure and/or methods may be sent to the eNode B through which the UE may be connecting. As such, according to an example embodiment, the UE specific procedures between a specific eNode B and the MME may be implemented through the CGW.

Additionally, in other example embodiments, some of the non-UE specific procedures may be between a specific eNode B and the MME. For example, if a procedure or method may originate from the eNode B, then it should be between that eNode B and MME. In some embodiments, if a procedure and/or method may originate from the MME the logic employed by the CGW with regard to how to route the signaling may be a function of the procedure and/or method itself. Examples of CGW logic that may be supported and/or used may include one or more of the following functions: reset; S1 setup; error indication; eNode B configuration update; MME configuration update; overload start; overload stop; write replace warning; kill; eNode B direct information transfer; MME direct information transfer; eNodeB configuration transfer; MME configuration transfer; and the like.

For example, in one embodiment, upon receipt of a RESET signal by the MME, the CGW may send such a message to eNode Bs under the purview of the CGW. Additionally, upon receipt of a S1 SETUP REQUEST signal from an eNode B, the CGW may respond with an S1 SETUP RESPONSE signal, if it may have successfully completed the S1 Setup procedure with the MME. If not, the CGW may respond with the S1 SETUP FAILURE signal indicating a time period of when the eNode B may re-try the S1 Setup procedure.

According to another embodiment, upon receipt of an ERROR INDICATION message from an eNode B, the CGW may forward this message to the MME. Upon receipt of the ERROR INDICATION message from the MME, the CGW may send this message to the eNode Bs under the purview of the CGW. Additionally, upon receipt of an ENB CONFIGURATION UPDATE message from an eNode B, the CGW may respond with the ENB CONFIGURATION UPDATE ACK message and may forward the ENB CONFIGURATION UPDATE message to the MME.

Upon receipt of a MME CONFIGURATION UPDATE message from a MME, the CGW may respond with the MME CONFIGURATION UPDATE ACK message and may forward the MME CONFIGURATION UPDATE message to eNode Bs under the purview of the CGW.

Additionally, in embodiments, upon receipt of an OVERLOAD START message from the MME, the CGW may send this message to eNode Bs under its purview and upon receipt of an OVERLOAD STOP message from the MME, the CGW may send this message to eNode Bs under its purview.

In yet another embodiment, upon receipt of a WRITE-REPLACE WARNING REQUEST from the MME, the CGW may respond with a WRITE-REPLACE WARNING RESPONSE message and may send a WRITE-REPLACE WARNING REQUEST message to each eNode B under the purview of the CGW.

Additionally, upon receipt of a KILL REQUEST from the MME, the CGW may respond with a KILL RESPONSE message and may send a KILL REQUEST message to each eNode B under the purview of the CGW and/or upon receipt of an ENB DIRECT INFORMATION TRANSFER message from an eNode B, the CGW may forward this message to the MME.

Upon receipt of a MME DIRECT INFORMATION TRANSFER message from a MME, the CGW may forward this message to eNode Bs under the purview of the CGW; upon receipt of an ENB CONFIGURATION TRANSFER message from an eNode B, the CGW may forward this message to the MME; and/or upon receipt of a MME CONFIGURATION TRANSFER message from a MME, the CGW may forward this message to eNode Bs under the purview of the CGW.

In an example embodiment, during an establishment of a PDP context between a WTRU and a serving gateway, a MME may orchestrate the establishment of a GTP-U tunnel between the eNode B and the serving gateway. The MME may performs this function by GTP-C signaling over the S11 interface with the serving gateway (as shown in FIG. 108) and over the S1-MME interface with the eNode B. In accordance with the presently described systems and methods, when a CGW may be positioned between the eNode B and the serving gateway (as shown in FIG. 108), the CGW may monitor the signaling between the MME and eNode B. The CGW may also act as a GTP tunnel end-point to both the serving gateway and the eNode B.

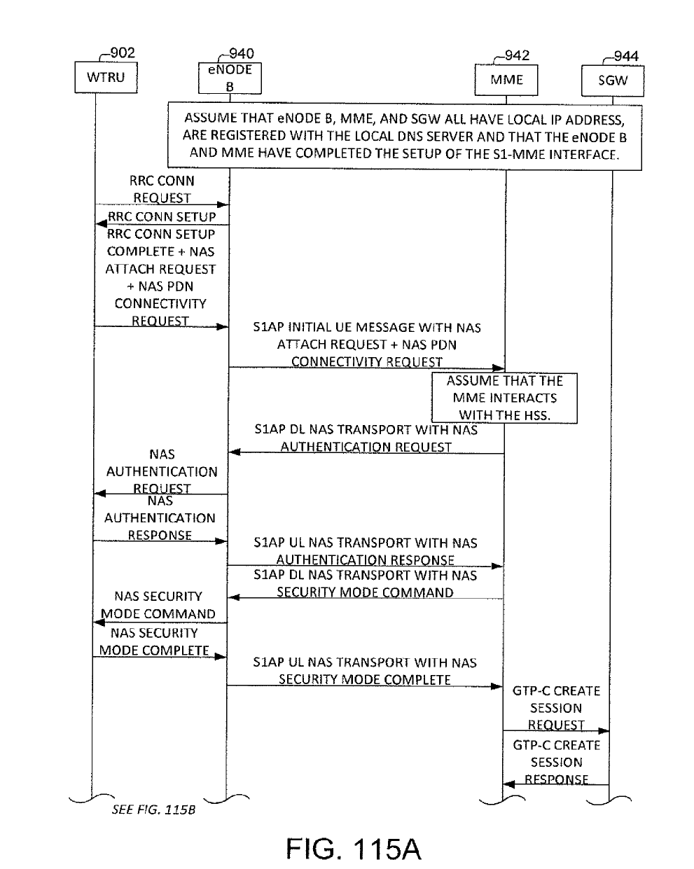

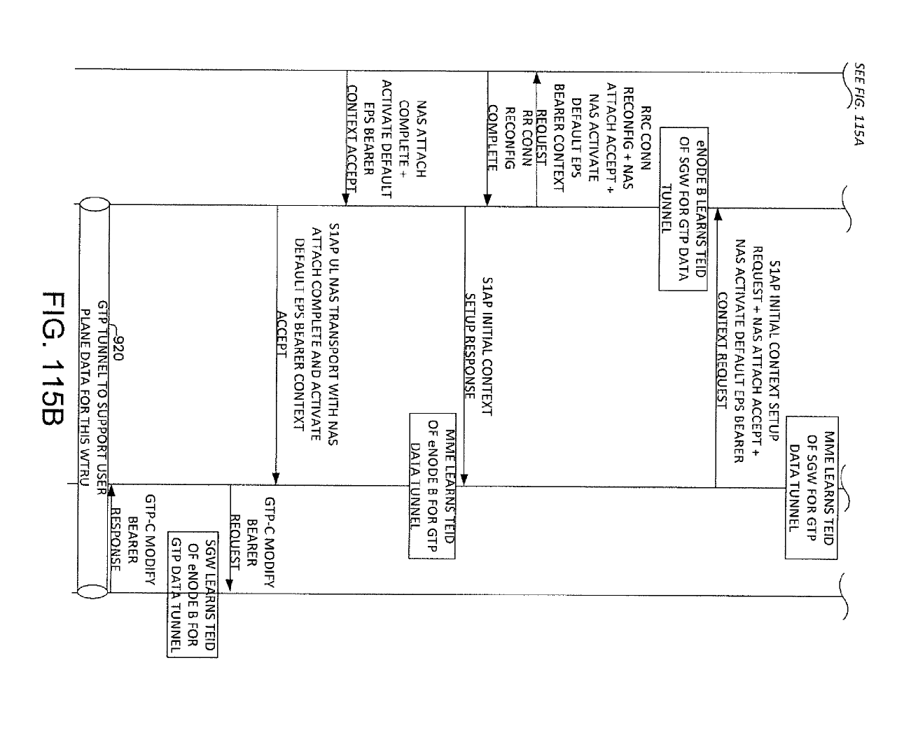

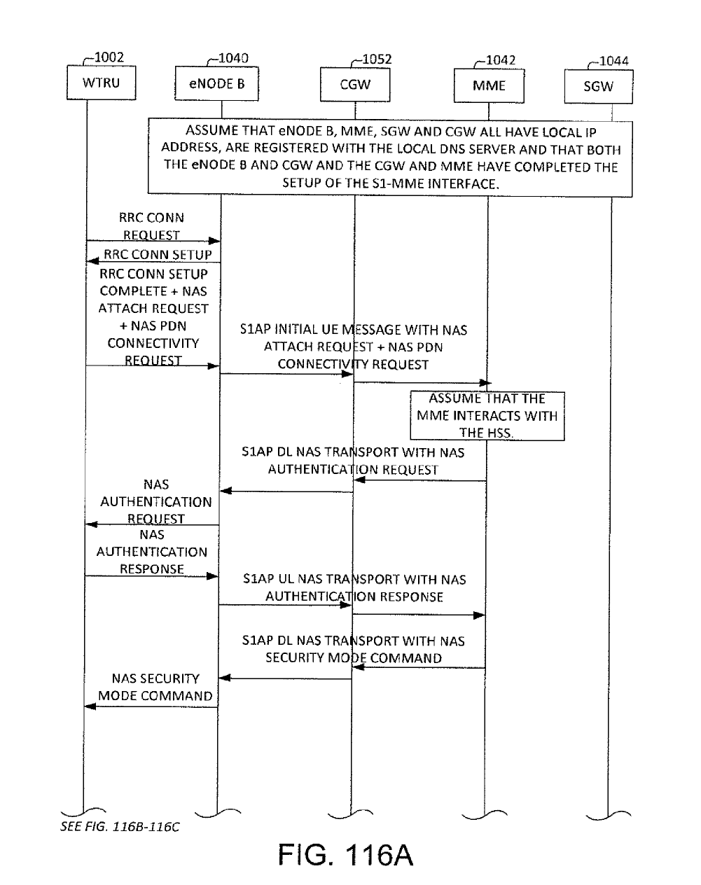

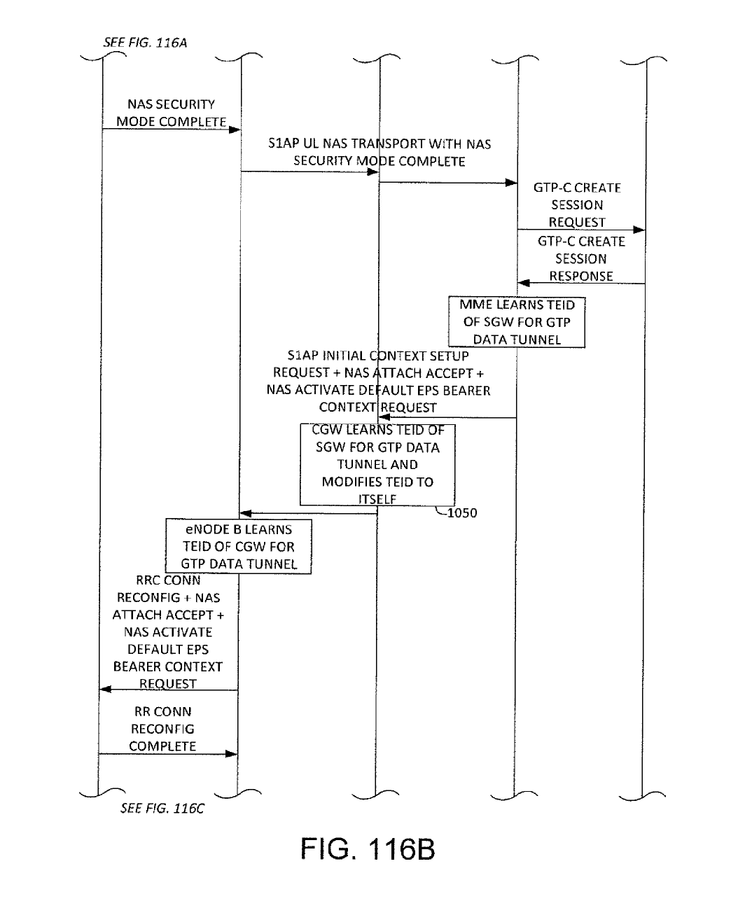

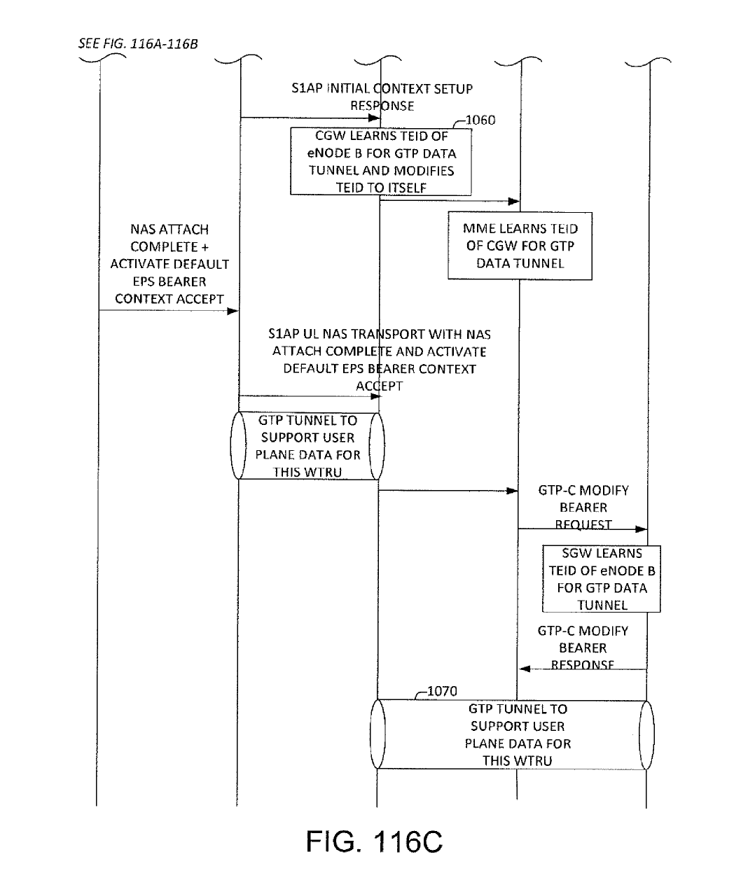

A procedure and/or method for establishing a PDP Context may be shown in FIGS. 115A-115B without a CGW. In the procedure and/or method shown in FIGS. 115A-115C, a MME 942 may inform an eNode B 1940 about the SGW TEID and may inform a SGW 1944 of the eNode B TEID. Based on the TEID information, the SOW 944 and eNode B 940 may form a GTP-U tunnel 920 (e.g. FIG. 115B). A procedure and/or method for establishing a PDP Context using a CGW may be shown in FIGS. 116A-116C. As shown in the illustrated embodiment, signaling between an eNode B 1040 and a MME 1042 may traverse a CGW 1052. As it may traverse through the CGW 1052, the S1AP protocol may be terminated and re-established. Additionally, as the MME 2042 may inform the SGW 1044 and eNode B 1040 of the tunnel endpoints to use to establish a GTP-U tunnel, at block 1050 and 1060, respectively, the CGW 1052 may eavesdrop to learn the SGW 1044 and eNode B 1040 TEIDs. The CGW 1052 may also modify the TEIDs within these signals as they pass through the CGW 1052 such that both the eNode B 1040 and SGW 1044 may believe that the CGW 1052 may be the tunnel endpoint with which each may communicate may be the CGW 1052.

A WTRU 1002 may then begin communication with an application server on the public Internet, for example, via its connection through the MCN. When uplink data packets may be received by the CGW 1052, from either the Wi-Fi AP connection or the cellular connection, the CGW 1052 may push these data packets towards the SGW 1044 via the GTP tunnel 1070 between it and the SGW. The SGW 1044 may send these data packets towards to the PGW (not shown) where they may be routed to the application server on the public Internet. When downlink data packets may be received by the CGW 1052 from the SGW 1044, they may be routed towards the WTRU 1002 through either the Wi-Fi connection or cellular connection.

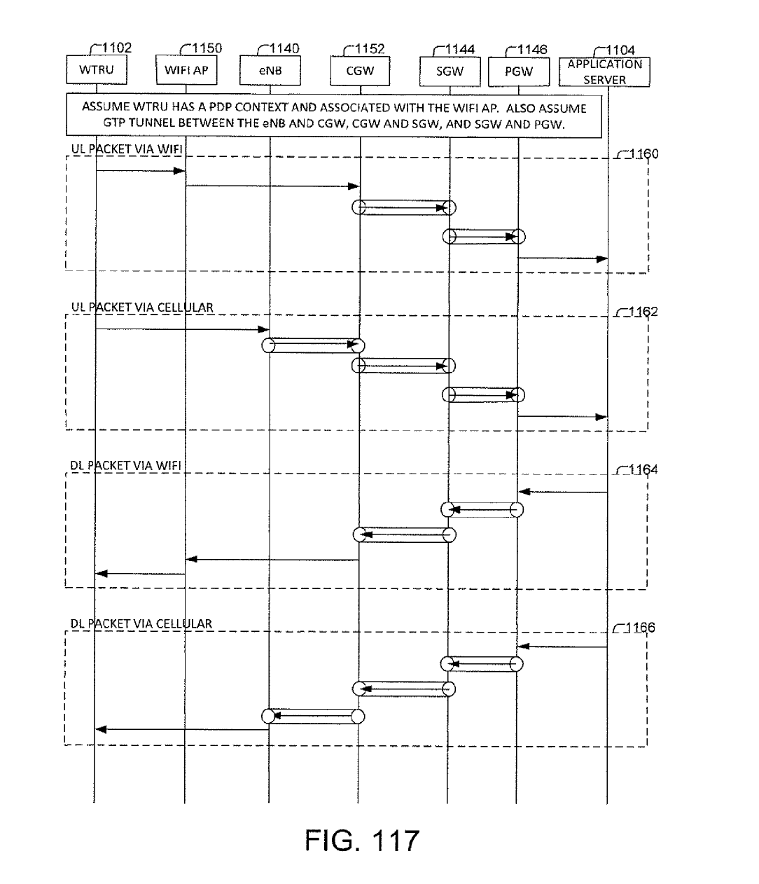

According to an example embodiment, a traversal of uplink and downlink data packets may be shown in FIG. 117. As shown in FIG. 117, a packet flow 1160 may show an uplink of a packet via Wi-Fi radio access technology. The data packets may originate at a WTRU 1102 and may be received by a Wi-Fi AP 1150. The Wi-Fi AP 1150 may send the data packets to a SGW 1144 via a CGW 1152. The SGW 1144 may send the data packets toward a PGW 1146. The PGW 1146 may send the data packets to an application server 1104. A packet flow 1162 may show an uplink of a packet via cellular radio access technology. The data packets may originate at the WTRU 1102 and may be received by an eNode B 1140. The eNode B 1140 may send the data packets to the SGW 1144 via the CGW 1152. The SGW 1144 may send the data packets toward the PGW 1146. The PGW 1146 may send the data packets to the application server 1104. A packet flow 1164 may show a downlink of a packet via Wi-Fi radio access technology. The data packets may originate at the application server 1104 and may be received by the PGW 1146. The PGW 1146 may send the data packets to the SGW 1144. The SGW 1144 may send the data packets to the Wi-Fi AP 1150 via the CGW 1152. The Wi-Fi AP 1150 may send the data packets to the WTRU 1102. A packet flow 1166 may show a downlink of a data packet via cellular radio access technology. The data packets may originate at the application server 1104 and may be received by the PGW 1146. The PGW 1146 may send the packets to the SGW 1144. The SGW 1144 may send the data packets to the eNode B 1140 via the CGW 1152. The eNode B 1140 may send the data packets to the WTRU 1102.

A CGW may also make IP routing decisions based on a wide variety of variables such as a MCN policy and/or measurements taken from flows that may traverse a CGW in an embodiment. The policy may be preloaded within the CGW or may be provisioned within the CGW as per the evolving standards related to ANDSF. Regardless, the decisions or determinations that may be made by the CGW may include one or more of the following: balance the load between the cellular and Wi-Fi connection; offload the licensed spectrum (e.g. move IP Flows from cellular to Wi-Fi); or maintain a connection in the presence of a poor RF environment. The WTRU may support DFM where a flow may be moved from one transport to another or the WTRU may support DFA where a flow may be routed over several transports simultaneously.

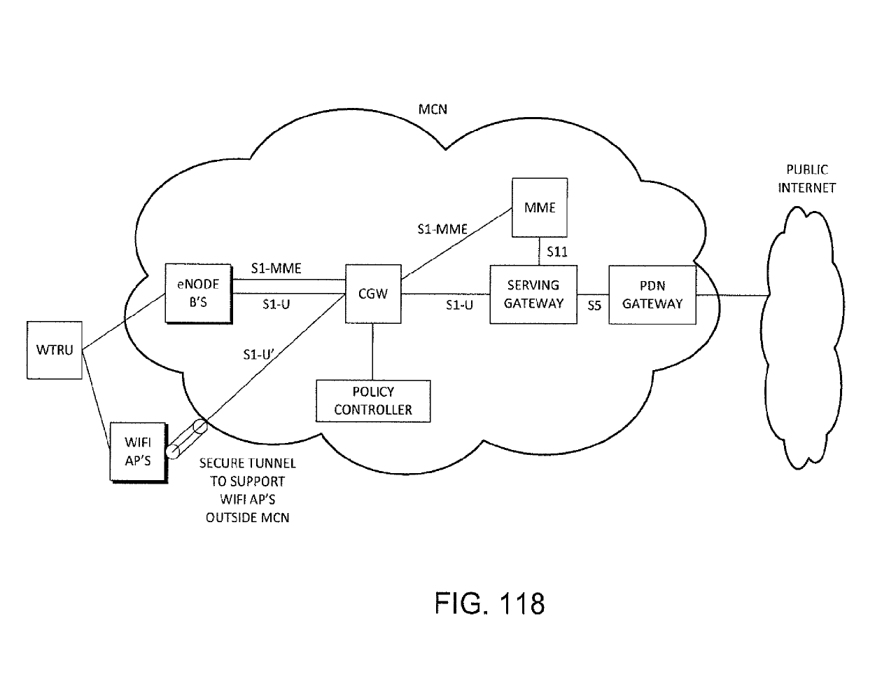

Additionally, in accordance with the systems and methods described herein, a wide variety of architectures may be utilized. FIGS. 118-123 illustrates example embodiments of architectures that may use a CGW integrated into a MCN. In example embodiments, while each of these architectures may be different, the procedures and/or methods (or slightly modified versions of the procedures and/or methods) described above may be applicable to the various architectures shown in FIGS. 118-123.

Referring to FIG. 118, an architecture similar to FIG. 2 may be shown where Wi-Fi APs may be located outside the MCN. To support such an architecture, a tunnel or secure interface may be utilized between the Wi-Fi AP's and the CGW. This secure interface may or may travel through the Secure Gateway (SeGW) at the edge of the MCN.

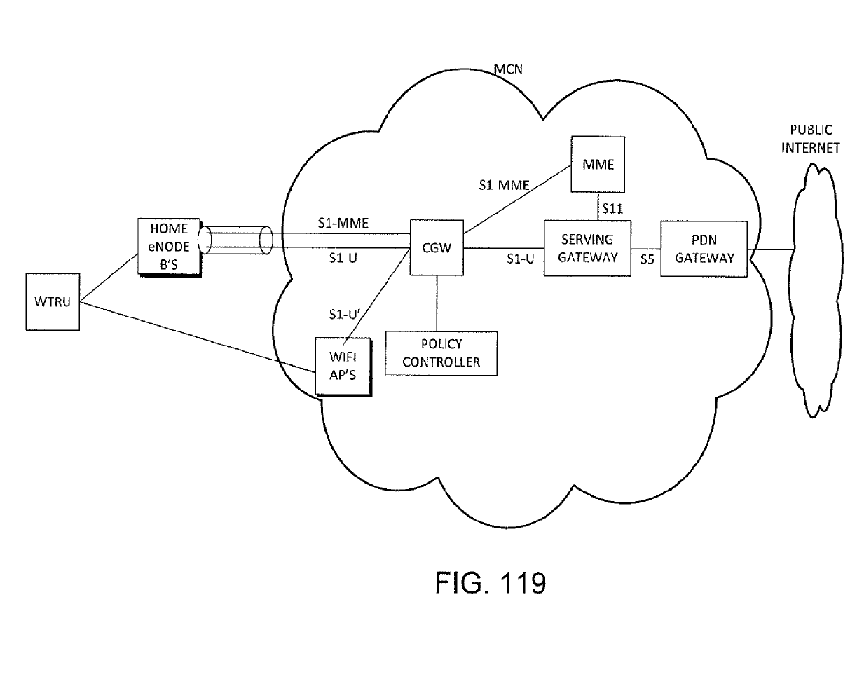

FIGS. 119-123 illustrated architectures utilizing Home eNode Bs (HNBs or HeNBs) in place of eNode Bs. While the Wi-Fi APs may be shown within the MCN in each of these architectures, it may be appreciated that the Wi-Fi APs may be placed within the MCN or outside the MCN with a secure interface back to the CGW (as illustrated in FIG. 118). As shown in each of FIGS. 119-123, a secure tunnel or secure interface may be utilized between the Home eNode Bs or HNBs and the CGW. The procedures defined above may also apply to these architectures.

Referring now to FIG. 119, the CGW may utilize similar interfaces to the Home eNode B as described above with reference to FIG. 108. As such, the procedures and protocols may be similar to those described above. In such an embodiment, the CGW may sit between the Home eNode Bs and both the MME and the SGW. As such, the CGW may appear as a MME and SGW to the Home eNode Bs and the CGW may appear as Home eNode Bs to both the MME and SGW.

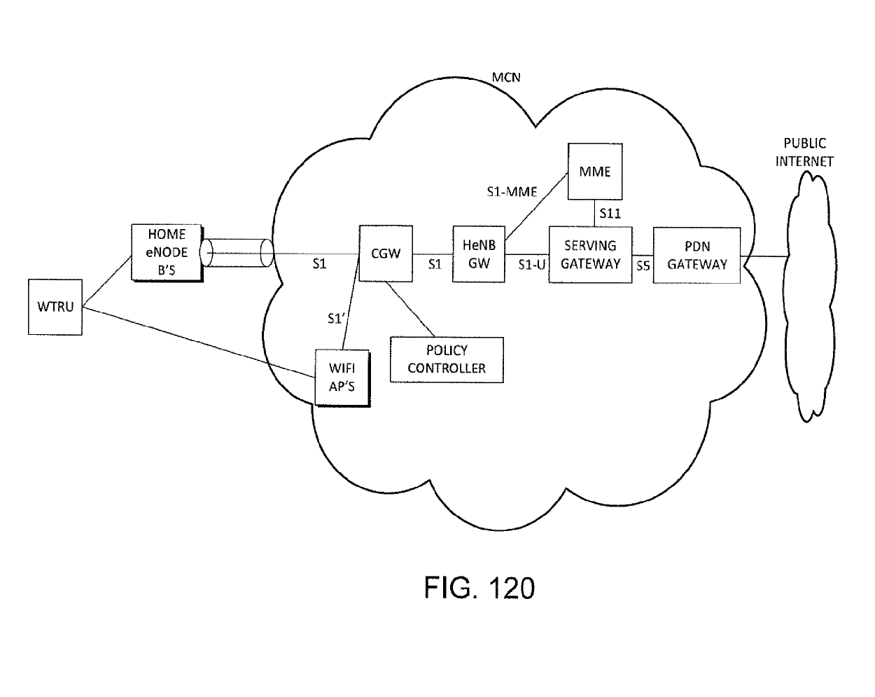

FIGS. 120-123 illustrate architectures when a Home eNode B Gateway (shown as HeNB GW) may be present. FIGS. 120-123 illustrate example placement locations of the CGW in implementations utilizing a Home eNode B Gateway. As described herein, in some embodiments, the Home eNode B Gateway may aggregate the S1-MME and S1-U interfaces. In other embodiments, it may sit on the S1-MME interface.

Referring to FIG. 120, the HeNB GW may aggregate the S1-MME and S1-U interface. In such an embodiment, the CGW may have an S1 interface with the HeNB GW and the Home eNode B. It may be the responsibility of the CGW to separate out the S1-MME and S1-U data. In an embodiment, the S1-MME data may be sent to the Home eNode B while the S1-U data may be split between the Wi-Fi APs (e.g. via the S1′ interface) and Home eNode Bs. Other non-cellular radio access technologies may be used as well such as WiMAX and/or Bluetooth, for example.

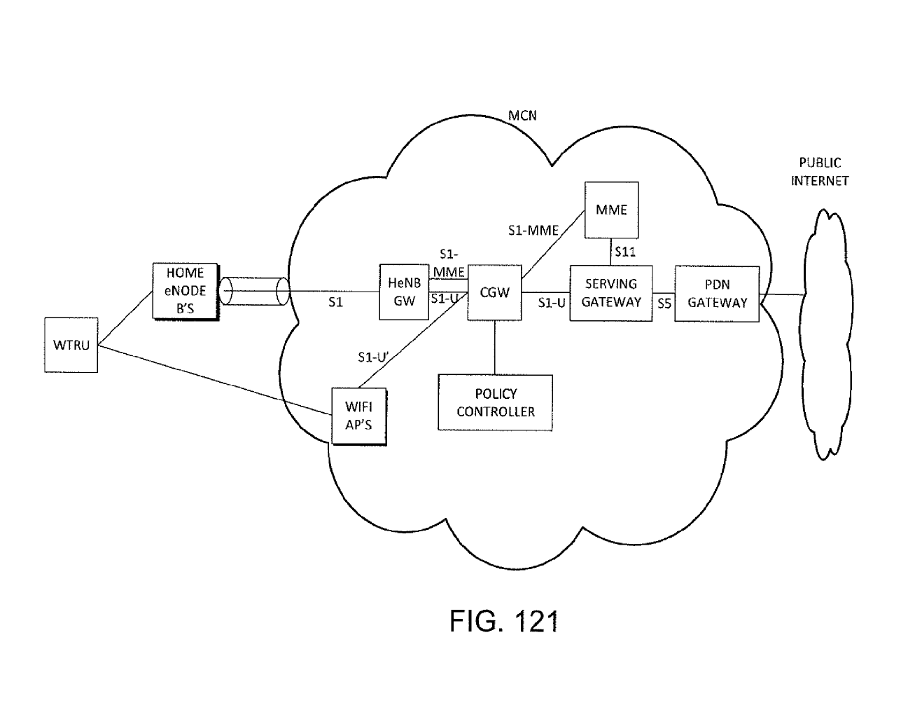

Referring to FIG. 121, the CGW may be placed between the HeNB GW and both the MME and SGW. In such an embodiment, the CGW may maintain the S1-MME interface between the HeNB GW and the MME. It may also maintain the S1-U interface between the SGW and the HeNB GW and some data may be routed through the Wi-Fi AP's via the S1-U′ interface.

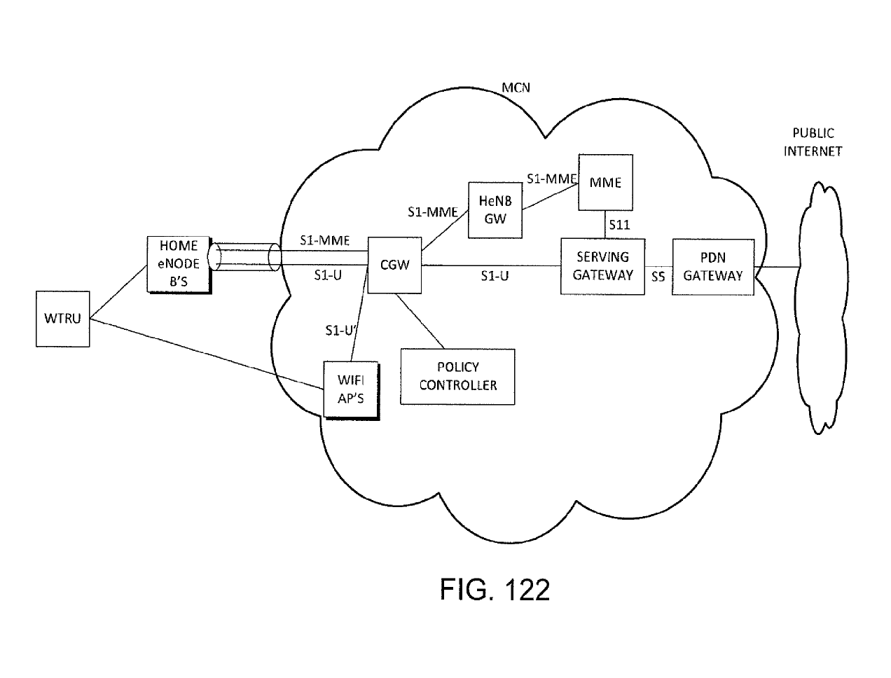

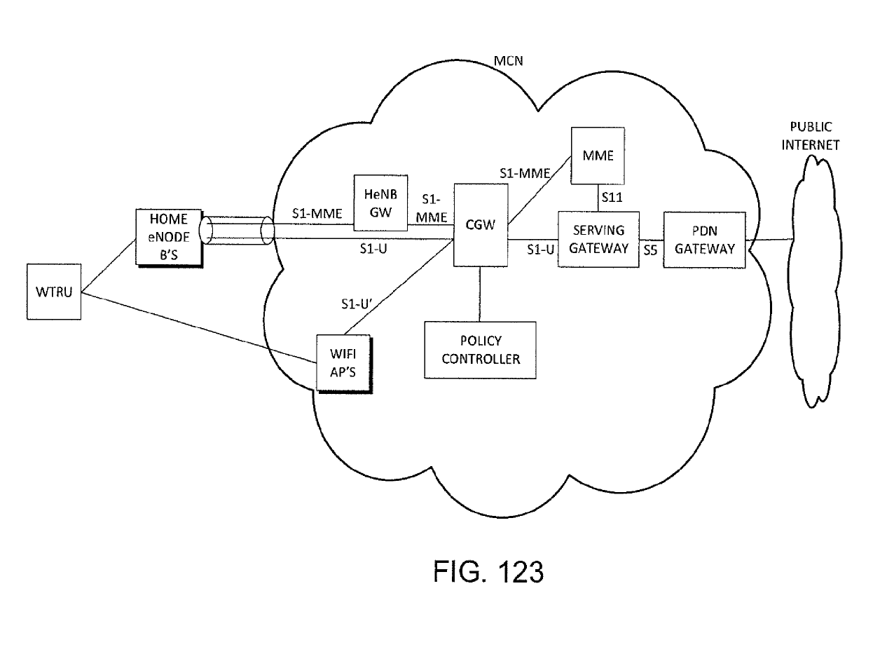

Referring now to FIGS. 122 and 123, the HeNB GW may be illustrated as acting on the S1-MME interfaces. For such architectures, the HeNB GW may be considered a pass through (e.g. a pass through node).

According to an embodiment (e.g. as described above), a policy may be used by the CGW to make routing decisions. The policy may be locally stored within the CGW. Additionally, a policy may be delivered from the CGW to the UE. Dynamic flow management (DFM) for load balancing, RSSI measurements, and dynamic flow management for link down condition may also be provided and/or used. An example a readable version of XML schema and SOAP signaling for example embodiments presented herein may be attached as an Appendix hereto and may be incorporated herein by reference.

As described above, the CGW may support the delivery of a policy to a UE. As such, in an embodiment, the CGW may act as a SOAP Server and the UE may act as a SOAP Client. Upon connecting to the CGW, the UE may connect to the SOAP Server and may register. In some embodiments, the UE may then request a policy that the CGW may provide to it. The policy delivered may be, in some implementations, local to the CGW. In such embodiments, the CGW may not connect to an external Policy Controller to acquire the policy for the specific UE as the CGW may have the policy for a UE that may connect to it for the prototype. In other embodiments, the CGW may connect to an external Policy Controller or other supplier of policy information.

Additionally, in one embodiment, the CGW may have a SOAP Server that may be running and may be ready to accept a connection from a UE. The CGW may use an agreed-upon port. The CGW may also have a known LAN IP address for pre-provisioning the SOAP Client within the UE. The CGW may use, in some embodiments, an XML schema (e.g. Release 10 XML schema) and may maintain a local policy for a UE based on such XML schema. The CGW may maintain a plurality of policies such as one policy for a first UE and a second policy for a second UE, and the like. In some embodiments, one policy may be a default policy with other policies that may be provided to UEs satisfying various conditions. In various embodiments, the XML policy may not have a UE ID (IMSI) and since the policy stored within the CGW may use a UE ID field, the policy stored within the CGW may not be identical to the XML schema. In such embodiments, it may, at a minimum, include the parameters in the XML schema.

A CGW may also have the functionality to respond to SOAP messages that may be sent from the UE over HTTP to support one or more of the following features: UE registration to the SOAP Server (registerRequest) with the SOAP Server within the CGW responding with registerResponse message; UE policy request to the SOAP Server (getPolicyRequest) with the SOAP Server within the CGW responding with the getPolicyResponse message; and the like. The getPolicyResponse message may carry the information to configure the UE for RSSI measurements as described herein.

A CGW may also be configured to accept SOAP messages from the UE on an active transport, may ignore an unregisterRequest message from the UE, and/or may ignore a reasonCode and reportAnalytics in the getPolicyRequest message. The CGW may also respond to receipt of multiple registerRequest messages from the same UE by sending a IMSI of the UE. In some embodiments, the CGW may not perform retransmission of SOAP signaling except what may be supported by SOAP itself and the protocols that may be used to transfer the messages between the UE and CGW. As such, the CGW may not do anything exceptional to ensure that the SOAP signaling may be received by the UE.

The CGW may map the “RoutingRule” from the XML schema to “No Preference”, “Wi-Fi Preferred”, “Cellular Preferred”, “Cellular Only”, “Wi-Fi Only”, and so forth. The CGW may also map the “IPFlow” from the XML schema and mapping the IP addresses, port numbers, and so forth to “HTTP Video”, “FTP”, “SIP” and “Other”.

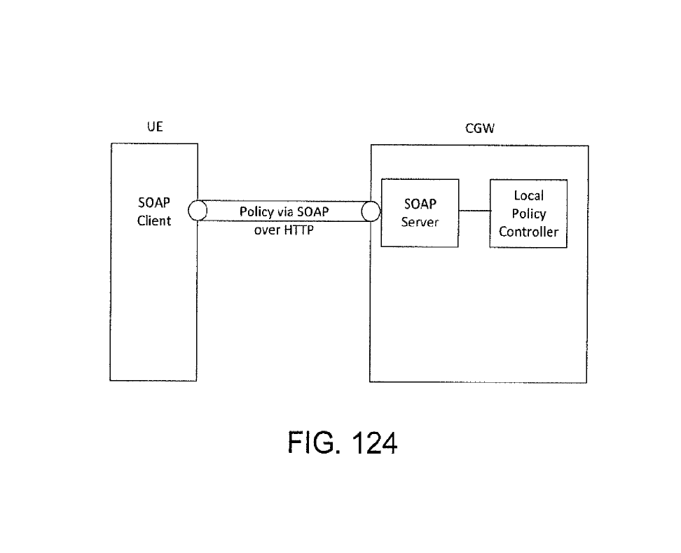

FIG. 124 shows an example embodiment of a configuration of a UE by a CGW. In an embodiment, FIG. 124 may represent a functional representation of an example CGW architecture. The CGW may have a SOAP Server and a “Local Policy Controller” that may perform non-SOAP functions as described herein.

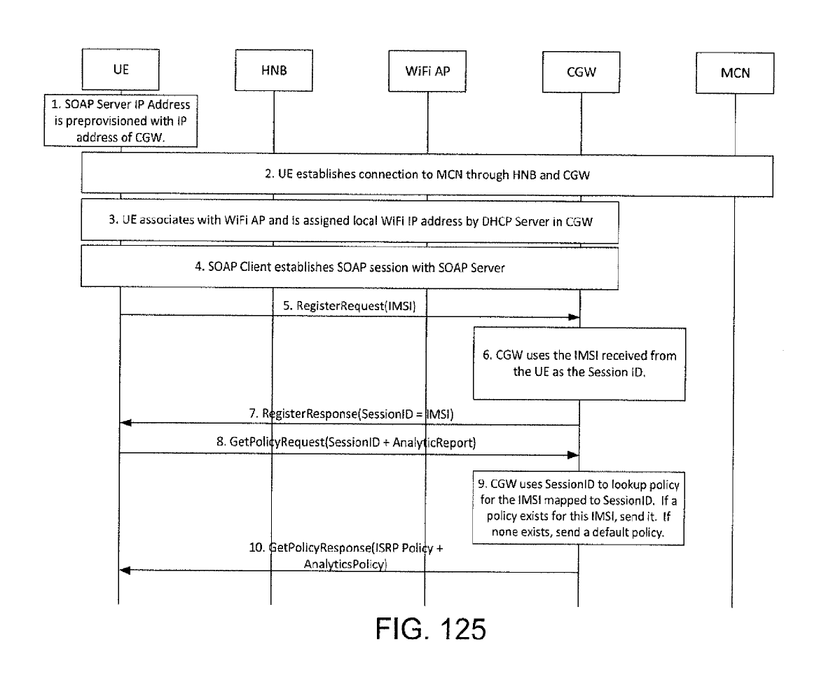

FIG. 125 illustrates an example embodiment of a message sequence chart (MSC) associated with an example interaction between the CGW and the UE that may be illustrated in FIG. 124. As shown in 125, at 1, the UE may already have the LAN IP address of the CGW. The UE may be preconfigured with this IP address; therefore, the CGW may use a known LAN IP address. At 2 and 3, the UE may perform the preexisting actions described above in the presence of the CGW. At 4, the SOAP Client within the UE may establish a SOAP session with the SOAP Server in the CGW using HTTP. In some embodiments, the SOAP signaling to effectuate this SOAP session may be standard signaling. At 5, the SOAP Client may send a registerRequest message to the SOAP Server in the CGW. Such a message may be configured as follows: MSISDN=Don't Care (DC); IMSI=IMSI of the UE (from SIM); IMEI=DC; and the like. According to embodiments, a MSISDN and/or an IMEI may or may not be used.

At 6, the CGW may use the IMSI received from the UE at 5 as the SessionID for this policy communication session with the UE. If the CGW may receive multiple registerRequests from the UE, each may be replied to by the CGW sending the IMSI as the SessionID. Furthermore, if a UE may send an unregisterRequest message to the CGW, the CGW may take no action and may ignore this message.

At 7, the SOAP Server in the CGW may send the registerResponse message to the UE. This message will contain the Session ID provided at 6 as follows: SessionID=IMSI received from UE in RegisterRequest.

At 8, the SOAP Client in the UE may send a getPolicyRequest message to the CGW with the Session ID it may have received at 7 and other parameters. A reasonCode may be included to indicate why the UE may be requesting a policy. The message may also include a PolicyRequest string which may be included on the location of the UE and the RSSI measurements taken by the UE. The message sent by the UE to the CGW may take the form of one or more of the following: SessionID=IMSI received from the CGW in the RegisterResponse; ReasonCode=DC; PolicyRequestString=DC; and the like. According to embodiments, the ReasonCode and/or the PolicyRequestString may or may not be used.

At 9, the CGW may use the IMSI that may be received at 8 to search for a policy that may match the IMSI. If one may be found, the matching policy may be sent to the UE. If no match may found, the CGW may send the default policy to the UE. In an embodiment, it may be known which UEs may be connecting to the CGW, therefore, the CGW may be pre-configured with an explicit policy for each UE or a default policy may be in place. There may also be flexibility with regard to which policies may be loaded and/or stored in the CGW. The CGW may also extract the RSSI configuration to be sent to the UE. In some embodiments, a unique RSSI configuration per UE or groups of UEs may be provided and/or used.

With regard to the internally stored policy, in embodiments, there may be one policy with multiple entries, one per UE and a default for a UE that may not have an entry. Additionally, in other embodiments, there may be multiple policies, one per UE and a default for a UE that may not have an entry. Additionally, in yet other embodiments, there may be a combination of single policies with multiple entries and multiple policies or other technique providing equivalent functionality. For example, as long as there may be a way to uniquely identify the policy for a specific UE and uniquely identify the default policy, it may be an acceptable policy management technique that may be used herein. For each UE and the default entry, under ISRP, there may also be four ForFlowBased entries, each one defining the routing rules for FTP, SIP, HTTP video and Other IP Flows. In each of these ForFlowBased entries, the RulePriority field may be used. For the rules in the policy, RulePriority may be set to 1, except for the “Other” policy, which may use a higher numbered RulePriority.

When the CGW may be selecting a policy to apply to a flow, it may use those rules with RulePriority set to 1 first, and may use the “Other” policy if RulePriority 1 rules may not apply. According to an embodiment, in the rule for each IP Flow type, there may be two IP Flow entries, one for downlink and the other for uplink. In some embodiments, both the uplink and downlink may share the same routing rule. In other embodiments, uplink and downlink flows may travel over different transports.

Referring again to FIG. 125, at 10, the SOAP Server in the CGW may send the UE a getPolicyResponse message that may include the matching IFOM policy as determined at 9. It may also send the RSSI configuration information to configure the UE to perform RSSI measurements. The RSSI measurement portion of the message may be described in more detail below. During, for example, 10, the CGW may send a PolicyResponse message to the UE that may include one or more of the following parameters:
Policy=DC or Not Included (NI)
DiscoveryInformation=DC or NI
ISRP
   ForFlowBased(1)
      IPFlow
         StartSourcePortNumber—xsd:int—[0 . . . 1]
         EndSourcePortNumber—xsd:int—[0 . . . 1]
      RoutingCriteria=DC or NI
      RoutingRule(1)
         AccessTechnology=1
         AccessNetworkPriority=255
      RoutingRule(2)
         AccessTechnology=3
         AccessNetworkPriority=1
      RulePriority=1
   ForFlowBased(2)
      IPFlow
         StartSourcePortNumber=5060
         EndSourcePortNumber=5061
      RoutingCriteria=DC or NI
      RoutingRule(1)
         AccessTechnology=1
         AccessNetworkPriority=250
      RoutingRule(2)
         AccessTechnology=3
         AccessNetworkPriority=250
      RulePriority=1
   ForFlowBased(3)
      IPFlow(1)
         StartSourceIPAddress=23.126.201.133
         EndSourceIPAddress=23.126.201.140
      IPFlow(2)
         StartDestIPAddress=23.126.201.133
         EndDestIPAddress=23.126.201.140
      RoutingCriteria=DC or NI
      RoutingRule(1)
         AccessTechnology=1
         AccessNetworkPriority=2
      RoutingRule(2)
         AccessTechnology=3
         AccessNetworkPriority=1
      RulePriority=1
   ForFlowBased(4)
      IPFlow(1)
         StartSourceIPAddress=0.0.0.0
         EndSourceIPAddress=255.255.255.255
      IPFlow(2)
         StartDestIPAddress=0.0.0.0
         EndDestIPAddress=255.255.255.255
      RoutingCriteria=DC or NI
      RoutingRule(1)
         AccessTechnology=1
         AccessNetworkPriority=1
      RoutingRule(2)
         AccessTechnology=3
         AccessNetworkPriority=255
      RulePriority=2
   ForNonSeamlessOffload=DC or NI
   Roaming=DC or NI
   PLMN=PLMN of HNB
   UpdatePolicy=DC or NI
PolicyPollIntervalSecs=DC or NI
AnalyticsPolicy
AnalyticsReportingIntervalSecs=60
   NetworkBasedPolicies
      AccessNetworkType=3
      NumReadings=5
      ReadingPeriodSeconds—xsd:int=12
      LowSignalAlarm
         Name=“Wi-Fi”
         MinLevel=15
         SecondsBelow=2

The foregoing example policy may include four entries, one each for FTP (1st), SIP (2nd), HTTP video (3rd) and other (4th). For the FTP rule, the policy may be set such that the Wi-Fi transport may be the transport that may be used for this type of traffic (Wi-Fi). For the SIP rule, the policy may be set such that there may be no preference in which transport may be selected (No Preference). For the HTTP video rule, the policy may be set such that the Wi-Fi transport may be preferred (Wi-Fi Preferred). For the other rule, the policy may be set such that the Cellular transport may be the transport that may be used for this type of traffic (Cellular). In an example embodiment, the Rule Priority field of each of the four entries may be set such that the FTP, SIP and HTTP video rules may be a higher priority than the Other IP Flow rule. This may ensure that the FTP, SIP and HTTP video rules may be applied first, allowing the Other IP Flow rule to be used for a IP Flow that may not be FTP or SIP or IMP video. For the HTTP video entry, an example IP address of an HTTP video source may be selected. In an example embodiment, this may be set to the IP address of the HTTP video source that may be used in a test bench.

There may also be additional logic related to the policy that involves the mapping of the policy to various routing rules. Each entry under “ForFlowBased” may include both an “IPFlow” and “RoutingRule.” The “IPFlow” may be used to identify the service type and may be mapped to the Service Type. The “RoutingRule” may be used to identify how an IP Flow may be routed and may be mapped to the appropriate Routing Rule. The “IPFlow” entries in the policy may be mapped to the internally used values of the services. In an embodiment, the IP addresses and ports of the application server may be known such that the CGW may know such information (e.g. as shown in Table 8). Table 8 may provide an example Service Table Mapping.

TABLE 8

| IP Addresses List | Port Numbers List | Service Type |
|---|---|---|
| W1.X1.Y1.Z1, | | “HTTP Video” |
| W2.X2.Y2.Z2 | | |
| | 20, 21 | “FTP” |
| | 5060 and 5061 | “SIP” |

The IP Addresses shown in Table 8 may be the IP addresses of the application server for that type of service. Additionally, the Port Numbers may be the port numbers of the application server for that type of service. The Flow Type may be “HTTP Video”, “FTP”, and “SIP.” For each “IPFlow” under each “ForFlowBased” entry, there may be either ports or IP addresses. If IP addresses or port numbers may be included, those IP addresses or port numbers may be compared to the entries in the above table. If there may be a match, the Service Type may be extracted. If there may be no match, this may be assumed to be the default policy. Such information may also be extracted.

The “RoutingRule” entries in the policy may be converted internally within the CGW to match up with the concepts used for various routing rules. As such, each “RoutingRule” may get mapped to the internal rule that may have the following values: “No Preference”, “Cellular Preferred”, “Wi-Fi Preferred”, “Cellular” or “Cellular Only” and “Wi-Fi” or “Wi-Fi Only.” For each “RoutingRule” under each “ForFlowBased” entry there may be two entries. In some embodiments, it may be stipulated as such since the rules may be locally based in the CGW. For example, there may be one entry for Wi-Fi and one for Cellular. Additionally, each entry may have an AccessNetworkPriority. Based on these values, the internal CGW policy may be deduced. In an example embodiment, the AccessNetworkPriority may be a value from 1-250, 254, and 255. Additionally, zero and 251-253 may be reserved, 254 may mean that the transport should be avoided, and 255 may bean that the transport may be forbidden for the type of traffic defined in the IPFlow section. For priorities between 1 and 250, the lower the number, the higher the priority may be of the Access Network. For some embodiments, it may be stipulated that 254 may not be used and that at least one of the entries may have a priority between 1 and 250. The following may be a mapping between a policy and an internal policy in accordance with one embodiment:
1. If AccessNetworkPriority for Wi-Fi=AccessNetworkPriority for cellular and both may be between 1 and 250, then “No Preference.”
2. If AccessNetworkPriority for Wi-Fi<AccessNetworkPriority for cellular and both may be between 1 and 250, then “Wi-Fi Preferred.”
3. If AccessNetworkPriority for Wi-Fi>AccessNetworkPriority for cellular and both may be between 1 and 250, then “Cellular Preferred”.
4. If AccessNetworkPriority for Wi-Fi is between 1 and 250 and AccessNetworkPriority for cellular may be 255, then “Wi-Fi” or “Wi-Fi Only.”
5. If AccessNetworkPriority for Wi-Fi is 255 and AccessNetworkPriority for cellular may be between 1 and 250, then “Cellular” or “Cellular Only.”

Based on the above two mappings, the CGW may know the routing rules for the specific flow types, as shown in Table 9, which may be a Flow Type-Routing Rule table after mapping may be performed.

TABLE 9

| Flow Type | Routing Rule |
|---|---|
| “HTTP Video” | “Wi-Fi Preferred” |
| “FTP” | “Wi-Fi Preferred” |
| “SIP” | “Cellular Preferred” |
| “Other” | “Cellular Only” |

As described above, Dynamic Flow Management (DFM) for load balancing may be provided and/or used by the system and methods described herein (e.g. by a CGW). For example, in some embodiments, there may be no throughput measurements from the UE. In other embodiments, for each IP Flow, the UE may send counts of packets received and sent over each transport. In either embodiment, the CGW may measure some of the IP Flows and the amount of bytes that may traverse the CGW.

In an embodiment, it may be possible that a transport may be congested in downlink but not uplink, or vice versa, or not congested or congested in both directions. In such embodiments, DFM may perform load balancing based on the downlink traffic and may ignore the uplink traffic congestion. In other embodiments, uplink traffic congestion may be considered.

For example, the capacity of each transport may be estimated. In some embodiments, for UDP traffic there may be no flow control. The throughput measured in the downlink direction at the CGW may correspond to the desired throughput (e.g. assuming that there may not be bottlenecks in the core network). The downlink measurement may provide the throughput condition or usage for the real-time streaming protocols (e.g. voice, video), although this may not be used for interactive protocols (e.g. NFS operating over UDP) due to the burst-like nature of those protocols. Thus, in some embodiments, the values may be averaged over several seconds. For example, the CGW may make a measurement of the number of packets for each UDP IP Flow over the past second. It may repeat this measurement every second for each UDP IP Flow. The CGW may then compute the weighted average as follows:

$$Bandwidth = \frac{50 \times {m}_{t = 0} + 25 \times {m}_{t = - 1} + 15 \times {m}_{t = - 2} + 10 \times {m}_{t = - 3}}{100}$$

where m may be the measurement for an IP Flow at the current time (t=0) and the previous 3 seconds (t=−1, t=−2, t=−3).

The weighting factors may vary for various embodiments. Regardless, the measured throughputs may be used when deciding which transport to place a new UDP IP Flow and may be used for load balancing.

Since TCP may have the capacity to adapt to the varying conditions of a transport, if a TCP flow may be moved to a transport that may have less bandwidth, TCP may adapt the transmission to the reduced bandwidth. The TCP flows may (e.g. with the exception of certain interactive protocols (e.g. SSH, telnet)) fill the available bandwidth in one direction. As such, measuring the throughput of the TCP flows may not be informative other than to determine the overall throughput through a transport. Therefore, for TCP IP Flows, the CGW may count the number of IP Flows. The counted number of IP Flows may be used when deciding which transport to place a new TCP IP Flow and may be used for load balancing the TCP IP Flows across the available transports.

To support such a function two processes may be executed. First, packet processing may be executed. This may be the logic that executes each time a new uplink or downlink packet may be received by the CGW. If the packet may be part of a new IP Flow, this logic may assign the IP Flow to a transport as a function of the policy for the UE, the type of IP Flow and the load currently on each transport. In addition, this logic may measure the throughput for each UDP IP Flow. Second, load balancing processing may be executed. This logic may attempt to balance both the TCP and UDP IP Flows that may pass through the CGW. It may such load balancing based on the downlink portions of the IP Flows. For TCP, it may use the number of IP Flows while for UDP, it may use the measured throughput at the CGW of the IP Flows. It may also use the heuristically calculated capacity of each transport. In some embodiments, this logic may execute periodically (e.g. based on the expiration of a timer), when an IP Flow may be added, and/or when an IP Flow may be removed.

Additionally, with regard to Dynamic Flow Management (DFM) functionalities, the CGW may have the ability to change the heuristic capacity of each transport without recompiling the CGW image. The CGW may count the number of TCP IP Flows for each transport for each UE that may be connected to the CGW. The CGW may measure the number of packets for each UDP IP Flow for each transport and may do so for each UE that is connected to the CGW. The CGW may have the ability to determine if a packet may be part of an existing IP Flow. The CGW may have the ability to access the policy for each IP Flow from each UE that may be connected to the CGW. The CGW may have the ability to route a downlink packet to a UE over the “proper” transport. The “proper” transport may be the function of the UE policy, the IP Flow that the packet may be part of and the load on each transport. The CGW may also have the ability to periodically load balance the IP Flows. Additionally, in an embodiment, the CGW may have the ability to make an initial transport assignment for a new IP Flow.

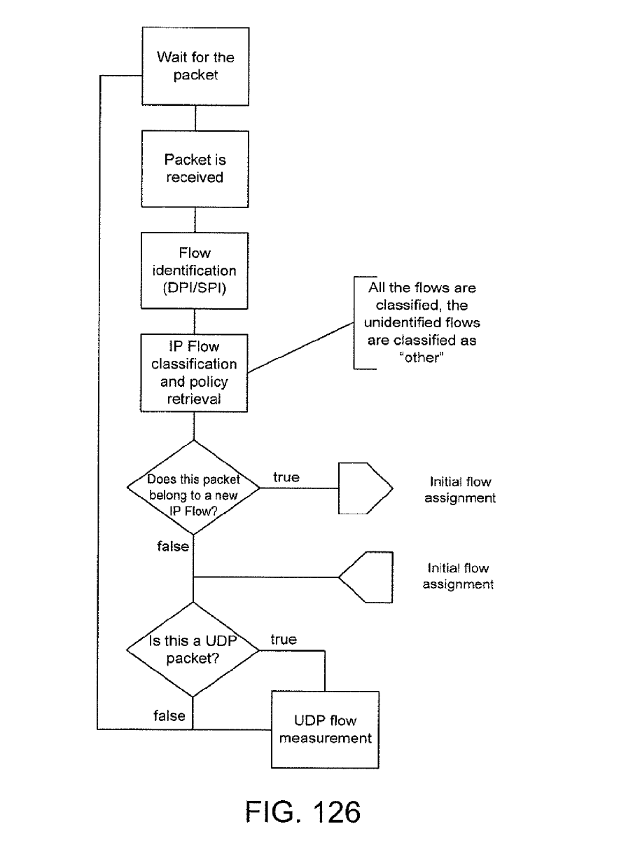

In an example embodiment, the functionality that may be provided and/or used for Dynamic Flow Management may include packet processing and load processing. The Packet Processing logic may be executed upon every receipt of a packet by the CGW. A non-limiting example packet processing method and flow diagram associated therewith may be shown in FIG. 126. The CGW may route the packet to the DPI processing, for example, shown in FIG. 126. Once the DPI may be performed on the packet, its type may be known (or not known in which it may be classified as “Other”). The policy for the type of IP Flow for the specific UE may be extracted. After the policy may be retrieved, the CGW may determine if this packet may be part of a new IP Flow. If so, the CGW may invoke logic that may determine or decide the initial transport to place this IP Flow. After the initial transport may be assigned, this function may analyze whether the data packet is UDP or not. If it may be UDP, the bandwidth consumed by this IP Flow may be updated as a result of this packet. The packet may then be dispatched over the selected and/or assigned transport to its destination.

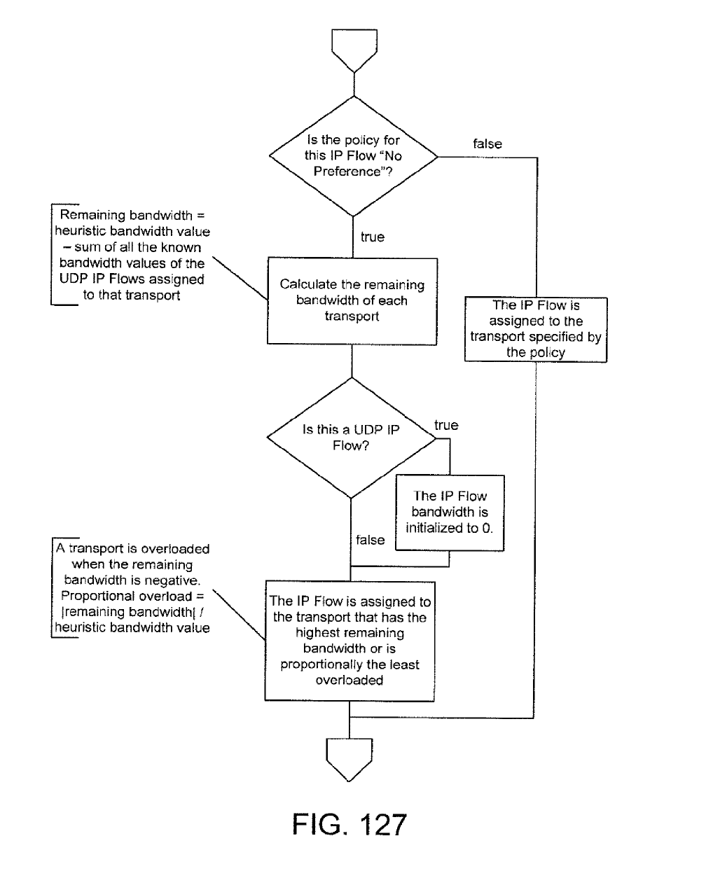

FIG. 127 depicts an example embodiment of a flow diagram of a method or process that may be performed when a new IP Flow has been detected. If the policy for this type of IP Flow for the specific UE may be either Wi-Fi, Cellular, Wi-Fi Preferred, or Cellular Preferred, the IP Flow may be initially assigned to the desired or preferred transport. If the policy may be No Preference, the CGW may calculate the remaining bandwidth of each transport. If the IP Flow may be of type UDP, the bandwidth calculation for this IP Flow may be initialized to zero. After this, the CGW may compute the remaining bandwidth on each transport. If at least one transport may have remaining bandwidth, the CGW, au assign the IP Flow to that transport that may have the highest remaining bandwidth. If both transports may not have remaining bandwidth, the CGW may assign the IP Flow to the transport that may be the least proportionally overloaded.

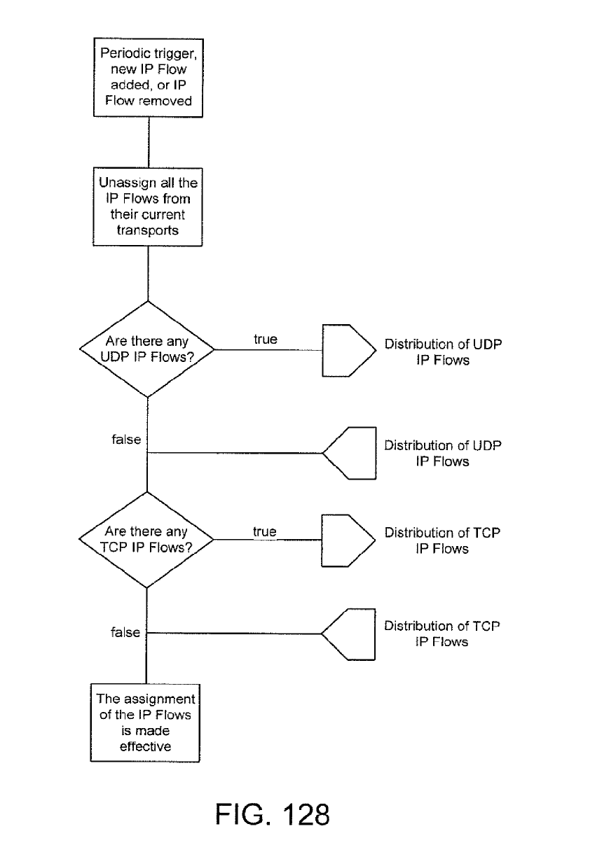

In some embodiments, load balancing may be executed periodically, when a new IP Flow may be added or when an IP Flow may be deleted. An example embodiment of a flow diagram for a method of load balancing may be shown in FIG. 128. When this logic in the CGW may be triggered, current IP Flows may have their current transport selections erased. After this clearing of the existing transports, the CGW may determine or decide on the distribution of the UDP flows and may then determine or decide on the distribution of the TCP flows. After both these functions are executed, the CGW may make the new transport selections effective.

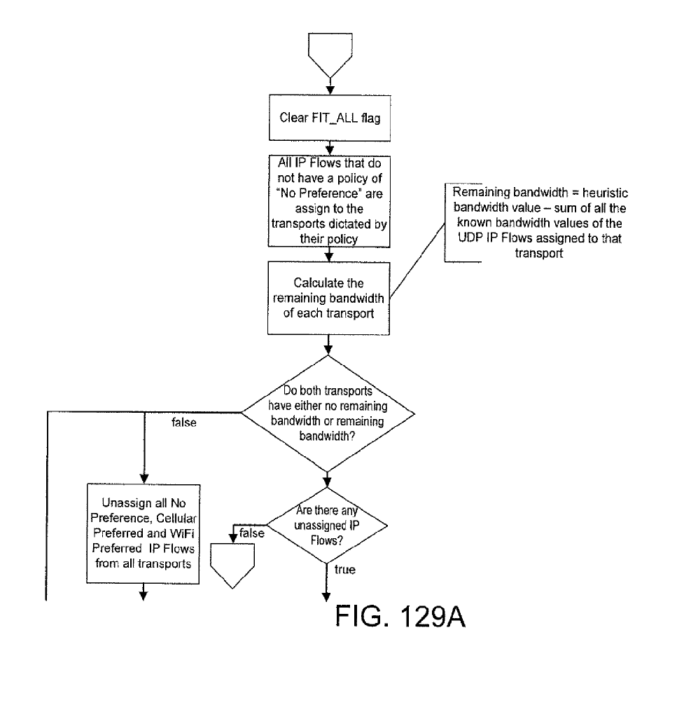

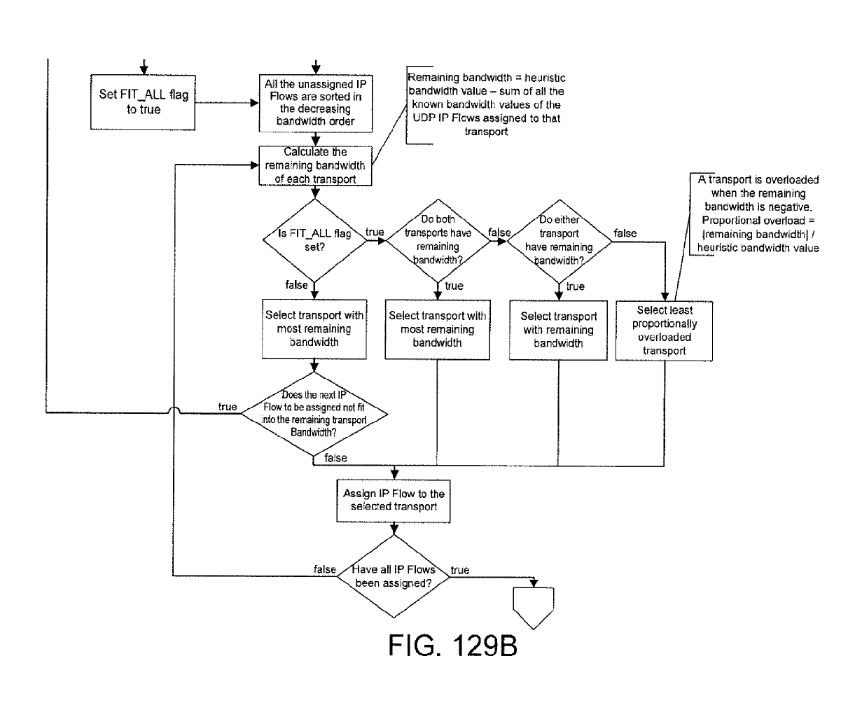

A UDP IP Flow assignment process flow in accordance with an embodiment may be shown in FIGS. 129A-B. For UDP IP Flows that may not have a policy of No Preference, this logic in the CGW may assign these UDP IP Flows to their used or preferred transports. For the remaining IP Flows, the CGW may sort them in order of decreasing bandwidth usage and may attempt to assign the IP Flow to the transport that has the most capacity remaining or is the least proportionally overloaded. If the transports may not have sufficient bandwidth for the No Preference IP Flows, the CGW may then try to perform this load balancing using the No Preference, Cellular Preferred, and/or Wi-Fi Preferred IP Flows.

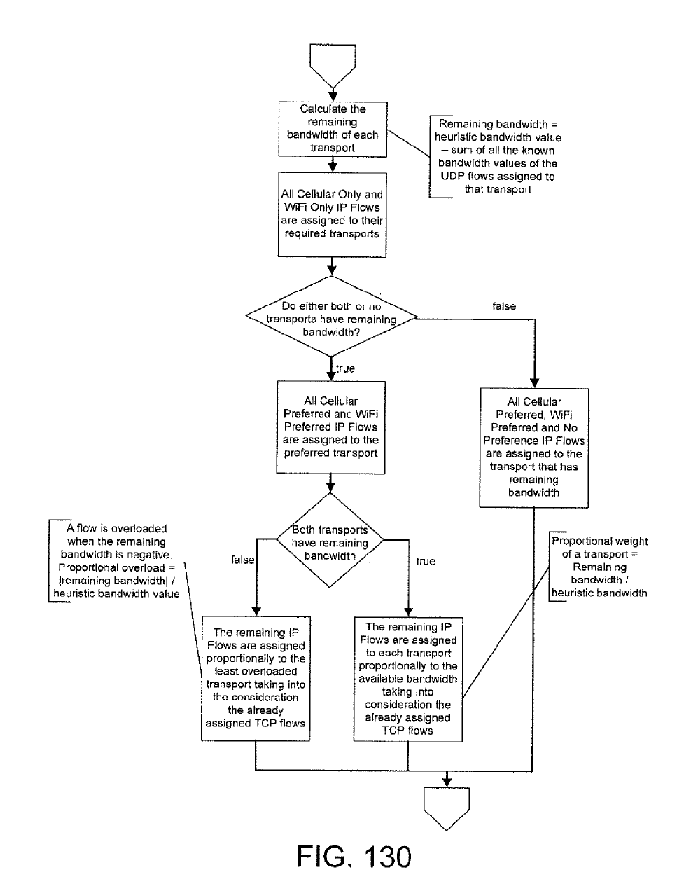

An example embodiment of a TCP IP Flow assignment process flow or method may be shown in FIG. 130. In the illustrated embodiment, TCP IP Flows that may have a preference of Wi-Fi or Cellular may be assigned to their respective transports. After this, each transport may be evaluated to determine if both, neither or one may have remaining bandwidth. If one transport may have remaining bandwidth, the CGW may assign the Wi-Fi Preferred, Cellular Preferred and No Preference TCP IP Flows to that transport. If both transports may have bandwidth available or neither may have bandwidth available, the TCP IP Flows may be attempted to be proportionally assigned onto the transports to, for example, maintain a load balance relative to each transport capacity and currently utilized bandwidth.

As described above, received Signal Strength Indicator (RSSI) measurements may be provided and/or used (e.g. in the CGW and/or UE). For example, the UE and CGW may exchange measurement information using the same SOAP transport and XML schema that may be used for the policy request and delivery. The CGW may send measurement configuration information to the UE and the UE may send RSSI measurements periodically and alerts when the RSSI measurement passes through defined values for defined periods of time. The values that may trigger these alerts may be sent in the configuration message from the CGW to the UE.

After being configured, the UE may monitor the RSSI of the transports and may send a report to the CGW upon either of these two events. First, if there may be an excursion through a defined threshold for a defined period of time, the UE may send a message to the CGW indicating which threshold may have triggered the message. Second, if a periodic timer may expire, the UE may send a message to the CGW with a RSSI measurement that may be taken by the UE as configured by the CGW.

The CGW may keep track of the state of each transport and upon receipt of each type of measurement report and may performed various functions that may be described herein. For example, with regard to RSSI measurements, the CGW may have a SOAP Server that may be running and may be ready to accept a connection from a UE and may use an agreed-upon port. The CGW may have a known LAN IP address for the pre-provisioning of the SOAP Client within the UE. The CGW may use an XML schema that man include the parameters for the CGW to configure the UE for RSSI measurements and for the UE to report the RSSI measurements to the CGW. The CGW may set the analyticsPolicy portion of the getPolicyReponse message that may be sent from the CGW to the UE, using SOAP. The RSSI configuration parameters may be extracted from the locally maintained table (e.g. included in and maintain by the CGW) that may have the threshold values to be sent to the UE to configure RSSI measurements. According to an example embodiment, the table may include these threshold values per specific IMSI and may also have a default entry for a UE that may not have an IMSI matching the specific IMSI values. The CGW may be able to accept the alertNotification message from the UE over either the Wi-Fi or Cellular transport. In some embodiments, the CGW may have event specific procedures that may be invoked upon receiving an alertNotification message from the UE and may be able to maintain the state of each transport to support this processing. The CGW may also be able to trigger processing to move certain IP flows away from transports that may be deteriorating.

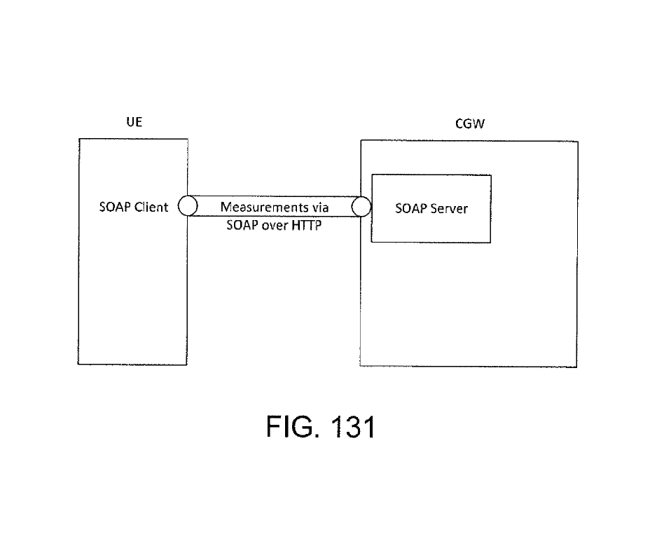

FIG. 131 shows an example embodiment of a configuration of a UE and a CGW that may provide and/or use measurements. The CGW may have a SOAP Server that may interact with the SOAP Client within the UE. The SOAP Server may configure the UE to take RSSI measurements. The UE may take the RSSI measurements according to the configuration supplied by the CGW and may issue measurements reports to the CGW upon certain events occurring.

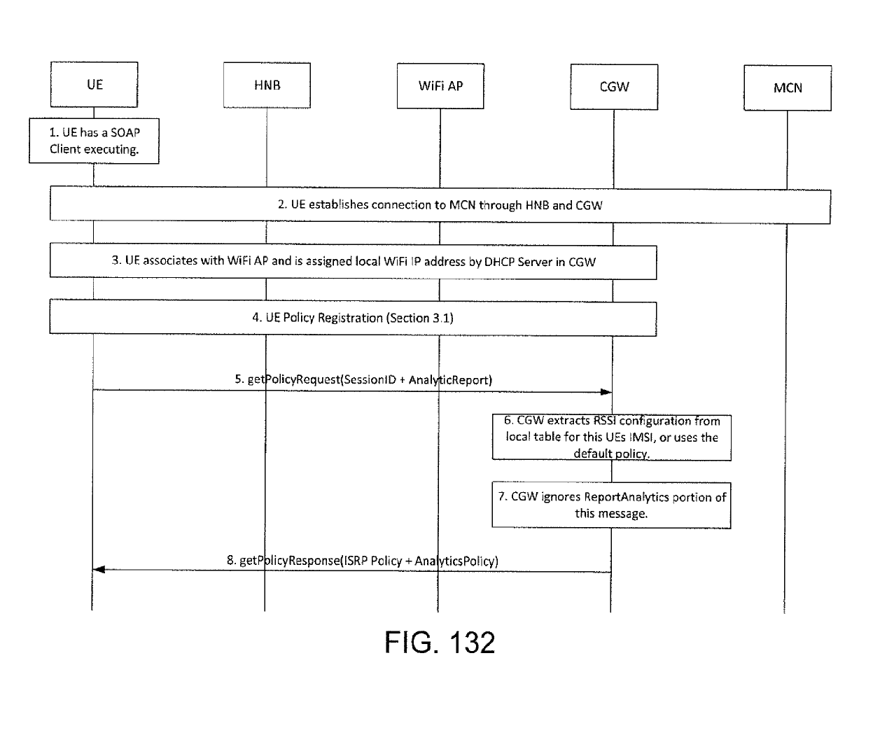

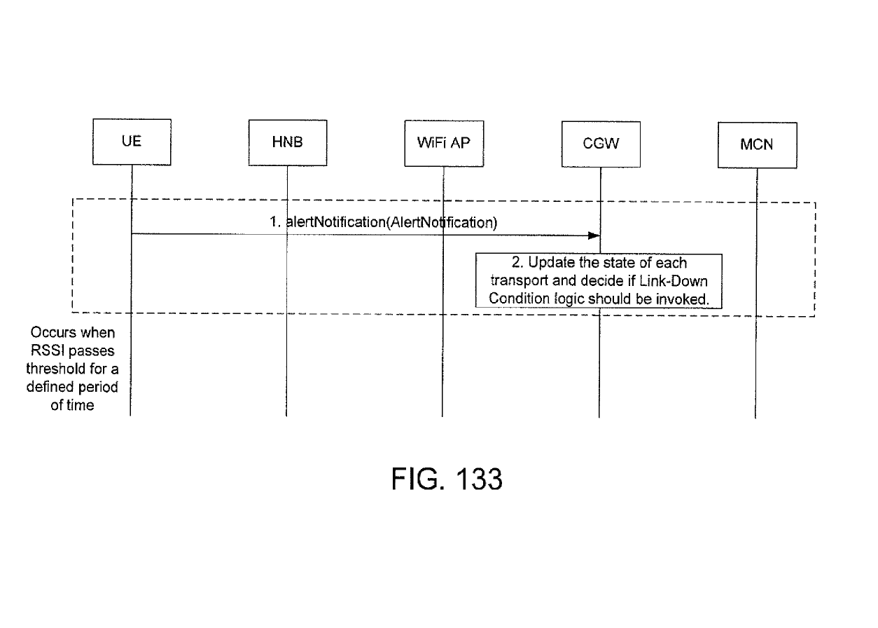

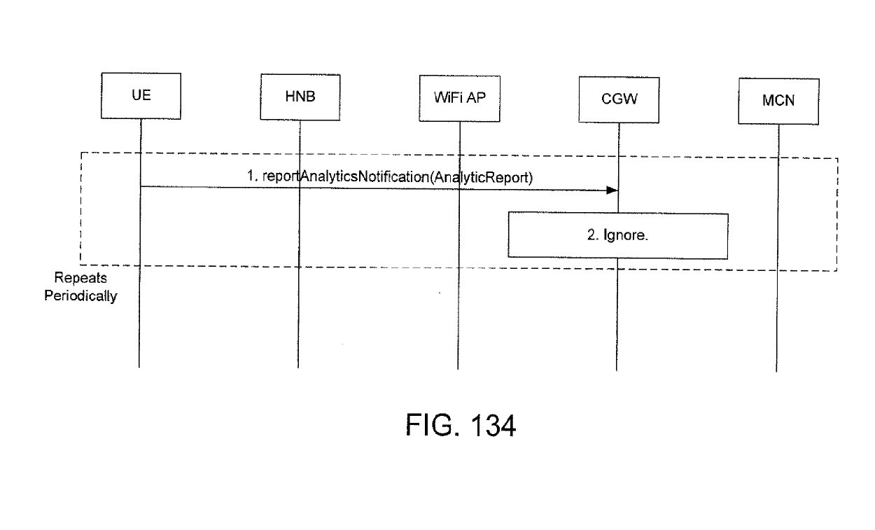

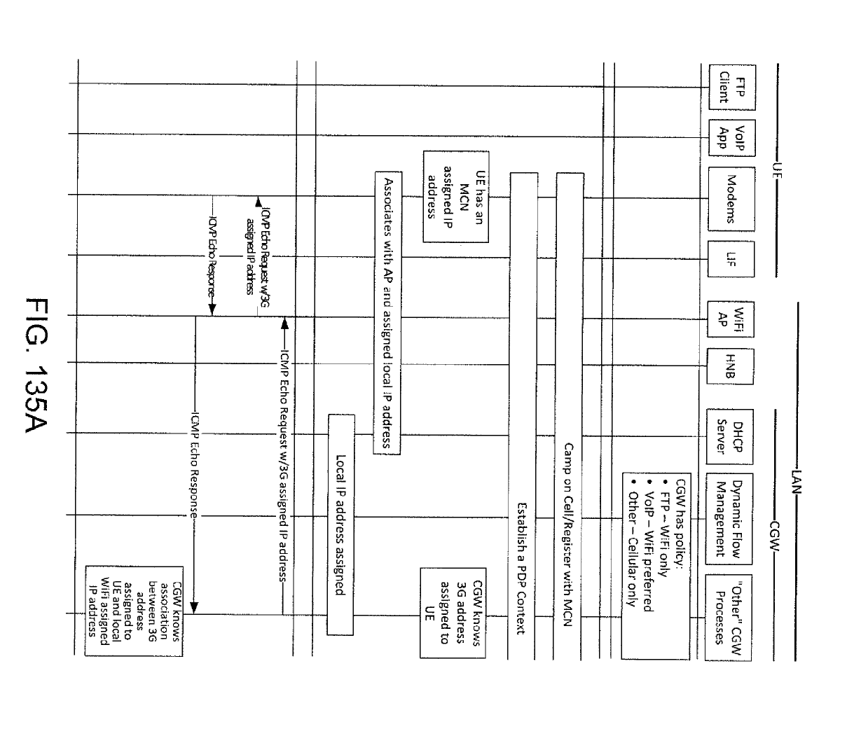

An example MSC describing the interaction for configuring the UE to perform measurements may be shown in FIG. 132. FIGS. 133-134 show example subsequent interactions for reporting of the measurements from the UE to the CGW. Referring to FIG. 132, at 1, the UE may have a SOAP Client that may be executing. At 2 and 3, the UE may perform actions in the presence of the CGW. At 4, the UE may register with the SOAP policy Server. At 5, the UE may issue the getPolicyRequest message to the CGW. This message may include, for example, the SessionID and analyticReport. At 6, the CGW may use the SessionID to determine which UE may be making this request. Once the CGW may have extracted the SessionID (which may be the IMSI), the CGW may extract from its internal table the RSSI measurement configuration parameters. An example of the parameters that may be included in this table may be shown in Table 10 below. In an embodiment, the IMSI field may be a 15-digit IMSI or the string “Default.” Based on the configuration, the UE may issue a measurement report periodically.

According to an example embodiment, an Analytics Reporting Interval may determine how often a UE may issue a periodic measurement report. For example, if the Analytics Reporting Interval may be set to 120 seconds, the UE may issue a periodic measurement report every two minutes. An Access Network Type may be used to define which transport the Network Based Policies may be specified. The Network Based Policies may be repeated once per transport. As such, if there may be two transports, there may be two Network Based Policy entries, one for Wi-Fi, the other for Cellular. The Number of Readings and Reading Periods parameters may configure the UE as to what to include in the periodic measurement report. The Number of Readings may also configure the UE for how many readings to include while the Reading Periods may also configure the UE as to how often to take a measurement. For example, the Number of Readings may be set to six and the Reading Periods may be set to 20 seconds. For such a configuration, the measurements reports from the UE may include the last six RSSI measurements, each taken 20 seconds apart. In some embodiments, the UE may be configured such that it may not send the periodic reports. Further, it may be possible to configure the UE to send periodic reports on one of the two transports or both of the transports. The Low Signal Alarm parameters in such a message may configure the UE as to when to issue a notification to the CGW that a transport's quality may have traversed through the threshold for a defined period of time. According to an embodiment, a Name field may be used to provide a unique name to identify this message for the specific UE. For example, in some embodiments, the CGW may set the Name field to either “Wi-Fi” or “Cellular.” The Minimum Level parameters may be the percent of signal quality that may be used to trigger the alarm and the Seconds Below may be how long the signal quality may be below (or subsequently above) to set or reset the alarm.

TABLE 10

| | Analytics Policy | | | | | | |
|---|---|---|---|---|---|---|---|
| | | Network Based Policies | | | | | |
| | Analytics | | | | Low Signal Alarm | | |
| | Reporting | Access | | Reading | | | Seconds |
| | Interval | Network | Number | Periods | | Minimum | Below |
| IMSI | (seconds) | Type | Readings | (seconds) | Name | Level | (seconds) |
| 123456789012345 | 120 | 3 | 6 | 20 | “Wi-Fi” | 15 | 2 |
| . . . | . . . | . . . | . . . | . . . | . . . | . . . | . . . |
| Default | 120 | 3 | 6 | 20 | “Wi-Fi” | 15 | 2 |

At 7, the CGW may ignore the ReportAnalytics that may be received in the getPolicyRequest. At 8, the CGW may use the information extracted from Table 10 and may send the getPolicyResponse with the RSSI configuration information. The contents of this message may be similar to the message described above are described at 9 in FIG. 125.

After the UE may be configured, the UE may send a low signal alarm or an alert notification to the CGW as shown in FIG. 133. Table 11 shows an example alert notification in accordance with one embodiment.

TABLE 11

| | Alert | Alert |
|---|---|---|
| Session ID | Name | Data |
| IMSI of UE | “Wi-Fi” | “On” |

In an example embodiment, the Session ID may indicate which device may have issued the alarm. The Alert Name may be used to indicate the alert type and may be the same value or a similar value that may be sent to the UE in the getPolicyResponse message. The Alert Data may be either “On” or “Off.” According to an embodiment, the value of “On” may be used to indicate that the RSSI signal may have dropped below the configured threshold for the configured time period. If the RSSI signal may recover and go above the configured threshold for the configured time period, the UE may issue an Alert Notification message with the Alert Data field set to “Off.” An example of the Alert Notification message activating the alarm may be as follows:
1. SessionId=IMSI received from the CGW in the RegisterResponse
2. AlertName=“Wi-Fi” (which may be in the PolicyResponse message that may be received from the CGW)
3. AlertData=“On” (indicating that the alarm may have turned on)

Additionally, if the RSSI may recover and go above the configured threshold for a defined period of time, the UE may issue an Alert Notification to deactivate the alarm as follows:
1. SessionId=IMSI received from the CGW in the RegisterResponse
2. AlertName=“Wi-Fi” (which may be in the PolicyResponse message that may be received from the CGW)
3. AlertData—xsd:string—“Off” (indicating that the alarm may have turned off)

Upon reception of the Alert Notification, the CGW may invoke the process flow described below that calculates the state of each transport and may decide if a link-down condition exists.

After the UE has been configured, the UE may send periodic reports and a reports analytics notification depending on how it may be configured as shown in FIG. 134. An example of the Report Analytics message may be shown in Table 12.

TABLE 12

| | Analytic Report | | | | |
|---|---|---|---|---|---|
| | | Access Network Area | | Reading | |
| Session | Access Network | 3GPP | WLAN | | Signal |
| ID | Type | Location | Location | Time | Quality |
| IMSI of | “Wi-Fi” | N/A | SSID value | 10 | 25 |
| UE | | | | 20 | 35 |
| | | | | 30 | 40 |
| | | | | 40 | 35 |
| | | | | 50 | 45 |
| IMSI of | “Cellular” | PLMN value | N/A | 10 | 33 |
| UE | | | | 20 | 28 |
| | | | | 30 | 22 |
| | | | | 40 | 26 |
| | | | | 50 | 41 |

According to an embodiment, the Session ID may identify the UE that may be sending the Report. Additionally, the Access Network Type may indicate for which transport the report may be generated. In an example embodiment, one report may have a single Analytic Report for a single transport or may have multiple Analytic Reports, one for each transport. For each Analytic Report, either the cellular (e.g. 3GPP) location or WLAN location information may be included. For 3GPP, the PLMN may be included. For WLAN, the SSID may be included. The Reading field may include a number of measured parameters related to the transport and this field may be repeated several times (e.g. as defined by the configuration from the CGW). Two other fields that may be provided and/or used may include a timestamp and a signal quality. According to example embodiments, the timestamp may be in POSIX time and the signal quality may be a percentage where a value of 100 may indicate full quality. An example of an Analytics Report may be as follows:

SessionId=IMSI received from the CGW in the RegisterResponse

Analytics
a. AccessNetworkType=3
b. AccessNetworkArea=DC
c. Reading(1)
   i. Timestamp=X (denotes time of measurement)
   ii. SignalQuality=55
   iii. Throughput=NI
   iv. Latency=NI
   v. AvgPacketLoss=NI
d. Reading(2)
   i. Timestamp=X+12 seconds (denotes time of measurement)
   ii. SignalQuality=67
   iii. Throughput=NI
   iv. Latency=NI
   v. AvgPacketLoss=NI
e. Reading(3)
   i. Timestamp=X+24 seconds (denotes time of measurement)
   ii. SignalQuality=78
   iii. Throughput=NI
   iv. Latency=NI
   v. AvgPacketLoss=NI
f. Reading(4)
   i. Timestamp=X+36 seconds (denotes time of measurement)
   ii. SignalQuality=53
   iii. Throughput=NI
   iv. Latency=NI
   v. AvgPacketLoss=NI
g. Reading(5)
   i. Timestamp=X+48 seconds (denotes time of measurement)
   ii. SignalQuality=36
   iii. Throughput=NI
   iv. Latency=NI
   v. AvgPacketLoss=NI

As shown in the foregoing example, the Analytics message may include 5 readings, each made 12 seconds apart. In an embodiment, the above values may be examples and both the CGW and UE may be able to support different values for these parameters. Also, in the foregoing example, the UE may have been configured to measure the RSSI of the Wi-Fi transport. In other embodiments, the CGW may configure the UE to report measurements on both the Wi-Fi and Cellular transports, on just one of the transports or on neither transport.

According to another example embodiment, the CGW may maintain the state of each transport (e.g. a transport state) between it and each UE. For example, the CGW may use two inputs to maintain a transport state. First, the CGW may use the alert notifications that may be received from the UE that may indicate whether or not the alarm may be on or off per transport from a specific UE. Second, the CGW may use the Wi-Fi-3G connection linkage status that may indicate whether or not a device's 3G MCN assigned IP address may be reachable through the Wi-Fi connection. Upon determining the state of a transport, the CGW may attempt to move certain IP Flows from a transport that has degraded.

Once the CGW may have configured the UE with a policy including the RSSI measurement configuration, the CGW may initialize the “state” of each transport for this particular UE to Good. For a Cellular transport, the “state” may have one of two values: good and poor. For a Wi-Fi transport, the “state” may have one of three values: good, poor, and down. As alerts may be received from the UE, the CGW may update the state of each transport. For a Cellular transport for a specific UE, the state of that transport may be updated as follows. If the CGW may receive an AlertNotification message with the alarm on from a particular UE, it may set that transport state to Poor. The CGW may know which transport the alarm may be for since the AlertName may be either Wi-Fi or Cellular. If the CGW may receive an AlertNotification message with the alarm off from a particular UE, it may set that transport state to Good. The CGW may know which transport the alarm may be for since the AlertName may be either Wi-Fi or Cellular.

For a Wi-Fi transport for a specific UE, the state of that transport may be updated as follows. If the CGW may receive an AlertNotification message with the alarm on from a particular UE, it may set that transport state to Poor. The CGW may know which transport the alarm may be for since the AlertName may be either Wi-Fi or Cellular. If the CGW may receive an AlertNotification message with the alarm of from a particular UE, it may be set that transport state to Good. The CGW may know which transport the alarm may be for since the AlertName may be either Wi-Fi or Cellular.

Based on the current state of a transport and the transition from the previous state to the current state, the CGW may attempt to move flows away from a transport that may be deteriorating. In an embodiment, the CGW may not be able to do this without looking at the state of the other transport. When the CGW may attempt to move flows away from a transport that may be deteriorating, the CTW may also move flows to the other transport. If that transport may also be deteriorating, flows may not be moved from one deteriorating transport to another deteriorating transport. Therefore, after updating the state of each transport for a particular UE upon receipt of the AlertNotification from the UE, the CGW may perform one or more of the following procedures: if both transports may be transitioned from Good to Poor, do nothing; if both transport may be transitioned from Poor to Good, do nothing; if one transport may go from Good to Poor and the other transport may be Good, then attempt to move IP Flows from the Poor transport to the Good transport; if one transport may go from Poor to Good and the other transport may be Poor, then attempt to move IP Flows from the Poor transport to the Good transport; other permutations, do nothing; and the like. While other procedures and/or methods may be used in additional embodiments, flows may also be triggered to be moved from a transport that may have a poor RSSI to a transport that may have a good RSSI in those procedures and/or methods.

As described herein (e.g. above), Dynamic Flow Management (DFM) for a link-down condition may be provided and/or used (e.g. by the CGW). For example, in an embodiment, the following (e.g. logic) associated with DFM (e.g. for a link-down condition) may be invoked during the RSSI measurement exchange under certain conditions. Example conditions that may trigger such DFM and the logic associated therewith may include one transport deteriorating, (good RSSI to poor RSSI), while the other transport may have a good RSSI or one transport improving (bad RSSI to good RSSI), while the other transport may have a poor RSSI. When one of these events may occur, the processing described below may be utilized. This processing moves IP Flows, for the specific UE, from the deteriorating transport, signified by its state being Poor, to the transport with a state of Good. The criteria to be used may include the policy for each IP Flow. Additionally, in an embodiment, unlike with load balancing, when a certain number of flows may be moved per iteration of the logic to prevent thrashing, when a “link down” condition occurs, the CGW may move as many flows as possible based on the routing rules within the policy.

To implement such functionality, the CGW may (e.g. when triggered) move IP Flows from a poor RSSI transport to a good RSSI transport based on the following criteria. The policy for each IP Flow having a routing rule of “No Preference” and Wi-Fi Preferred” or “Cellular Preferred” may be moved from the poor RSSI transport to the good RSSI transport. Each IP Flow that may have a routing rule of “Wi-Fi Only” or “Cellular Only” may not be moved from the poor RSSI transport to the good RSSI transport. According to some embodiments, such a rule may cause some IP Flows to get dropped, however, if a policy “forbids” the use of a transport for an IP Flow, then regardless of the event, the CGW may not violate these specific routing rules.

The CGW may have lists, tables or some other constructs (herein referred to as Current Routing Decision Table) that may include or provide one or more of the following for each current IP Flow: UE Identity; Current transport; Routing Rule as per the policy; and the like

When the foregoing (e.g. this logic) may be executed, the CGW may know one or more of the following as described above: UE Identity (e.g. and which UE sent the measurement report); Poor transport; Good transport; and the like.

The CGW may use both sets of information to move IP Flows away from a transport that may be deteriorating by searching for matches between these two sets where the following three conditions may be met:
1. UE Identity from Current Routing Decision Table=UE Identity in measurement report.
2. Current Transport from Current Routing Decision Table=Poor Transport from measurement report.
3. Routing Rule as per the policy from Current Routing Decision Table=“No Preference”, “Wi-Fi Preferred” or “Cellular Preferred”

An IP Flow that may match the above three criteria may be e moved from the Poor transport to the Good transport and the Current Routing Decision Table may be updated.

According to an embodiment (e.g. as described above), a policy may be used by the CGW to make routing decisions. The policy may be locally stored within the CGW. Additionally, a dynamic flow management for load balancing based on a number of IP Flows and deep packet inspection (DPI) that may be may be used to identify various types of Internet data traffic, such as, HTTP video, FTP, and VoIP, for example, may be provided and/or used (e.g. by a CGW) as described herein.

As used herein, references to “number of IP flows” in various embodiments may refer the sum of IP flows associated with VoIP, HTTP Video and FTP. In such embodiments, it may not include IP Flows not associated with VoIP, HTTP Video and FTP. For example, an IP Flow that may carry DNS queries and responses may not be included in the “Number of IP Flows.” An IP flow may be a set of packets that have the same 5-tuple. Additionally, references to “VoIP” may imply VoIP using the SIP protocol for signaling.

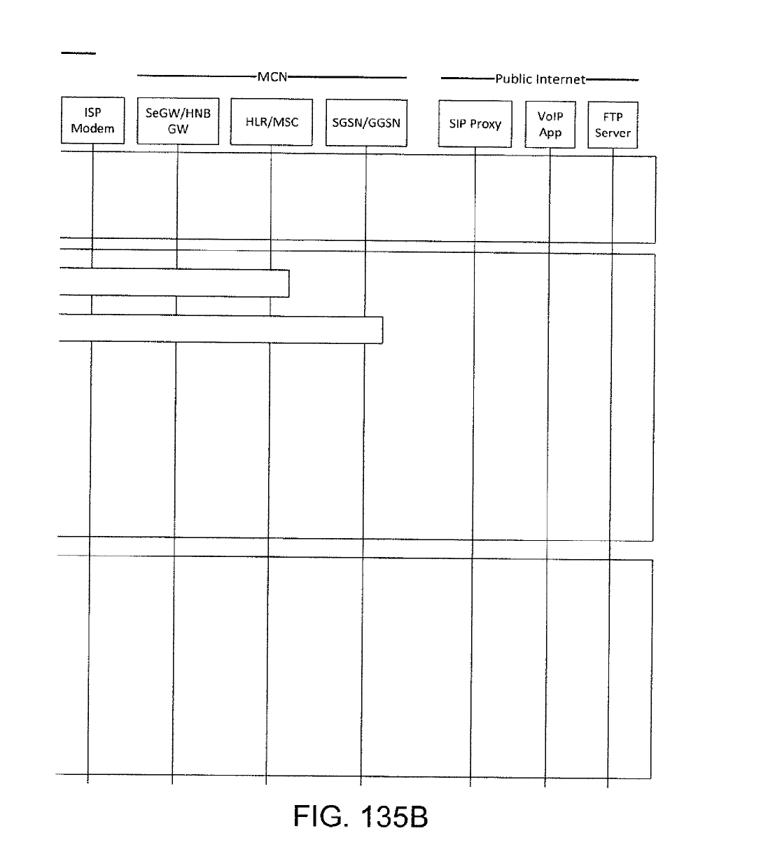

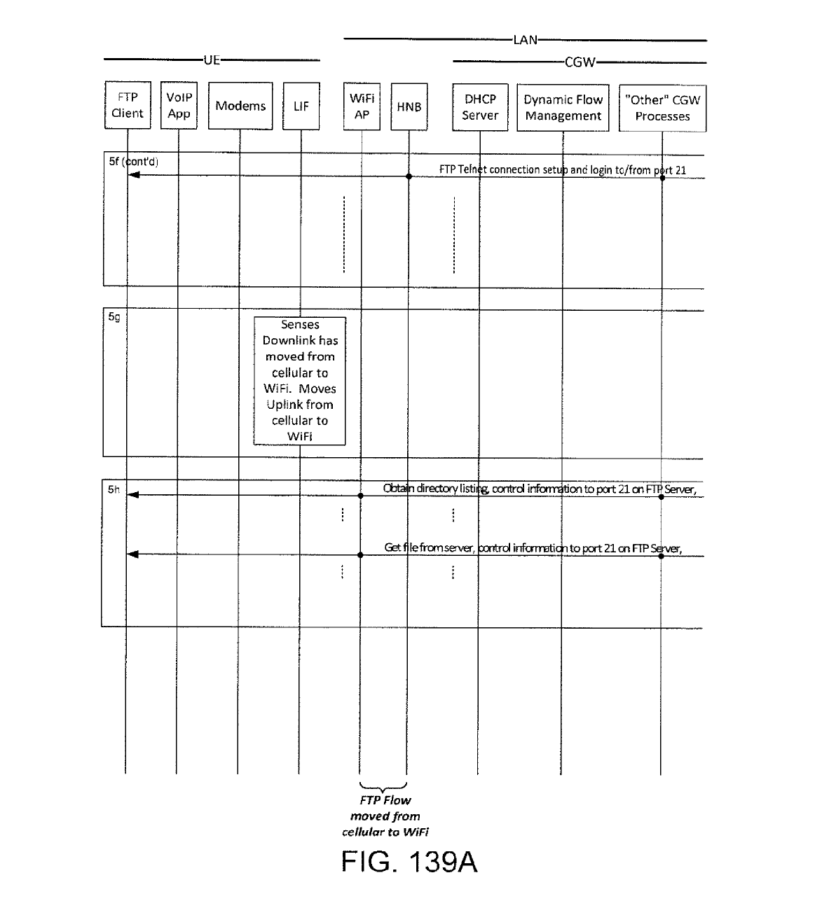

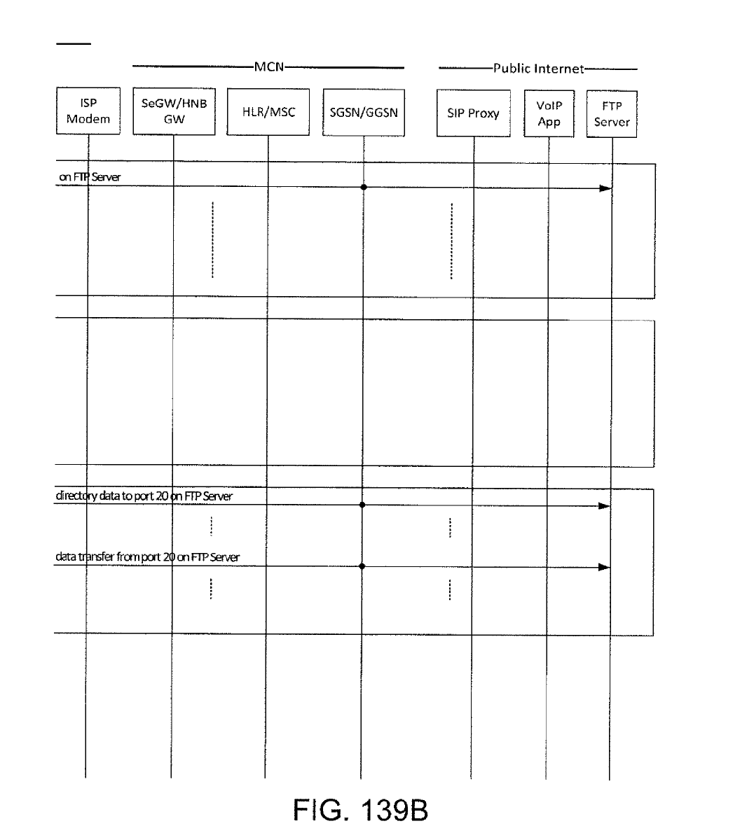

According to an example embodiment, a method using the CGW for providing IP flows may described below with reference to FIGS. 135A-141B. The procedures and sub-procedures associated with the method described below may reference or be associated with the corresponding numbered blocks in FIGS. 135A-141B.

Referring to FIG. 135A-B:
1. A CGW may have a policy that may state FTP IP flows may be transmitted via Wi-Fi, HTTP Video IP flows may be transmitted via Wi-Fi, VoIP IP flows may be transmitted preferably via Wi-Fi, other IP flows may be cellular, and the like. In one embodiment, the policy may be a local file read from within the CGW. In an example embodiment, there may be one profile for the UEs or specific profiles for specific UEs or classes of UEs, for example.
2. A UE may connect through the CGW with both a Wi-Fi and cellular connection.
3. The CGW may perform a 3G/Wi-Fi association to learn that the UE may have both a Wi-Fi and cellular connection.

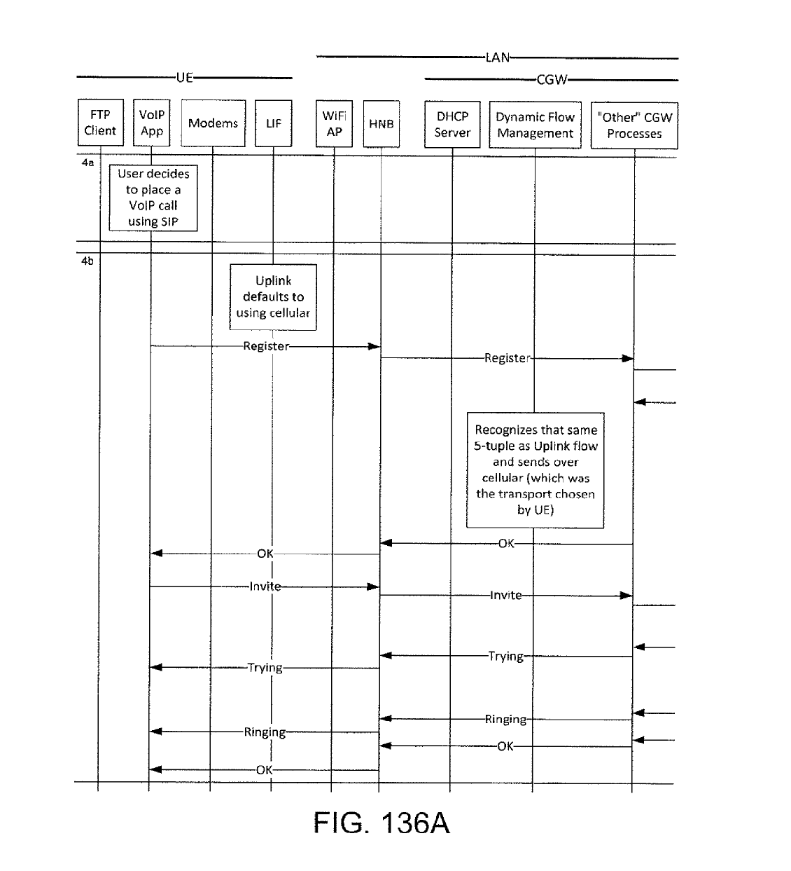

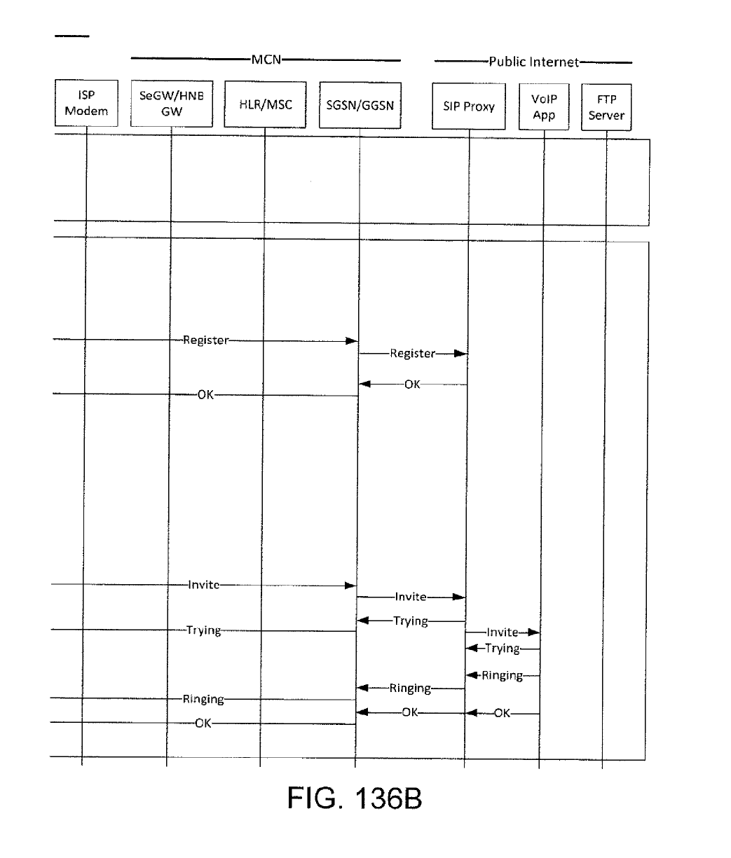

Referring to FIGS. 136A-B:
4. On the UE, a VoIP session may start with an entity outside the CGW LAN and outside the CN or CNE (e.g. public Internet traffic that may pass through the MCN).
   a. For example, a user may start the VoIP session.
   b. The UE may default to using cellular (e.g. for such as session) so the first uplink packets of this IP Flow may be sent over cellular. The CGW may learn this and may send the downlink packets associated with this 5-tuple over cellular to the UE.

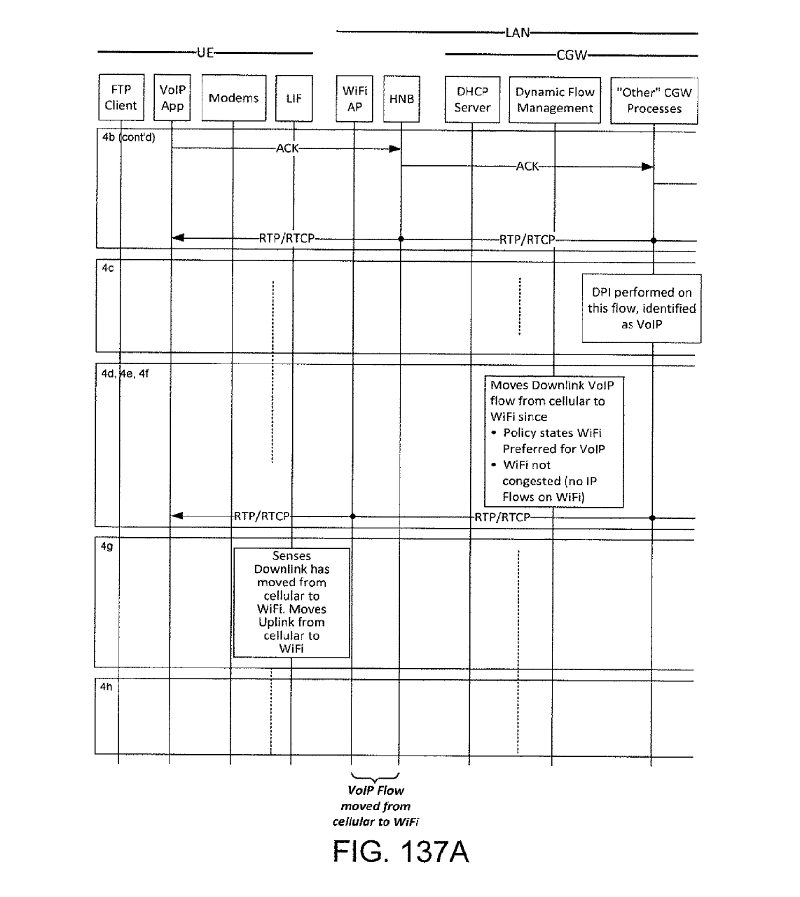

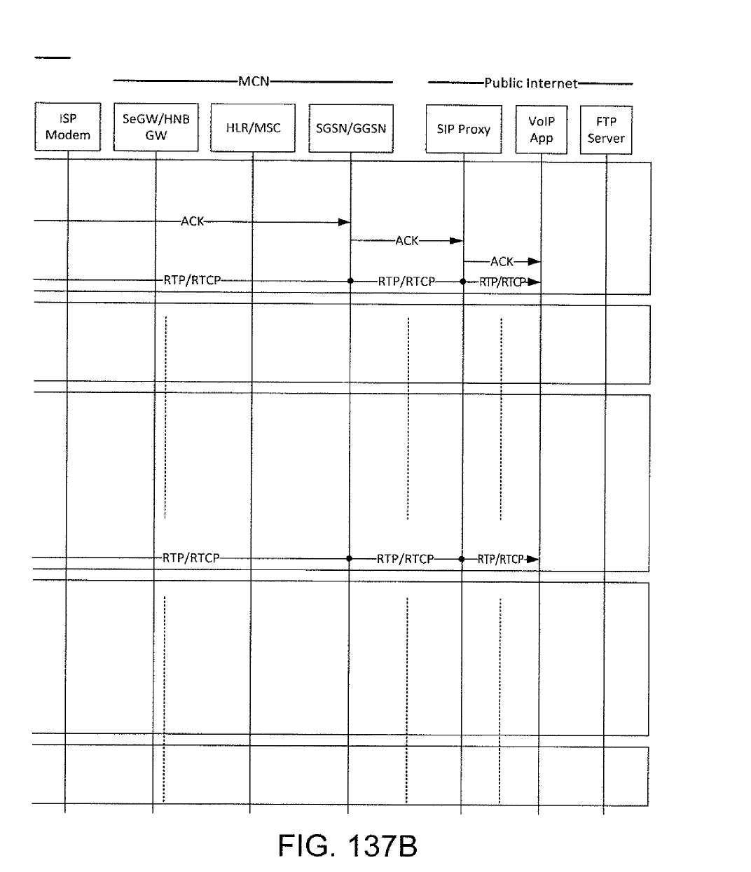

Referring to FIGS. 137A-B, which may be a continuation of block 4 from FIGS. 136A-B:
a. As the VoIP session may be established, the CGW may perform DPI and may learn the flow may be VoIP.
b. The CGW may then consult the policy, which may state that VoIP may wish to use or prefer Wi-Fi.
c. The CGW may measures the number of IP flows through it and may learn that the Wi-Fi transport may not be occupied (e.g. Number of IP Flows=0).
d. The CGW may begin sending the downlink packets associated with this IP flow over Wi-Fi.
e. The UE, in an embodiment, may then sense that the downlink packets associated with this IP flow may be the packets being received over Wi-Fi. The UE may then begin sending uplink packets associated with this IP Flow over Wi-Fi.
f. The VoIP session may continue with both the uplink and downlink data being sent over Wi-Fi.

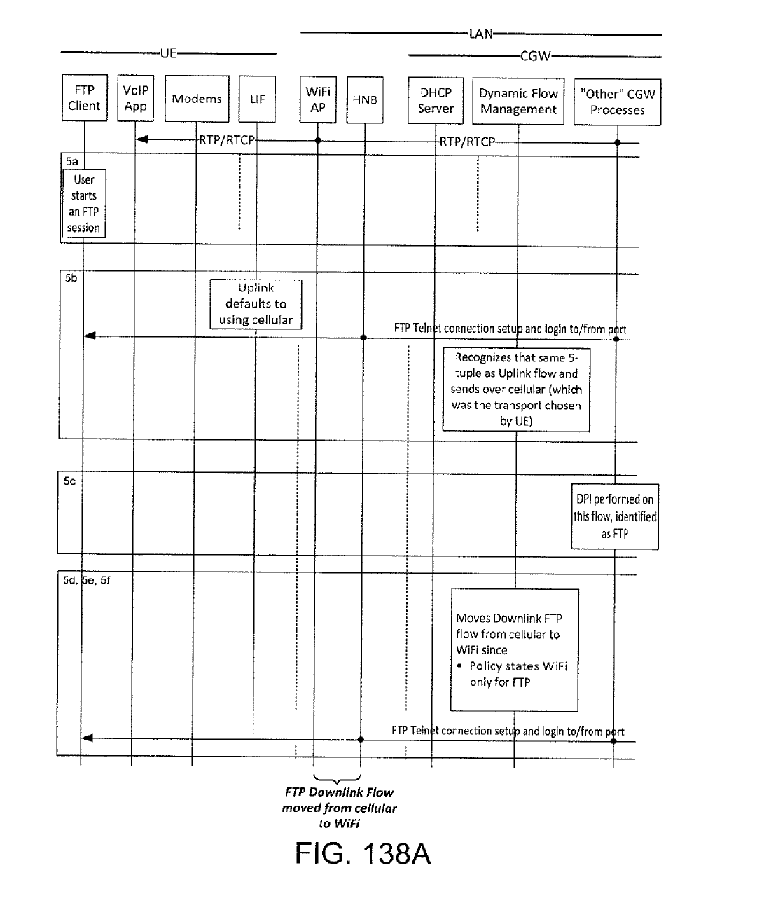

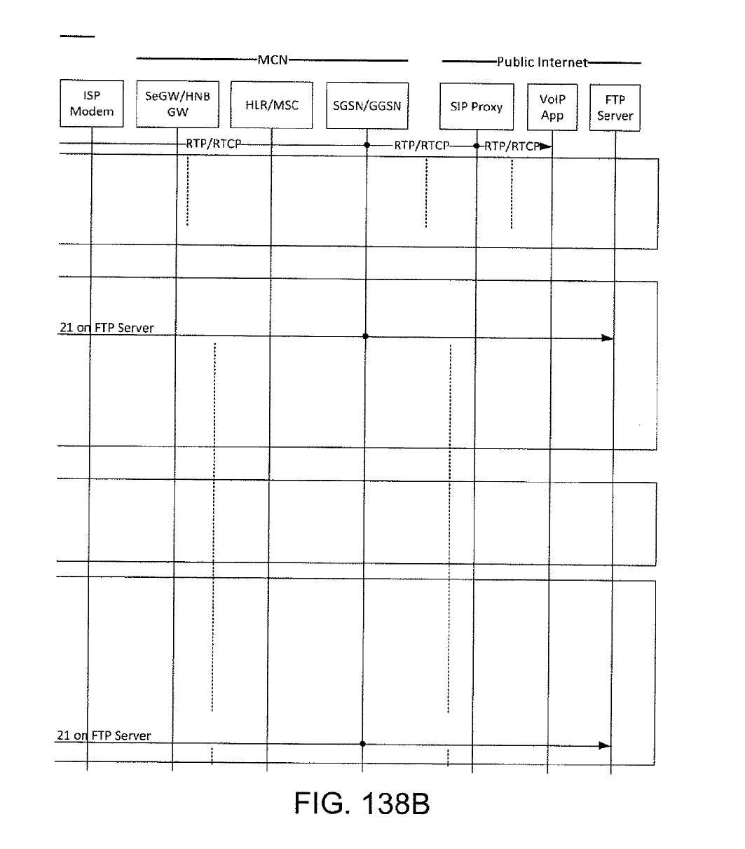

Referring now to FIGS. 138A-B and 139A-B:
5. On the same UE, an FTP transfer may be started.
   a. For example, a user may start an FTP session.
   b. The UE may default to using cellular (e.g. for such a session) so the first uplink packets of this IP Flow may be sent over cellular. The CGW may learn this and may send the downlink packets associated with this 5-tuple over cellular to the UE.
   c. As the FTP session may be established, the CGW may perform DPI and may learn the flow may be FTP.
   d. The CGW may consult the policy, which may state that FTP may use Wi-Fi.
   e. The CGW may assign this IP Flow to Wi-Fi since it may be included or instructed by the policy.
   f. The CGW may begin sending the downlink packets associated with this IP flow over Wi-Fi.
   g. The UE may then sense that the downlink packets associated with this IP flow may be the packets being received over Wi-Fi. The UE may then begin sending uplink packets associated with this IP Flow over Wi-Fi.
   h. The FTP session continues, with both the uplink and downlink data being sent over Wi-Fi.

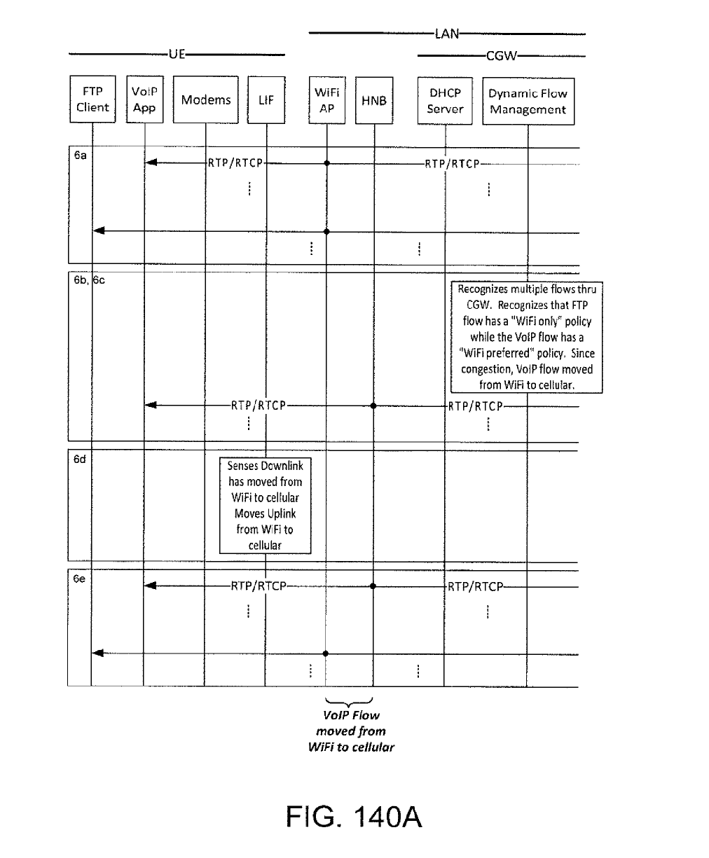

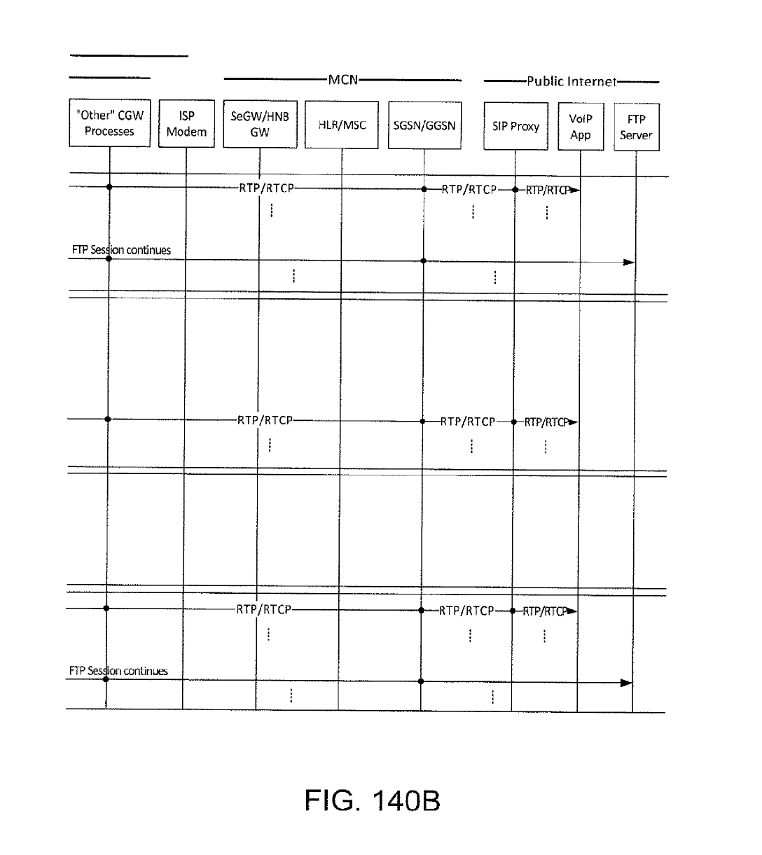

Referring now to FIGS. 140A-B:
6. Periodically, the CGW may review the flows that may be passing through it versus the policies for those flows and may determine if IP Flows may be moved to perform load balancing of the traffic flowing through it. In an embodiment, while transports may be reviewed periodically and load balancing may be performed based on this review, it may not be limited. For example, this review may be triggered by a variety of events such as the introduction of a new IP Flow, the ending of an existing IP Flow, the expiration of a timer, and the like, for example.
   a. In such an embodiment, there are two flows, one that may be directed to or instructed use Wi-Fi (e.g. the FTP Session) and another that may prefer to use Wi-Fi (e.g. the VoIP session).
   b. The CGW may decide or determine to move the VoIP flow from Wi-Fi to cellular since the cellular transport may not be loaded (e.g. Number of IP Flows=0), the Wi-Fi transport may have other IP Flows, and the policy for those flows on Wi-Fi may allow the movement of the VoIP flow.
   c. The CGW may then start sending the downlink packets associated with the VoIP IP Flow over cellular.
   d. The UE may senses that the VoIP packets may be the flows being delivered over cellular and may begin sending the uplink packets via cellular.
   e. At this point, both the uplink and downlink packets associated with the VoIP flow may be delivered over cellular. The uplink and downlink packets associated with the FTP IP Flow may still be delivered over Wi-Fi.

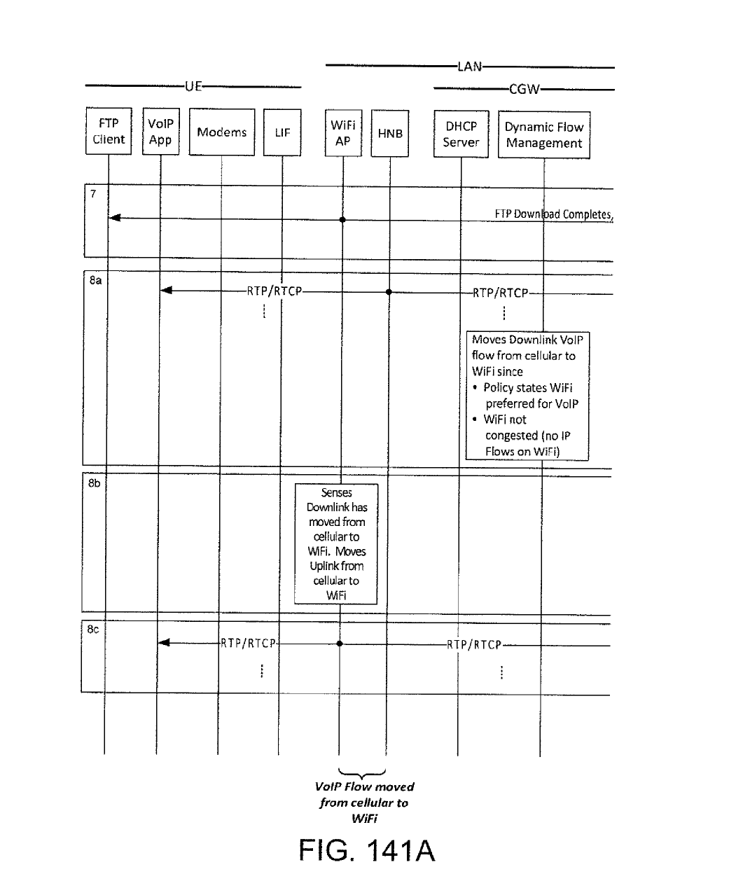

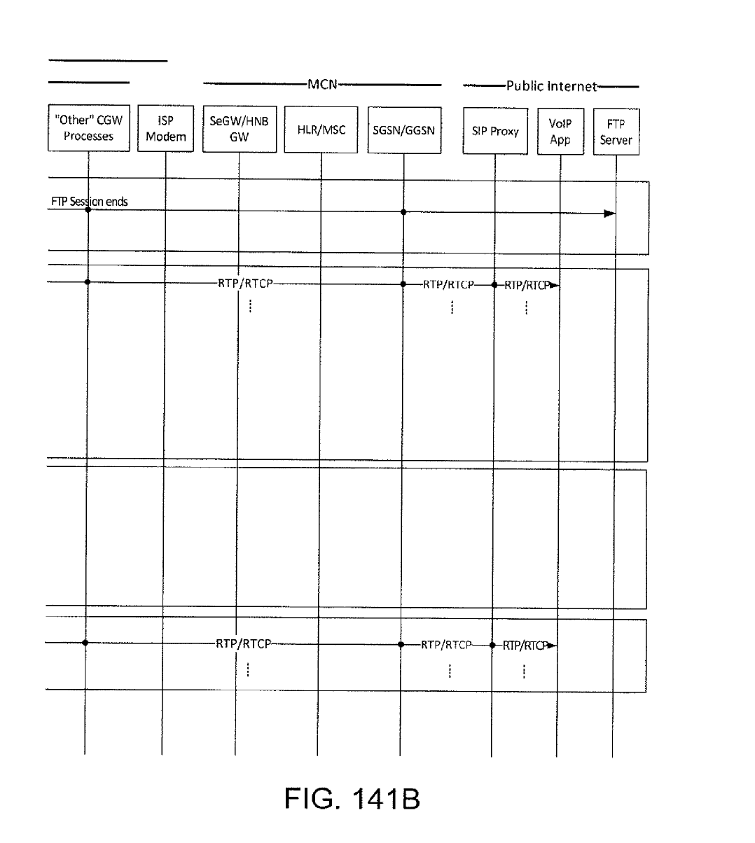

Referring now to FIGS. 141A-B:
7. The FTP transfer may then conclude and the FTP session may end.
8. As part of a periodic review of the flows and policies for those flows, the CGW may determine that the Wi-Fi connection may not be longer in use (e.g. Number of IP Flows=0 as the FTB session may have ended at 7) and may decide to move the VoIP flow back to Wi-Fi.
   a. The CGW may begin sending the downlink packets associated with this IP flow over Wi-Fi.
   b. The UE may sense that the downlink packets associated with this IP flow may be the packets being received over Wi-Fi. The UE may then begin sending uplink packets associated with this IP Flow over Wi-Fi.
   c. The VoIP session may continue with both the uplink and downlink data being sent over Wi-Fi.

In accordance with various embodiments, the architecture for a CGW described herein may support ability to identity an IP Flow based on DPI, the ability to count the number of HTTP Video, FTP, VoIP flows, and/or other types of flows, the ability to determine that, based on a policy and the number of IP Flows, some flows may be moved between Wi-Fi and Cellular and some flows may not be moved between Wi-Fi and cellular, and the ability to move one or more IP Flows from one transport to another. In an embodiment, UEs or devices such as a wireless terminal device or a WTRU communicating with the CGW may be able to support dynamic flow management and may be able to configure flows such that uplink may follow the downlink.

Example functional data structures that may be provided and/or used (e.g. in the CGW, and the like) may be shown below. For example, Table 13 may show an example Rule Table that may be included in a data structure that may be provided and/or used.

TABLE 13

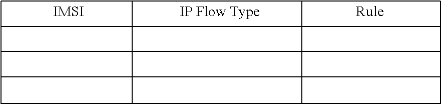

As shown in Table 13, there may be an entry for each IP Flow per IMSI or per a generic IMSI (e.g. it may apply to IMSIs) that may describe how each IF Flow may be routed. Example IP Flow types may include HTTP Video, VoIP/SIP, FTP, and Other. Example routing rules associated with the IP Flow types may include, for example, no preference, cellular preferred, Wi-Fi preferred, cellular (e.g. cellular only), and Wi-Fi (e.g. Wi-Fi only).

In some embodiments, IP Flow Types HTTP Video, VoIP/SIP, and FTP may use any of the rules listed above. However, IP Flow Type Other may have a rule of Cellular or Wi-Fi. Additionally, in embodiments, if the policy may be stored locally within the CGW, the CGW may not check to ensure the policy may adhere to such rules or instructions.

Table 14 may show an example device linkage table that may be included in a data structure that may be provided and/or used.

TABLE 14

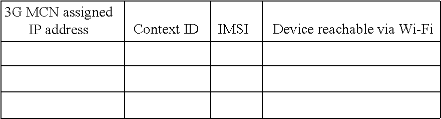

As shown in Table 14, a device linkage table may be populated for each device that may be assigned a PDP context through the CGW with the IMSI of that device, the Context ID that may be used for communications between the HNB and HNB GW, and 3G MCN that may be assigned IP address by the GGSN. Additionally, the CGW may populate the Device reachable via Wi-Fi field as a result of the 3G/Wi-Fi association done within the CGW. This field may be a Boolean.

Table 15 may show an example routing policy table that may be included in a data structure that may be provided and/or used.

TABLE 15

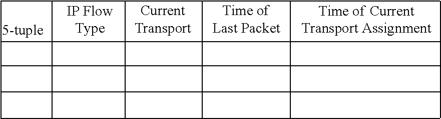

As shown in Table 15, the current routing policy table may maintain for each 5-tuple the IP Flow Type, the current transport that may be used to route the 5-tuple, the time the last packet of this 5-tuple that may have been processed and the time that the current transport field may have been set to its current value. The 5-tuple may include low IP address, high IP address, low port number, high port number, and IP Type. In some embodiments, example IP Flow Types may include HTTP Video, VoIP/SIP, FTP, Pending and Unknown.

The IP Flow Types of HTTP Video, VoIP/SIP and FTP may be assigned if and when an IP Flow may be identified by the DPI module to be of those specific types. An IP Flow Type of Pending may be used to indicate that the DPI module may be in the process of figuring out what the specific flow may be. An IP Flow Type of Unknown may be used when the DPI module may have attempted to, but may have been unable to, determine the specific flow type.

Example current transport values may be Wi-Fi and Cellular. The Time of Last Packet field may include the time when the most recent packet may have been received for that IP Flow. This may be used when the current routing policy table may be periodically reviewed to review stale IP Flow information. The Time of Current Transport Assignment may include the time when the current transport field may have been last modified. This may be used when performing load balancing to prevent an IP Flow from thrashing between transports.

Table 16 may show an example transport IP Flow thresholds table that may be included in a data structure that may be provided and/or used.

TABLE 16

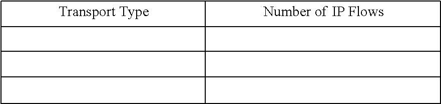

As shown in Table, The transport IP Flow thresholds table may include the number of IP Flows per Transport Type. This table may be used when deciding or determine whether or not a transport may be congested or may not be congested. Example Transport Type values may include Wi-Fi and Cellular. The Number of IP Flows may be an integer values greater than or equal to one. In an embodiment, for a specific transport, the Minimum may be less than the Maximum.

Example functionality of a CGW that may use the data structures described herein may be as follows. For example, in one embodiment, when the CGW may be started, the CGW may read in or may have resident in its memory, or otherwise obtain or receive a policy or policies in a rule table (e.g. of the structure or format shown in Table 13) and may read in or have resident in its memory, or otherwise may obtain or receive a transport IP thresholds table (e.g. of the structure or format shown in Table 16). Examples of such tables (e.g. a rule table and a transport IP thresholds table) with values may be shown below in Table 17 and Table 18.

TABLE 17

| IMSI | IP Flow Type | Rule |
|---|---|---|
| All | FTP | Wi-Fi |
| All | HTTP Video | Wi-Fi |
| All | VoIP | Wi-Fi Preferred |
| All | Other | Cellular |

TABLE 18

| Transport Type | # of IP Flows |
|---|---|
| Cellular | 1 |
| Wi-Fi | 1 |

In an embodiment, Table 17 may be a rule table during an initial CGW state and, similarly, Table 18 may a transport table during an initial CGW state. According to some embodiments, these tables may be fixed for the duration of when the CGW may be powered-up. In other embodiments, the system operator may change the contents of these tables when the CGW may not be running.

Additionally, the CGW may be cognizant of a UE connecting to the MCN and of a UE connecting to the Wi-Fi AP. The DHCP Server may be the CGW that may assign the Wi-Fi modem within the UE a local IP address after it may associates with the Wi-Fi AP. The 3G modem within the UE may also camp on the HNB. The UE may register with the MCN and the HNB may register the UE with the HNB GW. During the HNB-to-HNB GW registration of the UE, the CGW may learn the IMSI and Context ID for this UE. The CGW may populate a device linkage table (e.g. that may be of the format or structure shown in Table 14) with such information. After the 3G registration may be complete, the UE may establish a PDP context with the MCN and may be assigned a 3G MCN assigned IP address. This IP address may be entered into the device linkage table. An example device linkage table populated during a UE connection may be shown as Table 19.

TABLE 19

| 3G MCN | | | Device |
|---|---|---|---|
| assigned | Context | | reachable |
| IP address | ID | IMSI | via Wi-Fi |
| 123.45.67.890 | 123 | 310 150 123456789 | |

After the UE may have both a local Wi-Fi IP address and a PDP context, the CGW may issue an ICMP Request with the 3G MCN assigned IP address and may wait for a reply. If there may be a reply, the CGW may know that the device (e.g. the UE) may be reachable via both the cellular and Wi-Fi transports. An example of a device linkage table populated during UE Wi-Fi/3G PDP context may be shown in Table 20.

TABLE 20

| 3G MCN | | | Device |
|---|---|---|---|
| assigned | Context | | reachable |
| IP address | ID | IMSI | via Wi-Fi |
| 123.45.67.890 | 123 | 310 150 123456789 | Yes |

After the UE may have established a PDP context and may have a local Wi-Fi connection, the device may send and receive data. The CGW may logic to know how to route packets associated with an IP Flow for both uplink and downlink directions. While the embodiment provided above in FIGS. 135A-141B may have a UE initiating the VoIP call (mobile originated) and initiating the FTP session, it may be possible that a session could instead be initiated towards the UE instead of from the UE. As such, the logic within the CGW may also handle the case when the first packets may either be uplink or downlink. Additionally, similar logic may be used to handle the routing of packets while the DPI module may be determining the flow type and after the flow type may have been determined.

When an uplink packet may be received from the UE by the CGW, the destination address may be analyzed. If the destination address may be within the LAN, the packet may be dispatched to that destination. If the destination address may be outside the LAN, the current routing policy table (e.g. that may be of the format or structure shown in Table 15) may be consulted and one or more of the following may be performed.

If the 5-tuple may exist in the table and the IP Flow Type may not be Pending, the packet may be sent to the MCN via the GTP/IPSec tunnels that may be established with the MCN and the Time of Last Packet in the Current Routing Policy Table may be set to the current time. If the 5-tuple may exist in the table and the IP Flow Type may be Pending, the packet may be routed to the DPI module, the packet may be sent to the MCN via the GTP/IPSec tunnels that may be established with the MCN, and the Time of Last Packet in the Current Routing Policy Table may be set to the current time. If the 5-tuple may not exist in the table, the 5-tuple may be added to the table, the IP Flow Type may be set to Pending, the Current Transport in the Current Routing Policy Table may be set to the transport on which the packet may have been received, the packet may be routed to the DPI module, the packet may be sent to the MCN via the GTP/IPSec tunnels that may be established with the MCN, the Time of Last Packet in the Current Routing Policy Table may be set to the current time, and/or the Time of Current Transport Assignment in the Current Routing Policy Table may be set to the current time.

When a downlink packet may be received by the CGW, the destination address may be analyzed. If the destination address is within the LAN, the packet may be dispatched to that destination. If the destination address may be a 3G MCN assigned IP address, the current routing policy table may be consulted and one or more of the following may be performed.

For example, if the 5-tuple may exist in the table and the IP Flow Type may not be Pending, the packet may be sent to the UE via the Current Transport in the Current Routing Policy Table for this 5-tuple and the Time of Last Packet in the Current Routing Policy Table may be set to the current time. If the 5-tuple may exist in the table and the IP Flow Type may be Pending, the packet may be routed to the DPI module, the packet may be sent to the UE via the Current Transport in the Current Routing Policy Table for this 5-tuple, and the Time of Last Packet in the Current Routing Policy Table may be set to the current time. If the 5-tuple may not exist in the table, the 5-tuple may be added to the table, the IP Flow Type may set to Pending, the Current Transport in the Current Routing Policy Table may be set to the transport indicated by the “Other” IP Flow Type in the Rule Table for this UE, the packet may be routed to the DPI module, the packet may be sent to the UE via the Current Transport in the Current Routing Policy Table for this 5-tuple, the Time of Last Packet in the Current Routing Policy Table may be set to the current time, and the Time of Current Transport Assignment in the Current Routing Policy Table may be set to the current time.

According to an embodiment, when the DPI module may determine the IP Flow type or may be unable to determine the IP Flow Type after examining a number of packets, the DPI module may update the Current Routing Policy Table with either the specific IP Flow Type or Unknown respectively.

In various embodiments, the CGW may also determine how congested each transport is when deciding on which transport to place a new “No Preference” IP Flow and when performing load balancing. In some embodiments, a transport may be defined to be either congested or not congested. For example, a search may be made through the Current Routing Policy Table and the number of VoIP, HTTP Video and FTP IP flows assigned to each transport may be counted. If the number of IP Flows may be less than the number of IP Flows for this transport from the Transport IP Flow Thresholds Table, the transport may be marked as not congested. Otherwise, the transport may be marked as congested.

The CGW (e.g. logic included therein) may execute when a new IP Flow may have been identified as either HTTP Video, VoTP, FTP, or Unknown. Table 21 indicates which transport may be selected for a newly identified IP Flow depending on the congestion on the transports and the rule for this IP Flow from the Rule Table. Upon such an execution, the Current Transport in the Current Routing Policy Table may be updated based on Table 21.

TABLE 21

| Transport Status | | Policy of new IP flow for the specific UE | | | | |
|---|---|---|---|---|---|---|
| Wi-Fi | Cellular | | | | | |
| Transport | Transport | Cellular | Wi-Fi | | | |
| Status | Status | Preferred | Preferred | No Preference | Cellular | Wi-Fi |
| Not | Not | Cellular | Wi-Fi | Based on the | Cellular | Wi-Fi |
| Congested | Congested | | | proportionate | | |
| | | | | loading of each | | |
| | | | | transport. | | |
| Not | Congested | Flow may be | Wi-Fi | Wi-Fi | Cellular | Wi-Fi |
| Congested | | placed on Wi-Fi | | | | |
| | | transport unless | | | | |
| | | adding this flow | | | | |
| | | may make Wi-Fi | | | | |
| | | become congested. | | | | |
| | | If so the flow may | | | | |
| | | be placed on | | | | |
| | | cellular transport. | | | | |
| Congested | Not | Cellular | Flow may be | Cellular | Cellular | Wi-Fi |
| | Congested | | placed on | | | |
| | | | cellular | | | |
| | | | transport | | | |
| | | | unless adding | | | |
| | | | this flow may | | | |
| | | | make cellular | | | |
| | | | become | | | |
| | | | congested. If | | | |
| | | | so the flow | | | |
| | | | may be placed | | | |
| | | | on Wi-Fi | | | |
| | | | transport. | | | |
| Congested | Congested | Cellular | Wi-Fi | Based on the | Cellular | Wi-Fi |
| | | | | proportionate | | |
| | | | | loading on each | | |
| | | | | transport. | | |

As shown in Table 21, there may be five outcomes: assign to Wi-Fi, assign to cellular, assign to Wi-Fi if assigning the IP Flow to Wi-Fi may not push the Wi-Fi transport into congestion, assign to Cellular if assigning the IP Flow to Cellular may not push the Cellular transport into congestion, or assign to the transport which may have the least congestion.

For the two cases where the IP Flow may be assigned to a transport if it may not push that transport into congestion, the logic (e.g. performed by the CGW) may be similar to the following.

The current routing policy table may be searched through and the number of VoIP, HTTP Video and FTP IP flows that may be assigned to the desired transport may be counted. If the number of IP Flows may be less than the number of IP Flows for this transport, the IP Flow may be placed on that transport. The current transport of the current routing policy table may be set to the desired transport. Otherwise, the IP Flow may be placed on the other transport. The current transport of the current routing policy table may be set to the other transport.

For the case where the IP Flow may be assigned to the transport which may have the least congestion, the logic (e.g. performed by the CGW) may be similar to the following.

For each transport the current routing policy table may be searched through and the number of VoIP, HTTP Video, and FTP IP flows that may be assigned to the transport may be counted. The load may be computed based on the following equation:

$$load = \frac{\begin{matrix}Count of VoIP , HTTP Video and \\ FTP IP Flows on this transport\end{matrix} }{ \begin{matrix}\# IP Flows from Transport IP \\ Flow Thresholds Table for this transport\end{matrix}}$$

In an embodiment, after computing the load for each transport, the IP Flow may be placed on the transport with the smallest load

In various embodiments, IP Flows with a policy of Wi-Fi and Cellular may not be moved for load balancing. Therefore, in those embodiments, IP Flows with a policy of Wi-Fi Preferred, Cellular Preferred, and No Preference may be eligible for movement from one transport to another in an effort to balance the load among transports. However, in some embodiments, there are some situations when an IP Flow may be moved, even when not permitted by the policy. For example, if an IP Flow may have been “recently” moved to the current transport, the IP Flow may be moved. This may prevent, or at least reduce the chances, of an IP Flow from thrashing from one transport to another. Also, if the number of IP Flows already moved on a single iteration may exceed a limit, an IP Flow may be moved. This may prevent or reduce the likelihood of moving too many IP Flows from one transport to another in a single iteration.

According to example embodiments, one or more parameters may be used to determine if the IP Flow should be moved. For example, the parameters may include an IP Flow Thrashing Time Limit and a Changed IP Flows Limit. The first parameter may be used to control how often an IP Flow may be moved from one transport to another, as described above, to prevent thrashing of an IP Flow between transports. The second parameter may be used to control how many IP Flows may move in a single iteration. As described above, this parameter may prevent to many IP Flows from moving from one transport to another in a single iteration of the algorithm.

Table 22 defines an example load balancing that may occur as a function of the congestion on each transport. In addition to the functionality in this′table, before any IP Flow may be moved, the IP Flow may be checked to ensure that a large number of IP Flows may have already been moved on this iteration and may ensure that the IP flow about to be moved may not have been recently moved. Once the number of IP Flows that may be moved in a single iteration may have been reached, no more IP Flows may be moved on this iteration. Additionally, in some embodiments, if an IP Flow may have been recently moved to its current transport, it may not be moved.

TABLE 22

| Wi-Fi | Cellular | |
|---|---|---|
| Transport | Transport | |
| Status | Status | Action |
| Not | Not | No Action |
| Congested | Congested | |
| Not | Congested | 1. First move the least recently assigned |
| Congested | | ‘Wi-Fi Preferred’ flows from 3G to Wi-Fi until 3G |
| | | may come out congestion. |
| | | 2. If 3G may still be congested and Wi-Fi may not |
| | | be congested then move the least recently assigned |
| | | ‘No Preferred’ flows from 3G to Wi-Fi until Wi-Fi |
| | | may not become congested. |
| | | 3. If 3G may still be congested and Wi-Fi may not |
| | | be congested then move the least recently assigned |
| | | ‘3G Preferred’ flows from 3G to Wi-Fi until Wi-Fi |
| | | may not become congested. |
| Congested | Not | 1. First move the least recently assigned |
| | Congested | ‘3G Preferred’ flows from Wi-Fi to 3G until Wi-Fi |
| | | may come out congestion. |
| | | 2. If Wi-Fi may still be congested and 3G may not |
| | | be congested then move the least recently assigned |
| | | ‘No Preferred’ flows from Wi-Fi to 3G until 3G |
| | | may not become congested. |
| | | 3. If Wi-Fi may still be congested and 3G may not |
| | | be congested then move the least recently assigned |
| | | ‘Wi-Fi Preferred’ flows from Wi-Fi to 3G until 3G |
| | | may not become congested. |
| Congested | Congested | Move the least recently assigned ‘Wi-Fi Preferred’ |
| | | flows from 3G to Wi-Fi and ‘3G Preferred’ flows |
| | | from Wi-Fi to 3G until one of the transport may |
| | | come out of congestion or until there may be no |
| | | flows to move (e.g. the flows aligned to their |
| | | respective transports). |

In some embodiments, the DPI may use OpenDPI to identify, for example, HTTP Video, FTP traffic and/or other types of traffic.

The DPI functionality may also make use of the ports that may be used by various data types. For example, for FTP, once the CGW may receive a packet that may have a port of 20 or 21, this IP Flow may be pushed through OpenDPI to ensure that it may be FTP. For HTTP Video, when the CGW may receive a packet that may have a port of 80, this IP Flow may be pushed through the OpenDPI to ensure that it may be HTTP Video.

Additionally, the DPI functionality may be used to update the IP Flow Type in the Current Routing Policy Table. Upon the recognition of a new IP Flow, the CGW may set the IP Flow Type in the Current Routing Policy Table to Unknown. After OpenDPI may have DPI'ed the IP Flow, the DPI function may update the IP Flow Type in the Current Routing Policy Table. It may either update the IP Flow Type to Unknown if it may be unable to identify the IP Flow or may set the IP Flow Type to HTTP Video, FTP, or VoIP.

In accordance with various embodiments, stale entries may be periodically removed from the Current Routing Policy Table. When this functionality may execute, each entry in the Current Routing Policy may be examined. The Time of Last Packet may be compared to the current time. If the difference between the current time and the Time of Last Packet may be more than a threshold limit, this entry within the Current Routing Policy Table may be deleted.

The population and/or consultation of the various tables that may occur during the example method described above with reference to FIGS. 135A-141B in accordance with one non-limiting embodiment may be described as follows. The procedures and sub-procedures enumerated below reference the corresponding numbered blocks in FIGS. 135A-141B.

At 1, the CGW may be started. After the CGW may be started, the Rule Table (e.g. shown in Table 23) and Transport IP Thresholds Table (e.g. shown in Table 24) may be populated as follows.

TABLE 23

| IMSI | IP Flow Type | Rule |
|---|---|---|
| All | FTP | Wi-Fi Only |
| All | HTTP Video | Wi-Fi Only |
| All | VoIP | Wi-Fi Preferred |
| All | Other | Cellular Only |

TABLE 24

| Transport Type | # of IP Flows |
|---|---|
| Cellular | 1 |
| Wi-Fi | 1 |

At 2, the UE may be assigned a local Wi-Fi IP address and may have established a PDP context. The CGW may decode the messages between the HNB and the HNB GW and SGSN to extract the information needed to populate the device linkage table as shown in Table 25.

TABLE 25

| 3G MCN assigned | Context | | Device reachable |
|---|---|---|---|
| IP address | ID | IMSI | via Wi-Fi |
| 123.45.67.890 | 123 | 310 150 123456789 | |

At 3, the CGW may determine that the UE may be reachable via both Wi-Fi and 3G. It may store or memorialize this in the device linkage table as shown in Table 26.

TABLE 26

| | | | Device |
|---|---|---|---|
| 3G MCN assigned | Context | | reachable |
| IP address | ID | IMSI | via Wi-Fi |
| 123.45.67.890 | 123 | 310 150 123456789 | Yes |

At 4, the user may start a VoIP session. At 4b, the UE may send the first uplink packet associated with the VoIP session. The current routing policy table may be updated as shown in Table 27.

TABLE 27

| | | | Time | Time of Current |
|---|---|---|---|---|
| | IP Flow | Current | of Last | Transport |
| 5-tuple | Type | Transport | Packet | Assignment |
| Low/Hi IP | Pending | Cellular | 1234 msecs | 1234 msecs |
| address | | | | |
| Low/Hi | | | | |
| Port # | | | | |
| IP Type | | | | |

At 4c, as packets associated with the VoIP session may pass through the CGW, the Time of Last Packet may be updated in the current routing policy table as shown in Table 28 (e.g. in an embodiment each packet that passes through the CGW may trigger an update to the Time of Last Update field for the specific IP Flow).

TABLE 28

| | | | | Time of Current |
|---|---|---|---|---|
| | IP Flow | Current | Time of Last | Transport |
| 5-tuple | Type | Transport | Packet | Assignment |
| Low/Hi IP | Pending | Cellular | 1245 msecs | 1234 msecs |
| address | | | | |
| Low/Hi | | | | |
| Port # | | | | |
| IP Type | | | | |

These packets may also be passed through the DPI module for IP Flow identification. If the DPI module succeeds in identifying the IP Flow, it may update the current routing policy table as shown in Table 29.

TABLE 29

| | | | | Time of Current |
|---|---|---|---|---|
| | IP Flow | Current | Time of Last | Transport |
| 5-tuple | Type | Transport | Packet | Assignment |
| Low/Hi IP | VoIP | Cellular | 1275 msecs | 1234 msecs |
| address | | | | |
| Low/Hi | | | | |
| Port # | | | | |
| IP Type | | | | |

At 4d, the CGW may consult the policy for VoIP for this UE. The policy may state, Wi-Fi Preferred, according to an embodiment. The CGW may look at the number of IP Flows on the Wi-Fi transport and may conclude that the Wi-Fi transport may be lightly congested (e.g. since the number of IP Flows on Wi-Fi maybe less than the Maximum Number of IP Flows for Wi-Fi in the transport IP Flows thresholds table). The CGW may update the current routing policy table as shown in Table 30.

TABLE 30

| | | | Time of | Time of Current |
|---|---|---|---|---|
| | IP Flow | Current | Last | Transport |
| 5-tuple | Type | Transport | Packet | Assignment |
| Low/Hi IP | VoIP | Wi-Fi | 1290 msecs | 1292 msecs |
| address | | | | |
| Low/Hi | | | | |
| Port # | | | | |
| IP Type | | | | |

At this point, downlink packets that may be received by the CGW for this IP Flow may be sent to the UE via Wi-Fi. At 4g, the UE may sense this and transition the uplink packets associated with this flow from cellular to Wi-Fi. Once the UE may perform this, traffic associated with this flow may be delivered via the Wi-Fi transport, as shown in Step 4h.

At 5, the user may start an FTP session. At 5b, the UE may send the first uplink packet associated with the FTP session. The current routing policy table may then be updated as shown in Table 31.

TABLE 31

| | | | | Time of Current |
|---|---|---|---|---|
| | IP Flow | Current | Time of Last | Transport |
| 5-tuple | Type | Transport | Packet | Assignment |
| Low/Hi IP | VoIP | Wi-Fi | 2013 msecs | 1292 msecs |
| address | | | | |
| Low/Hi | | | | |
| Port # | | | | |
| IP Type | | | | |
| Low/Hi IP | Pending | Cellular | 2015 msecs | 2015 msecs |
| address | | | | |
| Low/Hi | | | | |
| Port # | | | | |
| IP Type | | | | |

At 5c, as packets associated with the FTP session may pass through the CGW, the Time of Last Packet may be updated in the current routing policy table as shown in Table 32 (e.g. in an embodiment each packet that may pass through the CGW may trigger an update to the Time of Last Update field for the specific IP Flow).

TABLE 32

| | | | | Time of Current |
|---|---|---|---|---|
| | IP Flow | Current | Time of Last | Transport |
| 5-tuple | Type | Transport | Packet | Assignment |
| Low/Hi IP | VoIP | Wi-Fi | 2017 msecs | 1292 msecs |
| address | | | | |
| Low/Hi | | | | |
| Port # | | | | |
| IP Type | | | | |
| Low/Hi IP | Pending | Cellular | 2020 msecs | 2015 msecs |
| address | | | | |
| Low/Hi | | | | |
| Port # | | | | |
| IP Type | | | | |

These packets may also be passed through the DPI module for IP Flow identification. If the DPI module may succeed in identifying the IP Flow, it may update the current routing policy table as shown in Table 33.

TABLE 33

| | | | | Time of Current |
|---|---|---|---|---|
| | IP Flow | Current | Time of Last | Transport |
| 5-tuple | Type | Transport | Packet | Assignment |
| Low/Hi IP | VoIP | Wi-Fi | 2030 msecs | 1292 msecs |
| address | | | | |
| Low/Hi | | | | |
| Port # | | | | |
| IP Type | | | | |
| Low/Hi IP | FTP | Cellular | 2030 msecs | 2015 msecs |
| address | | | | |
| Low/Hi | | | | |
| Port # | | | | |
| IP Type | | | | |

At 5d, the CGW may consult the policy for FTP for this UE. The policy may state Wi-Fi. As such, the CGW may assign this IP Flow to use Wi-Fi. The CGW may update the current routing policy table as shown in Table 34.

TABLE 34

| | | | | Time of Current |
|---|---|---|---|---|
| | IP Flow | Current | Time of Last | Transport |
| 5-tuple | Type | Transport | Packet | Assignment |
| Low/Hi IP | VoIP | Wi-Fi | 2047 msecs | 1292 msecs |
| address | | | | |
| Low/Hi | | | | |
| Port # | | | | |
| IP Type | | | | |
| Low /Hi IP | FTP | Wi-Fi | 2048 msecs | 2048 msecs |
| address | | | | |
| Low/Hi | | | | |
| Port # | | | | |
| IP Type | | | | |

At this point, downlink packets that may be received by the CGW for this IP Flow may be sent to the UE via Wi-Fi. At 5g, the UE may sense this and transition the uplink packets associated with this flow from cellular to Wi-Fi. Once the UE may perform this, traffic associated with this flow may be delivered via the Wi-Fi transport as shown in 5h.

At 6 and 8, the CGW may periodically attempt to adjust the assigned transport for each IP Flow to better balance the load between the transports. In addition to executing this periodically, this may execute whenever an IP Flow may be added or deleted. At 6a, both the VoIP and FTP session may be using the Wi-Fi transport. The load balancing may be executed periodically and may determine, at 6b, to move the VoIP session to Cellular. Once the load balancing may start, the congestion on each transport may be calculated and the transport may be assigned as congested or not congested. For Cellular, there may be zero IP Flows and for Wi-Fi, there may be two IP Flows. When compared to the thresholds in the Transport IP Flows Thresholds Table, each transport may be tagged as follows: Cellular—Not congested and Wi-Fi—Congested.

Once this condition may be found, the load balancing may attempt to find IP Flows that may be moved from Wi-Fi to Cellular. The policy for each entry in the Current Routing Policy Table may be extracted from the rule table. In this instance, the load balancing (e.g. the CGW performing load balancing) may move the VoIP flow from Wi-Fi to Cellular since the VoIP IP Flow policy may be Wi-Fi Preferred. The FTP IP Flow may not be moved, since its policy may be Wi-Fi. After the load balancing may execute, the current routing policy table may be as shown in Table 35.

TABLE 35

| | | | | Time of Current |
|---|---|---|---|---|
| | IP Flow | Current | Time of Last | Transport |
| 5-tuple | Type | Transport | Packet | Assignment |
| Low/Hi IP | VoIP | Cellular | 39003 msecs | 39004 msecs |
| address | | | | |
| Low/Hi | | | | |
| Port # | | | | |
| IP Type | | | | |
| Low/Hi IP | FTP | Wi-Fi | 39001 msecs | 2048 msecs |
| address | | | | |
| Low/Hi | | | | |
| Port # | | | | |
| IP Type | | | | |

As a result, the FTP session information in the current touting policy table may be removed as shown in Table 36.

TABLE 36

| | | | | Time of Current |
|---|---|---|---|---|
| | IP Flow | Current | Time of Last | Transport |
| 5-tuple | Type | Transport | Packet | Assignment |
| Low/Hi IP | VoIP | Cellular | 69437 msecs | 39004 msecs |
| address | | | | |
| Low/Hi | | | | |
| Port # | | | | |
| IP Type | | | | |

After this removal, the congestion on each transport may be evaluated. Since the FTP session may have ended, there may be one IP Flow using the Cellular transport. When comparing the current IP Flows to the thresholds in the Transport IP Flows Thresholds Table, each transport may be tagged as follows: Cellular—Congested and Wi-Fi—Not Congested.

Since one transport may be congested and the other may not be congested, the load balancing may attempt to return IP Flows to their preferred transports. In this case, there may be one IP Flow, a VoIP session. The current transport may be Cellular but the policy may be Wi-Fi preferred for this IP Flow. As such, the VoIP session may be moved from Cellular to Wi-Fi. The resulting current routing policy transport table is as shown in Table 37.

TABLE 37

| | | | | Time of Current |
|---|---|---|---|---|
| | IP Flow | Current | Time of Last | Transport |
| 5-tuple | Type | Transport | Packet | Assignment |
| Low/Hi IP | VoIP | Wi-Fi | 69445 msecs | 69448 msecs |
| address | | | | |
| Low/Hi | | | | |
| Port # | | | | |
| IP Type | | | | |

At 7, the CGW may periodically remove stale entries from the current routing policy table. When such functionality (e.g. stale entry removal) may execute, each entry in the current routing policy may be examined. The Time of Last Packet may be compared to the current time. If the difference between the current time and the Time of Last Packet may be more than a threshold limit, this entry within the current routing policy table may be deleted. When the FTP session may end at 7, the current routing policy table may appear as shown in Table 38 when such functionality (e.g. logic) may be executed.

TABLE 38

| | | | | Time of Current |
|---|---|---|---|---|
| | IP Flow | Current | Time of Last | Transport |
| 5-tuple | Type | Transport | Packet | Assignment |
| Low/Hi IP | VoIP | Cellular | 69437 msecs | 39004 msecs |
| address | | | | |
| Low/Hi | | | | |
| Port # | | | | |
| IP Type | | | | |
| Low/Hi IP | FTP | Wi-Fi | 43561 msecs | 2048 msecs |
| address | | | | |
| Low/Hi | | | | |
| Port # | | | | |
| IP Type | | | | |

For illustration purposes, the current time may be 69500 msecs. In such an embodiment, that the current time may be greater than the Time of Last Packet for the FTP IP Flow entry. Therefore, it may be removed. The VoIP IP Flow entry may remain since the current time may be close to the Time of Last Packet. Applying the foregoing, the current routing policy table may be as shown in Table 39.

TABLE 39

| | | | | Time of Current |
|---|---|---|---|---|
| | IP Flow | Current | Time of Last | Transport |
| 5-tuple | Type | Transport | Packet | Assignment |
| Low/Hi IP | VoIP | Cellular | 69437 msecs | 39004 msecs |
| address | | | | |
| Low/Hi | | | | |
| Port # | | | | |
| IP Type | | | | |

The systems and methods (e.g. the CGW) that may be disclosed herein may further support features and/or functionality directed to Local IP Flow Mobility (IFOM), including support of IFOM and non-IFOM enabled mobiles; access to the local home network through 3G or Wi-Fi interfaces; access to the public Internet directly or via the Mobile Core Network (MCN); Deep Packet Inspection (DPI) and Shallow Packet Inspection (SPI) based flow segregation; and the like. The system and methods may provide for flow distribution over Wi-Fi and 3G interfaces as well as flow prioritization. The IFOM scheme may be transparent. Additionally, the systems and methods may be set apart from the PMIP based IFOM (e.g. the CGW may not behave as a Mobility Access Gateway). The systems and methods may also not support multiple subnet enterprise network topologies. In addition, in some embodiments, the LAN destined traffic may not subject to IFOM as described herein.

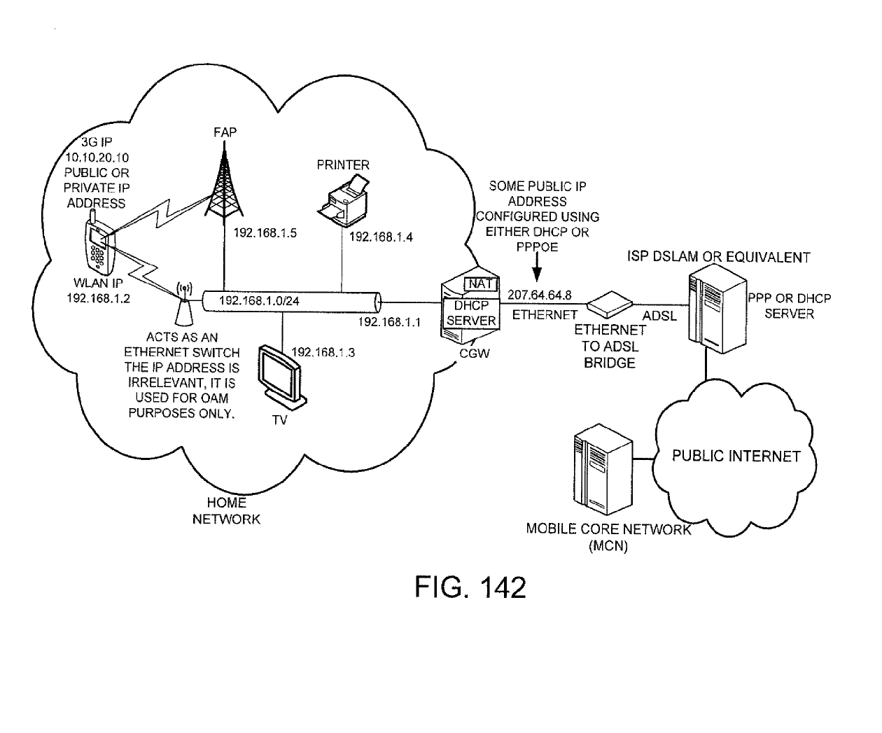

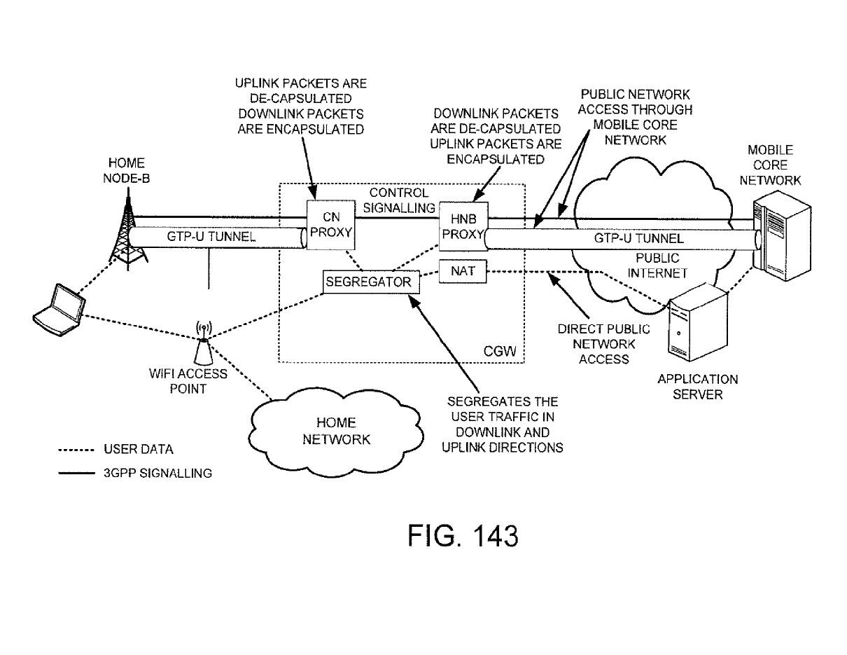

In example embodiments, home networks may usually be made of a single subnet, and some home, home office, and small business users may be knowledgeable enough to manage a multi subnet configuration. In such configurations, DNS may usually not be used to access local hosts. Rather, other self configuring (e.g. broadcast base) protocols may be used for that purpose (e.g. NetBIOS). According to another embodiment, home configurations may rely on local broadcasts that may use the presence of a single network. Such configurations may be shown in FIGS. 142 and 14.

In example embodiments, the CGW, and the like described herein may be implemented with a number of hardware and/or software components. For example, the CGW, and the like may be implemented using software such as Linux or a Linux operating system that may run on various hardware components.

Additionally, according to one embodiment, the CGW, and the like described herein may leverage access to Layer 2 (L2). Additional features that may also be used may include TUN/TAP devices (L2 and L3 tunneling logical interface); Netfilter; Netfilter queue; Iptables; Conntrack; Policy routing; Traffic control; services (e.g. DHC, and the like). Further, reuse of existing proxies may be included, and in some embodiments, the systems (e.g. the CGW) may take advantage of the Wi-Fi, including when the UE 3G IP address may be reachable through Wi-Fi such that the Wi-Fi interface may be used to route the downlink traffic from the local network through Wi-Fi even if the corresponding uplink request has been made through the 3G.

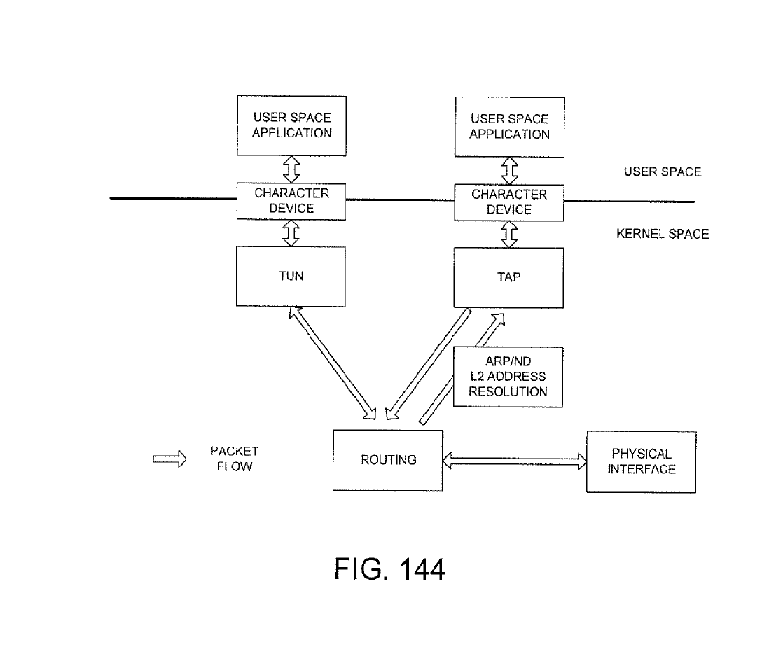

Additionally, TUN and TAP devices such as those depicted in FIG. 144 may be tunneling devices that may be used to attach a logical interface hooked to the IP stack and may offer a raw read/write interface in the user space. Specifically, TUN may be a L3 tunneling like device. The IP stack may treat this as a point to point tunneling device. The user space application may get the L3 and above and may or may not have an IP address assigned. For example, in an embodiment, the system may be used as a gateway device in the routing table. TAP may be a L2 device that may have its own MAC address. The IP stack may send Address Resolution Protocol (ARP) and/or Neighbor Discovery (ND) requests to resolve the L2 address of the destination in example embodiments. Additionally, the user space application may get the L2 (Ethernet) and above, may or may not have an IP address assigned and may be used as a gateway device in the routing table.

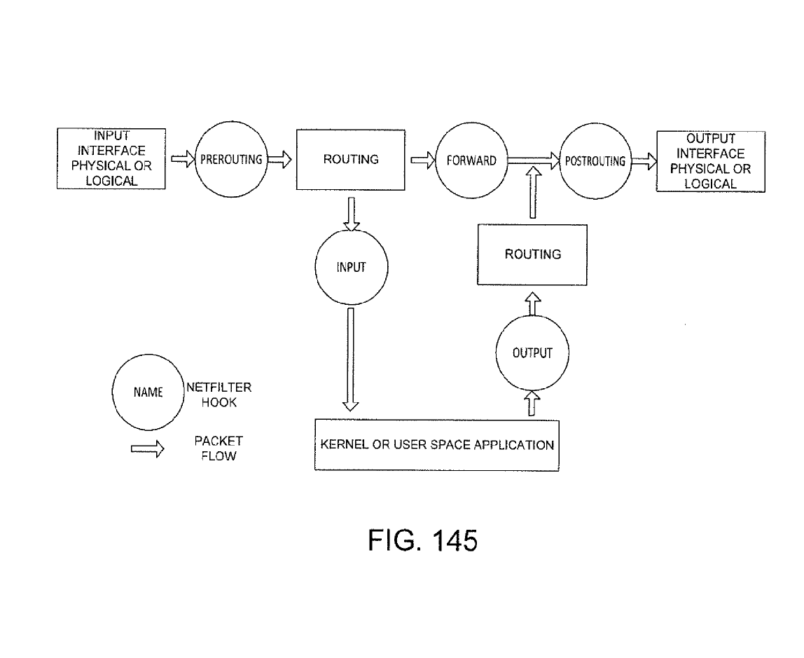

A netfilter and netfilter queue, for example, depicted in FIG. 145, may also be used (e.g. in a CGW, and the like) to provide a comprehensive infrastructure for manipulating packets. The netfilter and/or netfilter queue and the infrastructure provided thereby may be used to intercept and manipulate packets from user space (e.g. amongst other functionalities) and may enable packet marking. Iptables may also be provided and/or used to offer a user friendly framework to configure the IP packet manipulation. Conntrack may be a kernel level module that may also be used to provide a user space API. In an example embodiment, conntrack may be used to track sessions that may terminate or may be forwarded by the host.

Policy routing may be provided and/or used. For example, multiple routing tables may be configured, and rules to utilize the different tables may be specified. The rules may include Source, Destination, Type of Service (ToS), Packet mark (e.g. Not part of the IP protocol, Stored in an internal data structure associated to each packet; and the like).

Traffic control may also be provided and/or used. A traffic control (tc) toolset may be used and may be part of the “iproute2” package. It may be integrated with the functionalities of an IP stack (e.g. interoperates with policy based routing) that may be used. Some of the features may include: Attach and configure various queuing disciplines to the network interfaces; The network interfaces may be physical (Ethernet) or virtual (TUN/TAP); Different types of queuing disciplines maybe available including Classless: No distinctions between the different sessions, and Classful: The sessions may be associated to a class and each class may be subject to distinct treatment. Fair queuing may be added to a class, and the sessions may share bandwidth allocated the class. Network emulation (delays, data loss, and the like) may also be provided.

A CGW proxies structure (e.g. that may include a CN proxy and/or a HNB proxy) may also be provided and/or used. For example, proxies such as previously developed proxies may be reused with one or more of the following modifications: Removal of the MNTP hooks; Uplink source IP address mapping; Addition of new TUN interfaces to the CN and HNB proxy component; Addition of a Segregator component; Responsible for running the DPI and SPI and marking packets accordingly; Shares the session information with the proxies; Downloads the policy information for flow classification; Uses the netfilter queue interface to intercept packets; Addition of a UE accessibility through Wi-Fi feature.

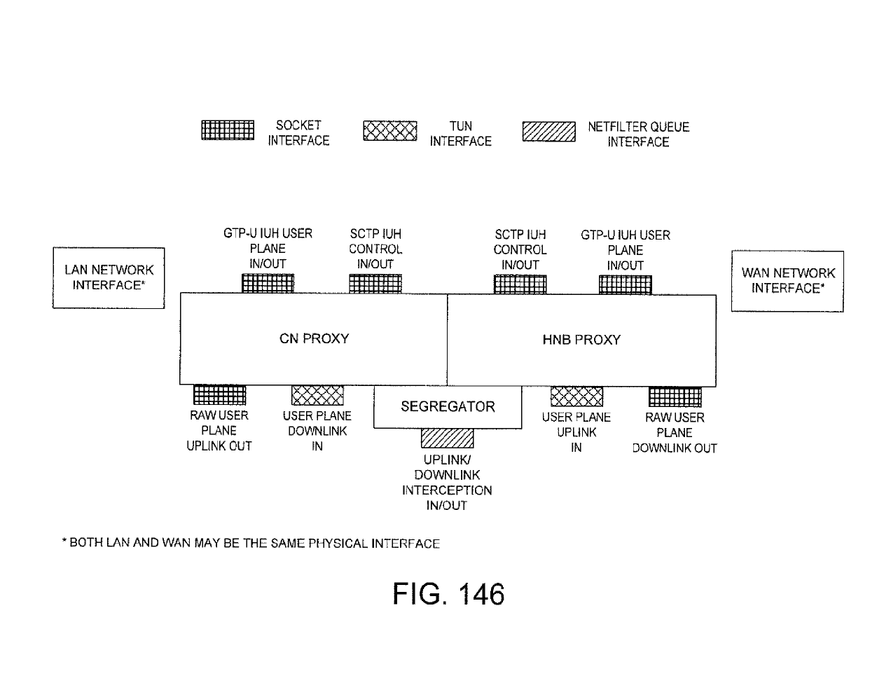

CGW components and interfaces that may support features described herein (e.g. may be depicted in FIG. 146. CGW functions that may be implemented on the CGW platform may include Packet routing; Source Network Address Translation (NAT) on the public interface; LAN DHCP server; Internet Service Provider (ISP) connection management; Traffic shaping and prioritization based on packet classification performed by the segregator; and the like.

In an embodiment, the Core Network (CN) and the Home Node B (HNB) proxies may intercept the 3G signaling and may build the session data base. For example, they may include a new PDP context that may be created; and may deal with incoming handovers and outgoing handovers. Additionally, they may periodically detect the reachability of the UE via the Wi-Fi interface. When reachable, they may modify the default routing table with UE's 3G IP address via the LAN interface. They may also detect the UE IP address on incoming handover.

CGW functions may also include features of the CN proxy such as decapsulate and send 3G uplink packets and encapsulate and send through the GTP tunnel the downlink packets

CGW functions may also include features of the HNB proxy such as: decapsulate and send 3G downlink packets and encapsulate and sends through the GTP tunnel the uplink packets

CGW functions may also include features of the Segregator such as: downloads the policy information; intercepts 3G (source or destination) packets; performs Deep Packet Inspection (DPI); control Shallow Packet Inspection (SPI); session tracking using the Conntrack API; Mark the flow with the target path information (uplink and downlink); mark the flow with the target priority information (e.g. downlink); measure the UDP session bandwidth in the downlink; perform Dynamic Flow Management (DFM).

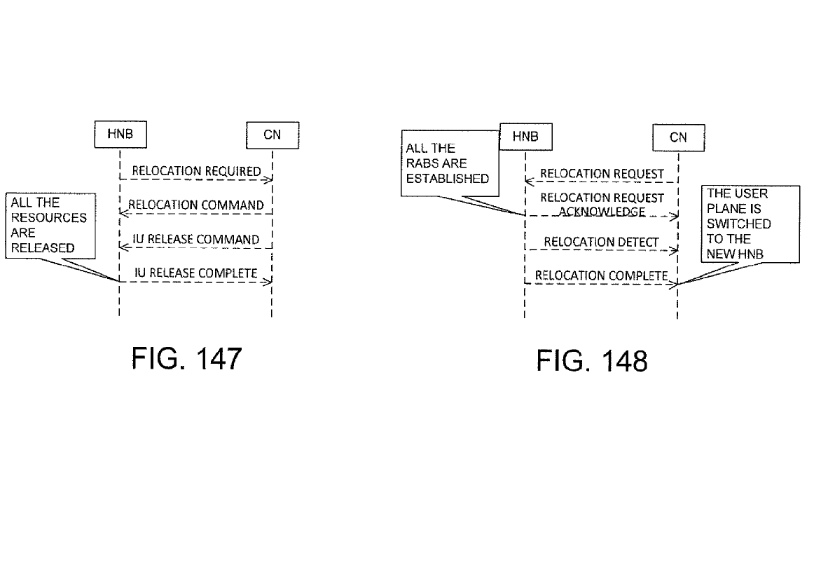

Outgoing handovers may be depicted in FIG. 147. The outgoing handover may be detected by the following exchange of messages between the HMB and the CN: The outgoing handover may be treated as a PDP context termination; After the HNB issues Iu Release Complete message the CGW may clear the data structures related to the UE.

The incoming handover, for example, that may be depicted in FIG. 148, may be characterized in that the incoming handover may not be treated the same as a PDP context creation because during the handover there may be no L3 signaling involved. Further, the PDP context related data structures may be created after HNB issues the Relocation complete message. In an embodiment, the data structures may be missing the UE IP address information. An additional functionality may be added to the proxies that may be used to the IP address of the UE in either uplink or downlink. Before forwarding either the uplink or downlink packet, the IP address may be verified (e.g. source when uplink, destination when downlink). The data structures may be populated with the detected IP address.

Segregator interception rules may also be provided and/or used (e.g. by the CGW). The segregator inception rules may include one or more of the following: not intercepted (e.g. including a packet with LAN source or destination IP addresses and/or packets with the CGW WAN IP source or destination IP address); intercepted (e.g. packets that may be intercepted by the segregator include any packet with 3G source IP address (e.g. either source or destination) and public interne IP address (e.g. either destination or source)); and the like.

CGW Network Address Translation (NAT) rules may also be provided and/or used. CGW NAT rules may include one or more of the following: the source NAT may be setup on the CGW WAN interface; the NAT may be applied to sessions except sessions that may be created by the CGW where the source may be the CGW WAN address in uplink and the destination may be the CGW WAN address in the downlink; and the like.

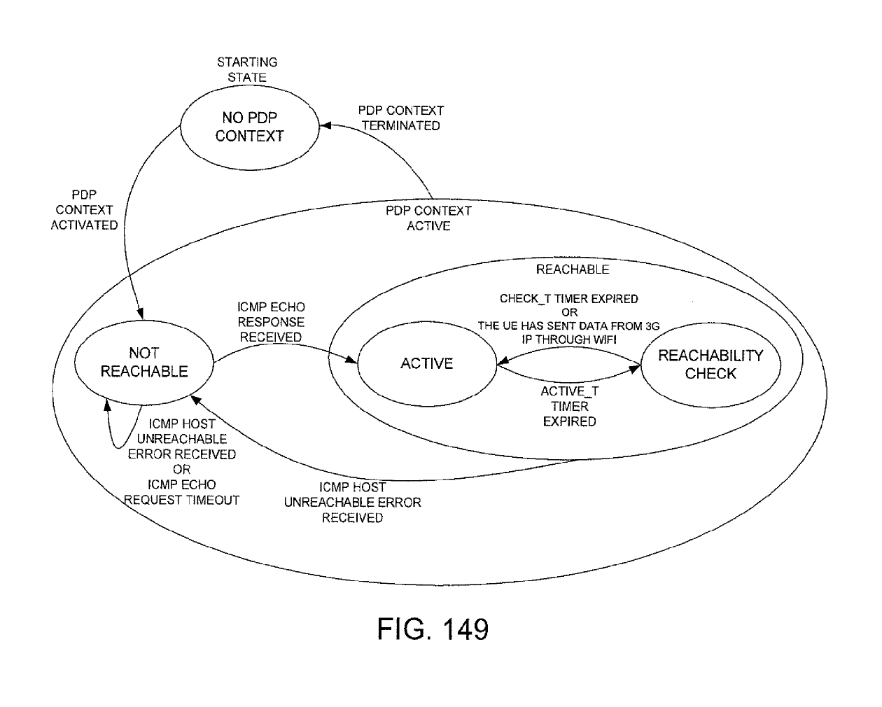

UE reachability via Wi-Fi detection procedure may be depicted in FIG. 149 may provide and/or use one or more of the following states: NO PDP CONTEXT; PDP CONTEXT ACTIVE; NOT REACHABLE; REACHABLE; ACTIVE; REACHABILITY CHECK. The foregoing states may have one or more of the following characteristics: NO PDP CONTEXT (e.g. the UE may not have created a PDP context and the CGW may not track the UE state); PDP CONTEXT ACTIVE (e.g. the UE may have created a PDP context and the UE state may be tracked by the CGW) which may include sub-states NOT REACHABLE and/or REACHABLE; NOT REACHABLE (e.g. the UE 3G IP address may not be reached through Wi-Fi, the CGW may try periodically to ping the UE with the 3G IP address through the Wi-Fi interface, and/or the CGW may not send data that may be destined to the UE 3G IP through the Wi-Fi interface); REACHABLE (e.g. the UE may have responded to the ICMP echo requests that may be sent by the CGW to the 3G IP address through the Wi-Fi interface, and/or the CGW may send selected traffic to the UE 3G IP address through the Wi-Fi interface) which may include sub-states ACTIVE and/or REACHABILITY CHECK; ACTIVE (e.g. the UE may send data actively from the 3G IP address through the Wi-Fi interface and/or each time the UE may send data from the 3G IP address through the Wi-Fi interface the ACTIVE_T timer may be restarted); and/or REACHABILITY CHECK (e.g. the UE 3G IP address may have been removed from the ARP table and/or when data may be sent to the UE, the CHECK_T timer may started and if no ICMP host unreachable error is received for the duration of this timer the state may be changed to ACTIVE).

The state transitions that may be depicted in FIG. 149 may also include one or more of the following: NO PDP CONTEXT to NOT REACHABLE (e.g. the UE may activate a PDP context, while leaving no action may be performed, and/or while entering the ICMP echo request may be sent to the UE 3G IP address through the Wi-Fi interface); PDP CONTEXT ACTIVE to NO PDP CONTEXT (e.g. the PDP context may have been deactivated, while leaving procedures may be aborted and the UE related data structures may be removed, and/or while entering no action may be performed); NOT REACHABLE to ACTIVE (e.g. the ICMP echo response for the UE 3G IP address may have been received through Wi-Fi, while leaving no action may be performed, and/or while entering the ACTIVE_T timer may be started); REACHABLE to NOT REACHABLE (e.g. the ICMP host unreachable error may be received for the 3G IP address from the Wi-Fi interface, while leaving pending timers may be stopped, and/or while entering the ICMP echo request may be sent to the UE 3G IP address through the Wi-Fi interface); ACTIVE to REACHABILITY CHECK (e.g. the ACTIVE_T timer may have expired and the UE may not have sent data from the 3G IP address through the Wi-Fi interface for a period grater then the duration of ACTIVE_T, when leaving no action may be performed, and/or when entering the ARP entry may be removed from the ARP table); REACHABILITY CHECK to ACTIVE (e.g. no ICMP host unreachable error may be received after sending data to the UE 3G IP address for the duration of the CHECK_T timer or if the UE may send data from the 3G IP address through Wi-Fi, when leaving the CHECK_T timer if pending may be stopped, and/or when entering the ACTIVE_T timer may be started); NOT REACHABLE to NOT REACHABLE (e.g. the ICMP host unreachable error may be received or the ICMP echo request may time out, when leaving no action may be performed, and/or when entering the ICMP echo request may be sent to the UE 3G IP address through the Wi-Fi interface); and the like.

The detection procedure described herein (e.g. shown in FIG. 149) may also be applicable, for example, to other cellular technologies or networks than 3G which may be shown. For example, the detection procedure may be used with LTE technologies or networks where, for example, an LTE attach may be equivalent to 3G attach and PDP context may be activated.

With respect to traffic prioritization, according to an embodiment, the CGW may be configured based on one or more of the following: the WAN and LAN interfaces may be separate; the LAN interface may provide wired access to HNB and to the Ethernet-Wi-Fi bridge with sufficient bandwidth capacity; the CN may not be a bottleneck; the WAN may not be a bottleneck; the traffic prioritization may take place in the downlink; there may be no back pressure in the uplink direction from the 3G and Wi-Fi bottlenecks.

The configuration of traffic prioritization within the system (e.g. within the CGW), and the location of the traffic prioritization module (e.g. that may be included in the CGW), may be set at the point where the traffic going through a path may be converging, for example, after segregation. In one embodiment, the traffic prioritization may take place at the bottleneck, but such a configuration may be challenging to implement when the bottlenecks are located at the links to the UE because there may be little control at the bottleneck location, and the priority information may be generally not available and a protocol may be implemented to provide the priority information from the CGW

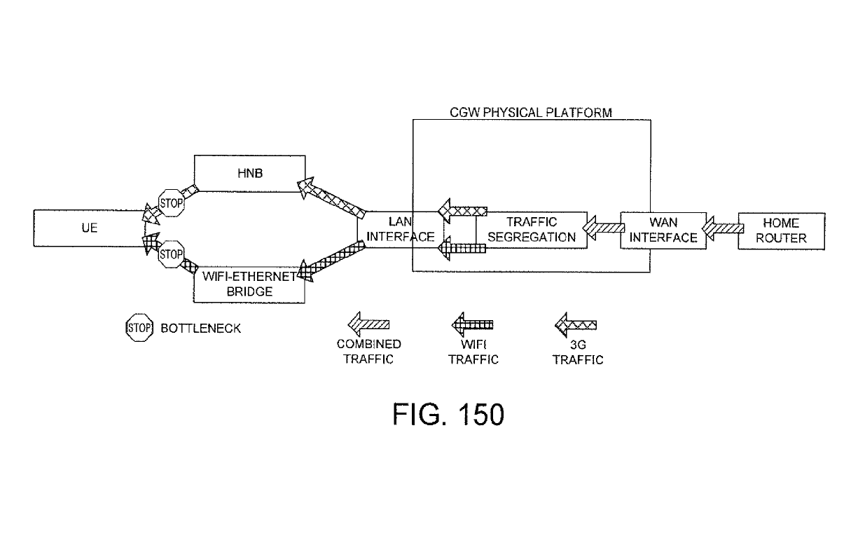

In an alternative embodiment, as shown in FIG. 150, rate limitation bottlenecks may be created in the CGW. There may be a bottleneck for the 3G access and a bottleneck for the Wi-Fi access. The rate limitation bottlenecks may rely on the theoretical capacity values. In one embodiment, the system may be configured with three levels of traffic priority A, B and C, where A may be the most prioritized and C may be the least prioritized. The segregator may be configured to tag the flow packets based on user priority and/or flow priority using the three types of flows. Additionally, the three types of flows A, B and C may be specified for each user.

In a further embodiment, there may be three types of users A, B and C where user type A may have access to traffic priorities A, B and C, user type B may have access to traffic priorities B and C and A type flows may be coerced to the B traffic priority), user type C may have access to band C, and A or B type flows may be coerced to the C traffic priorities. In an embodiment, the rate limitation bottlenecks may be created using the tc tool.

Additionally, according to an embodiment, the Wi-Fi rate limitation bottleneck may be setup at the physical LAN network interface. In such an embodiment, there may be four rate limited classes A, B, C, D and E that may be created under the same the Hierarchical Token Bucket (HTB) queuing discipline. Each class may be configured with the Stochastic Fair Queue (SFQ) to split the bandwidth equally between the flows in that class. The purpose of the classes may be as follows. Classes A, B, C may be configured for the prioritized 3G traffic through Wi-Fi. Default class D may be configured for the unclassified Wi-Fi traffic to and/or from the UE Wi-Fi IP addresses. Class E may be configured for the UE 3G traffic GTP tunneled to the HNB. The target rates of classes A, B, C and D may be configured with portions of the theoretical value of the Wi-Fi interface. Classes A, B, and C may share the Wi-Fi bandwidth taking into the consideration the maximum capacity of the Iuh interface between the CN and the HNB. Class D may take the remaining Wi-Fi bandwidth. The ceil rates may be configured to the total theoretical values of the Wi-Fi interface. The Wi-Fi theoretical value may be considered constant in one embodiment, and the target and ceil rates of class E may be configured to the maximum capacity of the HNB. Filters may also be configured to distribute the traffic amongst the configured classes as follows, for example, marked packets with a forward mark tag value using classes A, B and C; GTP packets using class E; unmarked packets using default class D; and the like. Such an embodiment may be configured such that the bandwidth of the CGW LAN interface may accommodate the throughput that may be used by both Wi-Fi and HNB.

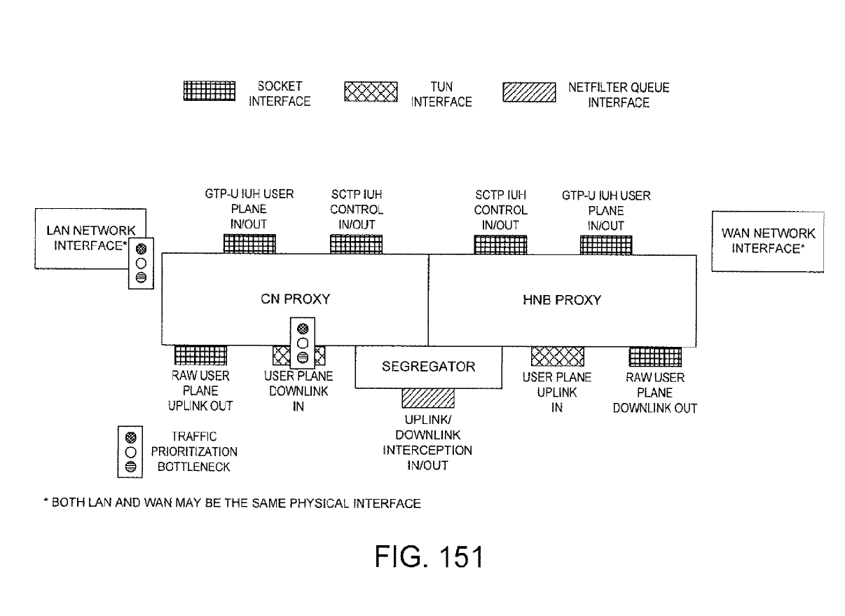

With respect to the 3G rate limitation bottleneck, setup may be at the user plane downlink TUN device. Such a bottleneck may also use three classes A, B, and C. Each class may take the share of the currently available bandwidth. Each class cell value may be configured to the currently available bandwidth. The total available bandwidth may depend on the quantity of PDP context. The total values as well as the values allocated to the classes may be adjusted as soon as or based on PDP contexts may be activated or deactivated. The formula for adjusting these values may take many forms. A block diagram of an example system having the above-referenced aspects may be shown in FIG. 151.

According to an example embodiment, routing tables as described herein may include a default routing table that may be named or referred to as default_rt. The default routing table may include policy routing tags such as no tag; DOWN_Wi-Fi_<priority>_TAG where the priority may be either A, B or C and the priority may correspond to the priority classes defined for the LAN interface; and the like. In one embodiment, the table and/or tags that may be included therein may provide support of default non 3G traffic in uplink and down link directions and/or access to the LAN by 3G and non-3G devices. Additionally, the entries may include routes to the LAN subnet; a default route through the WAN interface; access to UE such as a UE 3G IP address through the LAN interface for a UE where a 3G interface may be reachable through Wi-Fi or a UE 3G IP address through the CN-proxy TUN device for a UE where a 3G interface may not be reachable through the Wi-Fi.

A further routing table may be provided for the downlink via 3G that maybe named or referred to as ue_down_{—}3g_rt. The policy routing tags may include DOWN_{—}3G_<priority>_TAG, where the priority may be either A, B or C and the priority may correspond to the priority classes defined for the TUN interface, and the like. Such a table may be used to route UE destined traffic via the 3G network in the downlink direction. The entries may include default route through the CN proxy TUN interface.

A routing table may further include an uplink via MCN table that may be named or referred to as ue_up_{—}3g_rt. Such a table may include a policy routing tag UP_{—}3G_TAG and may provide routes for UE originated traffic via the 3G MCN in the uplink direction. The entries may include default routes through the HNB proxy TUN interface.

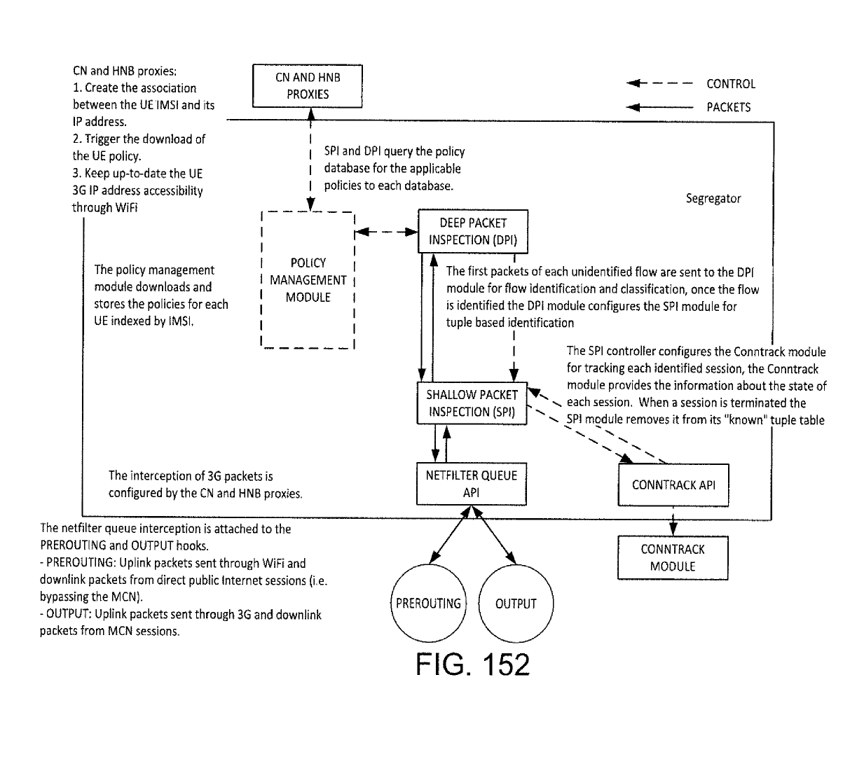

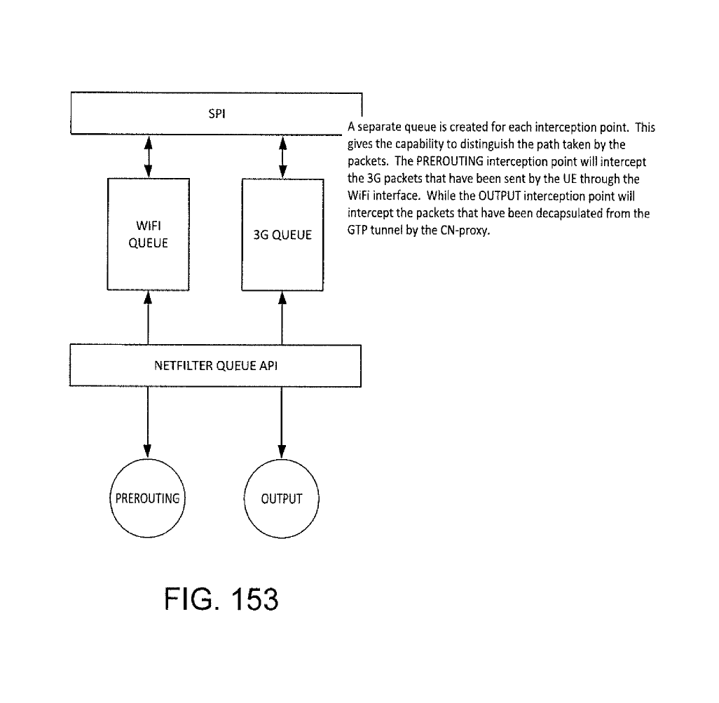

An example embodiment of an architecture of a segregator that may be used herein (e.g. in the CGW) may be shown in FIGS. 152 and 153.

Additionally, as described herein, dynamic flow management (DFM) may be provided within the system configuration (e.g. the CGW) and may use the available Wi-Fi interface to, for example, increase the bandwidth available to the 3G traffic. This may not imply a better quality of service for specific flows. Rather, the DFM may be used to distribute the TCP and UDP flows over available transports according to policies

The system (e.g. the CGW) and/or DFM that may be provided and/or used thereby as described may use available transports such as 3G and Wi-Fi. According to an example embodiment, the system and DFM may not depend upon support from the UE. For example, the system and/or DFM may operate in the downlink. Additionally, the transport bandwidths may be qualified by static heuristic values that may be determined during setup and/or in certain predetermined environments. The CN may have (e.g. in both the uplink and downlink) sufficient bandwidth and/or negligible data loss such that the wireless access (e.g. 3G and/or Wi-Fi) may be the main source of the bottleneck on the data path.

UDP protocol considerations (e.g. for DFM) may include real-time data transfers, simplicity, and/or may be used by layer 5 protocols that may implement or may not use reliability. When using UDP, there may be limited or no flow control at transport layer and little or no adaptation capability to the changing conditions. In an embodiment, for the applications to operate some minimal (e.g. depending on the application) bandwidth, baseline performance metrics may be established. In the downlink, the bandwidth may be established at the CGW by measuring the downlink flow data rate.

TCP protocol considerations (e.g. for DFM) may include TCP design elements such as bulk data transfers and data integrity preservation. According to an embodiment, the TPC may be used implement flow control, congestion avoidance, retransmissions, and the like and may have the capability to adapt to the changing network conditions as well as the capability to fill up the available bandwidth. In such an embodiment, it may be difficult to determine the bandwidth requirement by measuring the flow data rate.

According to embodiments, dynamic flow management may be established using when the PDP context may be active and/or at least one alternate transport may be present. In some embodiments, the DFM may be disabled in case either of these conditions may not be met. The deep and shallow packet inspections (DPI and/or SPI) may provide a flow classification. In the case that a flow may not be identified, the flow may be classified according to the policy of “other” flows which may be configurable or rely on some (e.g. configured or hardcoded) default values. Dynamic flow management factors may one or more of the following: policy such as binding (e.g. such as Strict binding, Preferred binding, Binding not specified) and/or identification (such as 5-tuple Shallow Packet Inspection (SPI) identification including immediate identification, Deep Packet Inspection (DPI) identification including packets that may be exchanged and/or the flow remain unidentified for a period of time); transport bandwidth usage level (e.g. the capacity of the transport may be estimated through experimentation and/or the bandwidth usage may be estimated by measuring the downlink UDP flows and counting the TCP flows); and the like.

Flow classifications may also be provided and/or used (e.g. with DFM and/or the CGW). Flow classification may include Movable flow, which may be a flow that may be assigned to a transport, may have two levels of priority (e.g. No preferred binding: Movable priority 1; Preferred binding: Movable priority 2). They may also include flows classified as an Unmovable flow, which may be a flow that may be assigned to a given transport, and/or have a strict binding.

Heuristic transport bandwidth may further be provided and/or used (e.g. in the DFM and/or CGW). For example, without the support from the UE, it may be difficult to estimate dynamically the available bandwidths of the transports. Each transport bandwidth may be established by running consecutive throughput tests in the target demonstration environment. Such experimental values may be stored in the CGW configuration. In an embodiment, the bandwidth may depend on interference from other systems, the number of UEs, the environment, and the like.

In one embodiment, the system architecture (e.g. the DFM and/or CGW) may be broken into two threads. A first thread (e.g. thread 1) that may execute continuously while forwarding packets and may performs flow identification and classification (DPI and SPI), initial flow assignment, and/or UDP flow bandwidth measurement. A second thread (e.g. thread 2) that may execute periodically and where flows may be unassigned and/or distribution of UDP flows and TCP flows may be performed.

According to an example embodiment, initial flow assignment (e.g. TCP or UDP) may be performed by SPI and it may be “unmovable” or “movable priority 2.” The flow may be assigned to a transport specified by the policy. In one example, the flow may be classified as “movable priority 1” and the remaining bandwidth may be calculated for each transport based on or using a heuristic bandwidth value that may include the sum of the known bandwidth values of the UDP flows that may be assigned to that transport. The flow may be assigned to the transport that may have the highest remaining bandwidth or may be proportionally the least overloaded. The initial bandwidth value for UDP flows may be assigned if the flow bandwidth may be known through the identification. If the flow bandwidth may not be known, the zero value may be assigned.

Measuring the UDP flow bandwidth may also be provided and/or used in the systems and/or methods described herein (e.g. DFM and/or CGW). For example, for each UDP flow, in the downlink direction the arrival time and the packet size may be recorded. The average may then be computed over a sampling period. Several consecutive sampling periods may be part of a larger time window. The bandwidth may then be computed by averaging the values calculated for the sampling periods in the time window. In some embodiments, the value calculated for each sample may be assigned a weight where the most recent samples may be assigned a higher weight than the oldest ones. Additionally, in other embodiments, alternative low pass filter principles may be used.

In one example embodiment that may be used herein (e.g. by the DFM and/or CGW), the time window is subdivided into 4 sampling periods such as 1: 0 to 0.5 s (e.g. for the oldest sample); 2: 0.5 to 1 s; 3: 1 to 1.5 s; and 4: 1.5 to 2 s (e.g. for the most recent sample); or any other suitable weight. Each sampling period may be assigned a weight, for example, as follows: 4: 50% such that the most recent sample may have the most weight; 3: 25%; 2: 15%; 1: 10%; or any other suitable weight. During each sampling period, the bandwidth may be computed by dividing the number of bytes transferred by the sample period (e.g. number of bytes transferred/sample period). The overall flow bandwidth may then be calculated as follows: (Sample 4×0.5)+(Sample 3×0.25)+(Sample 2×0.15)+(Sample 1×0.10).

The distribution of UDP flows that may be used and/or provided herein, in an embodiment, may be performed as follows: (1) the “unmovable” flows may be assigned to the appropriate transports; (2) the “movable priority 2” flows may be assigned to the appropriate transport; (3) the “movable priority 1” flows with known bandwidth may be sorted in decreasing bandwidth order; (4) the remaining bandwidth may be calculated for each transport (e.g. using or based on a heuristic bandwidth value that may include the sum of the known bandwidth values of the flows that may be assigned to that transport; (5) for each “movable priority 1” flow while the flow bandwidth may not exceed the remaining bandwidth of each of the transports, assign the flow to the transport that may have the highest remaining bandwidth and decrease the remaining bandwidth of the transport to which the flow may have been assigned; (6) if the flows may have been assigned this process may end; and (7) the movable flows may be de-assigned and (3) through (5) may be re-executed with one or more variants. The variants may include one or more of the following: the priorities of the movable flows may be ignored and the loop in (5) may continue even if none of the transports may have enough bandwidth to accommodate the flow. Each flow may be assigned to the transports that may be proportionally the least overloaded.

According to additional embodiments, the flows with unknown bandwidth may be treated as if the bandwidth may be null. In an alternative embodiment, the system may distribute these flows over the transports proportionally to the available bandwidth or to the lowest level of overload.

In example embodiments, distribution of TCP flows may be performed according to one or more of the following: the “unmovable” flows may be assigned to the appropriate transports; if both or none of the transports may have remaining bandwidth, then the “movable—priority 2” flows may be assigned to the appropriate transports and the “movable—priority 1” flows may be distributed amongst the transports in a way that may attempt to spread the TCP flows proportionally to the remaining bandwidth, or proportionally to the least overloaded; if a single transport may have remaining bandwidth then the “movable” flows may be assigned to that transport regardless of their priority.

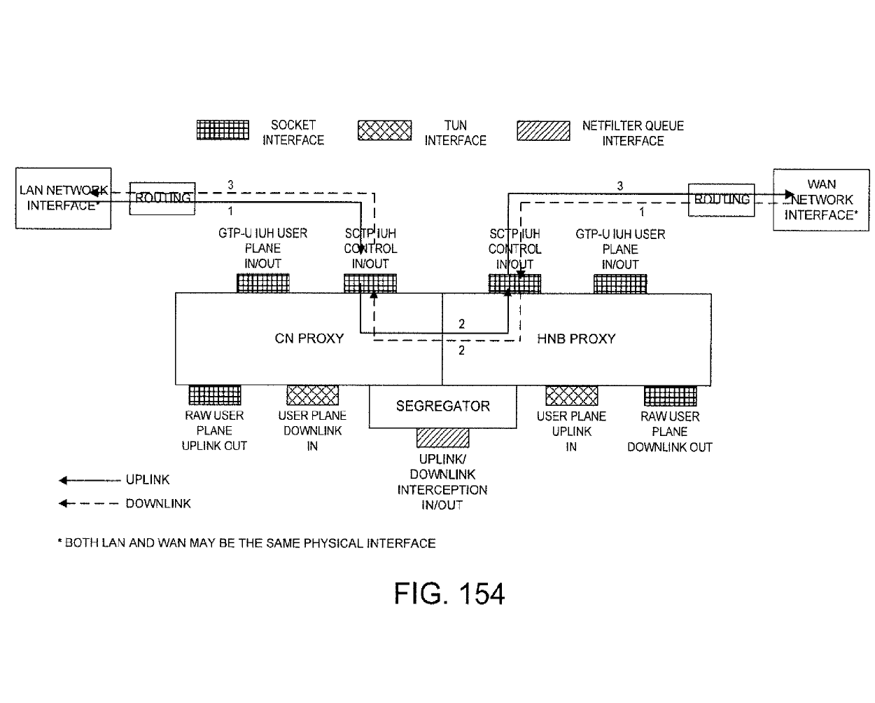

FIG. 154 illustrates an example embodiment of packet processing flows that may be provided and/or used herein. According to an embodiment, the packet processing flows depicted in FIG. 154 may be described for cellular (e.g. 3G) signaling for an uplink and/or downlink. For example, for 3G signaling for an uplink, (1) a Packet may be received through the LAN interface and routed (default_rt) to the CN proxy SCTP server: SRC=HNB, DST=CN-proxy (CGW LAN address); (2) the request/response may be processed, a new request/response may be created: SRC=HNB proxy (CGW WAN), DST=HNB Gateway (HNBGw); and/or (3) the packet may then sent out from the HNB proxy SCTP client socket and routed (default_rt) through the WAN interface.

Additionally, for 3G Signaling for a downlink, (1) a packet may be received through the WAN interface and routed (default_rt) to the HNB proxy SCTP server: SRC=HNBGw, DST=HNB proxy (CGW WAN); (2) the request/response may be processed, a new request/response may be created: SRC=CN proxy (CGW LAN), DST=HNB; and/or (3) the packet may be sent out from the CN proxy SCTP client socket and routed (default_rt) through the LAN interface.

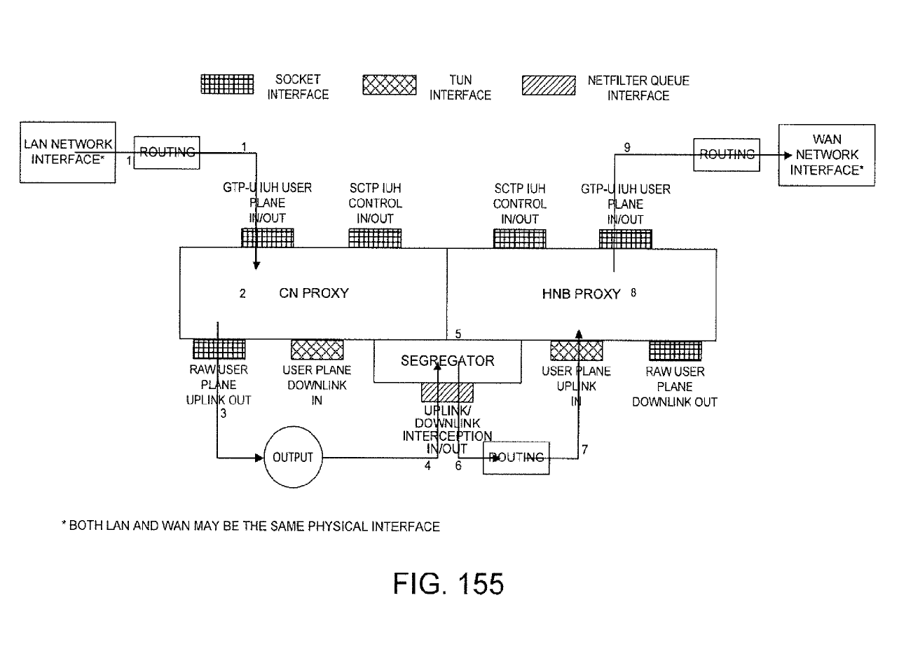

FIG. 155 illustrates an example embodiment of packet processing flows that may be provided and/or used herein. According to an embodiment, the packet processing flows depicted in FIG. 155 may be described for 3G⇄Public for an uplink via MCN. For example, for 3G⇄Public for an uplink via MCN, (1) a GTP-u packet may be received through LAN interface and routed to the CN-proxy GTP-u server: Outer: SRC=HNB, DST=CN-Proxy (CGW LAN); Inner: SRC=UE 3G, DST=Public; (2) the packet may be de-tunneled: SRC=UE 3G, DST=Public; (3) the packet may be sent out through the CN proxy RAW socket; (4) the packet may be intercepted by a Netfilter queue at the OUTPUT stage; (5) the segregator may analyze the packet and may tag it with UP_{—}3G_TAG; (6) the packet may be returned to the stack; (7) the packet may be routed (ue_up_{—}3g_rt) through the HNB proxy TUN interface; (8) the packet may be GTP-u tunneled: Outer: SRC=HNB proxy (CGW WAN), DST=HNBGw; Inner: SRC=UE 3G, DST=Public; and/or (9) the packet may be sent out through the HNB proxy GTP-u socket, routed (default_rt) and send out through the WAN interface.

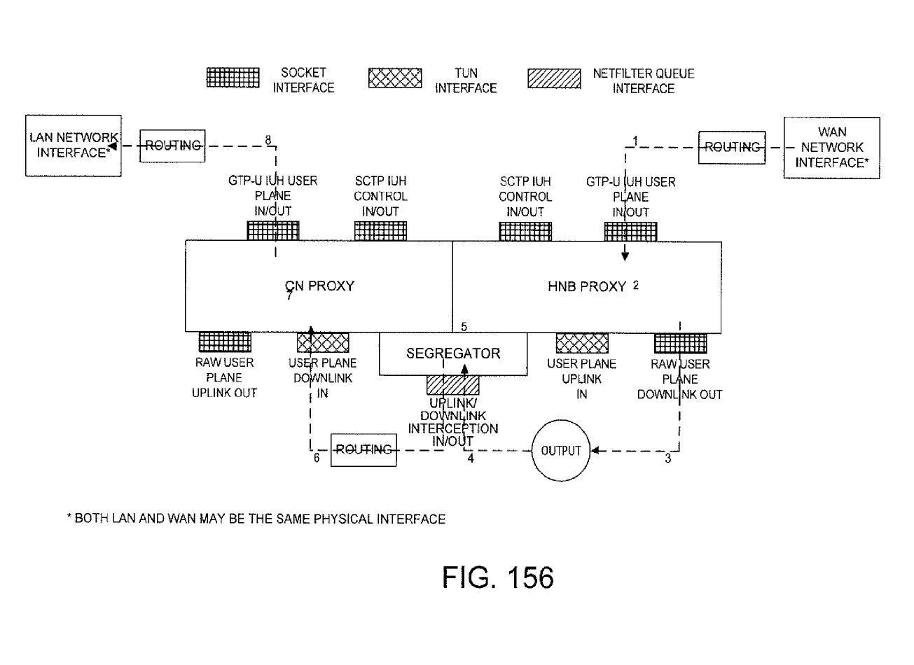

FIG. 156 illustrates an example embodiment of packet processing flows that may be provided and/or used herein. According to an embodiment, the packet processing flows depicted in FIG. 156 may be described for 3G⇄Public for a downlink via MCN. For example, for 3G⇄Public for a downlink via MCN, (1) a GTP-u packet may be received through WAN interface and routed to the HNB-proxy GTP-u server: Outer: SRC=HNBGw, DST=HNB-proxy (CGW WAN); Inner: SRC=Public, DST=UE 3G; (2) the packet may be de-tunneled: SRC=Public, DST=UE 3G; (3) the packet may be sent out through the HNB-proxy RAW socket; (4) the packet may be intercepted by a Netfilter queue at the OUTPUT stage; (5) the segregator may analyze the packet and may tag it with DOWN_{—}3G_<priority>_TAG; (6) the packet may be returned to the stack and routed (ue_down_{—}3g_rt) toward the CN-proxy TUN interface; (7) the packet may be GTP-u tunneled: Outer: SRC=CN proxy (CGW LAN), DST=HNB; Inner: SRC=Public, DST=UE 3G; and/or (8) the packet may be sent out through the CN-proxy GTP-u socket and routed (default_rt) through the LAN interface.

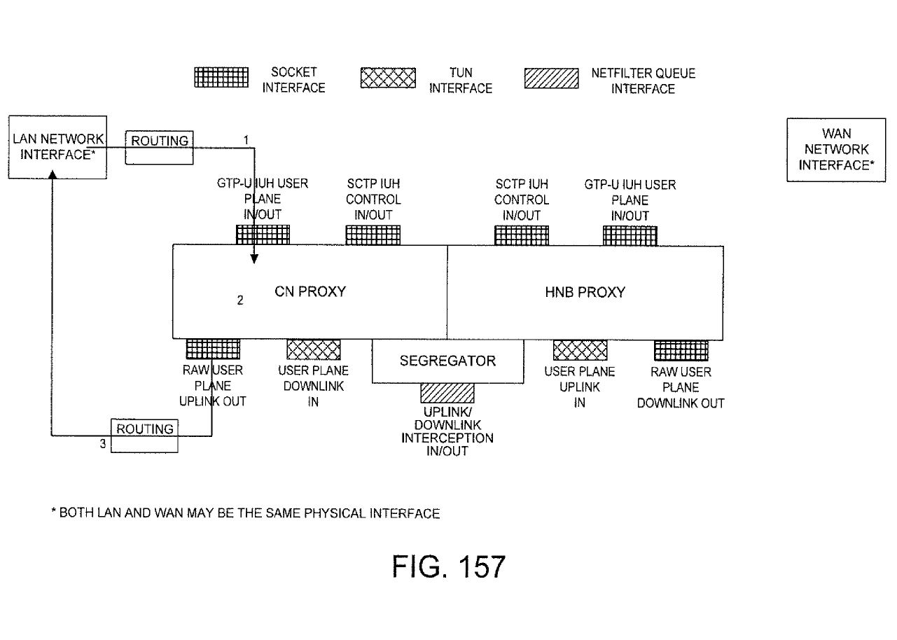

FIG. 157 illustrates an example embodiment of packet processing flows that may be provided and/or used herein. According to an embodiment, the packet processing flows depicted in FIG. 157 may be described for 3G⇄Local for an uplink. In this embodiment, the UE may be configured to route the local LAN sessions through the 3G interface. For example, for 3G⇄Local for an uplink, (1) a GTP-u packet may be received through LAN interface and routed to the CN-proxy GTP-u server: Outer: SRC=HNB, DST=CN-proxy (CGW LAN); Inner: SRC=UE 3G, DST=LAN; (2) the packet may be de-tunneled: SRC=UE 3G, DST=LAN; and/or (3) the packet may be sent out through the CN-proxy RAW socket and routed (default_rt) through the LAN interface.

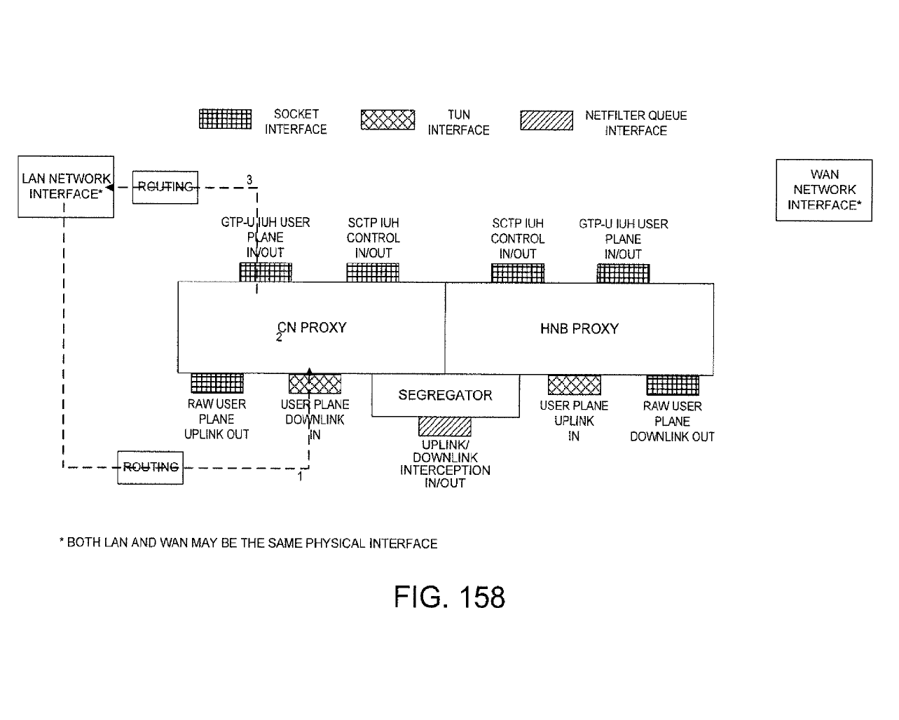

FIG. 158 illustrates an example embodiment of packet processing flows that may be provided and/or used herein. According to an embodiment, the packet processing flows depicted in FIG. 158 may be described for 3G⇄Local for a downlink. For example, for 3G⇄Local for a downlink, (1) the packet may be received through the LAN interface, routed (default_rt) through the CN-proxy TUN interface: SRC=LAN, DST=UE 3G (e.g. when the UE 3G address may not be reachable through Wi-Fi default_rt contains the CN-proxy TUN device gateway for the UE 3G destination); (2) the packet may be GTP-u tunneled: Outer: SRC=CN-proxy (CGW LAN), DST=HNB; Inner: SRC=LAN, DST=UE 3G; and/or (3) the packet may be sent through the GTP-u socket and routed (default_rt) through the LAN interface.

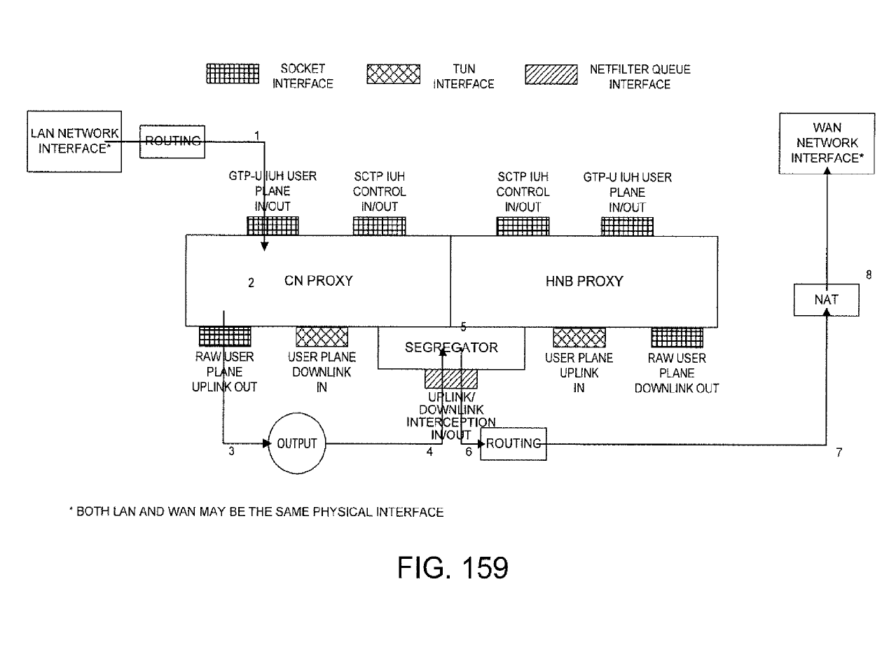

FIG. 159 illustrates an example embodiment of packet processing flows that may be provided and/or used herein. According to an embodiment, the packet processing flows depicted in FIG. 159 may be described for 3G⇄Local for an uplink with no MCN. For example, for 3G⇄Public for an uplink with no MCN, (1) a GTP-u packet may be received through LAN interface and routed to the CN-proxy GTP-u server: Outer: SRC=HNB, DST=CN-proxy (CGW LAN); Inner: SRC=UE 3G, DST=Public; (2) the packet may be de-tunneled: SRC=UE 3G, DST=Public; (3) the packet may be sent through the CN-proxy RAW socket; (4) the packet may be intercepted by a Netfilter queue at the OUTPUT stage; (5) the packet may be analyzed by the Segregator where no tag may be applied; (6) the packet may be returned to the protocol stack; (7) the packet may be routed (default_rt) toward the WAN interface; and/or (8) a source NAT may be applied on the packet and the packet may be sent through the WAN interface: SRC=CGW WAN, DST=Public.

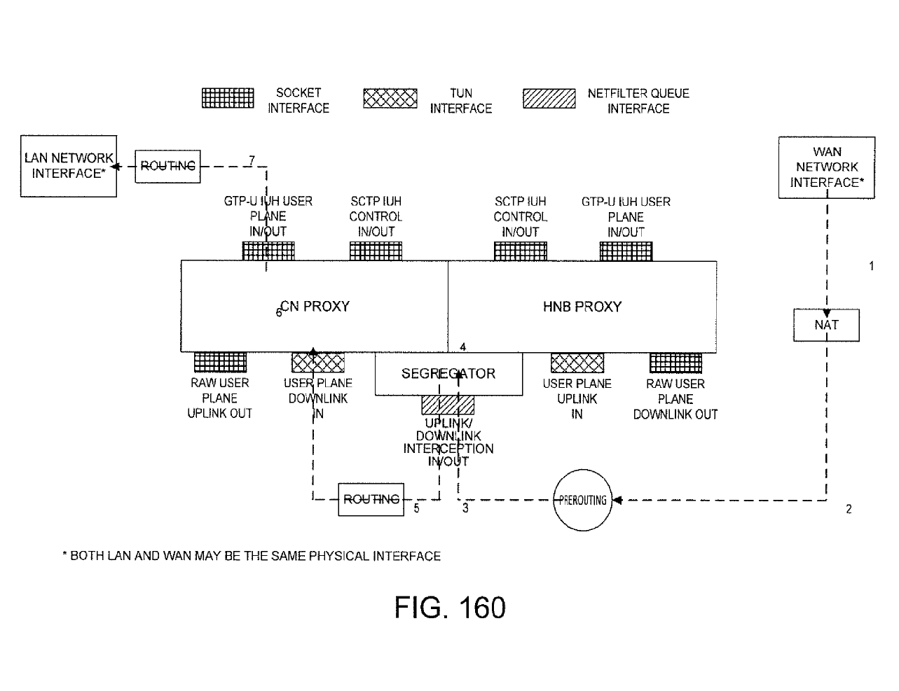

FIG. 160 illustrates an example embodiment of packet processing flows that may be provided and/or used herein. According to an embodiment, the packet processing flows depicted in FIG. 160 may be described for 3G⇄Public for downlink with no MCN. For example, for 3G⇄Public for downlink with no MCN, (1) a packet may be received on the WAN interface, SRC=Public, DST=CGW WAN; (2) the packet may be source de-NATed (e.g. if destination of the reply may be set to the source of the request): SRC=Public, DST=UE 3G; (3) the packet may be intercepted by a Netfilter queue at the PREROUTING stage; (4) the segregator may inspect the packet and may tag it with DOWN_{—}3G_<priority>_TAG; (5) the packet may be returned to the protocol stack and routed (ue_down_{—}3g) toward the CN-proxy TUN device; (6) the packet may be GTP-u tunneled: Outer: SRC=CN-proxy (CGW LAN), DST=HNB; Inner: SRC=Public, DST=UE 3G; and/or (7) the packet may be sent through the CN-proxy GTP-u socket, and routed (default_rt) through the LAN interface.

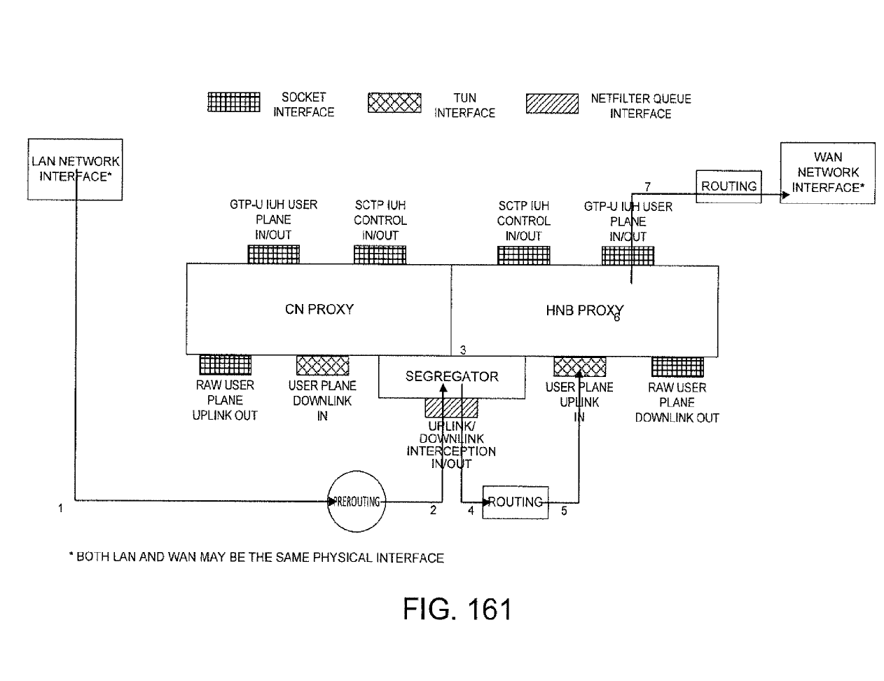

FIG. 161 illustrates an example embodiment of packet processing flows that may be provided and/or used herein. According to an embodiment, the packet processing flows depicted in FIG. 161 may be described for Wi-Fi 3G IP⇄Public for an uplink via MCN. For example, for Wi-Fi 3G IP⇄Public for an uplink via MCN, (1) the packet may be received through the LAN interface: SRC=UE 3G, DST=Public; (2) the packet may be intercepted by a Netfilter queue at the PREROUTING stage; (3) the segregator may inspect the packet and based on the policy and may tag it with UP_{—}3G_TAG; (4) the packet may be returned to the stack; (5) the packet may be routed (ue_up_{—}3g) toward the HNB-proxy TUN interface; (6) the packet may be GTP-u tunneled: Outer: SRC=HNB-proxy (CGW WAN), DST=HNBGw; Inner: SRC=UE 3G, DST=Public; and/or (7) the packet may be sent through the GTP-u socket and routed (default_rt) toward the WAN interface.

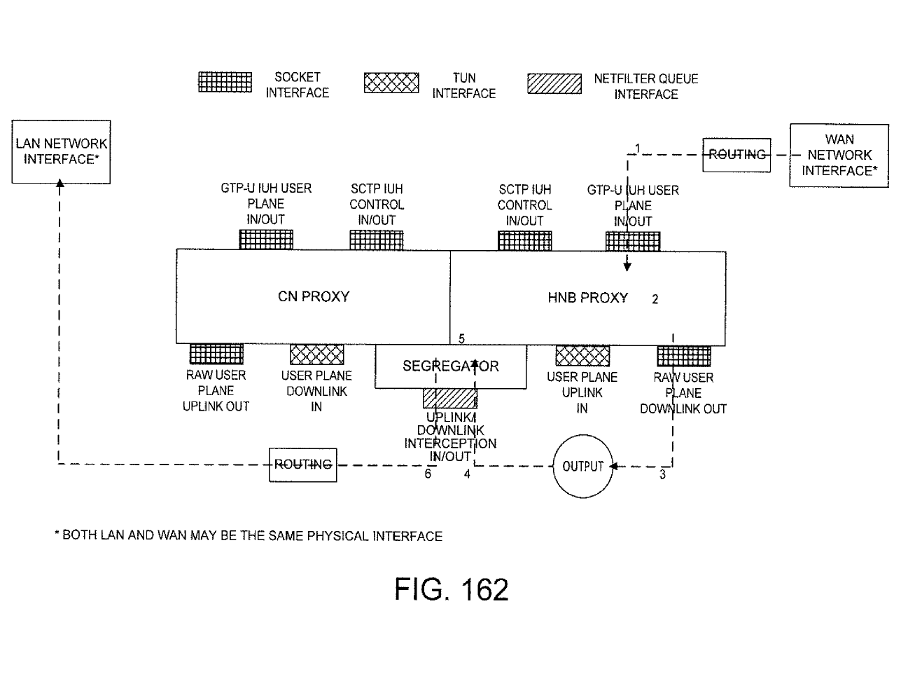

FIG. 162 illustrates an example embodiment of packet processing flows that may be provided and/or used herein. According to an embodiment, the packet processing flows depicted in FIG. 162 may be described for Wi-Fi 3G IP⇄Public for a downlink via MCN. For example, for Wi-Fi 3G IP⇄Public for a downlink via MCN, (1) a GTP-u packet may be received through the WAN interface, routed (default_rt) toward the HNB-proxy GTP-u server: Outer: SRC=HNBGw, DST=HNB-proxy (CGW WAN); Inner: SRC=Public, DST=UE 3G; (2) the packet may be de-tunneled: SRC=Public, DST=UE 3G; (3) the packet may be sent through the HNB-proxy RAW socket; (4) the packet may be intercepted by a Netfilter queue at the OUTPUT stage; (5) the packet may be inspected by the segregator and it may be tagged with DOWN_Wi-Fi_<priority>_TAG; and/or (6) the packet may be returned to the stack and routed (default_rt) toward the LAN interface.

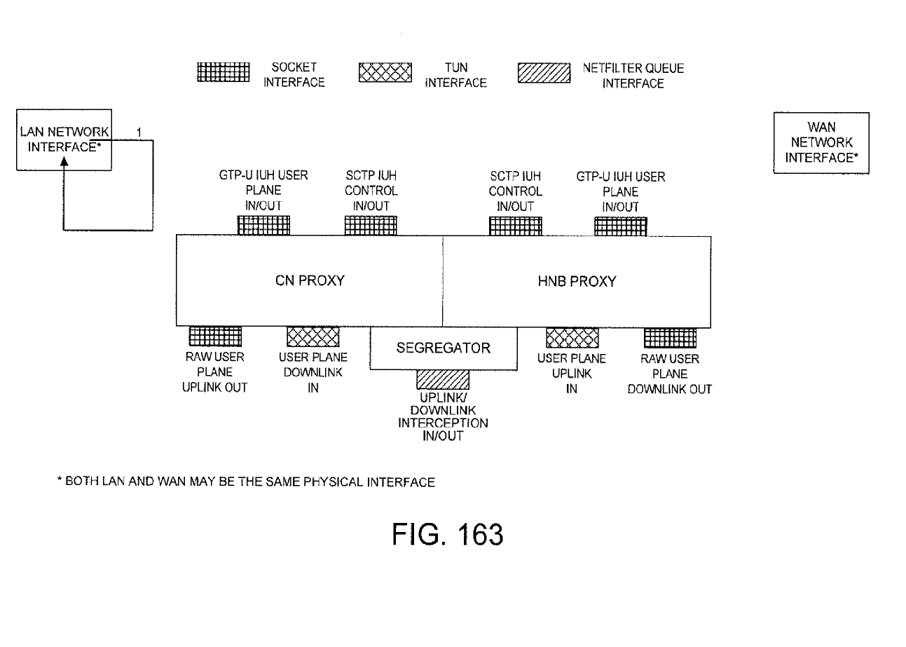

FIG. 163 illustrates an example embodiment of packet processing flows that may be provided and/or used herein. According to an embodiment, the packet processing flows depicted in FIG. 163 may be described for Wi-Fi 3G IP⇄Local for an uplink. For example, for Wi-Fi 3G IP⇄Local for an uplink, (1) the packet may be directly sent to the destination: SRC=UE 3G, DST=Local.

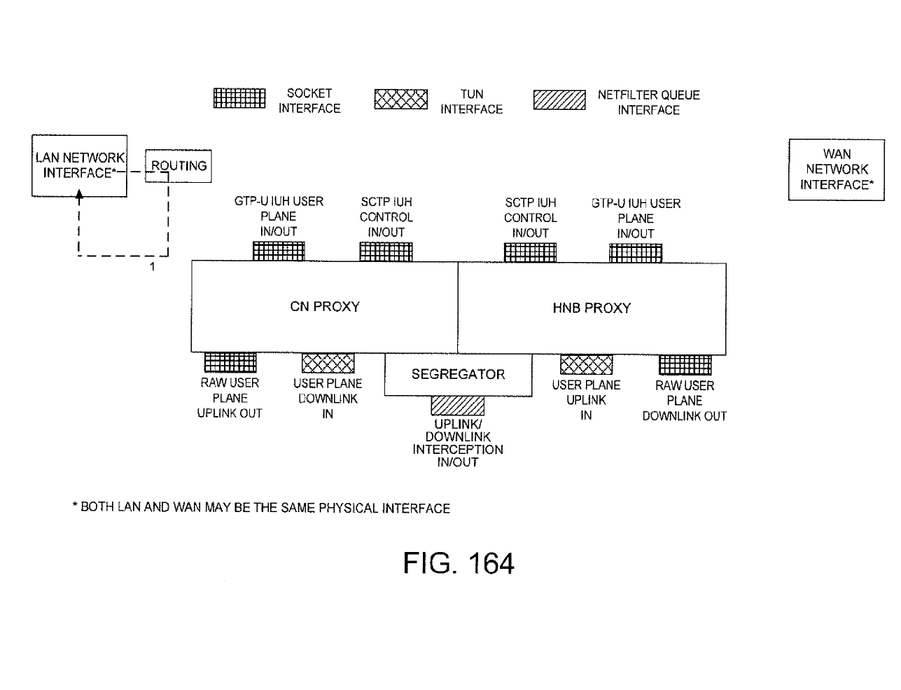

FIG. 164 illustrates an example embodiment of packet processing flows that may be provided and/or used herein. According to an embodiment, the packet processing flows depicted in FIG. 164 may be described for Wi-Fi 3G IP⇄Local for a downlink. In this embodiment, the UE 3G IP address may be reachable through Wi-Fi. For example, for Wi-Fi 3G IP⇄Local for a downlink, (1) the packet may be received and routed (default_rt) through the LAN interface: SRC=Local, DST=UE 3G.

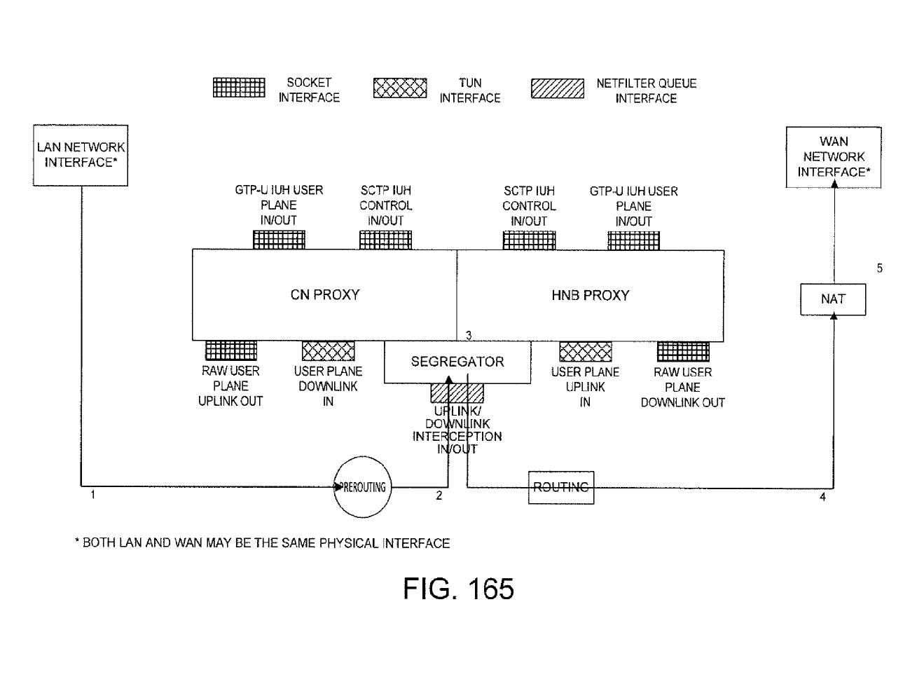

FIG. 165 illustrates an example embodiment of packet processing flows that may be provided and/or used herein. According to an embodiment, the packet processing flows depicted in FIG. 165 may be described for Wi-Fi 3G IP [symbol] Public for an uplink with no MCN. For example, for Wi-Fi 3G IP [symbol] Public for an uplink with no MCN, (1) the packet may be received through the LAN interface: SRC=UE 3G, DST=Public; (2) the packet may be intercepted by a Netfilter queue at the PREROUTING stage; (3) the segregator may inspect the packet and based on the policy may not apply tags; (4) the packet maybe returned to the stack and routed (default_rt) through the WAN interface; and/or (5) the packet maybe source NATed: SRC=CGW WAN, DST=Public.

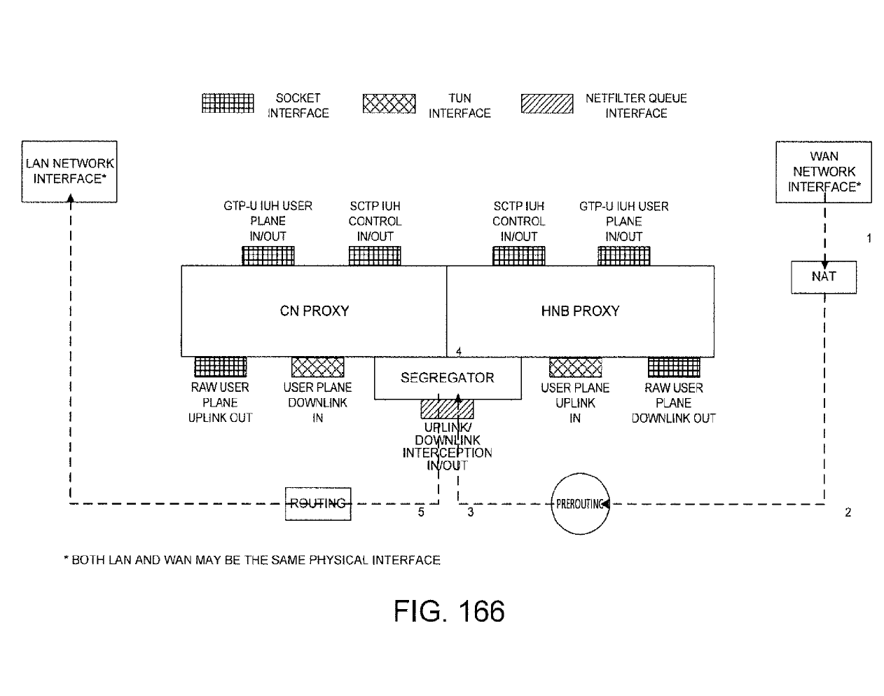

FIG. 166 illustrates an example embodiment of packet processing flows that may be provided and/or used herein. According to an embodiment, the packet processing flows depicted in FIG. 166 may be described for Wi-Fi 3G IP [symbol] Public for a downlink with no MCN. For example, for Wi-Fi 3G IP [symbol] Public for a downlink with no MCN, (1) the packet may be received through the WAN interface: SRC=Public, DST=CGW WAN; (2) the packet may be source de-NATed (e.g. the destination address of the response may be set to the source address of the request): SRC=Public, DST=UE 3G; (3) the packet may be intercepted by a Netfilter queue at the PREROUTING stage; (4) the packet may be inspected by the segregator and it may be tagged with DOWN_{—}3G_<priority>_TAG; and/or (5) the packet may be returned to the protocol stack and routed (default_rt) through the LAN interface.

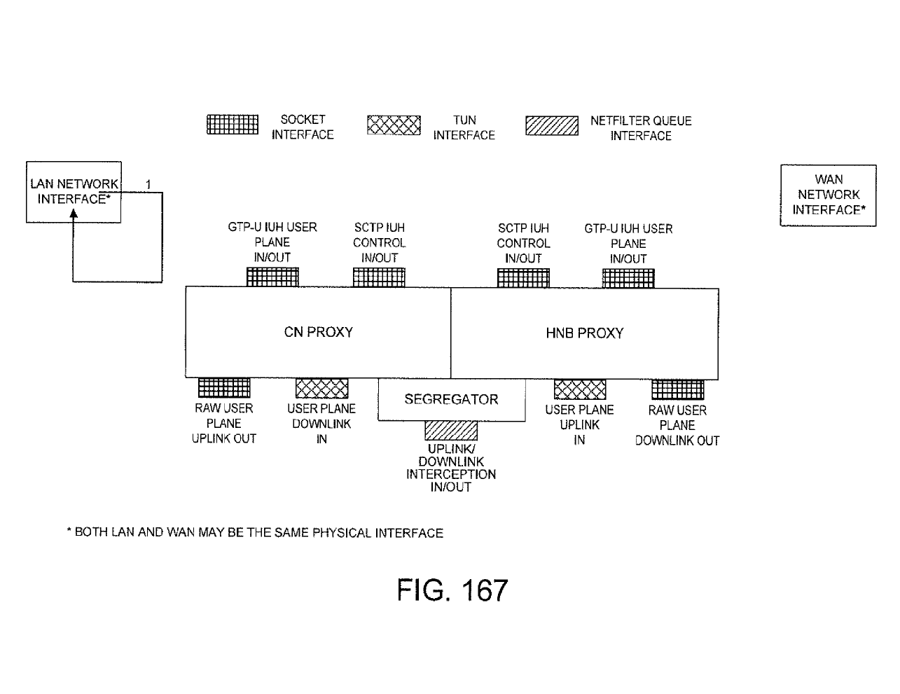

FIG. 167 illustrates an example embodiment of packet processing flows that may be provided and/or used herein. According to an embodiment, the packet processing flows depicted in FIG. 167 may be described for Wi-Fi LAN IP [symbol] Local for an uplink. For example, for Wi-Fi LAN IP [symbol] Local for an uplink, (1) the packet may be directly sent to the destination: SRC=UE Wi-Fi, DST=Local.

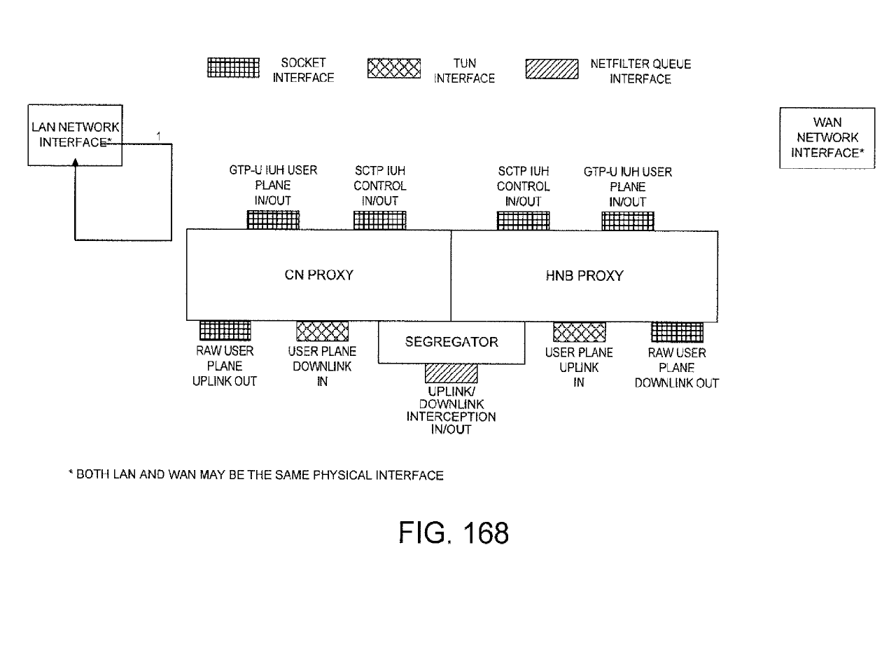

FIG. 168 illustrates an example embodiment of packet processing flows that may be provided and/or used herein. According to an embodiment, the packet processing flows depicted in FIG. 168 may be described for Wi-Fi LAN IP [symbol] Local for a downlink. For example, for Wi-Fi LAN IP [symbol] Local for a downlink, (1) the packet may be directly sent to the UE: SRC=Local, DST=UE Wi-Fi.

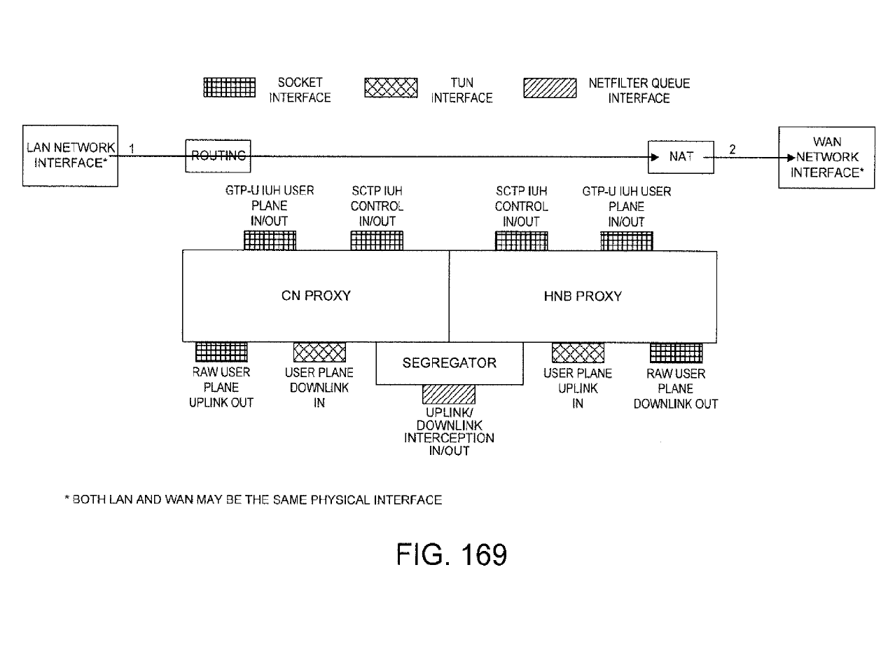

FIG. 169 illustrates an example embodiment of packet processing flows that may be provided and/or used herein. According to an embodiment, the packet processing flows depicted in FIG. 169 may be described for Wi-Fi LAN IP [symbol] Public for an uplink. For example, for Wi-Fi LAN IP [symbol] Public for an uplink, (1) the packet may be received through the LAN interface and routed (default_rt) through the WAN interface: SRC=UE Wi-Fi, DST=Public and/or (2) the packet may be source NATed and send through the WAN interface: SRC=CGW WAN, DST=Public.

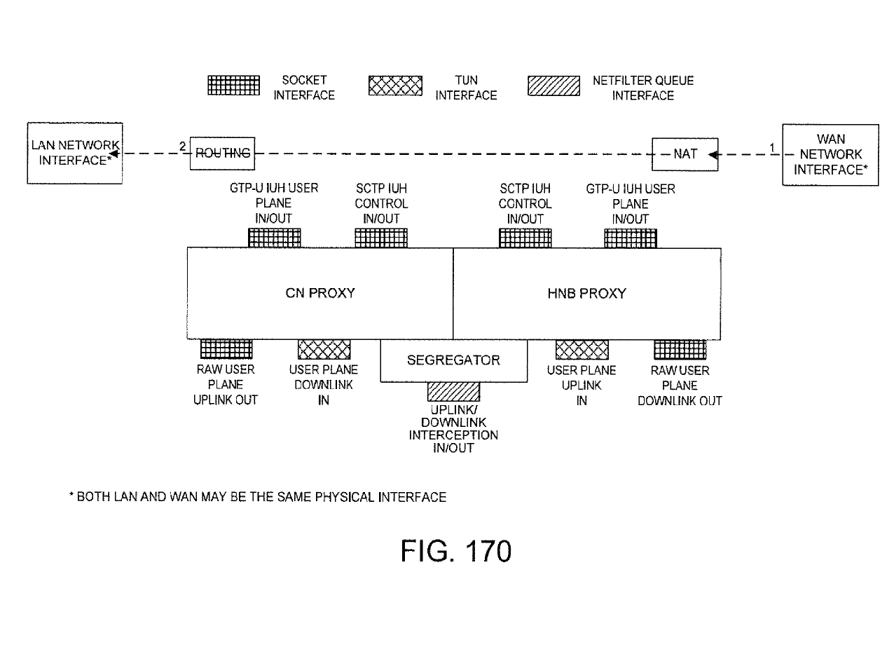

FIG. 170 illustrates an example embodiment of packet processing flows that may be provided and/or used herein. According to an embodiment, the packet processing flows depicted in FIG. 170 may be described for Wi-Fi LAN IP [symbol] Public for a downlink. For example, for Wi-Fi LAN IP [symbol] Public for a downlink, (1) the packet may be received through the WAN interface: SRC=Public, DST=CGW WAN and/or (2) the packet may be source deNATed (e.g. the destination of the response may be set to the source of the request) and routed (default_rt) through the LAN interface.

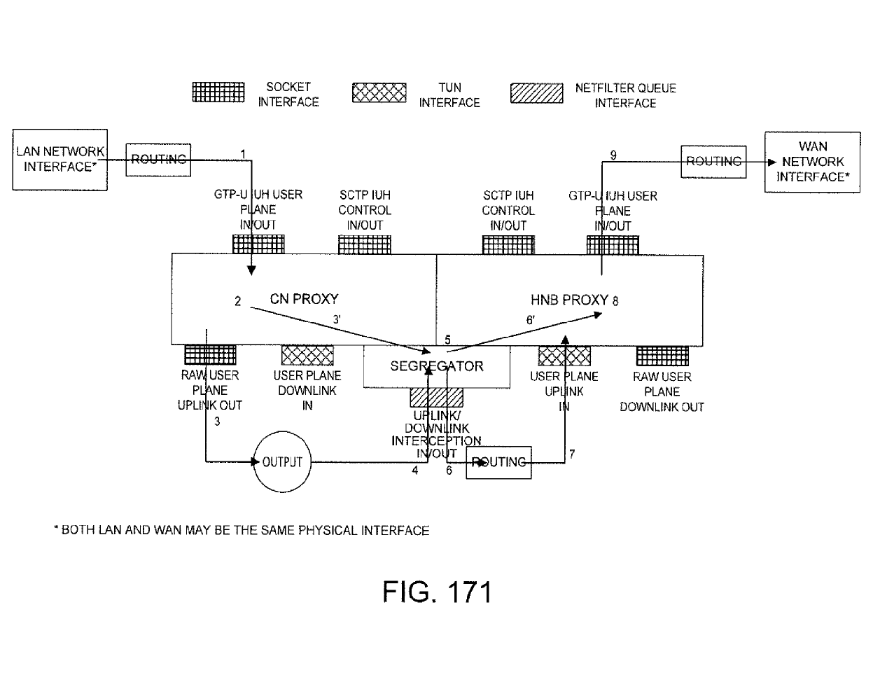

In an embodiment, one or more of the packet processing flows described above may be optimized and/or modified. FIG. 170 illustrates another example embodiment of packet processing flows (e.g. optimized processing flows) that may be provided and/or used herein. According to an embodiment, the packet processing flows depicted in FIG. 171 may be described for 3G [symbol] Public for an uplink via MCN. For example, for 3G [symbol] Public for an uplink via MCN, (1) a GTP-u packet may be received through LAN interface and routed to the CN-proxy GTP-u server: Outer: SRC=HNB, DST=CN-Proxy (CGW LAN); Inner: SRC=UE 3G, DST=Public; (2) the packet may be de-tunneled: SRC=UE 3G, DST=Public; (3′) for example, (3) and (4) above for such an embodiment may be replaced by 3′ which may forward the packet directly to the segregator using the interprocess communication; (6′) for example, (6) and (7) for such an embodiment may be are replaced by (6′) that may forward the packet directly to the HNB proxy using the interprocess communication; (8) the packet may be GTP-u tunneled: Outer: SRC=HNB proxy (CGW WAN), DST=HNBGw; Inner: SRC=UE 3G, DST=Public; and/or (9) the packet may be sent out through the HNB proxy GTP-u socket, routed (default_rt) and sent out through the WAN interface.

Although a device such as a UE, WTRU, terminal device, wireless terminal device, and the like may be described with respect to an interface or RAT, a first or second interface or first or second RAT, and the like, the device may also include additional interfaces or RATs (e.g. a third interface or RAT, a fourth interface or RAT, and the like) that may be managed as described herein by a CGW. For example, the device may include one or more interfaces or RATs such as Wi-Fi, LTE, UMTS, Bluetooth, WiMAX, and other suitable interfaces or RATs that may be managed by the CGW as described herein.

Additionally, embodiments or features described herein may provide and/or use a number of protocols or flows (e.g. that may be managed by a CGW). The protocols or flows may include data or traffic. According to example embodiments, the protocols or flows may include at least one of the following: HTTP video, HTTP data, peer-to-peer file sharing, web-based file sharing, streaming online video, flash online video, streaming peer-to-peer online video, audio, File Transfer Protocol (FTP) data, and Voice over IP (VoIP) data, and the like or a subset of the foregoing. Other protocols or flows (e.g. and/or a subset thereof) may also be provided and/or used (e.g. managed by the CGW).

Furthermore, although embodiments or features described herein may be described with respect to particular cellular technologies or network such as 3G, such embodiments may also be applicable to other cellular technologies or networks such as LTE, and the like.

Although the terms UE, WTRU, terminal device, and/or wireless terminal device may be used herein, it may and should be understood that the use of such terms may be used interchangeably and, as such, may not be distinguishable.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for segregating data, the method comprising:
storing a policy for a device on a converged gateway (CGW), the device comprising a first interface and a second interface;
receiving a flow addressed to the device at the CGW, the flow comprising a packet;
identifying a flow type of the packet at the CGW; and
transmitting the packet from the CGW to the device via one of the first and second interfaces identified in a policy associated the flow type when the device is reachable via the first and second interfaces.

2. The method of claim 1, wherein the flow type of the packet is identified as at least one of the following: HTTP video, HTTP data, peer-to-peer file sharing, web-based file sharing, streaming online video, flash online video, streaming peer-to-peer online video, audio, File Transfer Protocol (FTP) data, and Voice over IP (VoIP) data.

3. The method of claim 2, wherein the flow type of the packet is identified using one of a shallow packet inspection or a deep packet inspection.

4. The method of claim 1, further comprising inspecting the packet to identify the flow type.

5. The method of claim 1, wherein identifying a flow type of a packet comprises identifying the flow type based on a previously identified flow type.

6. The method of claim 1, further comprising:
prior to identifying the flow type of the packet, transmitting the packet to the device based on a default interface identified in the policy.

7. The method of claim 1, wherein the first interface comprises a cellular interface and the second interface comprises a Wi-Fi interface.

8. A method for segregating data, the method comprising:
receiving a packet from a mobile core network addressed to a device;
transmitting the packet via a cellular network when the device is not reachable over a Wireless Fidelity (Wi-Fi) network; and
determining a packet transport preference for the device and transmitting the packet to the device via the transport preference when the device is reachable over the Wi-Fi network, wherein the transport preference is one of the cellular network or the Wi-Fi network.

9. The method of claim 8, wherein the cellular network comprises at least one of the following:
a Home Node 13 (HMB), an eNodeB (eNB), a Home eNB (HeNB), and a femtocell.

10. The method of claim 8, further comprising identifying a flow using packet inspection; and
adding identification of flow to a flow routing table when the device is reachable over the Wi-Fi network.

11. The method of claim 10, further comprising:
receiving a second packet from the mobile core network addressed to the device, the second packet having a 3G IP destination address; and
when the device is reachable over the Wi-Fi network, transmitting the second packet to the device via a transport preference identified in the flow routing table.

12. A method for aggregating data, the method comprising:
receiving an Internet Protocol (IP) data flow;
identifying the IF data flow; and
transmitting the IP data flow to user equipment (UE) through a first radio access technology (RAT) and a second RAT based on a policy.

13. The method of claim 12, wherein the first RAT comprises a cellular network and the second RAT comprises a Wi-Fi network.

14. The method of claim 12, wherein the IP data flow is identified as at least one of the following: HTTP video, HTTP data, peer-to-peer file sharing, web-based file sharing, streaming online video, flash online video, streaming peer-to-peer online video, audio, File Transfer Protocol (FTP) data, and Voice over IP (VoIP) data.

15. The method of claim 12, wherein the policy comprises at least one of the following: user specific and data type specific.

16. A method for routing data, the method comprising:
receiving, at a converged gateway (CGW) within a mobile network, a network packet from a serving gateway, the network packet being addressed to a node associated with a first radio access technology; and
offloading, at the CGW, the network packet to a node associated with a second radio access technology.

17. The method of claim 16, wherein the first radio access technology comprises a cellular radio access technology, and wherein the node associated with the first radio access technology comprises at least one of the following: a Home Node B (HNB), eNodeB (eNB), a Home eNB (HeNB), and a femtocell.

18. The method of claim 1), wherein the second radio access technology is a non-cellular radio access technology.

19. The method of claim 18, wherein the non-cellular technology comprises a Wi-Fi technology, and wherein the node associated with the second radio access technology comprises a Wi-Fi Access Point (AP).

20. The method of claim 16, wherein the CGW is transparent relative to the node associated with the first radio access technology and the serving gateway.

21. The method of claim 16, wherein the network packet is part of an IP flow, and where a second network packet of the IP flow is routed, by the CGW, a to the node associated with the first radio access technology.

22. A method for routing traffic, the method comprising:
segregating, at a converged gateway (CGW), a plurality of traffic flows based at least in part on a segregation factor;
assigning, at the CGW, a traffic flow to one of plurality of radio access technology (RAT) connections provided by a terminal device; and
load balancing, at the CGW, the plurality of RAT connections.

23. The method of claim 22, further comprising:
determining, at the CGW, if the traffic flow is able to be reassigned to a different RAT included in the plurality of RATs when the assigned RAT is experiencing a problem; and
reassigning the traffic flow to the different RAT when the traffic flow is reassignable.

24. The method of claim 22, wherein the segregation factor is at least one of the following: a type of IP flow, a destination address, a source address, and a throughput characteristic.

25. The method of claim 22, wherein the type of IP flow comprises at least one of the following: HTTP video, HTTP data, peer-to-peer file sharing, web-based file sharing, streaming online video, flash online video, streaming peer-to-peer online video, audio, File Transfer Protocol (FTP) data, and Voice over IP (VoIP) data.

26. The method of claim 22, wherein the assigning of traffic flow is based at least one of the following: a quality level of the transports, a rule within the CGW, and a number of existing IP Flows on each RAT connection.

27. The method of claim 26, further comprising receiving, by the CGW, the quality level of the RAT connections as measured by the terminal device.

28. The method of claim 26, wherein the rule is stored by a Local Policy Server within the CGW.

29. The method of claim 28, wherein the rule is defined on a per terminal device and a per traffic flow type basis.

30. The method of claim 22, wherein the load balancing is based on at least one of the following:
a Quality level of the RAT connections, a rule within the CGW, and a number of existing IF Flows on each RAT connection.

31. The method of claim 30, further comprising receiving, at the CGW, the quality level of the RAT connections as measured by the terminal device.

32. The method of claim 30, wherein the rule is stored by a Local Policy Server within the CGW.

33. The method of claim 32, wherein the rule is defined on a per nal device and a per traffic flow type basis.

34. A method of routing data, the method comprising:
receiving a plurality of flows addressed to a device, the device having a first radio access technology (RAT) connection and a second RAT connection;
identifying a category of each of the flows;
prioritizing each of the flows based on the category and a classification of a user of the device; and
sending each of the plurality of the flows to the device via one of the first RAT connection and the second RAT connection based on the priority of each downlink flow.

35. The method of claim 34, wherein flows having a top priority are configured to be routed through the first RAT connection, and wherein flows having a bottom priority are routed through the second RAT connection.
